(19) United States
(12) Patent Application Publication
(10) Pub. No.: US 2022/0119659 A1
(43) Pub. Date: Apr. 21, 2022

(54) FORMULATIONS FOR USE WITH AN INTERMEDIATE TRANSFER MEMBER OF INDIRECT PRINTING SYSTEMS AND PRINTING PROCESSES UTILIZING SAME

(71) Applicant: LANDA CORPORATION LTD., Rehovot (IL)

(72) Inventors: Benzion LANDA, Nes Ziona (IL); Helena CHECHIK, Rehovot (IL); Einat TIROSH, Ramat Gan (IL); Moshe LEVANON, Rehovot (IL); Gal FINKELSTEIN, Tel Aviv (IL); Omer ASHKENAZI, Kfar Gibton (IL); On MERO, Ganei Tikva (IL); Dor LEVY, Petah Tikva (IL)

(21) Appl. No.: 17/414,087

(22) PCT Filed: Jan. 1, 2020
(86) PCT No.: PCT/IB2020/050001

§ 371 Date: Jun. 15, 2021

Related U.S. Application Data
(60) Provisional application No. 62/825,568, filed on Mar. 28, 2019.
(60) Provisional application No. 62/790,890, filed on Jan. 10, 2019.
(60) Provisional application No. 62/787,984, filed on Jan. 3, 2019.

(51) Int. Cl. C09D 11/322; B41M 5/00; B41M 5/025; C09D 11/38

(52) U.S. Cl. CPC C09D 11/322; C09D 11/38; B41M 5/0256; B41M 5/0017

(57) ABSTRACT

The present disclosure relates to formulations for use with an intermediate transfer members of indirect printing systems and printing methods utilizing same. The present disclosure further relates to intermediate transfer members having a release layer surface covered with the formulations of the invention. The present disclosure also relates to printed substrates, printed articles and printed patterns produced using the formulations of the invention and to kits comprising the formulations.

### TECHNOLOGICAL FIELD

The present disclosure relates to indirect printing processes and systems, more particularly to compositions suitable for the treatment of intermediate transfer members.

### BACKGROUND ART

References considered to be relevant as background to the presently disclosed subject matter are listed below:
[1] U.S. Pat. No. 9,428,663 describes indirect printing apparatus employing sacrificial coating on intermediate transfer member.
[2] US Patent Application No. 2015/0361288 describes sacrificial coating compositions for indirect printing processes.
[3] U.S. Pat. No. 10,081,175 describes auxiliary liquid set, image recording method and image recording apparatus.
[4] International Publication WO 2014/021840 describes optically clear fluid compositions formulated to be applied on a print.

The following patent applications/publications [5] to [33] to the Applicant provide potentially relevant background material, and are all incorporated herein by reference in their entirety:
[5] WO 2017/208246 (publication of PCT/IL2017/050616 filed Jun. 1, 2017);
[6] WO/2019/111223 (publication of PCT/IB2018/059761 filed Dec. 7, 2018);
[7] PCT application No. PCT/IB2019/055288;
[8] WO/2017/009722 (publication of PCT/IB2016/053049 filed May 25, 2016):
[9] WO/2016/166690 (publication of PCT/IB2016/052120 filed Apr. 4, 2016);
[10] WO/2016/151462 (publication of PCT/IB2016/051560 filed Mar. 20, 2016);
[11] WO/2016/113698 (publication of PCT/IB2016/050170 filed Jan. 14, 2016);
[12] WO/2015/110988 (publication of PCT/IB2015/050501 filed Jan. 22, 2015);
[13] WO/2015/036812 (publication of PCT/IB2013/002571 filed Sep. 12, 2013);
[14] WO/2015/036864 (publication of PCT/IB2014/002366 filed Sep. 11, 2014):
[15] WO/2015/036865 (publication of PCT/IB2014/002395 filed Sep. 11, 2014);
[16] WO/2015/036906 (publication of PCT/IB2014/064277 filed Sep. 12, 2014):
[17] WO/2013/136220 (publication of PCT/IB2013/051719 filed Mar. 5, 2013);
[18] WO/2013/132419 (publication of PCT/IB2013/051717 filed Mar. 5, 2013);
[19] WO/2013/132424 (publication of PCT/IB2013/051727 filed Mar. 5, 2013);
[20] WO/2013/132420 (publication of PCT/IB2013/051718 filed Mar. 5, 2013);
[21] WO/2013/132439 (publication of PCT/IB2013/051755 filed Mar. 5, 2013);
[22] WO/2013/132438 (publication of PCT/IB2013/051751 filed Mar. 5, 2013):
[23] WO/2013/132418 (publication of PCT/IB2013/051716 filed Mar. 5, 2013);
[24] WO/2013/132356 (publication of PCT/IB2013/050245 filed Jan. 10, 2013):
[25] WO/2013/132345 (publication of PCT/IB2013/000840 filed Mar. 5, 2013);
[26] WO/2013/132339 (publication of PCT/IB2013/000757 filed Mar. 5, 2013):
[27] WO/2013/132343 (publication of PCT/IB2013/000822 filed Mar. 5, 2013);
[28] WO/2013/132340 (publication of PCT/IB2013/000782 filed Mar. 5, 2013);
[29] WO/2013/132432 (publication of PCT/IB2013/051743 filed Mar. 5, 2013):
[30] WO/2019/012456 (publication of PCT/IB2018/055126 file on Jul. 11, 2018):
[31] U.S. Pat. No. 9,229,664:
[32] WO 2013/132424 (publication of PCT/IB2013/051727 filed Mar. 5,2013); and
[33] WO 2017/208152 (publication of PCT/IB2017/053177 filed May 30, 2017).

Acknowledgement of the above references herein is not to be inferred as meaning that these are in any way relevant to the patentability of the presently disclosed subject matter.

### SUMMARY OF THE INVENTION

The inventors of the present invention have developed aqueous formulations for use with an intermediate transfer member (ITM) of indirect printing systems.

As will be further disclosed herein, the aqueous formulations of the present invention can provide one or more of the following advantages: having improved solubility at room temperature, good wettability on the ITM, improved quality ink image, good ink wetting and ink spreading characteristics, exhibiting improved wet image quality and/or improved image transfer with aqueous inks, improved transfer to substrate media without dried treatment splitting phenomenon during printing, increased shelf life and improved processing in the indirect printing machinery. At times, to achieve one or more of the aforementioned advantages, the formulations according to the present invention may comprise at least one modified polysaccharide as disclosed herein.

Further, utilizing the aqueous formulations of the present invention as ITM treatment formulations in the printing processes disclosed herein resulted with high quality ink image and printed patterns/articles, with improved mechanical properties e.g., improved rub resistance. To achieve the improved mechanical properties, the formulations according to the present invention may further comprise at least one particulate material as disclosed herein.

In the present invention, a release surface of an intermediate transfer member is pre-treated (e.g., coated) with the aqueous formulations according to the present invention before deposition of an ink image thereto. The aqueous formulation (referred to herein also as aqueous treatment formulation) is applied to a surface of an ITM to form thereon a thin wet treatment layer which is optionally subjected to a drying process on the ITM release surface to leave a thin dried treatment film on the ITM release surface. Then after, droplets of an aqueous ink are deposited (e.g. by ink-jetting) onto the thin dried treatment film to form an ink image thereon. It is noted that the ink droplets may be continuous or none continuous. It is further noted that the ink droplets may cover the whole area of the thin dried film or part of the area thereof (the latter case results with regions on the dry thin treatment layer with no ink deposited thereon). The formed ink-image is then subjected to a drying process to leave an ink residue on the dried treatment film. The dried ink-image is then transferred, together with the thin dried treatment film, from the ITM surface to a final printed substrate (e.g. foil-based, paper-based or plastic-based).

Thus, the thin treatment layer according to the present disclosure is present on the top surface ara of the final printed substrate. Being the top layer, the thin treatment layer allows to beneficially tune image surface properties, such as coefficient of friction, mechanical strength etc., and as such serves as a protective layer to ink image surface.

As the present application will further disclose, the resulted printed images according to the present invention exhibit improved durability e.g., in terms of rub resistance and/or coefficient of friction. The improvement is believed to be achieved thanks to the presence of specific ingredients in the aqueous treatment formulations. In particular, the aqueous treatment formulations according to the present invention comprise specific thermoplastic and/or thermosetting particulate materials that provide the resulted printed article (i.e., a substrate with an ink image deposited thereon together with a thin dried treatment film) improved mechanical properties (such as improved rub resistance and/or improved coefficient of friction) compared to a printed article produced in the absence of said particulate materials. The improved mechanical properties of the printed article are manifested both in regions on the image wherein an ink is present therein as well as in regions wherein no ink is present (i.e., regions wherein only the thin dried treatment film is present).

The aforementioned specific particulate materials were found to be beneficially compatible with the various ingredients of the aqueous treatment formulations, with the nature of the various components of the indirect printing system according to the present invention (e.g., the ITM, the ink formulations) as well as with the printing conditions (e.g., temperatures, operation velocities etc.).

Additives such as wax particles or binders are known in the art as ink additives that improve the rub resistance of an ink image formed with said inks. Said additives are specific to the inks used and the addition thereof to each ink in the printing process is required to achieve the rub resistance of the printed ink. In contrast to the ink additives which are known in the art, the thermoplastic and/or thermosetting particulate materials are present in the aqueous treatment formulations according to the present invention. No ink is present in said aqueous treatment formulations. In the printing process according to the present invention the dry thin treatment film is first formed (the thermoplastic and/or thermosetting particulate materials are present in said dry thin treatment film). The ink is then deposited on said dry thin treatment film. The dry treatment film thus provides improved image durability to a great variety of inks. In particular, and as will be demonstrated herein below, the improved durability of the ink images of the present invention is not limited to specific inks but rather is achieved with a broad spectrum of inks. Accordingly, the improved durability achieved according to the present invention may be considered as universal to all inks, without manifestation of any damage to the printing quality, color gamut etc.

Thanks to the nature of the indirect printing method that utilizes the aqueous formulations according to the present invention, the need of rub (or others) resistance ink additives may be eliminated. It is noted however that the ink formulations according to the present invention may or may not include rub resistance or other mechanical improvement additives. To this end, when such additives (e.g., known in the art) are present in the ink formulations, the improvement in the mechanical properties of the resulted ink image may be either additive (the sum of the improvement resulted from the ink additives and from the aqueous treatment formulation according to the present invention) or synergistic (more than the sum of the improvement resulted from the ink additives and from the aqueous treatment formulation according to the present invention).

It is further noted that the improved mechanical properties of the image of the resulted printed article according to the present invention is manifested in regions of the image that contain ink as well as in regions without the ink. The regions without the ink are originated from regions on the treated ITM onto which ink was not deposited and hence during the transfer to the substrate only the treatment layer is transferred. Such regions illustrate improved durability such are improved coefficient of friction.

Coating compositions such as varnish or lacquer are known in the art as providing improved mechanical characteristics to the printed image. These coating compositions are unusually directly applied onto a printed image to provide a coating protecting layer. Such coating protecting layer is known of its relatively high thickness (e.g., more than 1 micron layer thickness). As opposed to such direct printing processes, the aqueous treatment formulations according to the present invention form a thin layer (at the nm scale) onto the ITM. Apart from beneficially providing the resulted printed article with improved durability, utilizing the aqueous treatment formulations in the process according to the present invention also provides improved transferability from the ITM to the final substrate surface by insuring contact. Further, the thin treatment layer produced from the aqueous treatment formulations according to the present invention also affects the surface of the ITM (e.g., a blanket) and as such enables beneficial ink drop lateral distribution onto the ITM, thus inter-alia providing the resulted ink image improved printing quality. Furthermore, the thin layer formed by the aqueous treatment formulations according to the present invention also provides protection of the ITM surface from contamination, degradation and mechanical damage and may also serve as disposal coating that is transferred from the ITM surface to the final substrate surface so that the ITM surface remains fresh after each transfer. Thus, utilizing the aqueous formulations according to the present invention avoids the necessity for application of varnish/protective layer.

Thus, the present invention provides in one of its aspects an aqueous (treatment) formulation for use with an intermediate transfer member of a printing system, the formulation comprising:

at least one water soluble polymer [e.g., at least one modified polysaccharide such as cellulose ether e.g., methylcellulose and hydroxypropyl methylcellulose (HPMC)];

at least one carrier liquid containing water; and

optionally, one or more of (a) at least one humectant (water absorbing agent): (b) at least one surfactant (e.g., a nonionic surfactant, a silicone surfactant); and (c) at least one wetting agent e.g., polyethyleneimine (PEI);

wherein said formulation optionally further comprises at least one particulate material selected from (i) at least one thermoplastic polymeric particulate material; (ii) at least one thermosetting polymeric particulate material; or (iii) a combination thereof.

In a further one of its aspects the present invention provides an aqueous (treatment) formulation for use with an intermediate transfer member of a printing system, the formulation comprising:

at least one modified polysaccharide such as cellulose ether e.g., methylcellulose and hydroxypropyl methylcellulose (HPMC)];

at least one carrier liquid containing water:

at least one particulate material selected from (i) at least one thermoplastic polymeric particulate material; (ii) at least one thermosetting polymeric particulate material; or (iii) a combination thereof; and

optionally, one or more of (a) at least one humectant (water absorbing agent); (b) at least one surfactant (e.g., a nonionic surfactant, a silicone surfactant); and (c) at least one wetting agent e.g., polyethyleneimine (PEI);

In another one of its aspects the present invention provides an aqueous (treatment) formulation for use with an intermediate transfer member of a printing system, the aqueous formulation comprising:

at least one modified polysaccharide [e.g., cellulose ether such as methylcellulose and hydroxypropyl methylcellulose (HPMC)];

at least one wetting agent (e.g., PEI);

at least one water absorbing agent:

at least one surfactant (e.g., a nonionic surfactant, a silicone surfactant);

at least one carrier liquid containing water; and

wherein said formulation optionally further comprises at least one particulate material selected from (i) at least one thermoplastic polymeric particulate material; (ii) at least one thermosetting polymeric particulate material; or (iii) a combination thereof.

Yet, in another one of its aspects the present invention provides an aqueous (treatment) formulation for use with an intermediate transfer member of a printing system, the formulation comprising:

a, at least one modified polysaccharide [e.g., cellulose ether such as methylcellulose and hydroxypropyl methylcellulose (HPMC)], having a solubility in water, or within the aqueous treatment formulation, of at least 1.5%, or at least 2%, or at least 3%, or at least 4%, or at least 5%, or at least 7%, or at least 8%, or at least 10%, by weight, at 25° C., and at least one or more of the following characteristics:

i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C. or at least 75° C., and optionally, at most 120° C., at most 110° C. at most 105° C., or between 60-120° C., or between 60-110° C., or between 60-100° C., or between 65-110° C., or between 65-105° C., or between 65-100° C., or between 70-110° C., or between 70-100° C., or between 75-110° C., or between 75-100° C., or between 80-100° C.;

ii. a viscosity, in mPa·s, as measured in 2% concentration by weight in water at 25° C., is at most 11, at most 10, at most 9, at most 8, at most 7, at most 6, at most 5, at most 4, and optionally, at least 0.5 or at least 1, or at least 2, or within a range of 0.5-10, 1-8, 2-8, 2-5, or 2-4;

b. water;

c, optionally at least one of, or two of or all three of: at least one water absorbing agent, at least one surfactant (e.g., a nonionic surfactant, a silicone surfactant), and at least one wetting agent [e.g., polyethylcneimine (PEI)]; and

wherein said formulation optionally further comprises at least one particulate material selected from (i) at least one thermoplastic polymeric particulate material; (ii) at least one thermosetting polymeric particulate material; or (iii) a combination thereof.

In another one of its aspects the present invention provides an aqueous (treatment) formulation for use with an intermediate transfer member of a printing system, the formulation comprising:

(a) at least one modified polysaccharide (e.g., cellulose ether such as methylcellulose and HPMC), having a solubility in water, or within the aqueous treatment formulation, of at least 1.5% or at least 2%, or at least 3% or at least 4%, or at least 5%, or at least 7%, or at least 8%, or at least 10%, by weight, at 25° C.;

(b) at least one wetting agent e.g., a PEI; and

(c) a carrier liquid containing water, said water making up at least 50% or at least 55% or at least 60% or at least 65% of the aqueous (treatment) formulation, on a weight-weight basis;

(d) optionally at least one of, at least two of, or all of: a water absorbing agent; a non-ionic surfactant; and a silicone surfactant; and

wherein said formulation optionally further comprises at least one particulate material selected from (i) at least one thermoplastic polymeric particulate material; (ii) at least one thermosetting polymeric particulate material; or (iii) a combination thereof.

In another one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);
one or more of (i) a cationic emulsion of at least one oxidized polyethylene wax particulate material; (ii) a dispersion and/or an emulsion of at least one coated wax particulate material; and (iii) a dispersion and/or an emulsion of at least one thermosetting polymeric particulate material; and

a carrier liquid containing water.

In another one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);
at least one cationic emulsion of at least one oxidized polyethylene wax particulate material;

a carrier liquid containing water; and

optionally, one or more of (a) at least one surfactant; (b) at least one humectant; and (c) at least one wetting agent.

In a further one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);

at least one dispersion or emulsion of at least one coated wax particulate material;

a carrier liquid containing water; and
optionally, one or more of (a) at least one surfactant; (b) at least one humectant; and (c) at least one wetting agent.

In yet a further one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);

at least one dispersion or emulsion of at least one thermosetting polymeric particulate material;

a carrier liquid containing water; and

optionally, one or more of (a) at least one surfactant; (b) at least one humectant; and (c) at least one wetting agent.

In a further one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);

at least one particulate material selected from (i) at least one oxidized polyethylene wax particulate material; (ii) at least one coated wax particulate material; (iii) at least one thermosetting polymeric particulate material; or (iv) any combination thereof;

a carrier liquid containing water; and
optionally, one or more of (a) at least one surfactant; (b) at least one humectant; and (c) at least one wetting agent.

Yet, in another one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);
at least one particulate material selected from (i) at least one coated wax particulate material, (ii) at least one thermosetting polymeric particulate material; or (iii) or any combination thereof;
a carrier liquid containing water; and
optionally, one or more of (a) at least one surfactant; (b) at least one humectant; and (c) at least one wetting agent.

In a further one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);

at least one coated wax particulate material; and

optionally, one or more of (a) at least one surfactant: (b) at least one humectant; and (c) at least one wetting agent.

In yet a further one of its aspects the present invention provides an aqueous (treatment) formulation for use with an intermediate transfer member of a printing system, the aqueous formulation comprising:

at least one water soluble polymer (optionally being at least one modified polysaccharide e.g., cellulose ether such as methylcellulose and HPMC);

at least one thermosetting polymeric particulate material;

a carrier liquid containing water; and
optionally, one or more of (a) at least one surfactant; at least one humectant; and (c) at least one wetting agent.

In another one of its aspects the present invention provides an aqueous formulation for use with an intermediate transfer member of a printing system, the aqueous formulation comprising:

at least one water soluble polymer (optionally wherein said at least one water soluble polymer being at least one modified polysaccharide e.g., cellulose ether such as methylcellulose and HPMC);

at least one surfactant (which may be a first non-ionic surfactant, optionally having a solubility in water of at least 7%, at 25° C. and/or a second non-ionic, silicone-containing surfactant, optionally having a solubility in water of at least 1%, at 25° C.):

at least one particulate material selected from (i) at least one thermoplastic polymeric particulate material (optionally in the form of an emulsion or a dispersion); (ii) at least one thermosetting polymeric particulate material (optionally in the form of an emulsion or a dispersion); or (iii) a combination thereof;

a carrier liquid containing water, optionally making up at least about 55%, by weight of the aqueous formulation; and

optionally, one or more of (a) at least one humectant; and (b) at least one wetting agent e.g., PEI.

In another one of its aspects the present invention provides an aqueous (treatment) formulation for use with an intermediate transfer member of a printing system, the aqueous formulation comprising:

at least 1.5%, by weight, of at least one water soluble polymer having a solubility in water of at least 5% at 25° C. (optionally wherein said at least one water soluble polymer being at least one modified polysaccharide e.g., cellulose ether such as methylcellulose and HPMC):

at least 5%, by weight, of a first non-ionic surfactant having a solubility in water of at least 7%, at 25° C.;

a second non-ionic, silicone-containing surfactant having a solubility in water of at least 1%, at 25° C.:

at least one particulate material selected from (i) at least one thermoplastic polymeric particulate material; (ii) at least one thermosetting polymeric particulate material; or (iii) a combination thereof:

a carrier liquid containing water, said water making up at least about 55%, by weight of the aqueous formulation; and

optionally, one or more of (a) at least one humectant; and (b) at least one wetting agent e.g., polyethylencimine (PEI).

In a further one of its aspects the present invention provides an aqueous (treatment) formulation for use with an intermediate transfer member of a printing system, the aqueous formulation comprising:

at least 1.5%, by weight, of at least one water soluble polymer having a solubility in water of at least 5% at 25° C. (optionally wherein said at least one water soluble polymer being at least one modified polysaccharide e.g., cellulose ether such as methylcellulose and HPMC);

at least 5%, by weight, of a first non-ionic surfactant having a solubility in water of at least 7%, at 25° C.;

a second non-ionic, silicone-containing surfactant having a solubility in water of at least 1%, at 25° C.;

at least one thermoplastic polymeric particulate material;

a carrier liquid containing water, said water making up at least about 55%, by weight of the aqueous formulation; and

optionally, one or more of (a) at least one humectant; and (b) at least one wetting agent e.g., PEI.

In a further one of its aspects the present invention provides an aqueous (treatment) formulation for use with an intermediate transfer member of a printing system, the aqueous formulation comprising:

at least 1.5%, by weight, of at least one water soluble polymer having a solubility in water of at least 5% at 25° C. (optionally wherein said at least one water soluble polymer being at least one modified polysaccharide e.g., cellulose ether such as methylcellulose and HPMC):

at least 5%, by weight, of a first non-ionic surfactant having a solubility in water of at least 7%, at 25° C.;

a second non-ionic, silicone-containing surfactant having a solubility in water of at least 1%, at 25° C.;

at least one thermosetting polymeric particulate material;

a carrier liquid containing water, said water making up at least about 55%, by weight of the aqueous formulation; and

optionally, one or more of (a) at least one humectant; and (b) at least one wetting agent e.g., PEI.

Yet, in a further one of its aspects the present invention provides an aqueous (treatment) formulation for use with an intermediate transfer member of a printing system, the aqueous formulation comprising:

at least 1.5%, by weight, of at least one water soluble polymer having a solubility in water of at least 5% at 25° C. (optionally wherein said at least one water soluble polymer being at least one modified polysaccharide e.g., cellulose ether such as methylcellulose and HPMC);

at least 5%, by weight, of a first non-ionic surfactant having a solubility in water of at least 7%, at 25° C.;

a second non-ionic, silicone-containing surfactant having a solubility in water of at least 1%, at 25° C.;

at least one dispersion and/or emulsion selected from (i) a dispersion and/or emulsion of at least one thermoplastic polymeric particulate material; (ii) a dispersion and/or emulsion of at least one thermosetting polymeric particulate material; or (iii) a combination thereof;

a carrier liquid containing water, said water making up at least about 55%, by weight of the aqueous formulation; and optionally, one or more of (a) at least one humectant; and (b) at least one wetting agent e.g., PEI.

In another one of its aspects the present invention provides an aqueous (treatment) formulation for use with an intermediate transfer member of a printing system, the aqueous formulation comprising:

at least 1.5%, by weight, of at least one water soluble polymer having a solubility in water of at least 5% at 25° C. (optionally wherein said at least one water soluble polymer being at least one modified polysaccharide e.g., cellulose ether such as methylcellulose and HPMC).

at least 5%, by weight, of a first non-ionic surfactant having a solubility in water of at least 7%, at 25° C.;

a second non-ionic, silicone-containing surfactant having a solubility in water of at least 1%, at 25° C.;
an emulsion and/or a dispersion ofat least one thermoplastic polymeric particulate material;

a carrier liquid containing water, said water making up at least about 55%, by weight of the aqueous formulation; and

optionally, one or more of (a) at least one humectant; and (b) at least one wetting agent e.g., PEI.

In a further one of its aspects the present invention provides an aqueous (treatment) formulation for use with an intermediate transfer member of a printing system, the aqueous formulation comprising:

at least 1.5%, by weight, of at least one water soluble polymer having a solubility in water of at least 5% at 25° C. (optionally wherein said at least one water soluble polymer being at least one modified polysaccharide e.g., cellulose ether such as methylcellulose and HPMC);

at least 5%, by weight, of a first non-ionic surfactant having a solubility in water of at least 7%, at 25° C.;

a second non-ionic, silicone-containing surfactant having a solubility in water of at least 1%, at 25° C.;

a dispersion and/or an emulsion of at least one thermosetting polymeric particulate material;

a carrier liquid containing water, said water making up at least about 55%, by weight of the aqueous formulation; and

optionally, one or more of (a) at least one humectant; and (b) at least one wetting agent e.g., PEI.

In some embodiments the particulate material according to the present invention is provided in the form of an emulsion.

In some embodiments the particulate material according to the present invention is provided in the form of a dispersion.

In another one of its aspects the present invention provides a method of indirect printing comprising:

a. providing an intermediate transfer member (ITM) comprising a release layer surface;
b. providing an aqueous (treatment) formulation according to the invention;
c. applying the aqueous (treatment) formulation onto the ITM release layer surface to form thereon a wet (treatment) layer optionally having a thickness (e.g., uniform thickness) of at most about 1.0 μm (e.g., at most 0.8 μm, at most 0.5 μm, at most 0.4 μm, at most 0.3 μm):
d, optionally subjecting the wet (treatment) layer to a drying process to form a dried (treatment) film layer, from the wet (treatment) layer, on the ITM release layer surface, said dried film layer optionally having a thickness of at least about 20 nm and at most about 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm);
e. depositing droplets of an aqueous ink onto the dried (treatment) film to form an ink image on the release layer surface of the ITM release layer surface;
f. drying the ink image to leave an ink-image residue on the ITM release layer surface; and
g. transferring the ink-image residue (e.g., together with the dried treatment film layer) onto a printing substrate by pressured contact between the ITM and the printing substrate.

In a further one of its aspects the present invention provides a method of indirect printing comprising:

a. providing an intermediate transfer member comprising a release layer surface;
b. providing an aqueous formulation comprising:

at least one water soluble polymer (optionally being at least one modified polysaccharide e.g., cellulose ether such as methylcellulose and HPMC);

at least one particulate material selected from (i) at least one thermoplastic polymeric particulate material (optionally provided in the form of an emulsion and/or a dispersion); (ii) at least one thermosetting polymeric particulate material (optionally provided in the form of an emulsion and/or a dispersion); or (iii) a combination thereof:

a carrier liquid containing water; and
optionally, one or more of (iv) at least one surfactant; (v) at least one humectant; and (vi) at least one wetting agent;
   c. applying the aqueous formulation onto the ITM release layer surface to form thereon a wet (treatment) layer optionally having a thickness (e.g., uniform thickness) of at most about 1.0 μm (e.g., at most 0.8 μm, at most 0.5 μm, at most 0.4 μm, at most 0.3 μm);
   d, optionally subjecting the wet (treatment) layer to a drying process to form a dried (treatment) film layer, from the wet (treatment) layer, on the ITM release layer surface, said dried film layer optionally having a thickness of at least about 20 nm and at most about 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm);
   e. depositing droplets of an aqueous ink onto the dried (treatment) film to form an ink image on the release layer surface of the ITM release layer surface;
   f. drying the ink image to leave an ink-image residue on the ITM release layer surface; and
   g. transferring the ink-image residue (e.g., together with the dried treatment film layer) onto a printing substrate by pressured contact between the ITM and the printing substrate.

In yet another one of its aspects the present invention provides a method of indirect printing on a substrate, the method comprising:

providing an intermediate transfer member:

providing an aqueous treatment formulation substantially as disclosed herein above and below;

applying the aqueous treatment formulation to an image receiving surface of the ITM to form a wet treatment layer;

optionally at least partially drying the wet treatment layer to form an at least partially dry treatment layer;

jetting aqueous ink droplets onto the partially dried treatment layer to form a wet ink image;

at least partially drying the wet ink image on the aqueous treatment layer to form a partially dried ink image film; and

transferring a partially dried ink image film to a printing substrate by pressured contact between said surface of the ITM and the printing substrate.

In yet a further one of its aspects the present invention provides a system for printing, the system comprising:

a. an intermediate transfer member comprising a release layer surface;
b. a quantity of the aqueous formulation according to the invention;
c. a treatment station for applying the aqueous formulation to the ITM surface to form thereon a wet (treatment) layer optionally having a thickness of at most about 1.0 μm (e.g., at most 0.8 μm, at most 0.5 μm, at most 0.4 μm, at most 0.3 μm);
d. an image forming station for forming ink images on the ITM by depositing droplets of an aqueous ink upon the ITM surface after the wet (treatment) layer has dried into a dried (treatment) film so that the droplets are applied to the dried film, said dried film layer optionally having a thickness of at least about 20 nm and at most about 200 nm (e.g. at most 200 nm, 190 nm, 180 nm, 170 nm, 160 nm, 150 nm, 140 nm, 130 nm, 120 nm, 110 nm, 100 nm. 90 nm, 80 nm, 70 nm, 60 nm, 50 nm, and optionally at least 20 nm or at least 30 nm); and
e. a transfer station for transferring the ink images (e.g., together with the dried treatment film layer) from the ITM to a substrate.

In yet another one of its aspects the present invention provides a system for indirect printing, the system comprising:

i. an intermediate transfer member e.g., comprising a silicone-based release layer surface:

ii. a container containing an aqueous (treatment) formulation substantially as disclosed herein;

iii. a treatment station for applying the aqueous (treatment) formulation to the silicone-based release layer surface of the ITM to form thereon a wet treatment layer;

iv. an optional drying station for drying the aqueous treatment formulation;

v, at least one ink jet nozzle positioned proximate to the intermediate transfer member and configured for jetting ink droplets onto the aqueous treatment formulation formed on the intermediate transfer member;

vi. an ink processing station configured to at least partially dry the ink on the aqueous treatment formulation formed on the intermediate transfer member to produce an ink-image residue; and

vii. an ink-image residue transfer mechanism for transferring the ink-image residue onto a printing substrate by pressured contact between the ITM and the printing substrate.

Yet, in a further one of its aspects the present invention provides a printing system comprising

a. an intermediate transfer member (ITM) comprising a flexible endless belt mounted over a plurality of guide rollers:
b. an image forming station configured to form ink images upon a surface of the ITM, first and second of the guide rollers being arranged upstream and downstream of the image forming station to define an upper run passing through the image forming station and a lower run;
c. an impression station through which the lower run of the ITM passes, the impression station being disposed downstream of the image forming station and configured to transfer the ink images from the ITM surface to substrate; and
d. a treatment station disposed downstream of the impression station and upstream of the image forming station for forming a uniform thin layer of a liquid formulation onto the ITM surface at the lower run thereof, the treatment station comprising:
e. a coater for coating the ITM with the aqueous (treatment) formulation according to the invention; and
f. a coating thickness-regulation assembly for removing excess liquid so as to leave only a desired uniform wet thin layer of the formulation, said layer optionally having a thickness of at most about 1.0 μm (e.g., at most 0.8 μm, at most 0.5 μm, at most 0.4 μm, at most 0.3 μm), the coating thickness-regulation assembly comprising a rounded tip facing the ITM surface at the lower run.

In another one of its aspects the present invention provides a system for printing, the system comprising:

a. an intermediate transfer member comprising a release layer surface:
b. a quantity of an aqueous formulation comprising:

at least one water soluble polymer (optionally being at least one modified polysaccharide e.g., cellulose ether such as methylcellulose and HPMC);

at least one particulate material selected from (i) at least one thermoplastic polymeric particulate material (optionally provided in the form of an emulsion and/or a dispersion); (ii) at least one thermosetting polymeric particulate material (optionally provided in the form of an emulsion and/or a dispersion); or (iii) a combination thereof;

a carrier liquid containing water; and
optionally, one or more of (iv) at least one surfactant; (v) at least one humectant; and (vi) at least one wetting agent;
   c. a treatment station for applying the aqueous formulation to the ITM surface to form thereon a wet (treatment) layer optionally having a thickness of at most about 1.0 μm (e.g., at most 0.8 μm, at most 0.5 μm, at most 0.4 μm, at most 0.3 μm);
   d. an image forming station for forming ink images on the ITM by depositing droplets of an aqueous ink upon the ITM surface after the wet (treatment) layer has dried into a dried (treatment) film so that the droplets are applied to the dried film, said dried film layer optionally having a thickness of at least about 20 nm and at most about 200 nm (e.g. at most 200 nm, 190 nm, 180 nm, 170 nm, 160 nm, 150 nm, 140 nm, 130 nm, 120 nm, 110 nm, 100 nm. 90 nm, 80 nm, 70 nm, 60 nm, 50 nm, and optionally at least 20 nm or at least 30 nm); and
   e. a transfer station for transferring the ink images (e.g., together with the dried treatment film layer) from the ITM to a substrate.

In yet another one of its aspects the present invention provides a system for printing, the system comprising:

a. an intermediate transfer member comprising a flexible endless belt mounted over a plurality of guide rollers;
b. an image forming station configured to form ink images upon a surface of the ITM, first and second of the guide rollers being arranged upstream and downstream of the image forming station to define an upper run passing through the image forming station and a lower run;
c. an impression station through which the lower run of the ITM passes, the impression station being disposed downstream of the image forming station and configured to transfer the ink images from the ITM surface to substrate; and
d. a treatment station disposed downstream of the impression station and upstream of the image forming station for forming a uniform thin layer of a liquid formulation onto the ITM surface at the lower run thereof, the treatment station comprising:
e. a coater for coating the ITM with a quantity of an aqueous (treatment) formulation comprising:

at least one water soluble polymer (optionally being at least one modified polysaccharide e.g., cellulose ether such as methylcellulose and HPMC);

at least one particulate material selected from (i) at least one thermoplastic polymeric particulate material (optionally provided in the form of an emulsion and/or a dispersion); (ii) at least one thermosetting polymeric particulate material (optionally provided in the form of an emulsion and/or a dispersion); or (iii) a combination thereof;

a carrier liquid containing water; and
optionally, one or more of (iv) at least one surfactant; (v) at least one humectant; and (vi) at least one wetting agent; and
   f. a coating thickness-regulation assembly for removing excess liquid so as to leave only a desired uniform wet thin layer of the formulation, said layer optionally having a thickness of at most about 1.0 μm (e.g., at most 0.8 μm, at most 0.5 μm, at most 0.4 μm, at most 0.3 μm), the coating thickness-regulation assembly comprising a rounded tip facing the ITM surface at the lower run.

In a further one of its aspects the present invention provides a method of improving at least one mechanical property (e.g., rub resistance, scratch resistance, coefficient of friction, surface tackiness etc.) of a printed ink image (on a substrate) comprising:

a. providing an intermediate transfer member comprising a release layer surface;
b. providing the aqueous formulation according to the present invention, wherein said formulation comprises at least one particulate material as disclosed herein;
c. applying the aqueous formulation onto the ITM release layer surface to form thereon a wet (treatment) layer optionally having a thickness (e.g., uniform thickness) of at most about 1.0 μm (e.g., at most 0.8 μm, at most 0.5 μm, at most 0.4 μm, at most 0.3 μm);
d, optionally subjecting the wet (treatment) layer of (c) to a drying process to form a dried (treatment) film layer, from the wet (treatment) layer, on the ITM release layer surface, said dried film layer optionally having a thickness of at least about 20 nm and at most 200 nm (e.g. at most 200 nm. 190 nm, 180 nm, 170 nm. 160 nm, 150 nm, 140 nm. 130 nm, 120 nm, 110 nm, 100 nm, 90 nm, 80 nm, 70 nm, 60 nm, 50 nm, and optionally at least 20 nm or at least 30 nm);
e. depositing droplets of an aqueous ink onto the optionally dried (treatment) film to form an ink image on the release layer surface of the ITM release layer surface;
f. drying the ink image to leave an ink-image residue on the ITM release layer surface; and
g. transferring the ink-image residue (e.g., together with the dried treatment film layer) onto a printing substrate by pressured contact between the ITM and the printing substrate;
to thereby produce a printed ink image on a substrate, wherein said printed ink image has at least one mechanical property improved compared to an ink image produced with said aqueous formulation but without the particulate material.

In yet a further one of its aspects the present invention provides a method of improving at least one mechanical property (e.g., rub resistance, scratch resistance, coefficient of friction, surface tackiness, etc.) of a printed ink image (on a substrate) comprising:

a. providing an intermediate transfer member comprising a release layer surface;
b. providing an aqueous formulation comprising:

at least one water soluble polymer (optionally being at least one modified polysaccharide e.g., cellulose ether such as methylcellulose and HPMC);

a carrier liquid containing water; and

optionally, one or more of (i) at least one surfactant; (ii) at least one humectant; and (iii) at least one wetting agent;

c. adding to the aqueous formulation of (b) one or more of (i) an emulsion and/or a dispersion of at least one thermoplastic polymeric particulate material; and (ii) a dispersion and/or an emulsion of at least one thermosetting polymeric particulate material:
d. applying the formulation produced in (c) onto the ITM release layer surface to form thereon a wet (treatment) layer optionally having a thickness (e.g., uniform thickness) of at most about 1.0 μm (e.g., at most 0.8 μm, at most 0.5 μm, at most 0.4 μm, at most 0.3 μm);
e, optionally subjecting the wet (treatment) layer of (d) to a drying process to form a dried (treatment) film layer, from the wet (treatment) layer, on the ITM release layer surface, said dried film layer optionally having a thickness of at least about 20 nm and at most 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm);
f. depositing droplets of an aqueous ink onto the optionally dried (treatment) film to form an ink image on the release layer surface of the ITM release layer surface:
g. drying the ink image to leave an ink-image residue on the ITM release layer surface; and
h. transferring the ink-image residue (e.g., together with the dried treatment film layer) onto a printing substrate by pressured contact between the ITM and the printing substrate:
to thereby produce a printed ink image on a substrate, wherein said printed ink image has at least one mechanical property improved compared to an ink image produced without addition of said emulsion or dispersion of (c) to the aqueous formulation of (b).

Yet, in a further one of its aspects the present invention provides a method of improving at least one mechanical property (e.g., rub resistance, scratch resistance, coefficient of friction, surface tackiness, etc.) of a printed ink image (on a substrate) comprising:

a. providing an intermediate transfer member comprising a release layer surface;
b. providing an aqueous formulation comprising:

at least one water soluble polymer (optionally being at least one modified polysaccharide e.g., cellulose ether such as methylcellulose and HPMC);

a carrier liquid containing water; and
optionally, one or more of (i) at least one surfactant; (ii) at least one humectant; and (iii) at least one wetting agent;
   c. adding to the aqueous formulation of (b) one or more of (i) a cationic emulsion of at least one oxidized polyethylene wax particulate material; (ii) a dispersion and/or an emulsion of at least one coated wax particulate material, and (iii) a dispersion and/or an emulsion of at least one thermosetting polymeric particulate material;
   d. applying the formulation produced in (c) onto the ITM release layer surface to form thereon a wet (treatment) layer optionally having a thickness (e.g., uniform thickness) of at most about 1.0 μm (e.g., at most 0.8 μm, at most 0.5 μm, at most 0.4 μm, at most 0.3 μm);
   e, optionally subjecting the wet (treatment) layer of (d) to a drying process to form a dried (treatment) film layer, from the wet (treatment) layer, on the ITM release layer surface, said dried film layer optionally having a thickness of at least about 20 nm and at most 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 run).
   f. depositing droplets of an aqueous ink onto the optionally dried (treatment) film to form an ink image on the release layer surface of the ITM release layer surface;
   g. drying the ink image to leave an ink-image residue on the ITM release layer surface; and
   h. transferring the ink-image residue (e.g., together with the dried treatment film layer) onto a printing substrate by pressured contact between the ITM and the printing substrate.
   to thereby produce a printed ink image on a substrate, wherein said printed ink image has at least one mechanical property improved compared to an ink image produced without addition of said emulsion or dispersion of (c) to the aqueous formulation of (b).

In another one of its aspects the present invention provides a method of improving at least one mechanical property of a printed ink image (on a substrate) comprising:

a. providing an intermediate transfer member comprising a release layer surface;
b. providing an aqueous formulation comprising:

at least one water soluble polymer (optionally being at least one modified polysaccharide e.g., cellulose ether such as methylcellulose and HPMC);

a carrier liquid containing water; and
optionally, one or more of (i) at least one surfactant; (ii) at least one humectant; and (iii) at least one wetting agent;
   c. adding to the aqueous formulation of (b) at least one particulate material selected from (i) at least one oxidized polyethylene wax particulate material (optionally provided in the form of a cationic emulsion); (ii) at least one coated wax particulate material (optionally provided in the form of an emulsion and/or a dispersion); (iii) at least one thermosetting polymeric particulate material (optionally provided in the form of an emulsion and/or a dispersion); (iv) or any combination thereof;
   d. applying the formulation produced in (c) onto the ITM release layer surface to form thereon a wet (treatment) layer optionally having a thickness (e.g., uniform thickness) of at most about 1.0 μm (e.g., at most 0.8 μm, at most 0.5 μm, at most 0.4 μm, at most 0.3 μm);
   e, optionally subjecting the wet (treatment) layer of (d) to a drying process to form a dried (treatment) film layer, from the wet (treatment) layer, on the ITM release layer surface, said dried film layer optionally having a thickness of at least about 20 nm and at most 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm);
   f. depositing droplets of an aqueous ink onto the optionally dried (treatment) film to form an ink image on the release layer surface of the ITM release layer surface:
   g. drying the ink image to leave an ink-image residue on the ITM release layer surface; and
   h. transferring the ink-image residue (e.g., together with the dried treatment film layer) onto a printing substrate by pressured contact between the ITM and the printing substrate:
   to thereby produce a printed ink image on a substrate, wherein said printed ink image has at least one mechanical property improved compared to an ink image produced without addition of said particulate material of (c) to the aqueous formulation of (b).

In a further one of its aspects the present invention provides a method of improving at least one mechanical property of a printed ink image (on a substrate) comprising:

a. providing an intermediate transfer member comprising a release layer surface;
b. providing an aqueous formulation comprising:

at least 1.5%, by weight, of at least one water soluble polymer having a solubility in water of at least 5% at 25° C. (optionally wherein said at least one water soluble polymer being at least one modified polysaccharide e.g., cellulose ether such as methylcellulose and HPMC);

at least 5%, by weight, of a first non-ionic surfactant having a solubility in water of at least 7%, at 25° C.;

a second non-ionic, silicone-containing surfactant having a solubility in water of at least 1%, at 25° C.;

a carrier liquid containing water, said water making up at least about 55%, by weight of the aqueous formulation; and

optionally, one or more of (i) at least one humectant; and (ii) at least one wetting agent e.g., PEI.

c. adding to the aqueous formulation of (b) at least one particulate material selected from (i) at least one thermoplastic polymeric particulate material (optionally provided in the form of an emulsion and/or a dispersion); (ii) at least one thermosetting polymeric particulate material (optionally provided in the form of an emulsion and/or a dispersion); or (iii) a combination thereof;
d. applying the formulation produced in (c) onto the ITM release layer surface to form thereon a wet (treatment) layer optionally having a thickness (e.g., uniform thickness) of at most about 1.0 μm (e.g., at most 0.8 μm, at most 0.5 μm, at most 0.4 μm, at most 0.3 μm):
e, optionally subjecting the wet (treatment) layer of (d) to a drying process to form a dried (treatment) film layer, from the wet (treatment) layer, on the ITM release layer surface, said dried film layer optionally having a thickness of at least about 20 nm and at most 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm);
f. depositing droplets of an aqueous ink onto the optionally dried (treatment) film to form an ink image on the release layer surface of the ITM release layer surface;
g. drying the ink image to leave an ink-image residue on the ITM release layer surface; and
h. transferring the ink-image residue (e.g., together with the dried treatment film layer) onto a printing substrate by pressured contact between the ITM and the printing substrate;
to thereby produce a printed ink image on a substrate, wherein said printed ink image has at least one mechanical property improved compared to an ink image produced without addition of said particulate material of (c) to the aqueous formulation of (b).

In yet a further one of its aspects the present invention provides a kit for printing with an indirect printing system, the kit comprising:

a. an intermediate transfer member comprising a release layer surface; and
b. a quantity of an aqueous treatment formulation according to the invention.

Yet, in a further one of its aspects the present invention provides a kit for printing with an indirect printing system, the kit comprising:

a. an intermediate transfer member comprising a release layer surface;
b. a quantity of an aqueous (treatment) formulation comprising:

at least one water soluble polymer (optionally being at least one modified polysaccharide e.g., cellulose ether such as methylcellulose and HPMC);

one or more of (i) a cationic emulsion of at least one oxidized polyethylene wax particulate material; (ii) a dispersion and/or an emulsion of at least one coated wax particulate material; and (iii) a dispersion and/or an emulsion of at least one thermosetting polymeric particulate material;

a carrier liquid containing water; and
optionally, one or more of (iv) at least one surfactant; (v) at least one humectant; and (vi) at least one wetting agent.

In another one of its aspects the present invention provides a kit for printing with an indirect printing system, the kit comprising:

a. an intermediate transfer member comprising a release layer surface:
b. a quantity of an aqueous treatment formulation comprising:

at least one water soluble polymer (optionally being at least one modified polysaccharide e.g., cellulose ether such as methylcellulose and HPMC);

a carrier liquid containing water; and
optionally, one or more of (i) at least one surfactant; (ii) at least one humectant; and (iii) at least one wetting agent; and
   c, one or more of (i) a cationic emulsion of at least one oxidized polyethylene wax particulate material; (ii) a dispersion and/or an emulsion of at least one coated wax particulate material; and (iii) a dispersion and/or an emulsion of at least one thermosetting polymeric particulate material.

In a further one of its aspects the present invention provides a kit for printing with an indirect printing system, the kit comprising:

a. an intermediate transfer member comprising a release layer surface;
b. a quantity of an aqueous (treatment) formulation comprising:

at least 1.5%, by weight, of at least one water soluble polymer having a solubility in water of at least 5% at 25° C. (optionally wherein said water soluble polymer being at least one modified polysaccharide e.g., cellulose ether such as methylcellulose and HPMC);

at least 5%, by weight, of a first non-ionic surfactant having a solubility in water of at least 7%, at 25° C.;

a second non-ionic, silicone-containing surfactant having a solubility in water of at least 1%, at 25° C.;

one or more of (i) a dispersion and/or an emulsion of at least one thermoplastic polymeric particulate material; and (ii) a dispersion and/or an emulsion of at least one thermosetting polymeric particulate material:

a carrier liquid containing water, said water making up at least about 55%, by weight of the aqueous formulation; and

optionally, one or more of (iii) at least one humectant; and (iv) at least one wetting agent e.g., polyethylencimine.

In a further one of its aspects the present invention provides a kit for printing with an indirect printing system, the kit comprising:

a. an intermediate transfer member comprising a release layer surface;
b. a quantity of an aqueous treatment formulation comprising:

at least 1.5%, by weight, of at least one water soluble polymer having a solubility in water of at least 5% at 25° C. (optionally wherein said water soluble polymer being at least one modified polysaccharide e.g., cellulose ether such as methylcellulose and HPMC);

at least 5%, by weight, of a first non-ionic surfactant having a solubility in water of at least 7%, at 25° C.;

a second non-ionic, silicone-containing surfactant having a solubility in water of at least 1%, at 25° C.;

a carrier liquid containing water, said water making up at least about 55%, by weight of the aqueous formulation; and

optionally, one or more of (i) at least one humectant; and (ii) at least one wetting agent (e.g., PEI); and

c, one or more of (i) a dispersion and/or an emulsion of at least one thermoplastic polymeric particulate material, and (ii) a dispersion and/or an emulsion of at least one thermosetting polymeric particulate material.

Yet, in a further one of its aspects the present invention provides a kit for printing with an indirect printing system, the kit comprising:

a. an intermediate transfer member comprising a release layer surface;
b. a quantity of an aqueous (treatment) formulation comprising:

at least one water soluble polymer (optionally being at least one modified polysaccharide e.g., cellulose ether such as methylcellulose and HPMC);

one or more of (i) a dispersion and/or an emulsion of at least one thermoplastic polymeric particulate material; and (ii) a dispersion and/or an emulsion of at least one thermosetting polymeric particulate material;

a carrier liquid containing water; and

optionally, one or more of (iii) at least one surfactant; (iv) at least one humectant, and (v) at least one wetting agent.

In yet a further one of its aspects the present invention provides a kit for printing with an indirect printing system, the kit comprising:

a. an intermediate transfer member comprising a release layer surface:
b. a quantity of an aqueous treatment formulation comprising:

at least one water soluble polymer (optionally being at least one modified polysaccharide e.g., cellulose ether such as methylcellulose and HPMC);

a carrier liquid containing water; and

optionally, one or more of (i) at least one surfactant; (ii) at least one humectant; and (iii) at least one wetting agent; and

c. a quantity of one or more of (i) a dispersion and/or an emulsion of at least one thermoplastic polymeric particulate material; and (ii) a dispersion and/or an emulsion of at least one thermosetting polymeric particulate material.

In a further one of its aspects the present invention provides a printed article comprising:

(i) a substrate (e.g., uncoated fibrous printing substrate, a commodity coated fibrous printing substrate, and a plastic printing substrate);

(ii) one or more ink dots (e.g., forming an ink image on said substrate, wherein said image may be continuous) fixedly adhered to at least a region of a surface of said substrate:

wherein said one or more ink dots and said at least a region of said surface of said substrate are covered with a substantially dry film layer (e.g., a continuous film) optionally having a thickness of at least about 20 nm and at most about 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm), wherein said substantially dry film layer comprises one or more of (i) at least one thermoplastic polymeric particulate material e.g., as disclosed herein; and (ii) at least one thermosetting polymeric particulate material e.g., as disclosed herein, and wherein said substantially dry film layer optionally further comprises at least one water soluble polymer (optionally being at least one modified polysaccharide as disclosed herein).

In a further one of its aspects the present invention provides a printed pattern on a substrate comprising:

(i) a substrate (e.g., uncoated fibrous printing substrate, a commodity coated fibrous printing substrate, and a plastic printing substrate);

(ii) one or more ink dots, which may be continuous thereby forming an ink film on said substrate or which may be spaced apart from each other:

wherein said one or more ink dots being fixedly adhered to at least a region of a surface of said substrate;

wherein said pattern being formed within boundaries defined in said substrate, such that the one or more ink dots and regions surrounding or separating said continuous or spaced apart dots are covered with a substantially dry film layer optionally having a thickness of at least about 20 nm and at most about 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm), wherein said substantially dry film layer comprises one or more of (i) at least one thermoplastic polymeric particulate material e.g., as disclosed herein; and (ii) at least one thermosetting polymeric particulate material e.g., as disclosed herein, and wherein said substantially dry film layer optionally further comprises at least one water soluble polymer (optionally being at least one modified polysaccharide as disclosed herein).

In yet a further one of its aspects the present invention provides a printed article/pattern produced according to the method of the invention.

In a further one of its aspects the present invention provides an intermediate transfer member comprising a release layer surface, wherein the surface is substantially covered with a substantially dry (treatment) continuous film layer as herein disclosed and exemplified.

The present invention further discloses methods, systems, ITMs, and printed substrates as herein defined and exemplified.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a flow chart of an indirect printing process according to some embodiments of the invention.

FIGS. 2A and 2C are flow charts of an indirect printing process in accordance with some embodiments of the invention.

FIGS. 2B-1 to 2B-5 schematically describe a process in which an aqueous treatment formulation and an aqueous ink are deposited on an ITM, and in which the ink image film produced is transferred from the ITM surface to a printing substrate, in accordance with some embodiments of the invention.

FIG. 3 illustrates an indirect printing process according to some embodiments of the invention.

FIGS. 4A-4C are flow charts of an indirect printing process in accordance with some embodiments of the invention.

FIG. 5 is a flow chart of an indirect printing process in accordance with some embodiments of the invention.

FIG. 6 is a photograph of the extreme end of a dried polyvinyl alcohols (PVA)-based treatment formulation as described in comparative Example 8B, having a thickness of at least 150-200 micrometer of formulation.

FIGS. 7A-7B are photographs of a PVA and HPMC-based treatment formulation, respectively, coated on a silicone-based blanket.

FIGS. 8A and 9A are photographs of images resulting from the PVA-based treatment formulation in Formulation 8A.

FIGS. 8B and 9B are photographs of images resulting from HPMC-based treatment formulation in Formulation 9.

FIG. 10 is a photograph of an exemplary image resulting from the use of the treatment formulation in Example 11.

FIG. 11 illustrates the rub resistance observed with thermoplastic particulate material containing aqueous treatment formulation according to some embodiments of the invention.

FIGS. 12A-12B illustrate the rub resistance observed with thermosetting particulate material containing aqueous treatment formulation according to some embodiments of the invention.

FIGS. 13A-13D illustrate a printed surface of paper printed according to some embodiments of the invention.

FIGS. 14A-14B illustrate printed patterns on a surface of a substrate according to some embodiments of the invention.

FIG. 15 illustrate relative thickness of ink dots and dry treatment film according to some embodiments of the invention.

### DETAILED DESCRIPTION OF THE INVENTION

The present invention provides in one of its aspects an aqueous (treatment) formulation for use with an intermediate transfer member of a printing system, the formulation comprising:

at least one water soluble polymer;

at least one carrier liquid containing water; and

optionally, one or more of (a) at least one humectant (water absorbing agent); (b) at least one surfactant (e.g., a nonionic surfactant, a silicone surfactant); and (c) at least one wetting agent e.g., polyethylencimine (PEI);

wherein said formulation optionally further comprises at least one particulate material selected from (i) at least one thermoplastic polymeric particulate material; (ii) at least one thermosetting polymeric particulate material; or (iii) a combination thereof.

Various embodiments will be detailed herein in connection with the aforementioned aspect. It is noted that one or more of these embodiments may be applicable to one or more aspects of the invention disclosed herein above and below. It is further noted that one or more embodiments which are detailed in connection with the aqueous (treatment) formulations of the invention may also be applicable to the other aspects of the invention as detailed herein e.g., methods, systems, processes, articles, printed patterns, printed substrates, ITMs and kits.

In some embodiments according to the present invention the at least one water soluble polymer is at least one modified polysaccharide as disclosed herein e.g., cellulose ether such as methylcellulose and HPMC.

In some embodiments the according to the present invention the aqueous treatment formulation has:

a, at least one modified polysaccharide optionally having a solubility in water, or within the aqueous treatment formulation, of at least 1.5%, or at least 2%, or at least 3%, or at least 4%, or at least 5%, or at least 7%, or at least 8%, or at least 10%, by weight, at 25° C., and optionally at least one or more of the following characteristics:

i. a temperature of gelation as measured at 2% concentration by weight in water, or in the aqueous treatment formulation, of at least 50° C., or at least 55° C., or at least 57° C., or at least 60° C. or at least 62° C., or at least 65° C., or at least 68° C., or at least 70° C., or at least 75° C., and optionally, at most 120° C., at most 110° C., at most 105° C., or between 60-120° C., or between 60-110° C., or between 60-100° C., or between 65-110° C., or between 65-105° C., or between 65-100° C., or between 70-110° C., or between 70-100° C., or between 75-110° C., or between 75-100° C., or between 80-100° C.:

ii. a viscosity, in mPa·s, as measured in 2% concentration by weight in water at 25° C., is at most 11, at most 10, at most 9, at most 8, at most 7, at most 6, at most 5, at most 4, and optionally, at least 0.5 or at least 1, or at least 2, or within a range of 0.5-10, 1-8, 2-8, 2-5, or 2-4:

b. water; and

c, optionally one or more of at least one water absorbing agent, at least one surfactant, and at least one wetting agent.

In some embodiments according to the present invention the temperature of gelation is as measured at 2% concentration by weight in water is at least 50° C. and the viscosity, in mPa·s, is as measured in 2% concentration by weight in water at 25° C., is at most 11.

In some embodiments according to the present invention the aqueous treatment formulation comprises:

(a) at least one modified polysaccharide having a solubility in water of at least 2%, or at least 3% or at least 4%, or at least 5%, or at least 7%, or at least 8%, or at least 10%, by weight, at 25° C., by weight, at 25° C.;

(b) at least one wetting agent; and

(c) a carrier liquid containing water, said water making up at least 50% or at least 55% or at least 60% or at least 65% of the aqueous treatment formulation, on a weight-weight basis:

said aqueous treatment formulation optionally further comprises at least one of, at least two of, or all three of: a water absorbing agent; a non-ionic surfactant; and a silicone surfactant.

In some embodiments according to the present invention the aqueous (treatment) formulation further comprises at least one particulate material selected from (i) at least one thermoplastic polymeric particulate material; (ii) at least one thermosetting polymeric particulate material; or (iii) a combination thereof.

In some embodiments according to the present invention the aqueous treatment formulation comprises:

(a) at least one modified polysaccharide optionally having a solubility in water of at least 2%, or at least 3% or at least 4%, or at least 5%, or at least 7%, or at least 8%, or at least 10%, by weight, at 25° C., by weight, at 25° C.;

(b) at least one wetting agent:

(c) a carrier liquid containing water, said water making up at least 50% or at least 55% or at least 60% or at least 65% of the aqueous treatment formulation, on a weight-weight basis;

(d) at least one particulate material selected from (i) at least one thermoplastic polymeric particulate material; (ii) at least one thermosetting polymeric particulate material; or (iii) a combination thereof; and

wherein said aqueous treatment formulation optionally further comprises at least one of, at least two of, or all three of; a water absorbing agent; a non-ionic surfactant; and a silicone surfactant.

In some embodiments according to the present invention the at least one modified polysaccharide may be a cellulose derivative.

In some embodiments according to the present invention the at least one modified polysaccharide may be cellulose ether.

In some embodiments according to the present invention the cellulose ether may be methylcellulose, or includes methylcellulose.

In some embodiments according to the present invention the cellulose ether may be hydroxypropyl methylcellulose.

In some embodiments according to the present invention the wetting agent may be polyethyleneimine.

In some embodiments according to the present invention the aqueous treatment formulation comprises: a methylcellulose, a polyethyleneimine, a water absorbing agent, a surfactant, and a carrier liquid (for example containing water).

In some embodiments according to the present invention the methylcellulose is a hydroxypropyl methylcellulose.

In some embodiments according to the present invention the aqueous treatment formulation comprises a hydroxypropyl methylcellulose, a polyethyleneimine, a water absorbing agent, a surfactant, and a carrier liquid (for example containing water).

In some embodiments according to the present invention the aqueous treatment formulation may include a polyethyleneimine.

In some embodiments according to the present invention the aqueous treatment formulation may include a surfactant.

In some embodiments according to the present invention the aqueous treatment formulation may include a water absorbing agent.

In some embodiments according to the present invention the aqueous treatment formulation may include a polyethyleneimine and a water absorbing agent.

In some embodiments according to the present invention aqueous treatment formulation may include a polyethyleneimine and a surfactant.

In some embodiments according to the present invention the aqueous treatment formulation may include a polyethyleneimine and a non-ionic surfactant.

In some embodiments according to the present invention aqueous treatment formulation may include a polyethylencimine and a silicone surfactant.

In some embodiments according to the present invention the aqueous treatment formulation may include a polyethyleneimine, a water absorbing agent and a surfactant.

In some embodiments according to the present invention the aqueous treatment formulation may include a polyethyleneimine, a water absorbing agent, a surfactant and an antimicrobial agent.

In some embodiments according to the present invention the modified polysaccharide may have a temperature of gelation as measured at 2% concentration by weight in water of at least 50° C. In some embodiments, the modified polysaccharide has a viscosity, in mPa·s, as measured in 2% concentration by weight in water at 25° C., is at most 11.

In some embodiments according to the present invention the aqueous treatment formulation has a ratio by weight of modified polysaccharide to polyethyleneimine within a range of 4:1 to 200:1.

In some embodiments according to the present invention the aqueous treatment formulation has a ratio by weight of modified polysaccharide to polyethyleneimine of 4:1-100:1.

In some embodiments according to the present invention the aqueous treatment formulation has a ratio by weight of modified polysaccharide to polyethyleneimine of 4:1-60:1.

In some embodiments according to the present invention the aqueous treatment formulation has a ratio by weight of modified polysaccharide to polyethyleneimine of 4:1-35:1.

In some embodiments according to the present invention the aqueous treatment formulation has a ratio by weight of modified polysaccharide to polyethyleneimine of 4:1-25:1.

In some embodiments according to the present invention the aqueous treatment formulation has a ratio by weight of modified polysaccharide to polyethyleneimine of 5:1-100:1.

In some embodiments according to the present invention the aqueous treatment formulation has a ratio by weight of modified polysaccharide to polyethyleneimine of 5:1-50:1.

In some embodiments according to the present invention the aqueous treatment formulation has a ratio by weight of modified polysaccharide to polyethyleneimine of 5:1-35:1.

In some embodiments according to the present invention the aqueous treatment formulation has a ratio by weight of modified polysaccharide to polyethyleneimine of 6:1-50:1.

In some embodiments according to the present invention the aqueous treatment formulation has a ratio by weight of modified polysaccharide to polyethyleneimine of 6:1-35:1.

In some embodiments according to the present invention the aqueous treatment formulation has a ratio by weight of modified polysaccharide to polyethyleneimine of 8:1-35:1.

In some embodiments according to the present invention the aqueous treatment formulation has a ratio by weight of modified polysaccharide to polyethyleneimine of 8:1-25:1.

As used herein the term “modified polysaccharide” refers to polymeric carbohydrate molecule composed of long chains of monosaccharide units bound together by glycosidic linkages wherein at least one of the hydrogen atoms of the hydroxyl groups in the monosaccharide unit is replaced with another group e.g., R.

In some embodiments according to the present invention the modified polysaccharide may be linear or branched. Non limiting examples of modified polysaccharides are starch, glycogen and structural polysaccharides such as cellulose and chitin.

In some embodiments according to the present invention the modified polysaccharide is homogeneous i.e., having the same repeating unit of monosaccharide (i.e., homopolysaccharide).

In some embodiments according to the present invention the modified polysaccharide is heterogeneous, containing more than one type of monosaccharide (i.e., heteropolysaccharides).

In some embodiments according to the present invention the monosaccharide is one or more of glucose, fructose and glyceraldehyde.

In some embodiments according to the present invention the repeating units in the modified polysaccharide is a six-carbon monosaccharides.

In some embodiments according to the present invention the repeating units in the modified polysaccharide is a five-carbon monosaccharides.

In some embodiments according to the present invention the number of monosaccharide units in the modified polysaccharide is between about 4 to about 3000.

In some embodiments according to the present invention the number of monosaccharide units in the modified polysaccharide is between about 10 to about 3000.

In some embodiments according to the present invention the modified polysaccharide may comprise disaccharide units selected from the group consisting of ttrehalose, cellobiose, cellulose, isomaltulose, lactulose, melibiose, sucrose, lactose, maltose (the hydrolysis product of the polysaccharide starch), chitobiose (the hydrolysis product of the polysaccharide chitin), kojibiose, nigerose, isomaltose, sophorose, laminaribiose, gentiobiose, turanose, maltulose, palatinose, gentiobiulose, mannobiose, melibiulose, rutinose, rutinulose and xylobiose.

In some embodiments according to the present invention the modified polysaccharide is of the Structure A, wherein R may be the same or different and is selected from the group consisting of: H, CH₃, CH₂COOH and CH₂CH(OH)CH₃ and n is an integer being of 3 or more, at times being of at least 4.

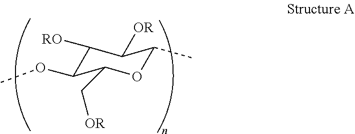

In some embodiments according to the present invention the modified polysaccharide is “modified cellulose” or “cellulose derivative” being of Structure B, which is a structure with anhydroglucose units joined by 1-4 linkages, having OR groups substitution at positions 2, 3, and 6 and wherein R is comprising but not limited to: H, CH₃, [CH₂CH₂O]ₘH, [CH₂CH(CH₃)O]ₘH, CH₂COONa. CH₂CH(OH)CH₃, COOCH₃, CH₂COOH, CH₂COO⁻ wherein m is an integer being of at least 1 and n is an integer being of at least 1.

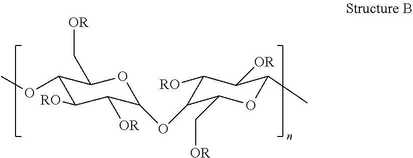

Examples include but are not limited to the following: methylcellulose, ethylcellulose, hydroxyethylmethylcellulose, hydroxypropylcellulose, and carboxymethylcellulose.

In some embodiments according to the present invention the modified polysaccharide is methylcellulose being of Structure B, wherein at least one of the R groups is CH₃ and the rest may include H with no further substitution with other alkyls.

Methylcellulose is characterized by the weight percent of methoxyl groups. The determination of the % methoxyl in methylcellulose (MC) polymer is carried out according to the United States Pharmacopeia (USP 37, “Methylcellulose”, pages 3776-3778). The weight percent is an average weight percentage based on the total weight of the cellulose repeat unit, including all substituents. The content of the methoxyl group is reported based on the mass of the methoxyl group (i.e., —OCH₃).

In some embodiments according to the present invention methylcellulose has % methoxyl of 18% or more; or 25%.

In some embodiments according to the present invention the cellulose derivative has % methoxyl of 50% or less; or 40% or less; and or 35% or less.

As will be discussed, methylcellulose can be characterized by the viscosity of a 2 wt.-% solution in water at 25° C., according to United States Pharmacopeia (USP 37, “Methylcellulose”, pages 3776-3778).

In some embodiments according to the present invention the modified polysaccharide is hydroxypropyl methylcellulose or “HPMC”. In some embodiments the HPMC may refer to Structure C, wherein R may be the same or different and is H, CH₃ or CH₂CH(OH)CH₃ and wherein n is at least 1.

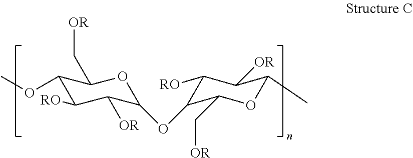

Hydroxypropyl methylcellulose is characterized by the weight percent of methoxyl groups and of hydroxypropyl groups. The weight percentages are based on the total weight of the hydroxypropyl methylcellulose. By convention, the weight percent is an average weight percentage based on the total weight of the cellulose repeat unit, including all substituents. The content of the methoxyl group is reported based on the mass of the methoxyl group (i.e., —OCH₃). The content of the hydroxypropoxyl group is reported based on the mass of the hydroxypropoxyl group (i.e., —O—C₃H₆OH). The determination of the % methoxyl and the % hydroxypropoxyl in HPMC is carried out according to the United States Pharmacopeia (USP 37, “Hypromellose”, pages 3296-3298). Hydroxypropyl methylcellulose can be characterized by the viscosity of a 2 wt. % solution in water at 25° C. according to United States Pharmacopeia (USP 37, “Hypromellose”, pages 3296-3298). Methods of preparing hydroxypropyl methylcellulose are described in International Patent Application, publication Nos. WO2012/051034 and WO 2012/173838. Examples of hydroxypropyl methylcellulose include but are not limited to: Methocel® K (HPMC 2208), Methoccl® E (HPMC 2910), and Methocel®, F (HPMC 2906).

In some embodiments according to the present invention the modified polysaccharide may be a cellulose derivative, cellulose ether, methyl cellulose or alternatively an HPMC.

In some embodiments according to the present invention the modified polysaccharide is methylcellulose and wherein at least 2% of R is a methyl (CH₃) group.

In some embodiments according to the present invention the HPMC may have a temperature of gelation as measured at 2% concentration by weight in water of at least 50° C., or at least 55° C., or at least 57° C., or at least 60° C.

In some embodiments according to the present invention the HPMC may have a viscosity, in mPa·s, as measured in 2% concentration by weight in water at 25° C., of at most 11, at most 10 or at most 9.

In some embodiments according to the present invention the aqueous treatment formulation has a ratio by weight of methylcellulose e.g., HPMC or cellulose derivative (e.g. cellulose ether) to polyethyleneimine within a range of 5 to 200:1. In some embodiments the ratio by weight of methylcellulose e.g., HPMC or cellulose derivative (e.g. cellulose ether) to polyethyleneimine may be 5 to 50:1. In some embodiments according to the present invention the ratio by weight of methylcellulose e.g., HPMC or cellulose derivative (e.g. cellulose ether) to polyethyleneimine may be 7-35:1. In some embodiments according to the present invention the ratio by weight of methylcellulose e.g., HPMC or cellulose derivative (e.g. cellulose ether) to polyethyleneimine may be 10-20:1.

In some embodiments according to the present invention the modified polysaccharide may be a non-thermoplastic polymer and/or a charged polysaccharide.

In some embodiments according to the present invention the charged polysaccharide may be or includes an acidic polysaccharide optionally containing carboxyl groups and/or sulfuric ester groups.

In some embodiments according to the present invention the charged polysaccharide may be a charged polysaccharide is or includes a positively charged polysaccharide.

In some embodiments according to the present invention the aqueous treatment formulation may further comprises at least one water absorbing agent. Water absorbing agents are known in the art. Non limiting example of applicable water absorbing agent include the one exemplified herein and may be selected from sugar and sugar alcohols.

In some embodiments according to the present invention the water absorbing agent may be a solid, in a pure state, at least within a range of 25° C. to 60° C.

In some embodiments according to the present invention, when the aqueous treatment formulation is evaporated to form a solid film, the water absorbing agent acts as a water absorber.

In some embodiments according to the present invention the aqueous treatment formulation comprises a solid water-absorbing agent that is selected to absorb water from the ink when the water-absorbing agent is disposed within the solid, dried treatment film.

In some embodiments such solid water-absorbing agents may have a melting point (i.e., when in a pure state) of at most 60° C. or at most 50° C. or at most 40° C. or at most 30° C. or at most 25° C. In some embodiments the concentration of the solid water-absorbing agent may be—for example, at least 1.5% or at least 2% or at least 2.5% or at least 3% or at least 4% or at least 5% wt./wt. In some embodiments the concentration of the solid water-absorbing agent may be—for example, at most 10% or at most 8% or at most 6%. In some embodiments the concentration of the solid water-absorbing agent may be—for example, between 1-15% or 2-10% or 3-8% or 4-7%. Examples of such water-absorbing agents include but are not limited to sucrose, urea, sorbitol, and isomalt.

In some embodiments according to the present invention the aqueous treatment formulation may further comprise a surfactant. In some embodiments the surfactant may include a first non-ionic surfactant having a solubility in water of at least 5% or at least 7% by weight, at 25° C., a silicone surfactant, or both. In some embodiments the first non-ionic surfactant may be in an amount of at least 6%, at least 7%, at least 8%, at least 9%, or at least 10%, by weight or at most 18%, at most 16%, at most 15%, at most 14%, or at most 13%, by weight, of said first non-ionic surfactant or within a range of 5.5-18%, 5.5-16%, 6.5-18/o, 6.5-16%, 7.5-18%, 7.5-16%, 8.5-18%, 8.5-16%, 9.5-18%, 9.5-16%, 10.5-18%, or 10.5-16%. In some embodiments the first non-ionic surfactant may have a cloud point temperature of said is at least 60° C., at least 70° C., at least 80° C., at least 90° C., at least 100° C., at least 105° C., at least 110° C., at least 115° C., at least 120° C., or at least 130° C., optionally as determined by the ASTM D7689-11 test method.

In some embodiments according to the present invention the aqueous treatment formulation contains at least 5%, at least 6%, at least 7%, at least 8%, at least 9%, or at least 10%, by weight, of said first non-ionic surfactant.

In some embodiments according to the present invention the aqueous treatment formulation may further comprise a second, or said, non-ionic silicone-containing surfactant, optionally a polysiloxane-polyoxyalkylene copolymer, and wherein further optionally, a concentration of said polysiloxane-polyoxyalkylene copolymer is at least 0.3%, at least 0.5%, at least 0.75%, or at least 1.0%, by weight, and yet further optionally, at most 5%, at most 4%, at most 3%, at most 2.5%, at most 2%, or at most 1.75%, by weight.

In some embodiments according to the present invention the non-ionic silicone-containing surfactant has a solubility in water of at least 1%, at 25° C.

In some embodiments according to the present invention the aqueous treatment formulation comprises at least 5%, by weight, of a first non-ionic surfactant having a solubility in water of at least 7%, at 25° C. and a second non-ionic, silicone-containing surfactant having a solubility in water of at least 1%, at 25° C.

In some embodiments according to the present invention the aqueous treatment formulation may comprise at least one modified polysaccharide (e.g., cellulose derivative such as cellulose ether, for example ethyl cellulose, methylcellulose e.g., HPMC) having at least one of the following characteristics:

i. a temperature of gelation as measured at 2% concentration by weight in water, or in the aqueous treatment formulation, of at least 50° C. or at least 55° C., or at least 57° C., or at least 60° C., or at least 62° C., or at least 65° C., or at least 68° C., or at least 70° C., or at least 75° C., and optionally, at most 120° C., at most 110° C. or at most 105° C., or between 60-120° C., or 60-110° C., or 60-100° C., or 65-110° C., or 65-105° C., or 65-100° C., or 70-110° C., or 70-100° C., or 75-110° C., or 75-100° C., or 80-100° C.;

ii. a viscosity in mPa·s, as measured in 2% concentration by weight in water at 25° C., of at most 11, at most 10, at most 9, at most 8, at most 7, at most 6, at most 5, at most 4, and optionally, at least 0.5 or at least 1, or at least 2 or a viscosity within a range of 0.5-10, 1-8, 2-8, 2-5, or 2-4;

iii. a hydroxypropyl substitution of at least 1%, 2%, 4%, 6%, 7% or between 1-30%, 5-25%, 5-20%, 5-10%, 7-9% or 7.3-8.3% or a hydroxypropyl substitution, on a molar basis, of at least 0.1, or at least 0.15 or at least 0.2 or between 0.1-1.0, 0.1-0.9, 0.1-0.7 or 0.1-0.3:

iv. a number average molecular weight, in Daltons, of at most 13,000 or at most 12000, or at most 11000, or at most 10,000, or at most 9000, or at most 8000.

In some embodiments of the invention described herein, the aqueous treatment formulation, has a ratio by weight of methylcellulose to polyethyleneimine within a range of 5 to 200:1. The ratio by weight of methylcellulose to polyethyleneimine can be 5 to 50:1. The ratio by weight of methylcellulose to polyethyleneimine can be 7-35:1. The ratio by weight of cellulose methylcellulose to polyethyleneimine can be 10-20:1.

In some embodiments according to the present invention the aqueous treatment formulation has a ratio by weight of hydroxypropyl methylcellulose to polyethylencimine within a range of 5 to 200:1. At times the ratio by weight of hydroxypropyl methylcellulose to polyethyleneimine may be 5 to 50:1. At times the ratio by weight of hydroxypropyl methylcellulose to polyethyleneimine may be 7-35:1. At times the ratio by weight of hydroxypropyl methylcellulose to polyethyleneimine may be 10-20:1.

In some embodiments according to the present invention the modified polysaccharide is a cellulose derivative (e.g. cellulose ether) or methylcellulose.

In some embodiments according to the present invention the methyl cellulose is HPMC.

In some embodiments according to the present invention the cellulose derivative (e.g. cellulose ether) or methylcellulose may have at least one or more of the following characteristics:

i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C., or at most 105° C., or between 60-120° C., or 60-110° C., or 60-100° C., or 65-110° C., or 65-105° C., or 65-100° C., or 70-110° C., or 70-100° C., or 75-110° C., or 75-100° C., or 80-100° C.;

ii. a viscosity in mPa·s, as measured in 2% concentration by weight in water at 25° C., of at most 11, at most 10, at most 9, at most 8, at most 7, at most 6, at most 5, at most 4, and optionally, at least 0.5 or at least 1, or at least 2 or a viscosity within a range of 0.5-10, 1-8, 2-8, 2-5, or 2-4;

iii. a hydroxypropyl substitution of at least 1%, 2%, 4%, 6%, 7% or between 1-30%, 5-25%, 5-20%, 5-10%, 7-9% or 7.3-8.3% or a hydroxypropyl substitution, on a molar basis, of at least 0.1, or at least 0.15 or at least 0.2 or between 0.1-1.0, 0.1-0.9, 0.1-0.7 or 0.1-0.3;

iv. a number average molecular weight, in Daltons, of at most 13,000 or at most 12000, or at most 11000, or at most 10,000, or at most 9000, or at most 8000.

The inclusion of a modified polysaccharide (e.g., cellulose derivative such ad cellulose ether and hydroxypropyl methylcellulose) may be especially useful for promoting formation of a polymer film or matrix in the dried treatment film that is sufficiently cohesive for good transfer on a variety of printing substrate media including for example plastic (e.g. PET (polyethylene terephthalate), PE (polyethylene), BOPP (biaxially oriented polypropylene)), or aluminum.

In some embodiments according to the present invention the substrate media may be entirely plastic.

The combination of polyethyleneimine and a modified polysaccharide (e.g., cellulose derivative such as cellulose ether or hydroxypropyl methylcellulose) may be especially useful for promoting formation of a polymer film or matrix in the dried treatment film that is sufficiently cohesive for good transfer on a variety of printing substrate media with high ink image quality.

In some embodiments according to the present invention the cellulose derivative (e.g. cellulose ether) is a methylcellulose. In some embodiments according to the present invention the methylcellulose is a hydroxypropyl methylcellulose.

In some embodiments according to the present invention the methylcellulose or hydroxypropyl methylcellulose has a temperature of gelation as measured at 2% concentration by weight in water, of at least 50° C. At times, the methylcellulose or hydroxypropyl methylcellulose has a temperature of gelation as measured at 2% concentration by weight in water of at least 55° C. At times, the methylcellulose or hydroxypropyl methylcellulose has a temperature of gelation as measured at 2% concentration by weight in water, of at least 57° C. At times, the methylcellulose or hydroxypropyl methylcellulose has a temperature of gelation as measured at 2% concentration by weight in water, of at least 60° C., or at least 62° C., or at least 65° C., or at least 68° C., or at least 70° C., or at least 75° C., and optionally, at most 120° C., at most 110° C., or at most 105° C. At times, the methylcellulose or hydroxypropyl methylcellulose has a temperature of gelation as measured at 2% concentration by weight in water, of between 60-120° C. At times, the methylcellulose or hydroxypropyl methylcellulose has a temperature of gelation as measured at 2% concentration by weight in water, of between 60-110° C. At times, the methylcellulose or hydroxypropyl methylcellulose has a temperature of gelation as measured at 2% concentration by weight in water of between 60-100° C. At times, the methylcellulose or hydroxypropyl methylcellulose has a temperature of gelation as measured at 2% concentration by weight in water of between, 65-110° C. At times, the methylcellulose or hydroxypropyl methylcellulose has a temperature of gelation as measured at 2% concentration by weight in water of between 65-100° C., or 65-100° C., or 70-110° C., or 70-100° C., or 75-110° C., or 75-100° C., or 80-100° C.

In some embodiments according to the present invention the modified polysaccharide is, or includes, a methylcellulose.

In some embodiments according to the present invention the methylcellulose has at least one of the following structural characteristics:

i. a hydroxypropyl substitution of at least 2%, or at least 4%, or at least 6%, or at least 7% or at most 20%, or at most 15%, or at most 14%, or at most 12% or between 4-15% or 7-12%;

ii. a hydroxypropyl molar substitution of more than 0.1 or more than 0.15 or more than 0.2; and

iii. a number average molecular weight, as measured in Daltons, of at most 13,000 or at most 12,000, or at most 11,000, or at most 10,000, or at most 9,000, or at most 8,000.

In some embodiments according to the present invention the aqueous treatment formulation comprises: a water absorbing agent; a surfactant; a carrier liquid containing water and a hydroxypropyl methylcellulose having a temperature of gelation as measured at 2% concentration by weight in water, of at least 50° C. At times, the hydroxypropyl methylcellulose may have a temperature of gelation as measured at 2% concentration by weight in water, of at least 55° C. At times, the hydroxypropyl methylcellulose may have a temperature of gelation as measured at 2% concentration by weight in water, of at least 60° C. Without wishing to be bound by theory, this may be especially ideal for replenishing of the treatment formulation as it may promote reduced need for mechanical scraping off the blanket after transfer to substrate. This may also affect large scale speed of belt capabilities.

In some embodiments according to the present invention the modified polysaccharide may be a non-thermoplastic polymer. In some embodiments according to the present invention the modified polysaccharide may include a charged polysaccharide. In some embodiments according to the present invention the charged polysaccharide may be or may include a positively charged polysaccharide. Non limiting examples of such polysaccharides include an acidic polysaccharide optionally containing carboxyl groups and/or sulfuric ester groups.

In some embodiments according to the present invention the charged polysaccharide may be an acidic polysaccharide (e.g., containing carboxyl groups (e.g., pectin) and/or sulfuric ester groups (e.g., carrageenan).

In some embodiments according to the present invention the charged polysaccharide may be a positively charged polysaccharide.

In some embodiments according to the present invention the modified polysaccharide may be a cellulose derivative (e.g. cellulose ether) such as hydroxypropyl methylcellulose.

In some embodiments according to the present invention the modified polysaccharide, cellulose derivative (e.g. cellulose ether) or HPMC may have a solubility in water, or within the aqueous treatment formulation, of at least 2%. At times, of at least 3%, by weight, at 25° C. At timers of at least 4%, by weight, at 25° C. At times, of at least 5%, by weight, at 25° C. At times, of at least 7%, by weight, at 25° C. At times, of at least 8%, by weight, at 25° C. At times, of 10%, by weight, at 25° C.

In some embodiments according to the present invention the modified polysaccharide e.g., methyl cellulose or HPMC has a viscosity in mPa·s as measured in 2% concentration by weight in water at 25° C. of at most 11, at most 10, at most 9, at most 8, at most 7, at most 6, at most 5, at most 4, and optionally, at least 0.5 or at least 1, or at least 2 or a viscosity within a range of 0.5-10, 1-8, 2-8, 2-5, or 2-4. At times, the modified polysaccharide e.g., cellulose derivative such as cellulose ether (e.g., methylcellulose or HPMC) has a viscosity in mPa·s as measured in 2% concentration by weight in water at 25° C. of, at most 10. At times, the modified polysaccharide e.g., cellulose derivative such as cellulose ether (e.g., methylcellulose or HPMC) has a viscosity in mPa·s as measured in 2% concentration by weight in water at 25° C. of at most 7. At times, the modified polysaccharide e.g., cellulose derivative such as cellulose ether (e.g., methylcellulose or HPMC) has a viscosity in mPa·s as measured in 2% concentration by weight in water at 25° C. of at most 4. At times, the modified polysaccharide e.g., cellulose derivative such as cellulose ether (e.g., methylcellulose or HPMC) has a viscosity in mPa·s as measured in 2% concentration by weight in water at 25° C. of at least 1. At times, the modified polysaccharide e.g., cellulose derivative such as cellulose ether (e.g., methylcellulose or HPMC) has a viscosity in mPa·s as measured in 2% concentration by weight in water at 25° C. of at least 0.5. At times, the modified polysaccharide e.g., cellulose derivative such as cellulose ether (e.g., methylcellulose or HPMC) has a viscosity in mPa·s as measured in 2% concentration by weight in water at 25° C. of within a range of 0.5-10.

In some embodiments according to the present invention the modified polysaccharide e.g., cellulose derivative such as cellulose ether (e.g., methylcellulose or HPMC) has a viscosity in mPa·s as measured in 2% concentration by weight in water at 25° C. of 1-8. At times, the modified polysaccharide e.g., cellulose derivative such as cellulose ether (e.g., methylcellulose or HPMC) has a viscosity in mPa·s as measured in 2% concentration by weight in water at 25° C. of 2-8. At times, the modified polysaccharide e.g., cellulose derivative such as cellulose ether (e.g., methylcellulose or HPMC) has a viscosity in mPa·s as measured in 2% concentration by weight in water at 25° C. of 2-5. At times, the modified polysaccharide e.g., cellulose derivative such as cellulose ether (e.g., methylcellulose or HPMC) has a viscosity in mPa·s as measured in 2% concentration by weight in water at 25° C. of 2-4. Significantly, despite the appreciably lower viscosity ranges compared to the prior art, there was no negative effect on the digital ink quality on the surface of the treatment formulation nor in transfer to printing substrate.

In some embodiments according to the present invention the viscosity of the treatment formulation is 15-30 or 20-25 or 20-25 mPa·s, as measured at 25° C.

In some embodiments according to the present invention the methylcellulose has at least one of the following structural characteristics:

i. a hydroxypropyl substitution of more than 2%, or more than 4%, or more than 6%, or more than 7% or at most 20% or at most 15%, or at most 14%, or at most 12% or between 1-30%, or between 4-15% or between 7-12% or between 5-25%, or between 5-20%, or between 5-10%, or between 7-9% or between 7.3-8.3%;

ii. a hydroxypropyl to methoxyl group molar substitution of more than 0.1 or more than 0.15 or more than 0.2 or between 0.1-1.0, or between 0.1-0.9, or between 0.1-0.7 or between 0.1-0.3;

iii. a degree of polymerization of less than 70, or 65 or 60 or 60 or 55; and

iv. an average molecular weight, as measured in Daltons, of at most 13,000 or at most 12,000, or at most 11,000, or at most 10,000, or at most 9,000, or at most 8,000.

In some embodiments according to the present invention the methylcellulose has a hydroxypropyl substitution of more than 2%. At times of more than 4%. At times of more than 6%. At times of more than 7%.

In some embodiments according to the present invention methylcellulose has a molar substitution of more than 0.1. At times of more than 0.15. At times of more than 0.2.

In some embodiments according to the present invention the methylcellulose has a degree of polymerization of less than 70. At times of less than 65. At times of less than 60. At times of less than 55.

In some embodiments according to the present invention the methylcellulose has a methoxyl substitution of less than 25%, or within a range of 15 to 25%.

In some embodiments according to the present invention the methylcellulose has a hydroxypropyl substitution within a range of 7 to 12%.

In some embodiments according to the present invention the modified polysaccharide has a solubility in water, or within the aqueous treatment formulation, of at least 1.5%, or at least 2%, or at least 3%, or at least 4%, or at least 5%, or at least 7%, or at least 8%, or at least 10%, by weight, at 25° C.

In some embodiments according to the present invention the cellulose derivative (e.g. cellulose ether) is a hydroxypropyl cellulose.

In some embodiments according to the present invention the methylcellulose is a hydroxypropyl methyl cellulose.

In some embodiments according to the present invention the methylcellulose has a methoxyl substitution of less than 25%.

In some embodiments according to the present invention the methylcellulose has a methoxyl substitution within a range of 15 to 25%.

In some embodiments according to the present invention the methylcellulose has a methoxyl substitution within a range of 15 to 25% and hydroxypropyl substitution of more than 2%.

In some embodiments according to the present invention the methylcellulose has a methoxyl substitution within a range of 15 to 25% and a hydroxypropyl substitution of more than 4%.

In some embodiments according to the present invention the methylcellulose has a methoxyl substitution within a range of 15 to 25% and a hydroxypropyl substitution of more than 6%.

In some embodiments according to the present invention the methylcellulose has a methoxyl substitution within a range of 15 to 25% and a hydroxypropyl substitution of more than 7%.

In some embodiments according to the present invention the methylcellulose has both a methoxyl substitution within a range of 15 to 25% and a hydroxyproproxyl substitution within a range of 7 to 12%.

Non limiting examples of HPMC for use in the present invention include Methocel® E, Methocel® F, Methocel® J, Methocel® K. Specifically, in some examples, the present invention employs Methocel® K3 LV, Methoccl® E3 LV, Methocel®, E5 LV, Methocel® E6 LV, Methocel® VLV.

In some embodiments according to the present invention the concentration of polyethyleneimine, by weight in the formulation, is at least 0.01%, at least 0.05%, at least 0.1% or at least 0.2%, and optionally, at most 1% at most 0.8%, at most 0.7% at most 0.6%, or at most 0.5% or within a range of 0.1 to 1%, 0.1 to 0.8%, 0.1 to 0.7%, 0.1 to 0.6%, 0.1 to 0.5%, 0.2 to 0.7%, 0.2 to 0.6%, or 0.2 to 0.5%. At times, the concentration of polyethyleneimine, by weight in the formulation, is at least 0.01%. At times, the concentration of polyethyleneimine, by weight in the formulation, is at least 0.05%. At times, the concentration of polyethyleneimine, by weight in the formulation, is at least 0.1%. At times, the concentration of polyethyleneimine, by weight in the formulation, is at least 0.2%. At times, the concentration of polyethyleneimine, by weight in the formulation, is at most 1%. At times, the concentration of polyethyleneimine, by weight in the formulation, is at most 0.8%. At times, the concentration of polyethyleneimine, by weight in the formulation, is at most 0.7%. At times, the concentration of polyethyleneimine, by weight in the formulation, is at most 0.6%. At times, the concentration of polyethyleneimine, by weight in the formulation, is at most 0.5%. At times, the concentration of polyethyleneimine, by weight in the formulation, is within a range of 0.1 to 1%. At times, the concentration of polyethyleneimine, by weight in the formulation, is within a range of 0.1 to 0.8%. At times, the concentration of polyethyleneimine, by weight in the formulation, is within a range of 0.1 to 0.7%. At times, the concentration of polyethyleneimine, by weight in the formulation, is within a range of 0.1 to 0.6%. At times, the concentration of polyethyleneimine, by weight in the formulation, is within a range of 0.1 to 0.5%. At times, the concentration of polyethyleneimine, by weight in the formulation, is within a range of 0.2 to 0.7%. At times, the concentration of polyethyleneimine, by weight in the formulation, is within a range of 0.2 to 0.6%. At times, the concentration of polyethyleneimine, by weight in the formulation, is within a range of 0.2 to 0.5%.

In some embodiments according to the present invention, the average molecular weight of said polyethyleneimine is at least 200,000, at least 350,000, at least 500,000, at least 700,000, at least 750,000 and optionally, at most 3,000,000, at most 2,500,000, or at most 2,000,000.

In some embodiments according to the present invention, the average molecular weight of said polyethyleneimine is 750,000.

In some embodiments according to the present invention, the ratio by weight of the cellulose derivative, e.g. cellulose ether, methylcellulose or hydroxypropyl methylcellulose to polyethyleneimine is 5-200:1, or 5-50:1, or 7-35:1, or 10-20:1.

In some embodiments according to the present invention the ratio by weight of the modified polysaccharide to the polyethyleneimine is 5-200:1, or 5-50:1, or 7-35:1, or 10-20:1.

In some embodiments according to the present invention, the formulation may further comprise a silicone surfactant, a non-ionic surfactant having a solubility in water of at least 5% or at least 7% by weight, or both. This may be useful for ensuring that the dried treatment film is useful for promoting good dot gain.

In some embodiments according to the present invention, the non-ionic surfactant within said aqueous treatment formulation, by weight, is within a range of 5.5-18%, 5.5-16%, 6.5-18%, 6.5-16%, 7.5-18%, 7.5-16%, 8.5-18%, 8.5-16%, 9.5-18%, 9.5-16%, 10.5-18%, or 10.5-16%. The first non-ionic surfactant is, mainly includes, or includes a polyethoxylated sorbitan ester. The polyethoxylated sorbitan ester may include at least one species selected from the group consisting of PEG-4 sorbitan monolaurate, PEG-20 sorbitan monolaurate, PEG-20 sorbitan monopalmitate, PEG-20 sorbitan monostearate, and PEG-20 sorbitan monooleate. The HLB number of said first non-ionic surfactant is at least 11, at least 12, at least 13, at least 14, or at least 14.5, and optionally, at most 22, at most 21, at most 20, at most 19, at most 18, or at most 17, and further optionally, within a range of 11 to 25, 11 to 23, 11.5 to 21, 11.5 to 20, 11.5 to 18, 12.5 to 21, 12.5 to 20, 12.5 to 18, 13.5 to 21, 13.5 to 20, 13.5 to 18, 14 to 20.5, 14 to 18.5, 14.5 to 20, 14.5 to 19, 14.5 to 18, or 14.5 to 17.5.

In some embodiments according to the present invention, the second, non-ionic silicone-containing surfactant which includes a polysiloxane-polyoxyalkylene copolymer, and wherein optionally, a concentration of said polysiloxane-polyoxyalkylene copolymer is at least 0.3%, at least 0.5%, at least 0.75%, or at least 1.0%, by weight, and further optionally, at most 5%, at most 4%, at most 3%, at most 2.5%, at most 2%, or at most 1.75%, by weight.

In some embodiments according to the present invention, the treatment formulation contains at least 0.3%, at least 0.5%, at least 0.75%, or at least 1.0%, by weight and optionally, at most 5%, at most 4%, at most 3%, at most 2.5%, at most 2%, or at most 1.75%, by weight, of said second, non-ionic silicone-containing surfactant.

In some embodiments according to the present invention, the aqueous treatment formulation has a cloud point temperature of said first non-ionic surfactant is at least 60° C., at least 70° C., at least 80° C. at least 90° C., at least 100° C., at least 105° C., at least 110° C., at least 115° C., at least 120° C., or at least 130° C., optionally as determined by the ASTM D7689-11 test method.

In some embodiments according to the present invention, the treatment formulation may further comprise a water absorbing agent.

In some embodiments according to the present invention the water absorbing agent is a sugar or sugar alcohol. In some embodiments the water absorbing agent is a sugar.

In some embodiments according to the present invention the treatment formulation may further comprise a biocide.

In some embodiments according to the present invention the treatment formulation may comprise at most 0.3%, or at most 0.1% quaternary ammonium salts.

In some embodiments according to the present invention the treatment formulation may be substantially devoid of quaternary ammonium salts.

In some embodiments according to the present invention the treatment formulation may comprise at most 0.3%, or at most 0.1% thermoplastic polymers.

In some embodiments according to the present invention the treatment formulation may be substantially devoid of thermoplastic polymers such as polyvinylpyrrolidones, polyvinylpyrrolidones copolymers and polyvinyl alcohols.

In some embodiments according to the present invention the treatment formulation may comprise at most 0.3%, or at most 0.1% polyvinyl alcohols (PVA).

In some embodiments according to the present invention the treatment formulation may be substantially devoid of polyvinyl alcohols (PVA).

In some embodiments according to the present invention the treatment formulation may be substantially devoid of starch and specifically a waxy starch.

In some embodiments according to the present invention the treatment formulation may comprise a total of at most 1%, at most 0.5%, at most 0.3%, or at most 0.1%, or is substantially devoid of all of the following: quaternary ammonium salts, starches, or specifically a waxy starch, thermoplastic polymers, and more specifically, PVA.

In some embodiments according to the present invention the treatment formulation may comprise at most 0.3%, at most 0.1%, or is substantially devoid of any methylcellulose without hydroxypropyl substitution.

In some embodiments according to the present invention the treatment formulation may comprise at most 0.3%, at most 0.1%, or is substantially devoid of, hygroscopic plasticizers.

In some embodiments according to the present invention the total percent solids by weight of the formulation is at least 8%, or at least 9%, or at least 10%, or at least 14%, or at least 16%, or at least 18%, or at least 20% or between 10-30% or 15-25%.

In some embodiments according to the present invention the cellulose derivative, cellulose ether, methylcellulose or hydroxypropyl methylcellulose is in an amount by weight of at least 1.5%, at least 2.0%, at least 2.5%, at least 3.0%, at least 3.1%, at least 3.2%.

In some embodiments according to the present invention the first non-ionic surfactant is in an amount of at least 5%, by weight.

In some embodiments according to the present invention the silicone surfactant is in an amount of at least 0.5%, by weight.

In some embodiments according to the present invention the treatment formulation comprises a modified polysaccharide in an amount of at least 1.5% or 2.0% or 2.5% or 3.0%, by weight.

In some embodiments according to the present invention the treatment formulation has a static surface tension within a range of 25 and 40 mN/m at 25° C.

In some embodiments according to the present invention the treatment formulation has a 25° C. dynamic viscosity that is at least 10 cP, or at least 12 cP, or at least 14 cP or within a range of 10 cP to 100 cP, 12 to 100 cP, 14 to 100 cP, 10 to 60 cP, or 12 to 40 cP. As discussed below, and without wishing to be bound by theory, it is believed that elevated viscosity is useful for counteracting any surface-tension driven tendency towards beading.

In some embodiments according to the present invention the ratio of solubility of the modified polysaccharide, at 80° C., to the solubility of said modified polysaccharide, at 25° C. is at most 0.9, at most 0.7, at most 0.5, at most 0.3, at most 0.1.

In some embodiments according to the present invention the treatment formulation may further comprise at least one wetting agent such as a polyether siloxane copolymer, such as Tego280®.

In some embodiments according to the present invention the concentration of said methylcellulose is within a range of 2.0 to 8/a, 2.5 to 6.5%, 2.5 to 6%, 2.5 to 5.5%, or 2.5 to 5% by weight, and wherein said evaporation load is within a range of 2.3:1 to 4.5:1, 2.3:1 to 4:1, 2.5:1 to 4.2:1, 2.5:1 to 4:1, 2.5:1 to 3.8:1, or 2.5:1 to 3.6:1.

In some embodiments according to the present invention the aqueous treatment formulation has a total surfactant concentration of at least 6%, at least 7%, at least 8%, at least 10%, or at least 12%, and optionally, within a range of 6 to 40%, 6 to 30%, 6 to 20%, 7 to 30%, 7 to 20%, 7 to 15%, 8 to 25%, 8 to 20%, 8 to 15%, 8 to 13%, 9 to 25%, 9 to 20%, 9 to 15%, 9 to 13%, 10 to 25%, 10 to 20%, 10 to 15%, or 10 to 13% by weight.

Moreover, for a particular residue thickness for the aqueous treatment solution, and for a given heat output delivered to the aqueous treatment solution, the viscosity of the aqueous treatment formulation will increase rapidly as a function of evaporation to achieve a high absolute viscosity that effectively counteracts the surface tension. Physically, it is more difficult to induce flow of fluids having a higher viscosity than fluids having a lower viscosity—i.e. to induce flow of fluids having the higher viscosity, a greater driving force is required. The combination of at least moderate initial viscosity (i.e. a 25° C. dynamic viscosity that is at least 10 cP) and rapid viscosity increase after evaporation (e.g. due to the low evaporation load) on the ITM surface ensures that the aqueous treatment formulation reaches a relatively ‘high’ (e.g. at least 10,000 cP) viscosity in a relatively short period of time (e.g. at most 1 second or at most 0.5 seconds). Therefore, even if there is some thermodynamic tendency towards beading, actual beading, which could negatively impact the properties of the dried treatment film is inhibited or appreciably mitigated.

In some embodiments according to the present invention the aqueous treatment formulation is completely dissolved at 25° C. e.g., when no particulate material is present in the formulation.

In some embodiments according to the present invention the total concentration of organic solvents within the aqueous treatment formulation is at most 3%, at most 2%, at most 1%, or at most 0.5%, by weight, or wherein the formulation is organic-solvent-free.

In a further one of its aspects the invention provides a method for indirect printing on a substrate comprising:
i. providing an intermediate transfer member (ITM);
ii. providing an aqueous treatment formulation substantially as disclosed herein;
iii. applying the aqueous treatment formulation to the ITM to form a wet treatment layer;
iv. optionally at least partially drying the wet treatment layer to form at least partially dry treatment layer;
v. depositing (e.g., by jetting) aqueous ink droplets onto the partially dried treatment layer to form a wet ink image;
vi. at least partially drying the wet ink image on the aqueous treatment layer to form a partially dried ink image film; and
vii. transferring a partially dried ink image film to a printing substrate by pressured contact between the ITM and the printing substrate.

In some embodiments according to the present invention the aqueous treatment formulation is provided at a temperature of about less than 55° C.

In some embodiments according to the present invention the at least partially drying of the wet treatment layer to form an at least partially dry treatment layer occurs at a ITM (e.g., blanket) temperature of at least 80° C.

In some embodiments according to the present invention the at least partially drying of the wet ink image on the aqueous treatment layer occurs at a temperature of at least 100° C., or at least 120° C. or at least 130° C. to form a partially dried ink image film.

In some embodiments according to the present invention the transferring to a substrate is at a temperature of at least 75° C., or at least 80° C. or between 75 to 150° C. or between 80 to 120° C.

In some embodiments according to the present invention the aqueous treatment formulation is selected such that said wet treatment layer is in a form of an aqueous gel layer on the image receiving surface of the ITM.

In some embodiments according to the present invention the temperature of the aqueous gel layer on said image receiving surface may be within a range of 50 to 100° C., 55 to 100° C., 57 to 100° C., 60 to 100° C., 62 to 100° C., 65 to 100° C., 67 to 100° C., 70 to 100° C., 75 to 100° C., or 80 to 100° C.

In some embodiments according to the present invention the printing substrate to which the ink image film (e.g. residue) is transferred has at least a contact surface made of plastic [e.g. PET (polyethylene terephthalate), PE (polyethylene), BOPP (biaxially oriented polypropylene)), or aluminum].

In some embodiments according to the present invention the substrate media may be a printing substrate selected from the group consisting of plastic, polyethylene terephthalate (PET), polyethylene (PE), biaxially oriented polypropylene (BOPP), aluminum, and combinations thereof.

In some embodiments according to the present invention the substrate media is entirely plastic.

In some embodiments according to the present invention the method for indirect printing further comprises: removing an ink-image residue film from said image receiving surface, said ink-image residue including a treatment formulation residue from said aqueous treatment formulation. In some embodiments, the method further comprises: removing by re-dissolution of at least 70%, at least 80%, at least 90%, or substantially all of said treatment formulation. In some embodiments, the method is devoid of any mechanical cleaning or mechanical residue removal operations.

In yet a further one of its aspects the invention provides a method for indirect printing on a substrate comprising:
i. providing an intermediate transfer member (ITM);
ii. providing an aqueous treatment formulation substantially as disclosed herein;
iii. applying the aqueous treatment formulation to the ITM to form a wet treatment layer;
iv. optionally at least partially drying the wet treatment layer to form an at least partially dry treatment layer;
v. depositing (e.g., by jetting) aqueous ink droplets onto the partially dried treatment layer to form a wet ink image;
vi. at least partially drying the wet ink image on the aqueous treatment layer to form a partially dried ink image film;
vii. transferring a partially dried ink image film to a printing substrate by pressured contact between the ITM and the printing substrate, and
wherein said method further comprises re-solubilizing the dried treatment film in the aqueous treatment formulation, and after step vii) the release surface is washed with the aqueous treatment solution and returned to step iii) to commence a new printing cycle.

In some embodiments according to the present invention the applying to the ITM is as a uniform sub-micron thickness over large areas of the ITM and/or at high print speeds of an aqueous treatment formulation.

In some embodiments according to the present invention the wet aqueous treatment formulation has a thickness of at most 0.8 μm, at most 0.5 μm, at most 0.4 μm, at most 0.3 μm, at most 0.2 μm, or at most 0.15 μm, and optionally, at least 0.05 μm or at least 0.10 μm, and further optionally, within a range of 0.05 to 0.8 μm, 0.10 to 0.5 μm, or 0.10 to 0.25 μm.

In some embodiments according to the present invention the ITM has a silicone-based release layer surface, said surface being sufficiently hydrophilic such that a receding contact angle of a drop of distilled water deposited on the silicone-based release layer surface is at most 60°.

In some embodiments according to the present invention the silicone-based release layer surface is sufficiently hydrophilic such that a 10-second dynamic contact angle (DCA) of a drop of distilled water deposited on the silicone-based release layer surface is at most 108°.

In some embodiments according to the present invention the provided ITM comprises a support layer and a release layer having said silicone-based release layer surface and a second surface that (i) opposes said silicone-based release layer surface, and (ii) is attached to said support layer, and wherein said release layer is formed of an addition-cured silicone material, wherein a thickness of said release layer is optionally at most 800 micrometers (μm), at times at most 500 micrometers (μm).

In some embodiments according to the present invention the addition-cured silicone material consists essentially of an addition-cured silicone, or contains, by weight, at least 95% of said addition-cured silicone.

In some embodiments according to the present invention the functional groups within said silicone-based release layer surface of the provided ITM make up at most 3%, by weight, of said addition-cured silicone material.

In some embodiments according to the invention the polyether glycol functionalized polydimethyl siloxane is impregnated in said addition-cured silicone material of the provided ITM.

In some embodiments according to the present invention the release layer of the provided ITM is adapted such that polar groups of the ink reception surface have an orientation away from or opposite from the second surface.

In some embodiments according to the present invention the surface hydrophobicity of the silicone-based release layer surface of the provided ITM is less than a bulk hydrophobicity of the cured silicone material within the release layer, the surface hydrophobicity being characterized by a receding contact angle of a droplet of distilled water on the ink reception surface, the bulk hydrophobicity being characterized by a receding contact angle of a droplet of distilled water disposed on an inner surface formed by exposing an area of the cured silicone material within the release layer to form an exposed area.

In some embodiments according to the present invention the wet treatment layer is formed and/or thinned by urging a rounded surface towards the ITM or vice versa, wherein:

i, the rounded surface has a radius of curvature of at most 2 mm or at most 1.5 mm or at most 1.25 mm or at most 1 mm; and/or

ii, the urging is at a force density in the cross-print direction of at least 250 g/cm or at least 350 g/cm or at least 400 gm/cm and/or at most 1 kg/cm or at most 750 g/cm or at most 600 g/cm; and/or

iii, the urging is performed by applying a pressure between and the ITM, a magnitude of the pressure being at least 0.1 bar or at least 0.25 bar or at least 0.35 bar or at least 0.5 bar, and optionally at most 2 bar or at most 1.5 bar, or at most 1 bar.

In some embodiments according to the present invention the formation of the wet treatment layer or thinning thereof comprises forcing the aqueous treatment formulation to flow such that a velocity gradient normal to the ITM is established, a magnitude of the velocity gradient being at least 10⁶ sec⁻¹ or at least 2×10⁶ sec⁻¹.

In some embodiments according to the present invention the drying process ofthe wet treatment layer is sufficiently rapid such that the viscosity of the aqueous treatment formulation increases rapidly enough to inhibit surface-tension-driven beading such that the dried treatment film has a smooth upper surface.

In some embodiments according to the present invention the smooth upper surface of the dried treatment film is characterized by an average roughness Rₐ of at most 12 nanometers or at most 10 nanometers or at most 9 nanometers or at most 8 nanometers or at most 7 nanometers or at most 4 nanometers or at most 3 nanometers, and optionally, at least 1 nanometer or at least 2 nanometers.

In some embodiments according to the present invention the drying of the treatment solution is performed sufficiently rapidly so as to prevent beading and so as leave a continuous hydrophilic and cohesive polymer treatment film having a thickness of at most 200 nm, or at most 150 nm, or at most 120 nm, or at most 100 nm, or at most 80 nm, or at most 70 nm, or at most 60 nm, or at most 50 nm, or at most 40 nm, or at most 30 nm.

In some embodiments according to the present invention the thickness of the dried treatment film to which the aqueous ink droplets are deposited is at most 200 nm, or at most 120 nm, or at most 100 nm, at most 80 nm, at most 70 nm, at most 60 nm, at most 50 nm, at most 45 nm, or at most 40 nm.

In some embodiments according to the present invention the thickness of the dried treatment film to which the aqueous ink droplets are deposited is at least 15 nm or at least 20 nm or at least 25 nm or at least 30 nm.

In some embodiments according to the present invention the dried treatment film is continuous over an entirety of a rectangle of the release surface of the ITM, wherein said rectangle has a width of at least 10 cm and a length of at least 10 meters.

In some embodiments according to the present invention the dried treatment film for at least 50% or at least 75% or at least 90% or at least 95% at least 95% or at least 99% or 100% of an area of the rectangle, a thickness of the dried treatment film does not deviate from an average thickness value within the rectangle by more than 50% or more than 40% or more than 30%.

In some embodiments according to the present invention during the drying process of the wet treatment layer, a dynamic viscosity thereof increases by at least a factor of 1000 within a period of time of at most 250 milliseconds.

In some embodiments according to the present invention the ink-image residue is transferred together with non-printed areas of the dried treatment film onto the printing substrate.

In some embodiments according to the present invention the thickness of the dried treatment film is at most 120 nm.

In some embodiments according to the present invention the dried treatment film is sufficiently cohesive such that during transfer of the ink-image residue, the dried treatment film completely separates from the ITM and transfers to the printing substrate with the dried ink image, both in printed and non-printed areas.

In some embodiments according to the present invention the method for indirect printing is performed such that:

i. an ink dot set IDS of ink substrate-residing ink dots is formed;

ii. a droplet plurality DP of the aqueous ink droplets that are deposited onto the ITM-residing dried treatment film forms the ink dot set IDS of ink substrate-residing ink dots such that there is a correspondence between:

A. each given droplet of the droplet plurality DP and

B. a respective given substrate-residing ink-dot of the ink-dot set such that the given droplet results in and/or evolves into the given substrate-residing ink-dot;

iii. during deposition, whenever a droplet of the droplet plurality collides with the dried treatment film on the ITM, kinetic energy of the colliding droplet deforms the droplet;

iv. a maximum impact radius of each of the deformed droplets over the surface of the ITM has a maximum impact radius value R_{MAX_IMPAXT};

v. subsequent to impact, physiochemical forces spread the deformed droplets such that each ink dot of substrate-residing ink-dot set IDS has a dried-dot radius R_{DRIED_DOT_ON_SUBSTRATE};

vi. for each droplet of the droplet plurality and corresponding ink dot of the ink dot set IDS. a ratio between

A, the substrate-residing dried-dot radius R_{DRIED_DOT_ON_SUBSTRATE}; and

B. the deformed-droplet maximum impact radius value R_{MAX_IMPACT} at least 1.1.

In some embodiments according to the present invention the method for indirect printing is performed such that:

i. a droplet plurality DP of the droplets that are deposited onto the ITM-residing dried treatment film generates an ink-dot set IDS of substrate-residing ink dots (i.e. fixedly adhered to a top substrate surface), each droplet of the droplet plurality DP corresponding to a different respective substrate-residing ink-dot of the ink-dot set IDS;

ii. each ink droplet of the droplet plurality DP is deposited, according to jetting parameters, onto the substrate;

iii, the jetting parameters together with the physicochemical properties of ink droplets of the droplet plurality DP collectively define an ink-jet-paper dot-radius R_{DIRECT-JETTING-ONTO-INK-JET-PAPER-THEORETICAL} which is the radius of the ink-dot obtained ifthe ink droplets were directly ink-jetted onto ink-jet-paper instead of the dried treatment film; and

iv. a ratio between (A) the dried-dot radius R_{DRIED_DOT_ON_SUBSTRATE} of the dots of the ink-dot set IDS and the (B) ink-jet-paper dot-radius R_{DIRECT-JETING-ONTO-INK-JET-PAPER-THEORETICAL}, is at least 1.1.

In some embodiments according to the present invention a cardinality of the ink dot set is at least 5 or at least 10 or at least 20 or at least 50 or at least 100, each ink dot of the ink dot set being distinct on the substrate. The ink dots of the ink dot set are contained within a square geometric projection projecting on the printing substrate, each ink-dot of the ink dot set being fixedly adhered to the surface of the printing substrate, all said ink dots within said square geometric projection being counted as individual members of the ink dot set IDS.

In some embodiments according to the present invention the aqueous treatment formulation is applied to at least portion(s) of the ITM that are in-motion at a velocity of at least 1 meters/second, at least 1.5 meters/second, at least 2 meters/second, at least 2.5 meters/second, at least 3 meters/second, optionally at most 5.5 meters/second, at most 5.0 meters/second, at most 4.5 meters/second, or at most 4.0 meters/second, to form the wet treatment layer thereon.

In some embodiments according to the present invention the dried treatment film to which the aqueous ink droplets are deposited and a surface of the dried treatment film are characterized by a dimensionless ratio between (i) an average roughness Rₐ and (ii) a thickness of the dried treatment layer, wherein said dimensionless ratio is at most 0.5, at most 0.4, at most 0.3, at most 0.25, at most 0.2, at most 0.15, or at most 0.1, and optionally, at least 0.02 or at least 0.03 or at least 0.04 or at least 0.05 or at least 0.06 or at least 0.07 or at least 0.08.

In some embodiments according to the invention the method utilizes a blanket with one or more features as disclosed herein.

In a further one of its aspects the invention provides an indirect printing system comprising:

i. an intermediate transfer member (ITM) comprising a silicone-based release layer surface;

ii. a container containing an aqueous treatment formulation containing an aqueous treatment formulation substantially as disclosed herein;

iii. a treatment station for applying the aqueous treatment formulation to the silicone-based release layer surface of the ITM to form thereon a wet treatment layer;

iv. an optional drying station for drying the aqueous treatment formulation;

v, at least one ink jet nozzle positioned proximate to the intermediate transfer member and configured for jetting ink droplets onto the aqueous treatment formulation formed on the intermediate transfer member;

vi. an ink processing station configured to at least partially dry the ink on the aqueous treatment formulation formed on the intermediate transfer member to produce an ink-image residue; and

vii. an ink-image residue transfer mechanism for transferring the ink-image residue onto a printing substrate by pressured contact between the ITM and the printing substrate.

In some embodiments according to the present invention, the system for the most part not dependent on or devoid of any mechanical formulation residue removal mechanism. Specifically, the system may be devoid of any mechanical residue removal (e.g., a scraping blade) mechanism adapted to mechanically remove an ink image film (e.g. ink image and treatment formulation residue) from the release layer surface. Alternatively, or in addition, the system further comprises a washing station for removing ink image film (e.g. ink image and residue or treatment formulation residue) from the silicone-based release layer surface. Optionally, the system may further comprise a treatment applicator means for reapplication of said treatment formulation.

In a further one of its aspects the present invention provides a method for indirect printing on a substrate comprising:

providing an aqueous treatment formulation as described herein;

applying the aqueous treatment formulation to the ITM to form a wet treatment layer;

optionally at least partially drying the wet treatment layer to form an at least partially dry treatment layer;

jetting aqueous ink droplets onto the partially dried treatment layer to form a wet ink image;

at least partially drying the wet ink image on the aqueous treatment layer to form a partially dried ink image film (e.g. an aqueous treatment coating); and

transferring a partially dried ink image film to a printing substrate by pressured contact between the ITM and the printing substrate.

In some embodiments according to the present invention, there are provided methods and apparatus useful for consistently producing a dry treatment layer that does not undergo splitting when transferring to various “difficult” printing substrates made of, or at least having a contact surface made of, materials such as plastic, [e.g. PET (polyethylene terephthalate), PE (polyethylene), BOPP (biaxially oriented polypropylene)], or aluminum.

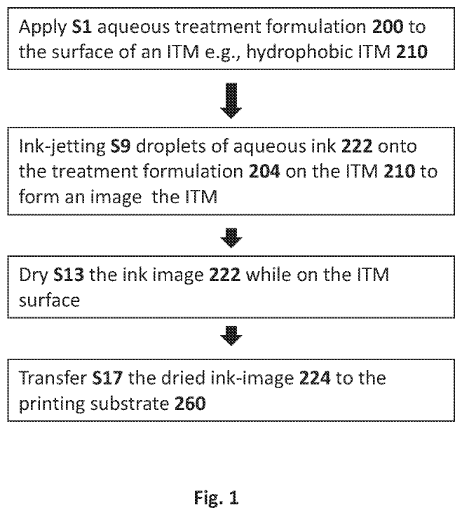

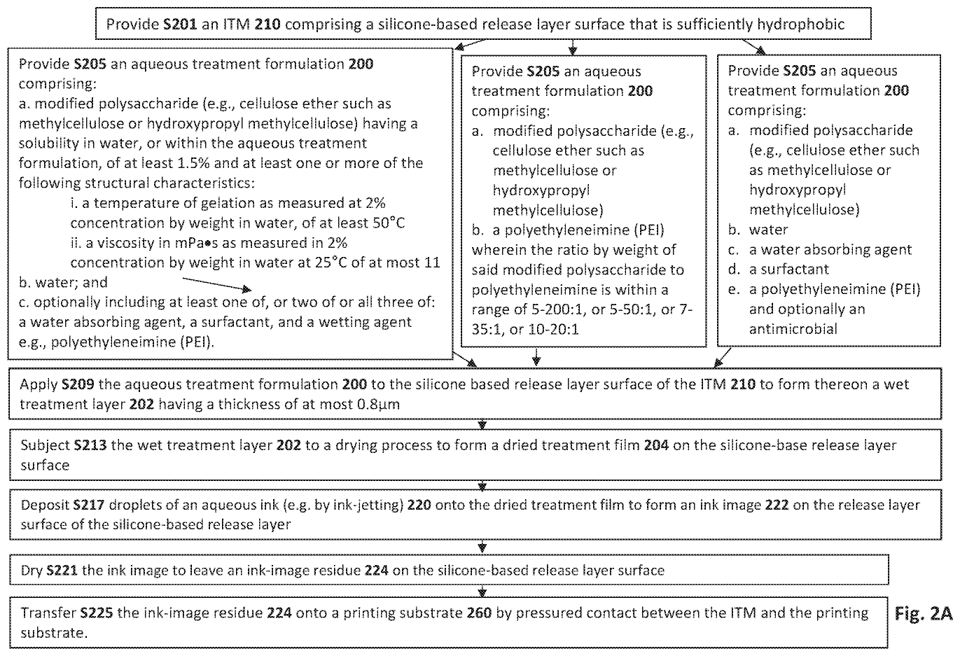

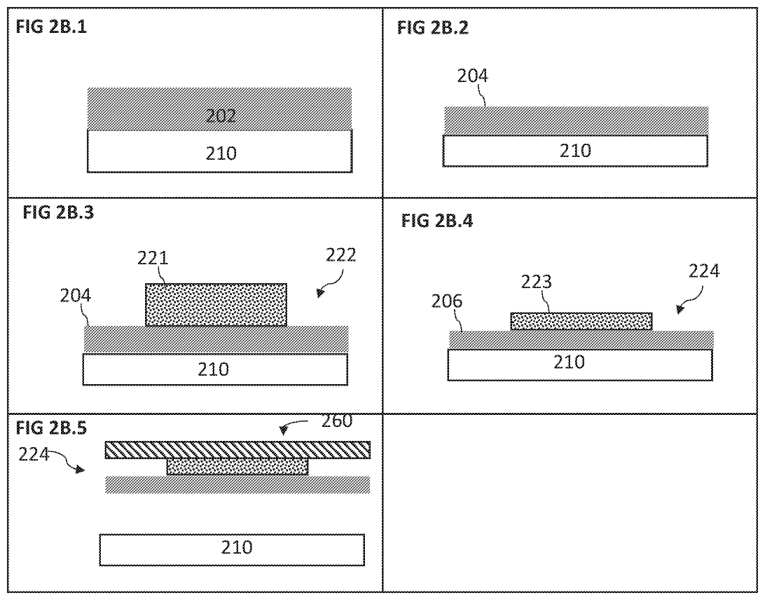

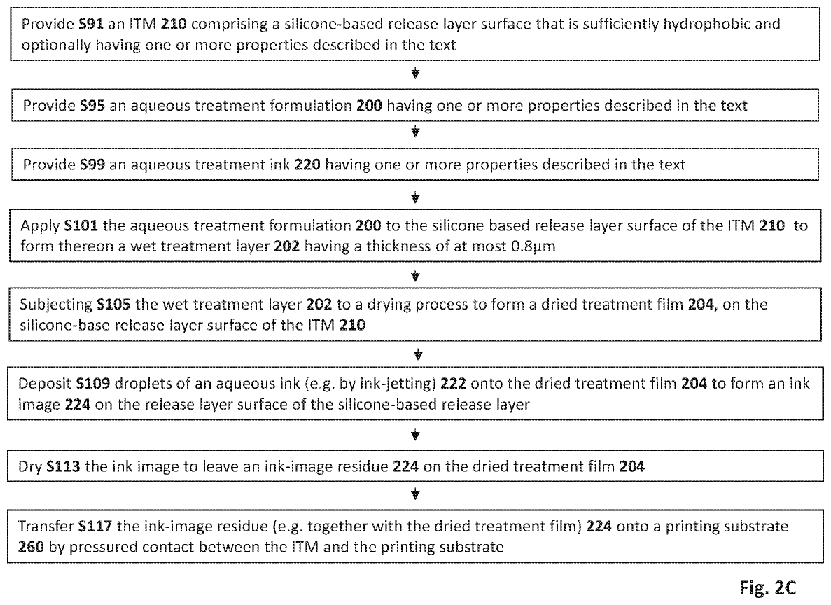

In some embodiments according to the present invention, the method of FIG. 1 refers to the illustration in FIGS. 2B.1 to 2B.5. FIG. 1 is a flow chart of a printing process according to some embodiments of the invention where an intermediate transfer member (ITM) (e.g. 210) is pre-treated with any of the aqueous treatment formulations disclosed in the present invention before deposition of an ink image thereto. In step S1 of FIG. 1 (or as shown in FIG. 2B.1), an aqueous treatment formulation (e.g. 202) of the present invention is applied to a surface of a hydrophobic ITM (e.g. 210) to pretreat the ITM surface and is optionally dried to provide a partially dried film 204 on the ITM 210, as schematically provided in FIG. 2B.2. In step S9 of FIG. 1, droplets of aqueous ink are ink-jetted onto the optionally dried treatment formulation (e.g. treatment film 206) to form a wet ink image 222 (e.g. comprising treatment film 204 and deposited ink 221) on the surface of the ITM, as schematically provided in FIG. 2B.3). In step S13 of FIG. 1 (or as schematically shown in FIG. 2B.4), the ink image (e.g. 222) is dried on the ITM surface to form an at least partially dried ink image film (224 as schematically provided in FIG. 2B.4 and comprising at least a partially dried treatment film 206 and partially dried deposited ink 223). In step S17 of FIG. 1, (or as schematically shown in FIG. 2B.5), the dried ink-image film 224 is transferred to a printing substrate 260, typically by pressure contacting.

FIG. 2A is an exemplary a flow-chart of a method of indirect printing by an aqueous ink onto a silicone-based release layer surface of an intermediate transfer member (ITM) having a layer of treatment or treatment formulation according to some embodiments of the invention. In some embodiments, the method of FIG. 2A refers to the illustration in FIGS. 2B.1-5. In some embodiments, the method of FIG. 2A (or any combination of steps thereof) may be performed using apparatus (or component(s) thereof) disclosed herein.

In some embodiments according to the present invention any of the methods of FIGS. 2A, 2B, and 2C may be performed to produce an ink image characterized by any combination of the following features; uniform and controlled dot gain, good and uniform print gloss, and good image quality due to high quality dots having consistent dot convexity and/or well-defined boundaries. Steps S201-S205 relate to the ingredients or components or consumables used in the printing process of FIG. 2A, while steps S209-S225 relate to the process itself.

Briefly, the steps of FIG. 2A are as follows: in steps S201 and S205, an ITM (e.g., comprising a silicone-based release layer surface) and an aqueous treatment formulation (e.g. a solution) of the present invention are provided, each having specific properties that are discussed herein. In step S209, the aqueous treatment formulation is applied to the release layer surface of the ITM to form thereon a wet treatment layer. In step S213, the wet treatment layer is subjected to a drying process to form therefrom a dried treatment film on the ITM. In step S217. droplets of aqueous ink are deposited onto this at least partially dried treatment film to form an ink image on the ITM surface. In step S221, this ink image is dried to leave an ink-image film or residue on the ITM surface, and in step S225 this ink-image residue or film is transferred to the printing substrate.

In some embodiments according to the present invention, there is provided methods and apparatus useful for producing a wet treatment layer of uniform sub-micron thickness over large areas of the ITM and/or at high print speeds.

A Discussion of Step S201 of FIG. 2A

Although in some embodiments the ITM provided in step S201 has a silicone based release layer, the release surface thereof may be less hydrophobic or appreciably less hydrophobic than many conventional silicone based release layers. This structural property can be measured and characterized in various ways.

For example, as illustrated in step S201 of FIG. 2A, the intermediate transfer member (ITM) comprises a silicone-based release layer surface that is sufficiently hydrophilic to satisfy at least one of the following properties: (i) a receding contact angle of a drop of distilled water deposited on the silicone-based release layer surface is at most 60°; and (ii) a 10-second dynamic contact angle (DCA) of a drop of distilled water deposited on the silicone-based release layer surface is at most 108°.

Any one of a number of techniques for reducing the hydrophobicity of the silicone based release layer may be employed.

In some embodiments according to the present invention, polar functional groups are introduced into and/or generated in the silicone based release layer. At times, functional groups may be added to the pre-polymeric batch (e.g. monomers in solution)—these functional groups may, upon curing, become integral part of the silicone polymer network. Alternatively, or additionally, the silicone-based release layer is pre-treated (e.g. by a corona discharge, or by an electron beam), thereby increasing a surface energy thereof.

Alternatively, the silicone based release layer may be manufactured to have a reduced hydrophobicity, even when substantially devoid of functional groups. At times, the silicone polymer backbone of the release layer may be structured so that the polar groups thereof (e.g., O—Si—O) are oriented in a direction that is generally normal to the local plane of the ITM surface and facing ‘upwards’ towards the release layer surface.

A Discussion of Step S205 of FIG. 2A

In some embodiments according to the present invention, there is provided an aqueous treatment formulation 200 comprising:

a. a modified polysaccharide (e.g., cellulose ether) having a solubility in water, or within the aqueous treatment formulation, of at least 1.5%, or at least 2%, or at least 3%, or at least 4%, or at least 5%, or at least 7%, or at least 8%, or at least 10%, by weight, at 25° C., and at least one or more of the following characteristics:

i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C., at most 105° C., or between 60-120° C., or between 60-110° C., or between 60-100° C., or between 65-110° C., or between 65-105° C., or between 65-100° C., or between 70-110° C., or between 70-100° C., or between 75-110° C., or between 75-100° C., or between 80-100° C.;

ii. a viscosity, in mPa·s, as measured in 2% concentration by weight in water at 25° C., is at most 11, at most 10, at most 9, at most 8, at most 7, at most 6, at most 5, at most 4, and optionally, at least 0.5 or at least 1, or at least 2, or within a range of 0.5-10, 1-8, 2-8, 2-5, or 2-4:

b. water; and

c, optionally including at least one of, or two of or all three of: a water absorbing agent, a surfactant, and a wetting agent e.g., polyethyleneimine.

Alternatively, in some embodiments of the present invention, there is provided S205 an aqueous treatment formulation 200 comprising:

(a) a modified polysaccharide (e.g., cellulose ether) having a solubility in water, or within the aqueous treatment formulation, of at least 2%, or at least 3% or at least 4%, or at least 5%, or at least 7%, or at least 8%, or 10%, by weight, at 25° C.;

(b) a polyethyleneimine (PEI); and

(c) a carrier liquid containing water, said water making up at least 50% or at least 55% or at least 60% or at least 65% of the aqueous treatment formulation, on a weight-weight basis;

said aqueous treatment formulation optionally including at least one of, at least two of, or all of: a water absorbing agent; a non-ionic surfactant; and a silicone surfactant.

In some embodiments according to the present invention the ratio by weight of the modified polysaccharide to polyethyleneimine is within a range by weight of 4:1-200:1, or 5-200:1, or 4:1-100:1, or 4:1-60:1, or 4:1-35:1, or 4:1-25:1, or 5:1-100:1, or 5:1-50:1, or 5:1-35:1, or 6:1-50:1, or 6:1-35:1, or 8:1-35:1 or 8:1-25:1, or 10:1-20:1.

In some embodiments according to the present invention there is provided S205 an aqueous treatment formulation 200 comprising: a modified polysaccharide (e.g., cellulose derivative such as cellulose ether e.g., methylcellulose or hydroxypropyl methylcellulose), a polyethyleneimine, a water absorbing agent, a surfactant, and a carrier liquid containing water. At times, the formulation may further comprise a suitable microbial, including, for example, 2-bromo-2-nitro-1,3-propanediol.

In some embodiments according to the present invention, the water absorbing agent may be selected from the list comprising: sucrose, urea, sorbitol, isomalt or any combination thereof.

In some embodiments according to the invention, the aqueous treatment formulation comprises a carrier liquid containing water, the water making up at least 65% (e.g. at least 70% or at least 75%), by weight of the aqueous treatment formulation.

A Discussion of Step S209 of FIG. 2A with Reference to FIG. 2B.1

In step S209, the aqueous treatment formulation 200 is applied to the silicone-based release layer surface of the ITM 210 to form thereon a wet treatment layer 202 having a thickness of at most 0.8 μm (e.g. at most 0.7 μm, or at most 0.6 μm, or at most 0.5 μm).

In some embodiments, step S209 is performed so that the wet treatment layer has a uniform thickness and is defect free, preferably over a large area such as over the entire area of the release layer. This may be particularly challenging when the wet treatment layer is of sub-micron thickness.

In step S209, an aqueous treatment formulation 200 is applied to the silicone-based release layer surface to form a wet treatment layer 202 optionally having a thickness of at most 0.8 μm.

In some embodiments of the invention the apparatus and methods for applying this wet treatment layer are provided so that the thickness is uniform, preferably over large areas of the ITM.

In some embodiments according to the invention, after coating the ITM surface with an initial coating of aqueous treatment formulation, excess treatment formulation may be removed from the initial coating to obtain a wet treatment layer having a uniform thickness, e.g. of at most 0.8 μm. At times, this may be accomplished by urging a highly-rounded surface (e.g. of a doctor blade) towards the ITM or vice versa. For example, a radius of curvature of the highly-rounded surface may be at most 1.5 mm or at most 1.25 mm or at most 1 mm.

A Discussion of Step S213 with reference to FIG. 2B.2

In step S213, the wet treatment layer 202 is subjected to a drying process to form a dried treatment film therefrom. At times, during the drying process of the wet treatment layer, a dynamic viscosity thereof increases by at least a factor of 1000 within a period of time of at most 0.5 seconds or at most 0.25 seconds.

In some embodiments according to the present invention, a thickness of the dried treatment film (e.g. cohesive polymer treatment film) 204 is at most 150 nanometers, or at most 120 nanometers, or at most 100 nanometers, or at most 80 nanometers, or at most 60 nanometers.

In some embodiments according to the present invention, the dried treatment film 204 has a smooth upper surface. At times, the drying process of the wet treatment layer is sufficiently rapid such that the viscosity of the aqueous treatment formulation increases rapidly enough to inhibit surface-tension-driven beading such that the dried treatment film has a smooth upper surface.

In some embodiments according to the present invention, the smooth upper surface of the dried treatment film is characterized by an average roughness Rₐ of at most 12 nanometers or at most 10 nanometers or at most 9 nanometers or at most 8 nanometers or at most 7 nanometers or at most 5 nanometers. The skilled artisan is directed to FIG. 2C and to the accompanying discussion.

In some embodiments according to the present invention, the dried treatment film is continuous over an entirety of a rectangle of the release surface of the ITM, wherein the rectangle has a width of at least 10 cm and a length of at least 10 meters.

In some embodiments according to the present invention the treatment film is transparent.

In some embodiments according to the present invention, one of the purposes of the dried treatment film is to protect the ITM surface from direct contact with droplets of aqueous ink deposited on the treatment film. Without wishing to be bound by theory, the inventors believe that the aqueous treatment formulations according to the present invention provide improved prevention against erosion by droplets of aqueous inks despite the particularly thin thickness of the dried treatment film (e.g. at most 150 or at most 120 or at most 100 or at most 80 nanometers).

In some embodiments according to the present invention, a cellulose derivative or more particularly a cellulose ether such as HPMC within the provided aqueous treatment formulation (e.g. in step S205 of FIG. 2A or in step S95 of FIG. 2C) is at least 2.0% or at least 2.5% or at least 3.0% or at least 3.5% by weight.

A Discussion of Steps S217 and S221 with Reference to FIGS. 2B.3 and 2B.4

In step S217, droplets of aqueous ink are deposited (e.g. by ink-droplet deposition) onto the dried treatment film to form an ink image on the ITM surface. In step S221, this ink image is dried to leave an ink-image residue or film on the ITM surface.

In some embodiments according to the present invention, a presence of water absorbing agent such at sugar and non-ionic surfactants in the dried treatment film plays a role in promoting dot spread and/or dot gain (e.g. uniform dot spreading and/or dot gain) when the droplets are deposited or immediately thereafter. As noted above, the formation (in step S213) of a dried treatment film of uniform thickness and/or free of defects and/or having a very smooth upper surface may facilitate uniform flow of aqueous ink on the film upper surface.

A Discussion of Step S225 with Reference to FIG. 2B.5

In step S225, the ink-image residue is transferred to a printing substrate. For example, the ink-image residue may be transferred together with non-printed areas of the dried treatment film onto the printing substrate.

In some embodiments according to the present invention, the dried treatment film is sufficiently cohesive such that during transfer of the ink-image residue, the dried treatment film completely separates from the ITM and transfers to the printing substrate with the dried ink image, both in printed and non-printed areas.

In some embodiments according to the present invention, a temperature of the ITM during transfer to the substrate is in the range of between 80° C. and 120° C. In some embodiments, the ITM temperature is at most 120° C. or at most 110° C. In some embodiments, the ITM temperature is at least 80° C. or at least 90° C. or at least 110C or at least 120° C.

In some embodiments according to the present invention, the choice of water-soluble binder in the aqueous treatment solution provided in step S205 helps to ensure (i.e. by forming a polymer film or matrix) that the dried treatment film formed in step S213 is sufficiently cohesive during transfer.

In some embodiments according to the present invention, the printing substrate to which the ink image residue film is transferred to at least a surface made of plastic (typically PET, PE, or BOPP); or aluminum. In some embodiments, the substrate media is entirely plastic.

The choice of components and concentrations of components in the ITM aqueous treatment formulation described in the present invention contribute to the resulting unexpected high performance as will be described below e.g., despite the use in some embodiments of a polysaccharide, cellulose derivative, methylcellulose or HPMC having a reduced viscosity in the wet layer formed on the ITM.

The inventors of the present invention have found that the aqueous treatment formulations disclosed herein, specifically enable or provide a highly effective means of producing a high quality image on the ITM, and following drying, transferring a relatively dry, high quality printing image from the ITM to a variety of printing substrates made of materials including plastic (such as PET, PE, BOPP) and aluminum, in addition to various grades of paper substrates, coated and uncoated, while maintaining high quality ink images typically characterized by low graininess and high quality ink dots (e.g. having large dot size and/or uniform dot gain).

Further, the formulations and methods of the present invention may be applied to produce an ink image characterized by any combination of the following features: uniform and controlled dot gain, good and uniform print gloss, and good image quality due to high quality dots having consistent dot convexity and/or well-defined boundaries.

In some embodiments according to the present invention, one feature of the aqueous treatment formulation provided in step S205 is that a static surface tension of the aqueous treatment formulation is within a range of 20 and 40 dynes/cm. For example, the aqueous treatment formulation comprises one or more surfactants. Thus, the aqueous treatment formulation of step S205 is less hydrophilic than many conventional treatment solutions, and significantly less hydrophilic than water.

In some embodiments according to the present invention, the combination of (i) a silicone-based release layer having a reduced hydrophobicity (step S201) and (ii) an aqueous treatment formulation having a reduced hydrophilicity, reduces (but does not necessarily eliminate) surface-tension effects which promote beading of the conventional aqueous treatment solution.

In addition to the static surface tension within a range of 20 and 40 dynes/cm, in some embodiments according to the present invention the aqueous treatment formulation provided in step S205 may have the following properties:

a, the aqueous treatment formulation comprises at least 5%, by weight, of a non-ionic surfactant. This may be useful for ensuring that the dried treatment film (i.e. produced in step S213) is useful for promoting good dot gain;

b, the aqueous treatment formulation comprises at least 1% (e.g. at least 1.5% or at least 2% or at least 3%), by weight, of at least one water soluble polymer having a solubility in water of at least 5% at 25° C. This may be useful for promoting formation of a polymer film or matrix in the dried treatment film (produced in step S213) that is sufficiently cohesive for good transfer in step 225.

c. a 25° C. dynamic viscosity that is at least 10 cP. It is believed that elevated viscosity is useful for counteracting any surface-tension driven tendency towards beading.

d. percent solids of the formulation, by weight, is at least 8%, or at least 9%, or at least 10/o, or at least 12%, or at least 14%, or at least 16%, or at least 18%, or at least 20% or within a range of 10-30% or 12-30% or 14-30% or 16-30% or 18-30% or 20-30% or 12-28% or 14-28% or 16-28% or 18-28% or 20-28% or 12-26% or 14-26% or 16-26% or 18-26% or 20-26%.

Physically, it is more difficult to induce flow of fluids having a higher viscosity than fluids having a lower viscosity—i.e. to induce flow of fluids having the higher viscosity, a greater driving force is required. The combination of at least moderate initial viscosity (i.e. a 25° C. dynamic viscosity that is at least 10 cP) and rapid viscosity increase after evaporation on the ITM surface ensures that the aqueous treatment formulation reaches a relatively ‘high’ (e.g. at least 10,000 cP) viscosity in a relatively short period of time (e.g. at most 0.4 second or at most 0.3 seconds). Therefore, even if there is some thermodynamic tendency towards beading, actual beading, which could negatively impact the properties of the dried treatment film (e.g., formed in step S213) is inhibited or appreciably mitigated.

In some embodiments according to the present invention, the 25° C. dynamic viscosity of initial aqueous treatment formulation may be at least 12 cP or at least 14 cP—for example, within a range of 10 to 100 cP, 12 to 100 cP, 14 to 100 cP, 10 to 60 cP, or 12 to 40 cP.

In some embodiments according to the present invention, the combination (A) of the release layer that is sufficiently hydrophilic to satisfy at least one of the following properties: (i) a receding contact angle of a drop of distilled water deposited on the silicone-based release layer surface is at most 60°; and (ii) a 10-second dynamic contact angle (DCA) of a drop of distilled water deposited on the silicone-based release layer surface is at most 108°; and (B) the static surface tension of the aqueous treatment formulation in the range of 20-40 dynes/cm is useful for minimizing a magnitude of a thermodynamic driving force that would cause beading. Furthermore, the aforementioned viscosity-related features are useful for countering this driving force.

This reduction of a magnitude of a thermodynamic force that drives beading, along with the counteracting of this tendency, ensures that any tendency to bead does not prevent the formulation, in step S209, of a wet layer of treatment formulation in step S209 having a uniform thickness.

In some embodiments according to the present invention, the aqueous treatment formulation comprises a carrier liquid containing water, the water making up at least 50% or at least 55% or at least 60% or at least 65% or at least 70% of the aqueous treatment formulation, on a weight-weight basis.

In some embodiments according to the present invention, the water making up at least 55% of the aqueous treatment formulation, on a weight-weight basis.

Embodiments of the invention relate to formulations, methods, apparatus and kits for achieving the potentially-competing goals of dot gain, image gloss and dot quality, preferably in a production environment in which high print speed is paramount. According to some embodiments, the inventors have found that it is useful to perform the method of FIG. 2A so that the dried treatment film formed in step S213 is very thin (e.g. at most 150 nanometers or at most 120 nanometers or at most 100 nanometers or at most 80 nanometers or at most 70 nanometers or at most 60 nanometers or at most 50 nanometers, and optionally at least 20 nanometers, or at least 30 nanometers) and/or continuous over large areas and/or characterized by a very smooth upper surface (e.g. to promote dot gain) and/or having properties (i.e. properties of the film per se, or of the film relative to the ITM surface) that promote good transfer from the ITM to substrate.

For example, thicker treatment films may negatively impact gloss or a uniformity thereof, since after transfer the dried ink residue may reside beneath the treatment film and on the substrate surface. Therefore, it may be preferred to produce a treatment film that is very thin.

For example, discontinuities in the treatment film and/or treatment film of varying thickness may yield images of a non-uniform gloss on the substrate or may produce an ink-image residue (in step S113) that loses its mechanical integrity upon transfer to substrate. Therefore, it may be preferred to produce a treatment film that is continuous over large areas—preferably, sufficiently cohesive to retain structural integrity when transferred to the printing substrate and/or having thenmorheological properties so the treatment film is tacky at transfer temperatures that are typically 80-150° C.

Embodiments of the invention relate to techniques for achieving these results simultaneously, even if they entail potentially-competing goals. For example, the need for the treatment film to be very thin makes it more challenging to form a treatment film that is continuous over a large area and/or sufficiently cohesive for good transfer to substrate and/or having a very smooth and uniform upper surface.

In some embodiments according to the present invention, the aqueous treatment formulation is prepared by a process comprising: providing or producing a solution of approximately 10% cellulose derivative or HPMC in water at 20° C. to 30° C. and gradually admixing components or optional components such as PEI, water absorbing agent, surfactants including any of various non-ionic surfactants, antimicrobial agents, etc. In some embodiments HPMC is Methocel® E3 or Methocel® K3.

Some embodiments of the present invention relate to a printing process described in FIG. 2C. In some non-limiting embodiments, systems and devices described in herein below may be employed to perform the method of FIG. 2C. The order of steps in FIG. 2C is not intended as limiting—in particular, steps S91-S99 may be performed in any order. In some embodiments, steps S101-S117 are performed in the order indicated in FIG. 2C.

In some embodiments, step S91 may be performed to provide any feature or combination of features of step S201 of FIG. 2A.

In some embodiments, step S95 may be performed to provide any feature or combination of features of step S205 of FIG. 2A.

In some embodiments, step S101 may be performed to provide any feature or combination of features of step S209 of FIG. 2A.

In some embodiments, step S105 may be performed to provide any feature or combination of features of step S213 of FIG. 2A.

In some embodiments, step S109 may be performed to provide any feature or combination of features of step S217 of FIG. 2A.

In some embodiments, step S113 may be performed to provide any feature or combination of features of step S221 of FIG. 2A.

In some embodiments, step S117 may be performed to provide any feature or combination of features of step S225 of FIG. 2A.

In some embodiments according to the present invention, steps S91-99 relate to the ingredients or components or consumables used in the process of FIG. 2G while steps S101-S117 relate to the process itself. Briefly, (i) in step S101 a thin treatment layer of a wet treatment formulation is applied to an intermediate transfer member (ITM) (e.g. having a release layer with hydrophobic properties), (ii) in step S105 this treatment layer is dried (e.g. rapidly dried) into a thin dried treatment film on a release surface of the ITM, (iii) in step S109 droplets of an aqueous ink are deposited (e.g. by jetting) onto the thin dried treatment film, (iv) in step S113 the ink image is dried to leave an ink image residue on the dried treatment film to form an ink image film on the ITM and (v) in step S117 the ink-image film is transferred to printing substrate.

The details of the ingredients of steps S91-S99, as well as the process steps S101-S117 are described herein above and below.

In some embodiments according to the present invention, steps S91-S117 are performed as follows:

(A) in step S91, an ITM is provided—e.g. at most moderately hydrophobic and/or having hydrophobic properties and/or having a release layer that is silicone based and/or only moderately hydrophobic and/or lacking functional groups;

(B) in step S95, an aqueous treatment solution is provided e.g., (i) having a high solids content and/or (ii) that is surfactant rich and/or (iii) that is only moderately hydrophilic and/or (iv) comprising a water soluble polymer and/or (v) comprising non-ionic surfactants such as polyethoxylated sorbitan esters and/or (vi) having a viscosity that is low enough so that the solution may be spread into a uniform thin layer and/or (vii) comprising hygroscopic material and/or (viii) substantially devoid of organic solvents and/or (ix) having at most a low concentration of flocculants containing polyvalent cations;

(C) in step S99 an aqueous ink is provided:

(D) in step S101 an aqueous treatment formulation is applied to the release surface of the ITM (e.g. an in-motion ITM) to form thereon a thin wet treatment layer (e.g. thickness 23 0.8μ);

(E) in step S105, the wet thin treatment layer may be air-dried (e.g., passively), or subjected to an active drying process (e.g. a rapid drying process) on the ITM release surface to leave a thin, at least partially dried treatment film (e.g. thickness ≤0.08μ) of the water soluble polymer on the ITM release surface. For example, the thin dried treatment film may have one or both of the following properties: (i) for example, the treatment film is continuous and/or cohesive film; (ii) an upper surface of the dried treatment film is characterized by a very low roughness;

(F) in step S109, droplets of aqueous ink are deposited (e.g. by ink-jetting) onto the thin dried treatment film to form an ink image thereon;

(G) in step S113, the ink-image is dried to leave an ink image film comprising the ink image residue on the dried treatment film (e.g. to achieve good ink-dot spreading);

(H) in step S117, the ink-image film is transferred (e.g. at a relatively low temperature) (e.g. together with the dried treatment film) from the ITM surface to printing substrate (e.g. paper-based or plastic-based).

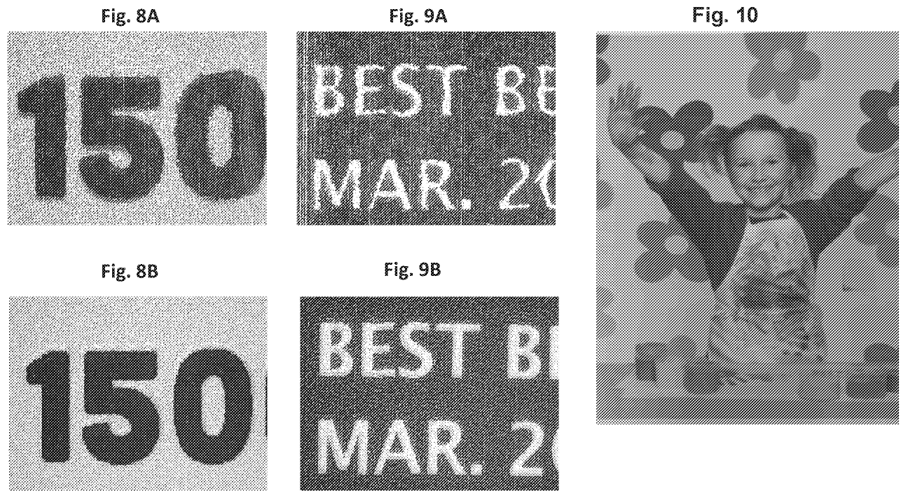

In some embodiments according to the present invention the process of FIG. 2C is performed so that when the aqueous treatment solution is applied to the ITM in step S101, there is little or no beading so that the resulting thin dried treatment film (i.e. obtained in step S105) is continuous and/or has a smooth (e.g. extremely smooth) upper surface. This smooth upper surface may be important for obtaining a substrate-residing ink image of high quality as can be seen in FIGS. 8A and 9A compared to FIGS. 8B and 9B.

One feature associated with conventional processes where the ITM is pre-treated and the ink image is applied on top of the pre-treated ITM, is that after transfer to substrate, the dried treatment film (e.g. after drying) resides over the ink image and may add to the ink image an undesired gloss. To overcome or minimize this potentially undesirable effect, the thin dried treatment film is obtained in step S105 (for example, having a thickness of at most 400 nanometers or at most 200 nanometers or at most 100 nanometers or even less). Furthermore, in some embodiments, this thin dried treatment film (i.e. obtained in step S105) is continuous, which can be beneficial, as discussed below.

Though not a limitation, in some embodiments, the process of FIG. 2C is performed so that the image-transfer of step S117 is performed at a low temperature (e.g. to an uncoated substrate)—e.g. a temperature of at most 90° C., or at most 85° C., at most 80° C., or at most 75° C., at most 70° C., or at most 65° C., at most 60° C.—for example, at about 60° C.

A Discussion of Step S91 of FIG. 2C

In some embodiments according to the present invention the ITM (i.e. the ITM provided in step S91 of FIG. 2C or in step S201 of FIG. 2A) may provide one or more (i.e. any combination of) of the following features A1-A5:

A1: Silicone based release layer—The release layer is formed of a silicone material (e.g. addition-cured)—this provides the ITM with hydrophobic properties useful in step S117.

A2: Cured silicone release layer—Before use in the method of FIG. 2C, the silicone-based release layer has been produced in a manner that reduces a hydrophobicity thereof. For example, instead of relying on the addition of functional, reactive groups to imbue the release layer with hydrophilicity, it is possible to cure the silicone release layer so that polar atoms in polar groups (e.g. the oxygen atom in a polar Si—O—Si moiety) are aligned or otherwise face outwardly with respect to the release layer surface. In this example, the oxygen atom of the “Si—O—Si” is not capable, under typical process conditions, of chemically bonding to the materials within the treatment solution, to the dried ink image and/or to the dried treatment film in step S117. However, in steps S101-S105, it is possible to benefit from the hydrophilicity of the outwardly-facing, polar “O”.

A3: Hydrophobicity of release laver—The release surface of the ITM may have moderately hydrophobic properties but is not overly hydrophobic. Thus, the release surface may have a surface energy (at 25° C.) of at least 23 dynes/cm, and more typically, at least 25 dynes/cm, at least 28 dynes/cm, at least 30 dynes/cm, at least 32 dynes/cm, at least 34 dynes/cm, or at least 36 dynes/cm, and/or at most 48 dynes/cm, at most 46 dynes/cm, at most 44 dynes/cm, at most 42 dynes/cm, at most 40 dynes/cm, at most 38 dynes/cm, or at most 37 dynes.

A4: A receding contact angle of a droplet of distilled water—A receding contact angle of a droplet of distilled water on the ink reception or release layer surface is typically at least 30° and more typically, 30° to 75°, 30° to 65°, 30° to 55°, or 35° to 55°.

A5: Functional groups in release layer—The release layer of the ITM may be devoid or substantially devoid of functional groups bonded within the cross-linked polymer structure; the inventors believe that such functional groups may increase or promote an undesired adhesion.

A Discussion of Step S95 of FIG. 2C

In step S95, an aqueous treatment formulation is provided. In some embodiments this treatment formulation comprises at least 50% wt/wt or at least 55% wt/wt or at least 60% wt/wt or at least 65% wt/wt water carrier liquid.

In some embodiments, the aqueous treatment formulation (i.e. the aqueous treatment formulation in its initial state before the application of step S101 of FIG. 2C or the aqueous treatment formulation in its initial state before the application of step S205 of FIG. 1) may provide one of more (i.e. any combination of) the of the following features:

B1: High solids load—In some embodiments, the initial aqueous treatment formulation has a high solids load or a highly concentrated solution having a total percent solids, by weight of the formulation, of at least 8%, or at least 9%, or at least 10%, or at least 12% or at least 14%, or at least 16%, or at least 18%, or at least 20% or at most 30%, or at most 28%, or at most 26% or between 12-30% or between 14-30% or between 16-30% or between 12-28% or between 14-28% or between 16-28% or between 18-28%, e.g., as measured by weighing the residue after evaporating the carrier liquid to dryness at 25° C.

B2: Surfactant rich—In some embodiments, the initial aqueous treatment formulation comprises at least 2% wt/wt, or at least 2.5% w/t, at least 3% wt/wt, or at least 4% w/t, or at least 5% wt/wt, or at least 6% wt/wt, or at least 7% wt/wt. or at least 8% wt/wt, or at least 9% wt/wt, or at least 10% wt/wt of surfactant(s). In some embodiments, the relatively high concentration of the surfactant in initial the aqueous treatment formulation may serve to make the aqueous treatment formulation less hydrophilic, thereby reducing a tendency of the aqueous treatment formulation to bead on the release surface of the ITM in step S101 and/or S105. In some embodiments, the relatively high concentration of the surfactant may be useful for spreading aqueous ink-droplets (or counteracting any tendency of the ink droplet to contract) over the surface of the dried ink film during steps S109 and/or S113, thereby increasing a coverage of the resulting ink dot which eventually resides on the substrate. Examples include but are not limited to: PEG-20 sorbitan monolaurate, Tween 80®, Tween 60®, Tergitol, Pluronic, Dynol, or in general any water soluble silicone or fluorinated surfactant.

B3: Presence (e.g. at relatively high concentration) of non-ionic surfactants and/or silicone or fluorinated surfactants—In some embodiments according to the present invention, the initial aqueous treatment formulation comprises at least 5% (e.g. at least 6%, at least 7%, at least 8%, at least 9%, or at least 10%) wt./wt. non-ionic surfactant. In some embodiments, a solubility of this non-ionic surfactant in water is at least 5% or at least 7% at 25° C., and typically higher. The unit “dynes/cm” is used interchangeably with “mN/m”. Suitable surfactant includes both non-ionic surfactants. A silicone surfactant can be in an amount of at least 0.5%, by weight. Example of nonionic surfactants include but are not limited to PEG-20 sorbitan monolaurate (e.g. Tween®20, Tween®60, Tween®80), Dynol surfactants (e.g. Dynol™800, Dynol™607, Dynol™960, Dynol™810), secondary alcohol ethoxylate (e.g. Tergitol™15-S-9, Tergitol™ 15-S-7, Tergitol™TMN6), and octylphenol ethoxylate (e.g. Triton™X-100, Triton®X35, Triton™X-15). Examples of silicone surfactant include but are not limited to polyether-modified polydimethylsiloxane (e.g. byk Lpx® 23289, Byk®347, Byk®349, Byk®333, Byk®3455, Byk®348) or polyether siloxane copolymer (e.g.TEGO®240, Tego®280, Tego 492, Tego 482). Examples of fluorinated surfactant include but are not limited to Dynax 4000, Dynax 4010.

B4: Moderately hydrophilic initial aqueous treatment formulation—In some embodiments according to the present invention, the initial aqueous treatment formulation is only moderately hydrophilic—e.g. having a static surface tension at 25° C. of at most 32 dynes/cm (e.g. between 20 and 32 dynes/cm) or at most 30 dynes/cm (e.g. between 20 and 32 dynes/cm) or at most 28 dynes/cm (e.g. between 20 and 32 dynes/cm). Because at times the release surface of the ITM has moderately hydrophobic (or moderately hydrophilic) properties, it may not be useful to employ an initial aqueous treatment formulation having high hydrophilicity, which would cause beading of the aqueous treatment formulation on the surface of the ITM in steps S101 and/or S105. This may be especially important for situations where the thickness of the wet treatment layer is thin, and it is desired to avoid bare patches, so the resulting thin dried treatment film is continuous.

B5: Presence of a polysaccharide or cellulose—In some embodiments, a presence of a modified polysaccharide (e.g., cellulose ether), specifically a methylcellulose, more specifically a hydroxypropyl substituted methylcellulose, and more specifically a methylcellulose having a gelation temperature of at least 55° C. or at least 60° C. as measured at 2% concentration by weight in water. In some embodiments, the initial aqueous formulation comprises at least 1.5% (e.g. at least 2%, at least 2.5%, or at least 3%), by weight, of a modified polysaccharide, specifically a soluble hydroxypropyl substituted methyl cellulose, having solubility in water of at least 5% at 25° C. and more specifically one with a gelation temperature of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C., at most 105° C., or between 60-120° C., or between 60-110° C., or between 60-100° C., or between 65-110° C., or between 65-105° C., or between 65-100° C., or between 70-110° C., or between 70-100° C., or between 75-110° C., or between 75-100° C., or between 80-100° C. In some embodiments, the formation of the polymer matrix promotes forming of the film and/or imbues the dried treatment film with desired elasticity and/or cohesiveness or tensile strength, even when the dried treatment film is quite thin. The modified polysaccharide, specifically a soluble hydroxypropyl substituted methyl cellulose has a viscosity in mPa·s as measured in 2% concentration by weight in water at 25° C. of at most 11, at most 10, at most 9, at most 8, at most 7, at most 6, at most 5, at most 4, and optionally, at least 0.5 or at least 1, or at least 2 or a viscosity within a range of 0.5-10, 1-8, 2-8, 2-5, or 2-4. The modified polysaccharide, specifically a soluble hydroxypropyl substituted methyl cellulose can have a temperature of gelation as measured at 2% concentration by weight in water,

B6: Relatively low viscosity before application to the ITM in step S101 of FIG. 2C (or before application to the ITM in step S209 of FIG. 2A)—As will be discussed below, in step S101 of FIG. 2C (or in step S209 of FIG. 2A) the inventors have found it to be desirable to apply a thin but relatively uniform wet layer of aqueous treatment formulation. Towards this end, in some embodiments the 25° C. dynamic viscosity of the initial aqueous treatment formulation may be at most 100 cP or at most 80 cP or at most 40 cP or at most 30 cP. Alternatively, or additionally, the 25° C. dynamic viscosity of the initial aqueous treatment formulation may be at least 8 cP or at least 10 cP or at least 12 cP or at least 14 cP—for example, within a range of 8 to 100 cP, 10 to 100 cP, 12 to 100 cP, 14 to 100 cP, 10 to 60 cP, or 12 to 40 cP. In some embodiments, this feature might be particularly useful when applying the treatment formulation to the ITM as it moves at high speeds (e.g. past an applicator arrangement—for example, a stationary applicator arrangement).

B7: Devoid of organic solvents or sugar alcohols such as glycerol—In some embodiments according to the present invention, a presence of low vapor pressure organic solvents might retard the drying of the treatment formulation on the surface of the ITM in step S105 and/or result in a treatment film lacking desired elasticity and/or cohesiveness or tensile strength desired for the transfer step S117. In some embodiments, the formulation is devoid of organic solvents, irrespective of their vapor pressure in the pure state, and/or comprises at most 3%, at most 2%, at most 1%, or at most 0.5%, or at most 0.25% or at most 0.1% by weight, organic solvents. In particular, in some embodiments, the formulation is devoid of organic solvents and/or comprises at most 3%, at most 2%, at most 1%, or at most 0.5%, or at most 0.25% or at most 0.1% by weight, glycerol. In some embodiments, the formulation is completely devoid of glycerol.

B8: Comprising water-absorbing materials—In some embodiments according to the present invention, the initial aqueous treatment formulation comprises a solid water-absorbing agent that is selected to absorb water from the ink when the water-absorbing agent is disposed within the solid, dried treatment film. For example, such solid water-absorbing agents may have a melting point (i.e., when in a pure state) of at most 60° C. or at most 50° C. or at most 40° C. or at most 30° C. or at most 25° C. The concentration of the solid water-absorbing agent may be—for example, at least 1.5% or at least 2% or at least 2.5% or at least 3% wt./wt. Examples of such water-absorbing agents include but are not limited to sucrose, urea, sorbitol, and isomalt.

B9: Having at most a low concentration of flocculants containing polyvalent cations (such as calcium chloride)—In some embodiments, it is believed that these compounds are not good for the image quality.

B10: Having a polyethyleneimine—In some embodiments according to the present invention, the concentration of the polyethyleneimine may be at least 0.05%, at least 0.1% or at least 0.2%, and optionally, at most 1% or at most 0.8%, at most 0.7% or at most 0.6%, at most 0.5% or within a range of 0.1 to 1%, 0.1 to 0.8%, 0.1 to 0.7%, 0.1 to 0.6%, 0.1 to 0.5%, 0.2 to 0.7%, 0.2 to 0.6%, or 0.2 to 0.5%.

It is noted that to one or more of the above noted features, further one or more features may be provided that derive from the presence of one or more particulate materials in the aqueous treatment formulation, as disclosed herein above and below.

A Discussion of Step S99 of FIG. 2C

Potential Features of the AQUEOUS INK:

Feature C1: In some embodiments according to the present invention (e.g. related to the method of FIG. 2A or of FIG. 2C), the ink provides one or more features of (any combination of features) disclosed in PCT/IB13/51755 or US2015/0025179, PCT/IB14/02395 or U.S. Ser. No. 14/917,461, all of which are hereby incorporated by reference. Exemplary features include but are not limited to: having at least one of (i) a viscosity of 2 to 25 cP at least one temperature in the range of 20−60° C. and (ii) a surface tension of not more than 50 millinewton/m at least one temperature in the range of 20−60° C.; and wherein at least one of the following two statements is true:

(1) the ink is such that, when substantially dried, (a) at least one temperature in the range of 70° C. to 195° C., the dried ink has a first dynamic viscosity in the range of 1,000,000 (1×106) cP to 300,000,000 (3×108) cP, and (b) at least one temperature in the range of 50° C. to 85° C., the dried ink has a second dynamic viscosity of at least 80,000,000 (8×107) cP, wherein the second dynamic viscosity exceeds the first dynamic viscosity; and (2) the weight ratio of the resin to the colorant is at least 1:1.

For example, the water-based inkjet ink formulation comprises: a solvent containing water and, optionally, a co-solvent, said water constituting at least 8 wt. % of the formulation; at least one colorant dispersed or at least partly dissolved within said solvent, said colorant constituting at least 1 wt. % of the formulation; and an organic polymeric resin, which is dispersed or at least partially dissolved within said solvent, the resin constituting 6 to 40 wt. % of the formulation, wherein the average molecular weight of said resin is at least 8,000.

A Discussion of Stet, S105 of FIG. 2C

Feature D1: In some embodiments according to the present invention the dried treatment layer formed in step S105 is thin but not a monolayer (e.g. significantly thicker than a monolayer)—e.g. having a thickness of at least 20 nanometers, and typically, at most 100 nanometers. In some embodiments, the dried treatment layer is extremely thin, having a thickness of at most 80 nanometers, or at most 75 nanometers, or at most 70 nanometers, or at most 65 nanometers, or at most 60 nanometers, or at most 55 nanometers, or at most 50 nanometers, or at most 45 nanometers, or at most 40 nanometers or at most 35 nanometers. Nevertheless, in some embodiments, even if the dried treatment film is extremely thin, it is thicker than monolayers or monolayer-type constructs. Thus, in some embodiments, a thickness of the dried treatment layer may be at least 25 nanometers or at least 30 nanometers or at least 40 nanometers or at least 50 nanometers. In some embodiments, providing this much ‘bulk’ (i.e. minimum thickness features—e.g. together with other feature(s) described below) facilitates formation of a dried treatment film that is cohesive and/or elastic—this may be useful in step S117 where it is desirable for the dried treatment film (i.e. at that stage bearing the dried ink image thereon) to maintain its structural integrity as it is transferred from the ITM to the substrate.

In some embodiments according to the present invention the dried treatment formulation or film may add an undesired gloss to the resulting after transfer to substrate—thus, the ability to form a thin but cohesive dried treatment layer may be useful. The thinness of the layer also facilitates evaporation and drying of the layer into a film.

Feature D2: In some embodiments according to the present invention the dried treatment film formed on the ITM in step S105 is continuous and is devoid of ‘bare patches’ thereon, despite the thinness or extreme thinness. As will be discussed below, in some embodiments, in order to achieve this (i.e. especially for thin or very thin layers), both of the following may be required: (i) the initially-applied wet layer applied in step S101 is continuous and devoid of bare-patches, even if the initially-applied wet layer is relatively thin, having a thickness of at most about 1μ (or at most 0.8μ or at most 0.6μ or at most 0.4μ and more typically, at most 0.3μ, at most 0.25μ, or at most 0.2μ, and/or at least 0.1μ) and (ii) the drying process of step S105 occurs very quickly, where the viscosity of the drying treatment formulation increases very rapidly (e.g. by a factor of at least 100 or at least 1000 or at least 10,000 within at most 100 milliseconds, at most 50 milliseconds, within at most 40 milliseconds, within at most 30 milliseconds, within at most 25 milliseconds, within at most 20 milliseconds, within at most 15 milliseconds or within at most 10 milliseconds). Because the ITM release layer has hydrophobic properties and the treatment formulation is aqueous and more hydrophilic, when the aqueous treatment formulation is applied to the ITM release layer, the aqueous treatment formulation may undergo beading. However, if the viscosity increases rapidly after application of the wet treatment layer, the higher viscosity treatment formulation may better resist beading than a formulation of lower viscosity. In some embodiments and as discussed above in feature “B1”, the aqueous treatment formulation may be rich in solids, so as to facilitate a rapid increase in viscosity.

Another anti-beading feature (i.e. anti-beading of the treatment formulation in steps S101-S105) useful for obtaining a continuous dried treatment film may relate to the relative properties of (i) the release surface of the ITM which in some embodiments has hydrophobic properties but is not overly hydrophobic (see feature (see Feature “BA”); and (ii) the aqueous treatment formulation which in some embodiments has hydrophilic properties but is not overly hydrophilic (see feature “B4”). When the static surface tension between the aqueous treatment formulation and the release layer of the ITM may be relatively small, there is less of a driving force towards beading, and the viscosity of the aqueous treatment formation (e.g. as it rapidly increases) may be sufficient to prevent beading.

As discussed above, despite the only moderate hydrophobicity of the release layer of the ITM (see feature “A3”), the ITM release layer may have specific properties (see feature “A5”), that limit an adhesion between the ITM release layer and the dried treatment film—thus, even if the treatment surface is only moderately hydrophobic to avoid beading of treatment formulation thereon in steps S101 and/or S105, it may be possible (e.g. thanks at least in part to feature “B2”) to avoid paying a ‘price’ for this benefit in step S117 when it is desired later to minimize adhesion forces between the release layer of the ITM and the dried treatment film.

Feature D3. In some embodiments according to the present invention the dried treatment film formed on the ITM in step S105 is characterized by an extremely low surface roughness—in some embodiments, the surface roughness may be characterized by an average roughness Rₐ (a commonly used one-dimensional roughness parameter) of at most 20 nanometers or at most 18 nanometers or at most 16 nanometers or at most 15 nanometers or at most 14 nanometers or at most 12 nanometers or at most 10 nanometers or at most 9 nanometers or at most 8 nanometers or at most 7 nanometers or at most 6 nanometers. The dried treatment film formed on the ITM may have an Rₐ of at least 3 nanometers or at least 5 nanometers.

In some embodiments, it may be possible to achieve such a low roughness average Rₐ even for thin or extremely thin dried treatment films formed in step S105—e.g. even when a ratio between the roughness average Rₐ and the thickness of the dried treatment layer is at least 0.02 or at least 0.03 or at least 0.04 or at least 0.05 or at least 0.06 or at least 0.07 or at least 0.08 or at least 0.9 or at least 0.1 or at least 0.11 or at least 0.12 or at least 0.13 or at least 0.14 or at least 0.15 or at least 0.16 or at least 0.17 or at least 0.18 or at least 0.19 or at least 0.2.

In some embodiments according to the present invention, the dried treatment film to which the aqueous ink droplets are deposited and a surface (e.g. upper surface of) of the dried treatment film are characterized by a dimensionless ratio between (i) an average roughness Rₐ, and (ii) a thickness of the dried treatment layer, wherein the dimensionless ratio is at most 0.5, at most 0.4, at most 0.3, at most 0.25, at most 0.2, at most 0.15, or at most 0.1, and optionally, at least 0.02 or at least 0.03 or at least 0.04 or at least 0.05 or at least 0.06 or at least 0.07 or at least 0.08.

Feature D4—In some embodiments according to the present invention, it is possible to obtain a continuous dry film covering an entirety of a rectangle of at least 10 cm by 1 meter, or an entirety of 1 m², 3 m², or 10 m². The film may have a thickness or average thickness of at most 120 nm, at most 100 nm, at most 80 nm, at most 60 nm, at most 50 nm, or at most 40 nm, and typically, at least 20 nm, at least 25 nm, or at least 30 nm.

A Discussion of step S109-S117

In some embodiments according to the present invention, steps S109 and/or S113 and/or S117 may be performed to provide one or more of the following process-related features:

Feature E1—In some embodiments, step S117 is performed at a high transfer temperature (e.g. at most 120° C. or at most 110° C. or at 100° C.).

In some embodiments, both the dried treatment film and the dried ink image are tacky at the transfer temperature and are thus amenable to being peeled cleanly away from the release layer.

Feature E2: Spreading—in some embodiments the manner in which droplets are deposited onto the film (e.g. the wetting angle) and the physical and/or chemical properties of the treatment film [A2 and/or A3 and/or A8—also the nanoparticles in the ink may contribute] is such as that a radius of an ink-dot exceeds a radius of the precursor droplet immediately upon impact on the dried treatment film—e.g. each droplet increases in size beyond the size resulting from spreading of the droplet caused by the impact energy of the droplet. [Dmax=2·Rmax, or Dimpact-max=2·Rimpact-max].

As noted above, the aqueous treatment formulations may further comprise at least one particulate material as disclosed herein.

Accordingly, in some embodiments of the present invention the aqueous formulation comprises:
at least one water soluble polymer;
one or more of (i) a cationic emulsion of at least one oxidized polyethylene wax particulate material; (ii) a dispersion and/or an emulsion of at least one coated wax particulate material; and (iii) a dispersion of at least one thermosetting polymeric particulate material;
a carrier liquid containing water; and
optionally, one or more of (a) at least one surfactant; (b) at least one humectant; and (c) at least one wetting agent e.g., PEI.

In some embodiments of the present invention the aqueous formulation comprises:

at least one water soluble polymer;

at least one surfactant (which may be a first non-ionic surfactant, optionally having a solubility in water of at least 7%, at 25° C. and/or a second non-ionic, silicone-containing surfactant, optionally having a solubility in water of at least 1%, at 25° C.);
at least one particulate material selected from (i) at least one thermoplastic polymeric particulate material (optionally in the form of an emulsion or a dispersion); (ii) at least one thermosetting polymeric particulate material (optionally in the form of an emulsion or a dispersion); or (iii) a combination thereof;

a carrier liquid containing water, optionally making up at least about 55%, by weight of the aqueous formulation; and

optionally, one or more of (a) at least one humectant; and (b) at least one wetting agent e.g., PEI.

In some embodiments of the present invention the aqueous formulation comprises:

at least one water soluble polymer, excluding a thermoplastic water soluble polymer;

at least one surfactant;
at least one particulate material selected from (i) at least one thermoplastic polymeric particulate material (optionally in the form of an emulsion or a dispersion); (ii) at least one thermosetting polymeric particulate material (optionally in the form of an emulsion or a dispersion); or (iii) a combination thereof;

a carrier liquid containing water, optionally making up at least about 55%, by weight of the aqueous formulation; and

optionally, one or more of (a) at least one humectant; and (b) at least one wetting agent e.g., PEI.

In some embodiments of the present invention the aqueous formulation comprises:

at least 1.5%, by weight, of at least one water soluble polymer having a solubility in water of at least 5% at 25° C.;

at least 5%, by weight, of a first non-ionic surfactant having a solubility in water of at least 7%, at 25° C.;

a second non-ionic, silicone-containing surfactant having a solubility in water of at least 1%, at 25° C.;
at least one particulate material selected from (i) at least one thermoplastic polymeric particulate material (optionally in the form of an emulsion or a dispersion); (ii) at least one thermosetting polymeric particulate material (optionally in the form of an emulsion or a dispersion); or (iii) a combination thereof;

a carrier liquid containing water, said water making up at least about 55%, by weight of the aqueous formulation; and

optionally, one or more of (a) at least one humectant; and (b) at least one wetting agent.

In some embodiments according to the present invention the aqueous formulation may further comprise additional surfactant other than said first and second non-ionic surfactants.

As used herein the term “aqueous” with respect to the formulations of the invention refers of formulations which content thereof is mainly aqueous e.g., water constitutes more than 50%, by weight of the formulation.

As used herein the term “aqueous formulation”, unless otherwise noted, refers to aqueous formulations which are used with an intermediate transfer member of an indirect printing system e.g., as herein described. As times, said term is interchangeable with the term “aqueous treatment formulation”.

As used herein the term “basic aqueous treatment formulation”, “basic solution” “basic formulation” or any lingual variations thereof are interchangeable and unless otherwise noted refer to the aqueous treatment formulations lacking the particulate material according to the invention.

In some embodiments according to the present invention the particulate material is provided in the form of an emulsion.

As used herein the term “emulsion” or any lingual variations thereof refers to a mixture of at least two immiscible liquids.

In some embodiments according to the present invention the emulsion may be an oil-in-water (o/w) emulsion having a continuous water phase.

In some embodiments according to the present invention the emulsion may be a water-in-oil (w/o) emulsion having a continuous oil phase.

In some embodiments according to the present invention the emulsion is an aqueous emulsion.

In some embodiments according to the present invention the emulsion is a cationic emulsion i.e., a positively charged emulsion (such as but not limited to an emulsion with an ammonium salt emulsifier).

In some embodiments according to the present invention the particulate material is provided in the form of a dispersion.

As used herein the term “dispersion” or any lingual variations thereof refers to a solution which is comprised of solid particles which are homogenously dispersed in a liquid phase.

In some embodiments according to the present invention the dispersion is an aqueous dispersion.

In some embodiments according to the present invention the dispersion is an oil dispersion.

In some embodiments according to the present invention the particulate material of the invention is dispersed in an emulsion e.g., in the water phase of the emulsion.

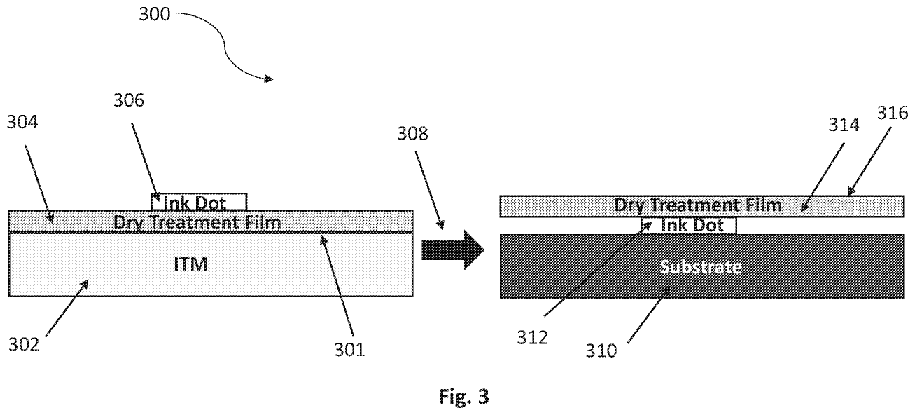

FIG. 3 illustrates an indirect printing process 300 according to some embodiments of the present invention in which a release surface 301 of an intermediate transfer member 302 is pre-treated (e.g., coated) with the aqueous formulations according to the present invention before deposition of an ink image thereto. The aqueous formulation (referred to herein also as aqueous treatment formulation) is applied to a surface 301 (which may be substantially smooth as detailed herein below) of an ITM (e.g., a hydrophobic ITM) to form thereon a thin wet treatment layer which is subjected to a drying process on the ITM release surface to leave a thin substantially dry treatment film 304 on the ITM 302 release surface 301. Then after, droplets of an aqueous ink are deposited (e.g. by ink-jetting) onto the thin substantially dried treatment film 304 to form an ink image thereon. The formed ink-image is then subjected to a drying process to leave an ink residue on the dried treatment film, represented in FIG. 3 as an ink dot 306. The dried ink-image (e.g., ink dot 306) is then transferred 308, together with the thin dried treatment film 304, from the 302 ITM surface 301 to the final substrate 310. The transferred ink dot 312 is fixedly adhered to the final printed substrate 310 as well as the transferred dry treatment film 314 which also covers the substrate in areas that are free of ink. It is noted that the relative dimensions of each of the components in FIG. 3 are only for illustration of the printing process and the produced products of the present invention and should not be considered as limiting. It is further noted that in some embodiments the ink dots, which may form an ink film, and the dry treatment film are distinct films i.e., no miscible of ingredients between the films occurs e.g., during the process of the invention. In some embodiments e.g., during the printing process, ingredients form the ink may penetrate, to some extent, the dry treatment film.

FIG. 3 demonstrates that in the illustrated process 300 the dry treatment film 314 becomes the top layer of the final printed substrate. As such, said film allows the tuning of the printed image surface properties, such as coefficient of friction, mechanical strength (e.g., rub and/or scratch resistance), sensitivity to humidity etc. At times, the dry treatment film 314 may also serve as a protective layer to the ink image surface (e.g., ink dot 312).

In some embodiments according to the present invention, the dry treatment film comprises one or more polymeric particulate materials as herein described (not shown in FIG. 3). In some embodiments the surface of the dry treatment film 316, which is distal to the surface of the substrate, is substantially smooth (e.g., having low surface roughness). This is achieved for example by utilizing ITMs as detailed herein above and below having substantially smooth release surface 301 which affects the surface of the dry treatment film placed thereon which following transfer 308 becomes surface 316 of the dry treatment film (in this respect, and without wishing to be bound by theory, the inventors of the present invention believe that the relative flatness or smoothness of the ink film of the present invention may largely be attributed to the smoothness of the release layer on the surface of the ITM, and to the inventive system and process in which the emerging ink film surface substantially complements that of that surface layer, and in which the developing ink film image may substantially retain or completely retain that complementary topography through the transfer onto the printing substrate).

Thus, in some embodiments according to the present invention, the particulate material is embedded in the substantially dry treatment film and is not protruding out of the dry treatment film surface 316, as such maintaining substantially smooth characteristics of the surface 316. To this end, and without wishing to be bound by any theory, the improved rub resistance of the printed image produced according to the present invention is believed to be via a shock absorbing mechanism e.g., the particulate material filling “empty” spaces in the dry treatment film.

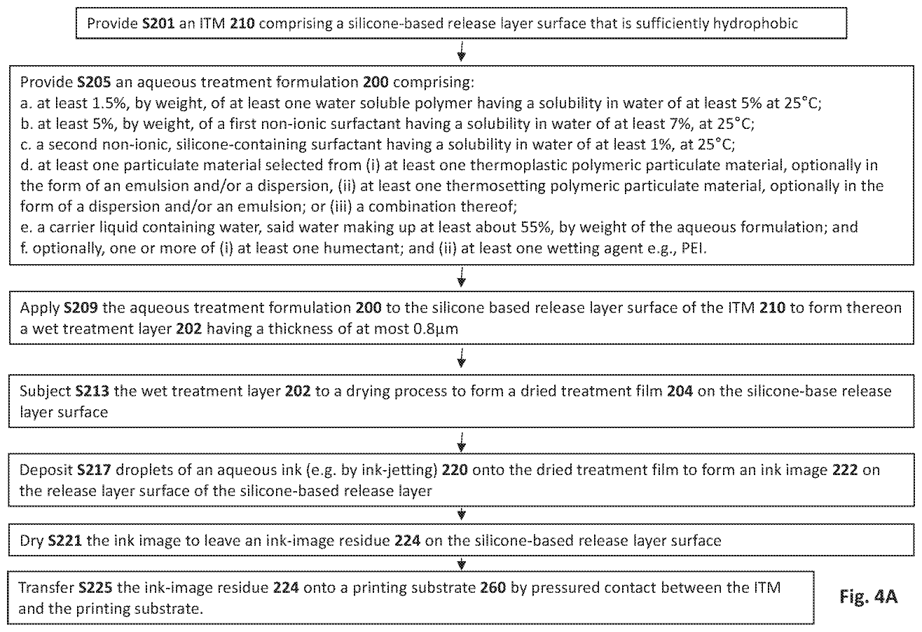

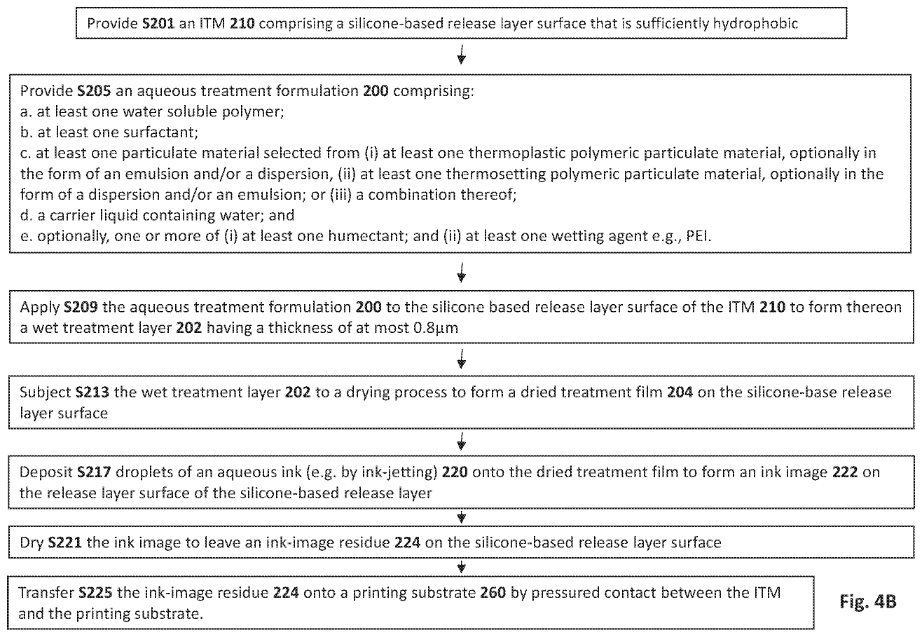

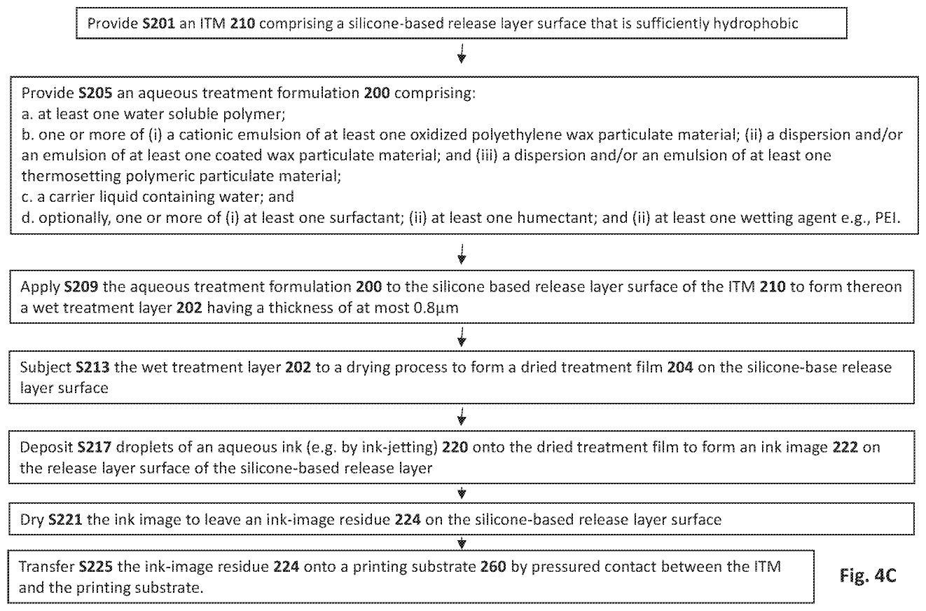

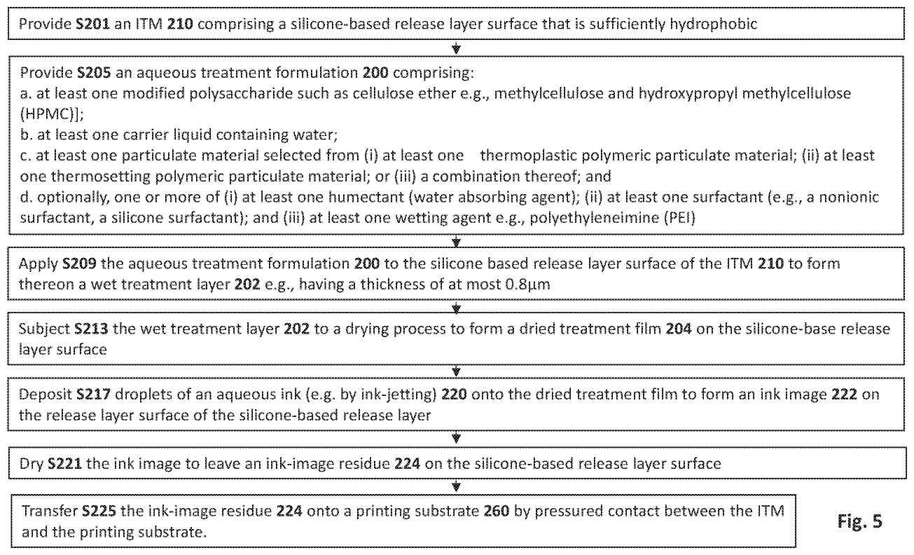

Similar to FIGS. 2A and 2C. FIGS. 4A to 4C and FIG. 5 display flow-charts of a method of indirect printing by an aqueous ink onto a silicone-based release layer surface of an intermediate transfer member having a layer of treatment or treatment formulation according to some embodiments of the invention.

It is noted that one or more of the embodiments/features detailed herein above in connection with FIGS. 2A and 2C, may be applicable to the exemplary disclosure of FIGS. 4A to 4C and FIG. 5.

The particulate materials utilized in accordance with the present invention may be of any shape and size, provided that the size dimensions thereof e.g., diameter, length, width, thickness are at the nanoscale.

In some embodiments according to the present invention the particulate material have a particle size (e.g., diameter or longest axis) of between about 1 nm to about 500 nm.

In some embodiments according to the present invention the shape of the particulate material may be selected from spherical, dot-shaped, rod-shaped, wire, cubic, cylindrical, polygonal, whisker-like, disk-like, platelet, multipod, frame and others.

In some embodiments according to the present invention the particulate material is of a size (e.g., diameter or longest axis) of between about 1 to about 500 nm, or any size there between. In some embodiments, the size is between 1 to 400 nm, between 1 to 450 nm, between 1 to 350 nm, between 1 to 250 nm, between 1 to 200 nm, between 1 to 150 nm, between 1 to 100 nm, between 1 to 50 nm, between 1 to 90 nm, between 1 to 80 nm, between 1 to 70 nm, between 1 to 60 nm, between 1 to 50 nm, between 10 to 500 run, between 20 to 500 nm, between 30 to 500 nm, between 40 to 500 nm, between 50 to 500 nm, between 60 to 500 nm, between 70 to 500 nm, between 80 to 500 nm, between 90 to 500 nm, between 100 to 500 nm, between 150 to 500 nm, between 200 to 500 nm, between 250 to 500 nm, between 300 to 500 nm, between 350 to 500 nm, between 400 to 500 nm, between 450 to 500 nm.

In some embodiments according to the present invention the particulate material is between about 1 to about 500 nm in size. In some embodiments, the particulate material is between about 50 to about 200 nm in size. In some embodiments, the particulate material is between about 300 to about 400 nm in size. In some embodiments, the particulate material is about 50 nm, about 100 nm, about 200 nm, about 300 nm, about 400 nm in size.

In some embodiments according to the present invention the particulate material has substantially a two dimensional disc like shape (i.e., with a diameter constituting the longest access of the particulate material).

In some embodiments according to the present invention one or more particulate materials may be comprised in the treatment formulations of the invention. At times, the particulate materials may have substantially the same size or may have a different size.

As used herein the term “thermoseting polymeric particulate material” or any lingual variations thereof refers to a particulate material which a is polymeric material (e.g., having relatively high molecular wright) that becomes irreversibly hardened upon being cured e.g., by the action of heat or suitable radiation). Once hardened this material cannot be re-melted.

As used herein the term “thermoplastic polymeric particulate material” or any lingual variations thereof refers to a particulate material which is a polymeric material (e.g., having relatively high molecular weight) that becomes pliable or moldable above a specific temperature and solidifies upon cooling. This material can be re-melted and reshaped.

In some embodiments according to the present invention the particulate material is homogeneously dispersed in the aqueous formulation.

In some embodiments according to the present invention the concentration of the emulsion of the particulate material within the aqueous formulation is at least about 0.5% and at most about 15%, by weight relative to the total weight of the formulation. In some embodiments said concentration is about 0.5%, at times about 1%, at times about 1.5%, at times about 2.0%, at times about 2.5%, at times about 3.00%, at times about 3.5%, at times about 4.0%, at times about 4.5%, at times about 5.0%, at times about 5.5%, at times about 6.0%, at times about 6.5%, at times about 7.0%, at times about 7.5%, at times about 8.0%, at times about 8.5%, at times about 9.0%, at times about 9.5%, at times about 10.0%, at times about 10.5%, at times about 11.0%, at times about 11.5%, at times about 12.0%, at times about 12.5%, at times about 13.0%, at times about 13.5%, at times about 14.0%, at times about 14.5%, and at times about 15.0%.

In some embodiments according to the present invention the concentration of the dispersion of the particulate material within the aqueous formulation is at least about 0.5% and at most about 15%, by weight relative to the total weight of the formulation. In some embodiments said concentration is about 0.5%, at times about 1%, at times about 1.5%, at times about 2.0%, at times about 2.5%, at times about 3.0%, at times about 3.5%, at times about 4.0%, at times about 4.5%, at times about 5.0%, at times about 5.5%, at times about 6.0%, at times about 6.5%, at times about 7.0%, at times about 7.5%, at times about 8.0%, at times about 8.5%, at times about 9.0%, at times about 9.5%, at times about 10.0%, at times about 10.5%, at times about 11.0%, at times about 11.5%, at times about 12.0%, at times about 12.5%, at times about 13.0%, at times about 13.5%, at times about 14.0%, at times about 14.5%, and at times about 15.0%.

In some embodiments according to the present invention the thermosetting polymeric particulate material is an hydrophilic particulate material.

In some embodiments according to the present invention the thermosetting polymeric particulate material is a hydrophobic particulate material.

In some embodiments according to the present invention the thermosetting polymeric particulate material is a hydrophobic particulate polymer selected from polytetrafluoroethylene (PTFE), perfluoroalkoxy alkane (PFA), fluorinated ethylene propylene (FEP) or any combination thereof.

In some embodiments according to the present invention the hydrophobic particulate material is PTFE (i.e., Teflon).

In some embodiments according to the present invention the PTFE particulate material is of a size (e.g., diameter or longest axis) of between about 1 to about 500 nm (e.g., 1, 2, 3, 4, 5, 6, 7, 8, 9, 10, 20, 30, 40, 50, 60, 70, 80, 90, 100, 200, 300, 400, and 500 nm).

In some embodiments according to the present invention the PTFE particulate material is of a size of between about 50 nm to about 200 nm (e.g., 50, 60, 70, 80, 90, 100, 110, 120, 130, 140, 150, 160, 170, 180, 190 and 200 nm).

In some embodiments according to the present invention the PTFE particulate material is of a size of about 200 nm and the concentration of the dispersion thereof within the aqueous formulation is between about 4% to about 12% (e.g., 4, 5, 6, 7, 8, 9, 10, 11, 12%), by weight relative to the total weight of the formulation.

In some embodiments according to the present invention the solid content of the particulate material e.g., PTFE in the aqueous formulation of the invention is between about 2% to 7% (e.g., 2.0, 2.5, 3.0, 3.5, 4.0, 4.5, 5.0, 5.5, 6.0, 6.5 and 7.0%).

In some embodiments according to the present invention the PTFE particulate material is of a size of about 300 nm to about 400 nm (e.g., 300, 310, 320, 330, 340, 350, 360, 370, 380, 390 and 400 nm).

In some embodiments according to the present invention the PTFE particulate material is of a size of about 300 nm to about 400 nm and the concentration of the dispersion thereof within the aqueous formulation is about 8%, by weight relative to the total weight of the formulation.

In some embodiments according to the present invention the PTFE dispersion is an aqueous dispersion having the following properties:
a. Viscosity—about 13 cP
b. Surface tension—about 31.4 mN/m
c. pH—about 9.95
d. Solid content—about 60%
e. Particle size—about 200 nm.

In some embodiments according to the present invention the thermoplastic polymeric particulate material is a wax particulate material.

Non limiting examples of wax particulate materials are paraffin waxes, polyethylene waxes, oxidized polyethylene waxes, ethylene copolymer waxes, montan based ester waxes, polyether waxes, poly(methylene), polypropylene waxes, microcrystalline waxes, polyolefin waxes, paraffin-ethylene acrylic acid copolymer waxes, carnauba waxes etc., or any combination thereof.

In some embodiments according to the present invention the wax particulate material is an oxidized polyethylene.

The molecular weight of the wax material may be of various values. Exemplary non limiting MWs are between about 700 to 1500 gr/mol (e.g., 700, 800, 900, 1000, 1100, 1200, 1300, 1400, and 1500). In some embodiments the MW is below 700 gr/mol. In some embodiments the Mw is above 1500 gr/mol.

Examples of thermoplastic particulate materials emulsions e.g., wax emulsions, may include nonionic emulsions, anionic emulsions, cationic emulsions and water-based emulsions.

In some embodiments according to the present invention the thermoplastic particulate materials emulsion is a cationic emulsion.

In some embodiments according to the present invention the wax emulsion is an aqueous emulsion.

In some embodiments according to the present invention the wax is provided in a cationic emulsion.

In some embodiments according to the present invention the wax particulate material is an oxidized polyethylene wax particulate material.

In some embodiments according to the present invention the particulate oxidized polyethylene wax is of a size (e.g., diameter or longest axis) of between about 1 nm to about 500 nm.

In some embodiments according to the present invention the particulate oxidized polyethylene wax is of a size of about 1 to about 500 nm and the concentration of the emulsion thereof within the aqueous formulation is between about 1.5% to about 5% (e.g., about 1.5%, 2.0%, 2.5%, 3.0%, 3.5%, 4.0%, 4.5% and 5.0%) by weight relative to the total weight of the formulation.

In some embodiments the solid content of the particulate material e.g., particulate oxidized polyethylene wax in the aqueous formulation of the present invention is between about 0.3% to 1.75% (e.g., 0.3, 0.4, 0.5, 0.6, 0.7, 0.8, 0.9, 1.0, 1.1, 1.2, 1.3, 1.4, 1.5, 1.6, 1.70 and 1.75%).

In some embodiments according to the present invention the particulate oxidized polyethylene wax has a glass transition temperature (Tg) value of about 130° C.

As used herein the term “glass transition temperature” or any lingual variations thereof refers to the softening temperature.

In some embodiments according to the present invention the thermoplastic particulate material (e.g., particulate oxidized polyethylene wax) has Tg value of about 80° C. to about 160° C. (e.g., 80, 85, 90, 95, 100, 115, 110, 115, 120, 125, 130, 135, 140, 145, 150, 155 or 160° C. At times said Tg value is of about 100° C. to about 160° C.

In some embodiments according to the present invention the thermoplastic particulate material (e.g., the coated wax particulate material NanoBYK 3620) has a Tg value of about 125° C., at times of about 130° C.

Without wishing to be bound by theory, the inventors of the present invention believe that the thermoplastic material (e.g., the wax) has to be of relatively high Tg in order to insure maintaining the particles shape and/or size, in particular after substantially drying of the treatment layer. Low Tg such as below 80° C. may cause particles to change during the process and may result with lack of activity (e.g., no rub resistance improvement).

In some embodiments according to the present invention the emulsion of at least one thermoplastic polymeric particulate material is a cationic emulsion.

In some embodiments according to the present invention the cationic emulsion is an emulsion of a particulate oxidized polyethylene wax.

In some embodiments according to the present invention the cationic emulsion of a particulate oxidized polyethylene wax has the following properties:

a. Viscosity—about 80 cP at 20° C.

b. Density—about 1 g/cm³

c. pH—about 9.5 at about 1% concentration

d. Solid content—about 25-29%

e. Particle size—below about 500 nm.

In some embodiments according to the present invention the thermoplastic polymeric particulate material is a coated wax particulate material.

In some embodiments according to the present invention the wax is coated with particles such as silicon dioxide.

In some embodiments according to the present invention the coated wax particulate material is a particulate wax material coated with silicon dioxide.

In some embodiments according to the present invention the coated wax particulate material is of a size (e.g., diameter or longest axis) of about 100 nm.

In some embodiments according to the present invention the coated wax particulate material is of a size (e.g., diameter or longest axis) of about 100 nm and the concentration of the emulsion (or dispersion) thereof within the aqueous formulation is at least about 10%, by weight relative to the total weight of the formulation.

In some embodiments the formulations according to the present invention are substantially free of aggregates (e.g., free of aggregates of anyone of the particulate materials. Said aggregates may be aggregates formed of the same particles or of a combination of one or more different particles.

In some embodiments according to the present invention the particulate material may be capable of being re-dispersed in the aqueous formulations according to the invention and the other non-particulate components of the formulation may be capable of being re-dissolved in the aqueous formulation, after being dried (e.g., on the ITM as detailed herein) so that after being re-dissolved and re-dispersible the resulted formulation retains the characteristics of the aqueous treatment formulation. To this end, the system utilized in the present invention may further comprise a cleaning station configured to remove residual dry treatment film from the ITM (e.g., by using one or more knives and/or one or more brushes, or other suitable means). Such systems are disclosed in WO 2017/208246 to the Applicant which content thereof is incorporated herein by reference.

In some embodiments the aqueous formulations according to the invention may further comprise at least one antibacterial agent.

In some embodiments the aqueous formulation according to the present invention has the following properties:

i. a static surface tension within a range of 20 and 40 mN/m at 25° C.:

ii. a 25° C. dynamic viscosity that is at least 10 cP; and

iii. a 60° C. evaporation load of at most 7.5:1, by weight.

In some embodiments of the present invention the aqueous treatment formulation may further comprise at least one humectant, optionally being a sugar.

As used herein the term “water soluble polymer” refers to a polymer which is soluble in water at 25° C. to some extent.

In some embodiments according to the present invention the water soluble polymer has a solubility in water of at least 5% at 25° C.

In some embodiments according to the present invention the solubility in water of the at least one water soluble polymer, at 25° C., is at least 7%, at least 10%, at least 12%, at least 15%, at least 20%, or at least 25%, and optionally, at most 80% or at most 60%.

In some embodiments according to the present invention the water soluble polymer is a binder, in particular, a soluble binder.

In some embodiments according to the present invention the water soluble polymer is selected from the group consisting of polyvinyl alcohol, water-soluble cellulose, polyvinylpyrrolidone (PVP), polyethylene oxide, and water-soluble acrylates.

In some embodiments according to the present invention the water soluble polymer is a modified polysaccharide as herein described.

In some embodiments the treatment formulations according to the present invention are devoid of a water soluble thermoplastic polymer.

In some embodiments according to the present invention a concentration of the water soluble polymer in the formulations of the present invention is within a range of 2.0 to 8%, 2.5 to 6.5%, 2.5 to 6%, 2.5 to 5.5/6, or 2.5 to 5%, optionally being of at most 10% or at most 8% or at most 6% or at most 5%.

In some embodiments according to the present invention the surfactant is a non-ionic surfactant e.g., a non-ionic silicone-containing surfactant.

In some embodiments the aqueous formulation has a total surfactant concentration of at least 0.3%, at least 0.5%, at least 0.75%, at least 1%, at least 2%, at least 3%, at least 4%, at least 5%, at least 6%, at least 7%, at least 8%, at least 9%, at least 10%, at least 11%, at least 12% and optionally, within a range of 6 to 40%, 6 to 30%, 6 to 20%, 7 to 30%, 7 to 20%, 7 to 15%, 8 to 25%, 8 to 20%, 8 to 15%, 8 to 13%, 9 to 25%, 9 to 20%, 9 to 15%, 9 to 13%, 10 to 25%, 10 to 20%, 10 to 15%, or 10 to 13%.

In some embodiments the aqueous formulation contains at least 6%, at least 7%, at least 8%, at least 9%, or at least 10%, by weight, of said first non-ionic surfactant.

In some embodiments according to the present invention the aqueous formulation contains at most 18%, at most 16%, at most 15%, at most 14%, or at most 13%, by weight, of said first non-ionic surfactant.

In some embodiments according to the present invention the concentration of the first non-ionic surfactant within the aqueous treatment formulation, by weight, is within a range of 5.5-18%, 5.5-16%, 6.5-18%, 6.5-16%, 7.5-18%, 7.5-16%, 8.5-18%, 8.5-16%, 9.5-18%, 9.5-16%, 10.5-18%, or 10.5-16%.

In some embodiments according to the present invention in the aqueous formulation the solubility in water of the first non-ionic surfactant, at 25° C., is at least 8%, at least 10%, at least 12%, at least 15%, at least 20%, at least 25%, or at least 30%, and optionally, at most 80% or at most 60%.

In some embodiments according to the present invention in the aqueous formulation the second, non-ionic silicone-containing surfactant includes a polysiloxane-polyoxyalkylene copolymer, and wherein optionally, a concentration of said polysiloxans-polyoxyalkylene copolymer is at least 0.3%, at least 0.5%, at least 0.75%, or at least 1.0%, by weight, and further optionally, at most 5%/o, at most 4/0, at most 3%, at most 2.5%, at most 2%, or at most 1.75%, by weight.

In some embodiments according to the present invention the aqueous formulation contains at least 0.3%, at least 0.5%, at least 0.75%, or at least 1.0%, by weight and optionally, at most 5%, at most 4%, at most 3%, at most 2.5%, at most 2%, or at most 1.75%, by weight, of said second, non-ionic silicone-containing surfactant.

In some embodiments according to the present invention the first non-ionic surfactant is, mainly includes, or includes a polyethoxylated sorbitan ester.

In some embodiments according to the present invention the polyethoxylated sorbitan ester includes at least one species or at least two species selected from the group consisting of PEG-4 sorbitan monolaurate, PEG-20 sorbitan monolaurate. PEG-20 sorbitan monopalmitate, PEG-20 sorbitan monostearate, and PEG-20 sorbitan monooleate.

In some embodiments according to the present invention an HLB number of said first non-ionic surfactant is at least 11, at least 12, at least 13, at least 14, or at least 14.5, and optionally, at most 22, at most 21, at most 20, at most 19, at most 18, or at most 17, and further optionally, within a range of 11 to 25, 11 to 23, 11.5 to 21, 11.5 to 20, 11.5 to 18, 12.5 to 21, 12.5 to 20, 12.5 to 18, 13.5 to 21, 13.5 to 20, 13.5 to 18, 14 to 20.5, 14 to 18.5, 14.5 to 20, 14.5 to 19, 14.5 to 18, or 14.5 to 17.5.

In some embodiments according to the present invention the aqueous formulation contains at least 6%, at least 7%, at least 8%, at least 9%, or at least 10%, by weight, of said first non-ionic surfactant.

In some embodiments according to the present invention the aqueous formulation contains at most 18%, at most 16%, at most 15%, at most 14%, or at most 13%, by weight, of said first non-ionic surfactant.

In some embodiments according to the present invention the first non-ionic surfactant within said aqueous formulation, by weight, is within a range of 5.5-18%, 5.5-16%, 6.5-18%, 6.5-16%, 7.5-18%, 7.5-16%, 8.5-18%, 8.5-16%, 9.5-18%, 9.5-16%, 10.5-18%, or 10.5-16%.

In some embodiments according to the present invention the second, non-ionic silicone-containing surfactant includes a polysiloxane-polyoxyalkylene copolymer, and wherein optionally, a concentration of said polysiloxane-polyoxyalkylene copolymer is at least 0.3%, at least 0.5%, at least 0.75%, or at least 1.0%, by weight, and further optionally, at most 5%, at most 4%, at most 3%, at most 2.5%, at most 2%, or at most 1.75%, by weight.

In some embodiments according to the present invention the aqueous formulation contains at least 0.3%, at least 0.5%, at least 0.75%, or at least 1.0%, by weight and optionally, at most 5%, at most 4%, at most 3%, at most 2.5%, at most 2%, or at most 1.75%, by weight, of said second, non-ionic silicone-containing surfactant.

In some embodiments according to the present invention a cloud point temperature of said first non-ionic surfactant is at least 60° C., at least 70° C., at least 80° C., at least 90° C., at least 100° C., at least 105° C., at least 110° C., at least 115° C., at least 120° C., or at least 130° C., optionally as determined by the ASTM D7689-11 test method.

In some embodiments, the aqueous formulation has a total surfactant concentration of at least 6%, at least 7%, at least 8%, at least 10%, or at least 12%, and optionally, within a range of 6 to 40%, 6 to 30%, 6 to 20%, 7 to 30%, 7 to 20%, 7 to 15%. 8 to 25%, 8 to 20%, 8 to 15%, 8 to 13%, 9 to 25%, 9 to 20%, 9 to 15%, 9 to 135%, 10 to 25%, 10 to 20%, 10 to 15%, or 10 to 13%.

In some embodiments according to the present invention the solubility in water of said at least one water soluble polymer, at 25° C., is at least 7%, at least 10%, at least 12%, at least 15%, at least 20%, or at least 25%, and optionally, at most 80% or at most 60%.

In some embodiments, the solubility in water of said first non-ionic surfactant, at 25° C., is at least 8%, at least 10%, at least 12%, at least 15%, at least 20%, at least 25%, or at least 30%, and optionally, at most 80% or at most 60%.

In some embodiments according to the present invention the concentration of said first non-ionic surfactant within said aqueous treatment formulation, by weight, is within a range of 1-18%, 1-15%, 1-12%, 1-10%, 1-8%, 2-18%, 2-15%, 2-12%, 2-10%, 2-8%, 3-18%, 3-15%, 3-12%, 3-10%, 3-8%, or 4-18%, 4-15%, 4-12%, 4-10%, or 4-8%.

In some embodiments according to the present invention the aqueous formulation comprises a wetting agent.

In some embodiments according to the present invention the wetting agent is PEI.

In some embodiments according to the present invention the concentration of the PEI within the aqueous formulation, by weight, is within a range of 0.1 to 1%, 0.1 to 0.8%, 0.1 to 0.7%, 0.1 to 0.6%, 0.1 to 0.5%, 0.2 to 0.7%, 0.2 to 0.6%, or 0.2 to 0.5%.

In some embodiments according to the present invention the concentration of the PEI within the aqueous formulation, by weight, is least 0.05%, at least 0.1% or at least 0.2%, and optionally, at most 1% or at most 0.8%, at most 0.7% or at most 0.6%, at most 0.5% or within a range of 0.1 to 1%, 0.1 to 0.8%, 0.1 to 0.7%, 0.1 to 0.6%, 0.1 to 0.5%, 0.2 to 0.7%, 0.2 to 0.6%, or 0.2 to 0.5%.

In some embodiments according to the present invention the PEI has an average molecular weight of at least 200,000, at least 350,000, at least 500,000, at least 700,000, at least 750,000 and optionally, at most 3,000,000, at most 2,500,000, or at most 2,000,000.

In some embodiments according to the present invention the PEI may serve as a surface active agent.

In some embodiments the formulation according to the present invention contains at least 55%, by weight of water.

In some embodiments the formulations according to the present invention may further comprise at least one agent selected whereby, when said aqueous treatment solution is evaporated to form a solid film, said agent absorbs water from said aqueous treatment solution. In some embodiments said agent is a solid, in a pure state, at least within a range of 25° C. to 60° C., whereby, when said aqueous treatment formulation is evaporated to form a solid film, said agent acts as a water absorber.

The aqueous treatment formulations of the present invention provide improved durability of the resulted printed article produced utilizing same. The improvements may be manifested in one or more mechanical properties of the printed article. In some embodiments the mechanical property which is improved is abrasion resistance.

As used herein the term “abrasion resistance” or any lingual variations thereof refer to a property describing the degree to which the printed image can maintain its surface and structural integrity under prolonged rubbing, scratching and scuffing.

In some embodiments according to the present invention the improved property is rub resistance. In some embodiments the improved property is scratch resistance. In some embodiments the improved property is scuffing resistance.

In some embodiments the mechanical property which is improved is surface tack (stickiness).

In some embodiments the mechanical property which is improved is reflected in the coefficient of friction of the printed article and/or of a printed pattern.

It is noted that embodiments disclosed herein in connection with a printed article are applicable mutatis mutandis to a printed pattern.

As used herein the term “Coefficient of Friction” (CoF) refers to the force which is needed to slide two surfaces past each other. The lower the needed force, the lower the CoF value is and the higher the slip. High friction (low slip) generally correlates with higher abrasion. Thus, improvement of the CoF is meant lower CoF value. In some embodiments the CoF value is below 1 (e.g., 0.10, 0.15, 0.20, 0.25, 0.30, 0.35, 0.40, 0.45, 0.50, 0.55, 0.60, 0.65, 0.70, 0.75, 0.80, 0.85, 0.90, 0.95).

In some embodiments the CoF values is between about 0.5-0.6 (e.g., 0.51, 0.52, 0.53, 0.54, 0.55, 0.56, 0.57, 0.58, 0.59, 0.60). In some embodiments the CoF values is about 0.5, at times 0.6.

As used herein the term “Scratch Resistance” refers to the resistance ability of a surface against damage caused by sharp objects moving over the surface causing micro cuts.

As used herein the term “Rub Resistance” refers to the resistance against wear through repeated rubbing over surface area.

The improvement of the rub resistance may be via various mechanisms such as abrasive wear, adhesive wear and shock absorbing. In some embodiments the rub resistance is achieved via abrasive wear mechanisms, at times via adhesive wear mechanism, even at times via shock absorbing.

As will be appreciated by a person versed in the art, any one of the mechanical properties detailed herein may be measured by known methods and apparatuses. For example, abrasion resistance may be measured by sweeping an abrasive block on top of each sample a number of times, and measuring the optical density of the samples as compared to baseline values established for those samples prior to the abrasive testing.

The sample can be placed into a TMI (Testing Machines Incorporated) ink rub tester (model #10-18-01) and a dry ink rub test can be performed using a 1.8 kg test block having a piece of Condat Gloss® paper (135 gsm) disposed thereon. Optical densities of the samples can be measured before the test and after 100 abrasion cycles. This abrasion resistance measurement procedure is recommended by the TMI Instruction Manual, and is based on ASTM procedure D5264.

In some embodiments according to the present invention the improvement in the abrasion resistance is as observed utilizing TMI.

Thus, in some embodiments according to the present invention the particulate material (e.g., oxidized polyethylene wax particulate material, coated wax particulate material, thermosetting polymeric particulate material, thermoplastic polymeric particulate material or any combinations thereof) is capable of improving at least one mechanical property (e.g., rub resistance, scratch resistance, coefficient of friction, surface tackiness, etc.) of a printed product (e.g., an ink image on a substrate) produced by utilizing the aqueous formulation with the intermediate transfer member of the printing system, wherein the improvement in the mechanical property is in comparison with a printed product (e.g., an ink image on a substrate) produced by utilizing an aqueous formulation identical to the aqueous formulation of the invention but lacking said particulate material.

In some embodiments according to the present invention the mechanical property is rub resistance.

In some embodiments according to the present invention the improvement in the rub resistance is of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90% or at least about 95% (e.g., based on visual detection of the printed product).

In another one of its aspects the present invention provides a method of indirect printing comprising:

a. providing an intermediate transfer member comprising a release layer surface;
b. providing the aqueous formulation of according to the invention;
c. applying the aqueous formulation onto the ITM release layer surface to form thereon a wet layer having a thickness of at most about 1.0 μm (e.g., at most 0.8 μm);
d, optionally subjecting the wet layer to a drying process to form a dried film layer, from the wet layer, on the ITM release layer surface, said dried film layer having a thickness of at least about 20 nm and at most about 200 nm;
c. depositing droplets of an aqueous ink onto the dried film to form an ink image on the release layer surface of the ITM release layer surface;
f. drying the ink image to leave an ink-image residue on the ITM release layer surface; and
g. transferring the ink-image residue onto a printing substrate by pressured contact between the ITM and the printing substrate.

It is noted that steps (a) and (b) above are not limited to the order thereof and can be interchangeable in order. This applies to corresponding steps detailed herein above and below in connection with the disclosed methods.

In some embodiments according to the present invention the aqueous ink is an aqueous ink formulation comprising at least one binder and at least one colorant.

In some embodiments according to the present invention the at least one colorant in the ink formulation is at least one coloring agent consisting of a pigment.

In some embodiments according to the present invention the at least one binder in the ink formulation is a negatively charged organic polymeric resin.

In some embodiments according to the present invention the average molecular weight of the negatively charged organic polymeric resin is at least 8,000.

In some embodiments according to the present invention the at least one binder in the ink formulation is an acrylic polymer and/or an acrylic-styrene co-polymer (e.g., with an average molecular weight around 60,000 g/mole).

In another one of its aspects the present invention provides a method of indirect printing comprising:

a. providing an intermediate transfer member comprising a release layer surface;
b. providing an aqueous formulation comprising:
at least one water soluble polymer;
at least one particulate material selected from (i) at least one thermoplastic polymeric particulate material; (ii) at least one thermosetting polymeric particulate material; or (iii) a combination thereof;
a carrier liquid containing water; and
optionally, one or more of (iv) at least one surfactant; (v) at least one humectant; and (vi) at least one wetting agent;
   c. applying the aqueous formulation onto the ITM release layer surface to form thereon a wet layer having a thickness of at most about 1.0 μm (e.g., at most 0.8 μm);
   d. subjecting the wet layer to a drying process to form a dried film layer, from the wet layer, on the ITM release layer surface, said dried film layer having a thickness of at least about 20 nm and at most about 200 nm:
   e. depositing droplets of an aqueous ink onto the dried film to form an ink image on the release layer surface of the ITM release layer surface;
   f. drying the ink image to leave an ink-image residue on the ITM release layer surface; and
   g. transferring the ink-image residue onto a printing substrate by pressured contact between the ITM and the printing substrate.

In some embodiments according to the present invention the particulate material have a particle size (e.g., diameter or longest axis) of between about 1 nm to about 500 nm.

In some embodiments according to the present invention the particulate material have substantially two dimensional disc-like shape (i.e., with a diameter constituting the longest access of the particulate material).

In some embodiments according to the present invention in the dried (treatment) film on the ITM release layer surface the diameter or longest axis of the particulate material is substantially parallel to the ITM.

In some embodiments according to the present invention a thickness of the dried (treatment) film to which the aqueous ink droplets are deposited is at most 200 nm, at most 120 nm, at most 100 nm, at most 80 nm, at most 70 nm, at most 60 nm, at most 50 nm, at most 45 nm, or at most 40 nm.

In some embodiments according to the present invention a thickness of the dried treatment film to which the aqueous ink droplets are deposited is at least 15 nm or at least 20 nm or at least 25 nm or at least 30 nm.

In some embodiments according to the present invention a thickness of the dried treatment film to which the aqueous ink droplets are deposited is at most about 50 nm.

In some embodiments according to the present invention a thickness of the dried treatment film to which the aqueous ink droplets are deposited is at most about 100 nm.

In some embodiments according to the present invention a thickness of the dried treatment film to which the aqueous ink droplets are deposited is at most about 120 nm.

In some embodiments according to the present invention a thickness of the dried treatment film to which the aqueous ink droplets are deposited is at most about 150 nm.

In some embodiments according to the present invention the dried treatment film is continuous over an entirety of a rectangle of the release surface of the ITM, wherein said rectangle has a width of at least 10 cm and a length of at least 10 meters.

In some embodiments according to the present invention the dried treatment film for at least 50% or at least 75% or at least 90% or at least 95% at least 95% or at least 99% or 100% of an area of the rectangle, a thickness of the dried treatment film does not deviate from an average thickness value within the rectangle by more than 50% or more than 40% or more than 30%.

In some embodiments according to the present invention the ink-image residue is transferred together with non-printed areas of the dried treatment film onto the printing substrate.

In some embodiments according to the present invention the dried treatment film is sufficiently cohesive such that during transfer of the ink-image residue, the dried treatment film completely separates from the ITM and transfers to the printing substrate with the dried ink image, both in printed and non-printed areas.

In some embodiments according to the present invention the ITM is an hydrophobic ITM.

In some embodiments according to the present invention the ITM comprises a silicone-based release layer surface that is sufficiently hydrophilic to satisfy at least one of the following properties:

(i) a receding contact angle of a drop of distilled water deposited on the silicone-based release layer surface is at most 60°; and

(ii) a 10-second dynamic contact angle (DCA) of a drop of distilled water deposited on the silicone-based release layer surface is at most 108°.

Other non-limiting examples of applicable ITM (e.g., blankets) are detailed herein below.

In some embodiments the methods disclosed herein provide a printed product with improved one or more mechanical property (e.g., rub resistance, scratch resistance, coefficient of friction, surface tackiness etc.), wherein the improvement in the one or more mechanical property is in comparison with a printed product produced by utilizing said method but in the absence of said particulate material.

In another one of its aspects the present invention provides a system for printing, the system comprising:

a. an intermediate transfer member comprising a release layer surface;
b. a quantity of the aqueous formulation according to the invention;
c. a treatment station for applying the aqueous formulation to the ITM surface to form thereon a wet layer having a thickness of at most about 1.0 μm (e.g., at most 0.8 μm);
d. an image forming station for forming ink images on the ITM by depositing droplets of an aqueous ink upon the ITM surface after the we layer has dried into a dried film so that the droplets are applied to the dried film, said dried film layer having a thickness of at least about 20 nm and at most about 200 nm; and
e. a transfer station for transferring the ink images from the ITM to a substrate.

In another one of its aspects the present invention provides a printing system comprising:

a. an intermediate transfer member (ITM) comprising a flexible endless belt mounted over a plurality of guide rollers;
b. an image forming station configured to form ink images upon a surface of the ITM, first and second of the guide rollers being arranged upstream and downstream of the image forming station to define an upper run passing through the image forming station and a lower run;
c. an impression station through which the lower run of the ITM passes, the impression station being disposed downstream of the image forming station and configured to transfer the ink images from the ITM surface to substrate; and
d. a treatment station disposed downstream of the impression station and upstream of the image forming station for forming a uniform thin layer of a liquid formulation onto the ITM surface at the lower run thereof, the treatment station comprising:
e. a coater for coating the ITM with the aqueous formulation according to the invention; and
f. a coating thickness-regulation assembly for removing excess liquid so as to leave only a desired uniform wet thin layer of the formulation, said layer having a thickness of at most about 1.0 μm (e.g., at most 0.8 μm) the coating thickness-regulation assembly comprising a rounded tip facing the ITM surface at the lower run.

In another one of its aspects the present invention provides a system for printing, the system comprising:

a. an intermediate transfer member comprising a release layer surface:
b. a quantity of an aqueous formulation comprising:
at least one water soluble polymer;
at least one particulate material selected from (i) at least one thermoplastic polymeric particulate material; (ii) at least one thermosetting polymeric particulate material; or (iii) a combination thereof;
a carrier liquid containing water; and
optionally, one or more of (iv) at least one surfactant; (v) at least one humectant; and (vi) at least one wetting agent:
   c. a treatment station for applying the aqueous formulation to the ITM surface to form thereon a wet layer having a thickness of at most about 1.0 μm (e.g., at most 0.8 μm);
   d. an image forming station for forming ink images on the ITM by depositing droplets of an aqueous ink upon the ITM surface after the wet layer has dried into a dried film so that the droplets are applied to the dried film, said dried film layer having a thickness of at least about 20 nm and at most about 200 nm; and
   e. a transfer station for transferring the ink images from the ITM to a substrate.

In another one of its aspects the present invention provide a printing system comprising:

a. an intermediate transfer member comprising a flexible endless belt mounted over a plurality of guide rollers,
b. an image forming station configured to form ink images upon a surface of the ITM. first and second of the guide rollers being arranged upstream and downstream of the image forming station to define an upper run passing through the image forming station and a lower run:
c. an impression station through which the lower run of the ITM passes, the impression station being disposed downstream of the image forming station and configured to transfer the ink images from the ITM surface to substrate; and
d. a treatment station disposed downstream of the impression station and upstream of the image forming station for forming a uniform thin layer of a liquid formulation onto the ITM surface at the lower run thereof, the treatment station comprising:
e. a coater for coating the ITM with a quantity of an aqueous formulation comprising:
at least one water soluble polymer;
at least one particulate material selected from (i) at least one thermoplastic polymeric particulate material; (ii) at least one thermosetting polymeric particulate material; or (iii) a combination thereof;
a carrier liquid containing water; and
optionally, one or more of (iv) at least one surfactant; (v) at least one humectant; and (vi) at least one wetting agent; and
   f. a coating thickness-regulation assembly for removing excess liquid so as to leave only a desired uniform wet thin layer of the formulation, said layer having a thickness of at most about 1.0 μm (e.g., at most 0.8 μm) the coating thickness-regulation assembly comprising a rounded tip facing the ITM surface at the lower run.

The systems of the present invention are further detailed herein below.

In another one of its aspects the present invention provides a method of improving at least one mechanical property of a printed ink image (on a substrate) comprising:

a. providing an intermediate transfer member comprising a release layer surface;
b. providing an aqueous formulation according to the invention, wherein said formulation comprises at least one particulate material as disclosed herein;
c. applying the aqueous formulation onto the ITM release layer surface to form thereon a wet (treatment) layer having a thickness of at most about 1.0 μm (e.g., at most 0.8 μm):
d, optionally subjecting the wet (treatment) layer of (c) to a drying process to form a dried (treatment) film layer, from the wet (treatment) layer, on the ITM release layer surface, said dried film layer having a thickness of at least about 20 nm and at most 200 nm;
e. depositing droplets of an aqueous ink onto the optionally dried (treatment) film to form an ink image on the release layer surface of the ITM release layer surface;
f. drying the ink image to leave an ink-image residue on the ITM release layer surface; and
g. transferring the ink-image residue onto a printing substrate by pressured contact between the ITM and the printing substrate;
to thereby produce a printed ink image on a substrate, wherein said printed ink image has at least one mechanical property improved compared to an ink image produced with said aqueous formulation but without said particulate material.

In a further one of its aspects the present invention provides a method of improving at least one mechanical property of a printed ink image (on a substrate) comprising:

a. providing an intermediate transfer member comprising a release layer surface;
b. providing an aqueous formulation comprising:
at least one water soluble polymer;
a carrier liquid containing water; and
optionally, one or more of (i) at least one surfactant; (ii) at least one humectant; and (iii) at least one wetting agent;
   c. adding to the aqueous formulation of (b) one or more of (i) a cationic emulsion of at least one oxidized polyethylene wax particulate material; (ii) a dispersion of at least one coated wax particulate material; and (iii) a dispersion of at least one thermosetting polymeric particulate material;
   d. applying the formulation produced in (c) onto the ITM release layer surface to form thereon a wet (treatment) layer having a thickness of at most about 1.0 μm (e.g., at most 0.8 μm);
   e, optionally subjecting the wet (treatment) layer of (d) to a drying process to form a dried (treatment) film layer, from the wet (treatment) layer, on the ITM release layer surface, said dried film layer having a thickness of at least about 20 nm and at most 200 nm;
   f. depositing droplets of an aqueous ink onto the optionally dried (treatment) film to form an ink image on the release layer surface of the ITM release layer surface:
   g. drying the ink image to leave an ink-image residue on the ITM release layer surface; and
   h. transferring the ink-image residue onto a printing substrate by pressured contact between the ITM and the printing substrate:
   to thereby produce a printed ink image on a substrate, wherein said printed ink image has at least one mechanical property improved compared to an ink image produced without addition of said emulsion or dispersion of (c) to the aqueous formulation of (b).

Yet, in a further one of its aspects the present invention provides a method of improving at least one mechanical property of a printed ink image (on a substrate) comprising:

a. providing an intermediate transfer member comprising a release layer surface;
b. providing an aqueous formulation comprising:
at least one water soluble polymer;
a carrier liquid containing water; and
optionally, one or more of (i) at least one surfactant; (ii) at least one humectant; and (iii) at least one wetting agent;
   c. adding to the aqueous formulation of (b) one or more of (i) a cationic emulsion of at least one oxidized polyethylene wax particulate material; (ii) a dispersion of at least one coated wax particulate material; and (iii) dispersion of at least one thermosetting polymeric particulate material;
   d. applying the formulation produced in (c) onto the ITM release layer surface to form thereon a wet (treatment) layer having a thickness of at most about 1.0 μm (e.g., at most 0.8 μm);
   e, optionally subjecting the wet (treatment) layer of (d) to a drying process to form a dried (treatment) film laver, from the wet (treatment) layer, on the ITM release layer surface, said dried film layer having a thickness of at least about 20 nm and at most 200 nm;
   f. depositing droplets of an aqueous ink onto the optionally dried (treatment) film to form an ink image on the release layer surface of the ITM release layer surface;
   g. drying the ink image to leave an ink-image residue on the ITM release layer surface; and
   h. transferring the ink-image residue onto a printing substrate by pressured contact between the ITM and the printing substrate;
   to thereby produce a printed ink image on a substrate, wherein said printed ink image has at least one mechanical property improved compared to an ink image produced without addition of said emulsion or dispersion of (c) to the aqueous formulation of (b).

In yet a further one of its aspects the present invention provides method of improving at least one mechanical property of a printed ink image (on a substrate) comprising:

a. providing an intermediate transfer member comprising a release layer surface;
b. providing an aqueous formulation comprising:

at least 1.5%, by weight, of at least one water soluble polymer having a solubility in water of at least 5% at 25° C.;

at least 5%, by weight, of a first non-ionic surfactant having a solubility in water of at least 7%, at 25° C.;

a second non-ionic, silicone-containing surfactant having a solubility in water of at least 1%, at 25° C.;

a carrier liquid containing water, said water making up at least about 55%, by weight of the aqueous formulation; and

optionally, one or more of (i) at least one humectant; and (ii) at least one wetting agent.

c. adding to the aqueous formulation of (b) one or more of (i) an emulsion or a dispersion of at least one thermoplastic polymeric particulate material; and (ii) an emulsion or a dispersion of at least one thermosetting polymeric particulate material;
d. applying the formulation produced in (c) onto the ITM release layer surface to form thereon a wet (treatment) layer having a thickness of at most about 1.0 μm (e.g., at most 0.8 μm).
e, optionally subjecting the wet (treatment) layer of (d) to a drying process to form a dried (treatment) film layer, from the wet (treatment) layer, on the ITM release layer surface, said dried film layer having a thickness of at least about 20 nm and at most 200 nm;
f. depositing droplets of an aqueous ink onto the optionally dried (treatment) film to form an ink image on the release layer surface of the ITM release layer surface:
g. drying the ink image to leave an ink-image residue on the ITM release layer surface; and
h. transferring the ink-image residue onto a printing substrate by pressured contact between the ITM and the printing substrate:
to thereby produce a printed ink image on a substrate, wherein said printed ink image has at least one mechanical property improved compared to an ink image produced without addition of said emulsion or dispersion of (c) to the aqueous formulation of (b).

In another one of its aspects the present invention provides a kit for printing with an indirect printing system, the kit comprising:

a. an intermediate transfer member comprising a release layer surface; and
b. a quantity of an aqueous treatment formulation according to the invention.

In yet another one of its aspects the present invention provides a kit for printing with an indirect printing system, the kit comprising:

a. an intermediate transfer member comprising a release layer surface;
b. a quantity of an aqueous formulation comprising:
at least one water soluble polymer;
one or more of (i) a cationic emulsion of at least one oxidized polyethylene wax particulate material; (ii) an emulsion or a dispersion of at least one coated wax particulate material; and (iii) a dispersion of at least one thermosetting polymeric particulate material;
a carrier liquid containing water; and
optionally, one or more of (iv) at least one surfactant; (v) at least one humectant; and (vi) at least one wetting agent.

In a further one of its aspects the present invention provides a kit for printing with an indirect printing system, the kit comprising:

a. an intermediate transfer member comprising a release layer surface;
b. a quantity of an aqueous formulation comprising:
at least one water soluble polymer;
a carrier liquid containing water; and
optionally, one or more of (i) at least one surfactant; (ii) at least one humectant; and (iii) at least one wetting agent; and
   c, one or more of (i) a cationic emulsion of at least one oxidized polyethylene wax particulate material; (ii) a dispersion or an emulsion of at least one coated wax particulate material; and (iii) a dispersion of at least one thermosetting polymeric particulate material.

Yet, in a further one of its aspects the present invention provides a kit for printing with an indirect printing system, the kit comprising:

a. an intermediate transfer member comprising a release layer surface;
b. a quantity of an aqueous formulation comprising:
at least 1.5%, by weight, of at least one water soluble polymer having a solubility in water of at least 5% at 25° C.;
at least 5%, by weight, of a first non-ionic surfactant having a solubility in water of at least 7%, at 25° C.;
a second non-ionic, silicone-containing surfactant having a solubility in water of at least 1%, at 25° C.;
one or more of (i) a dispersion and/or an emulsion of at least one thermoplastic polymeric particulate material; and (ii) a dispersion of at least one thermosetting polymeric particulate material;
a carrier liquid containing water, said water making up at least about 55%, by weight of the aqueous formulation; and

optionally, one or more of (iii) at least one humectant; and (iv) at least one wetting agent.

In a further one of its aspects the present invention provides a kit for printing with an indirect printing system, the kit comprising:

a. an intermediate transfer member comprising a release layer surface:
b. a quantity of an aqueous formulation comprising:
at least 1.5%, by weight, of at least one water soluble polymer having a solubility in water of at least 5% at 25° C.;
at least 5%, by weight, of a first non-ionic surfactant having a solubility in water of at least 7%, at 25° C.;
a second non-ionic, silicone-containing surfactant having a solubility in water of at least 1%, at 25° C.;
a carrier liquid containing water, said water making up at least about 55%, by weight of the aqueous formulation; and
optionally, one or more of (i) at least one humectant; and (ii) at least one wetting agent; and
   c, one or more of (i) a dispersion or an emulsion of at least one thermoplastic polymeric particulate material; and (ii) a dispersion or an emulsion of at least one thermosetting polymeric particulate material.

In another one of its aspects the present invention provides a kit for printing with an indirect printing system, the kit comprising:

a. an intermediate transfer member comprising a release layer surface:
b. a quantity of an aqueous formulation comprising:

at least one water soluble polymer;

one or more of (i) a dispersion and/or an emulsion of at least one thermoplastic polymeric particulate material; and (ii) a dispersion and/or an emulsion of at least one thermosetting polymeric particulate material:

a carrier liquid containing water; and

optionally, one or more of (iii) at least one surfactant; (iv) at least one humectant; and (v) at least one wetting agent.

Yet, in a further one of its aspects the present invention provides a kit for printing with an indirect printing system, the kit comprising:

a. an intermediate transfer member comprising a release layer surface;
b. a quantity of an aqueous formulation comprising:
at least one water soluble polymer;
a carrier liquid containing water; and
optionally, one or more of (i) at least one surfactant; (ii) at least one humectant; and (iii) at least one wetting agent; and
   c. a quantity of one or more of (i) a dispersion and/or an emulsion of at least one thermoplastic polymeric particulate material; and (ii) a dispersion and/or an emulsion of at least one thermosetting polymeric particulate material.

In a further one of its aspects the present invention provides a printed pattern on a substrate comprising:

(i) a substrate (e.g., uncoated fibrous printing substrate, a commodity coated fibrous printing substrate, and a plastic printing substrate);

(ii) one or more ink dots, which may be continuous thereby forming an ink film on said substrate or which may be spaced apart from each other;

wherein said one or more ink dots being fixedly adhered to at least a region of a surface of said substrate;

wherein said pattern being formed within boundaries defined in said substrate, such that the one or more ink dots and regions surrounding or separating said continuous or spaced apart dots are covered with a substantially dry film layer optionally having a thickness of at least about 20 nm and at most about 200 nm (e.g. at most 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, and optionally at least 20 nm or at least 30 nm), and wherein said substantially dry film layer comprises one or more of (i) at least one thermoplastic polymeric particulate material e.g., as disclosed herein; and (ii) at least one thermosetting polymeric particulate material e.g., as disclosed herein.

The dry film layer of said printed pattern is formed utilizing the formulations according to some embodiments of the present invention.

In some embodiments according to the present invention the substantially dry film layer may further comprise at least one water soluble polymer (optionally being at least one modified polysaccharide as disclosed herein).

In a further one of its aspects the present invention provides a printed article comprising:

(i) a substrate:

(ii) one or more ink dots fixedly adhered to at least a region of a surface of said substrate:

wherein said one or more ink dots and said at least a region of said surface of said substrate are covered with a substantially dry film layer having a thickness of at least about 20 nm and at most about 200 nm and wherein said substantially dry film layer comprises one or more of (i) at least one thermoplastic polymeric particulate material e.g., as disclosed herein; and (ii) at least one thermosetting polymeric particulate material e.g., as disclosed herein.

In some embodiments according to the present invention the substrate is selected from the group consisting of an uncoated fibrous printing substrate, a commodity coated fibrous printing substrate, plastic, polyethylene terephthalate (PET), polyethylene (PE), biaxially oriented polypropylene (BOPP), aluminum and any combinations thereof.

The dry film layer of said printed article is formed utilizing the formulations according to some embodiments of the present invention.

In some embodiments according to the present invention non-printed areas in the printed pattern/article are covered with the dry treatment formulations according to the invention. These areas illustrate beneficial mechanical characteristics such as rub and/or scratch resistance. These areas are further characterizes by the coefficient of friction values as herein disclosed and exemplified.

In some embodiments according to the present invention, in the printed pattern/article, the average thickness of the ink dot is within a range of 100-1,200 nm. 200-1,200 nm, 200-1,000 nm, 100-800 nm, 100-600 nm, 100-500 nm, 100-450 nm, 100-400 nm, 100-350 nm, 100-300 nm, 200-450 nm, 200-400 nm, or 200-350 nm. At times it is at least 150 nm, at least 200 nm, at least 250 nm, at least 300 nm, or at least 350 nm. At times it is within a range of 100-800 nm, 100-600 nm. 100-500 nm, 100-450 nm, 100-400 nm, 100-350 nm, 100-300 nm, 200-450 nm, 200-400 nm, or 200-350 nm. At times it has an average thickness or height of at most 5,000 nm, at most 4,000 nm, at most 3,500 nm, at most 3,000 nm, at most 2,500 nm, or at most 2.000 nm. At times it has an average thickness or height of at most 1,800 nm, at most 1,500 nm, at most 1,200 nm, at most 1,000 nm, at most 800 nm, at most 650 nm, at most 500 nm, at most 450 nm, or at most 400 nm.

In some embodiments of according to the present invention e.g., in the printed article and/or printed pattern, the thickness of the dry treatment layer (e.g., covering/being in direct contact with a printed ink dot and/or covering/being in direct contact with the printed substrate in ink free areas on the substrate) is substantially the same as the thickness of the ink dot. At times said dry treatment layer is less thick than the thickness of the ink dot.

In some embodiments according to the present invention the substrate is selected from the group consisting of an uncoated fibrous printing substrate, a commodity coated fibrous printing substrate, and a plastic printing substrate.

In some embodiments according to the present invention the substrate is a paper, optionally selected from the group of papers consisting of bond paper, uncoated offset paper, coated offset paper, copy paper, ground wood paper, coated ground wood paper, freesheet paper, coated freesheet paper, and laser paper.

In some embodiments in the article according to the present invention the particulate material have a particle size (e.g., diameter or longest axis) of between about 1 nm to about 500 nm.

In some embodiments in the article according to the present invention the particulate material have substantially two dimensional disc-like shape (i.e., with a diameter constituting the longest access of the particulate material).

In some embodiments in the article according to the present invention the diameter or longest axis of said particulate material is substantially parallel to said surface of the substrate.

In some embodiments in the article according to the present invention the thickness of the dry film layer is at most 200 nm, at most 120 nm, at most 100 nm, at most 80 nm, at most 70 nm, at most 60 nm, at most 50 nm, at most 45 nm, or at most 40 nm.

In some embodiments in the article according to the present invention the thickness of said dry film layer at least 15 nm or at least 20 nm or at least 25 nm or at least 30 nm.

In some embodiments in the article according to the present invention the thickness of said dry film is at most about 50 nm.

In some embodiments in the article according to the present invention the thickness of said dry film is at most about 100 nm.

In some embodiments in the article according to the present invention the thickness of said dry film is at most about 120 nm.

In some embodiments in the article according to the present invention the thickness of said dry film is at most about 150 nm.

In some embodiments in the article according to the present invention the dry film is continuous over an entirety of the surface of the substrate (e.g., covering region with or without ink dots).

In some embodiments in the article according to the present invention the dry film layer covers at least 50% or at least 75% or at least 90% or at least 95% at least 95% or at least 99% or 100% of said surface.

In some embodiments in the article according to the present invention the film layer may further comprise one or more of (i) at least one water soluble polymer; (ii) at least one surfactant; (iii) at least one humectant; (iv) at least one wetting agent; and (v) at least one antibacterial agent.

In some embodiments in the article according to the present invention the substantially dry film layer may further comprise at least one water soluble polymer (optionally being at least one modified polysaccharide as disclosed herein).

In some embodiments the article according to the present invention has improved one or more mechanical property in comparison with a printed article lacking the particulate material.

In some embodiments the improved mechanical property is manifested in ink containing regions on said substrate.

In some embodiments the improved mechanical property is manifested in regions of the surface of the substrate which are coated with said substantially dry film layer and are free of ink (ink free).

In some embodiments the mechanical property is selected from one or more of rub resistance, coefficient of friction, scratch resistance and surface tackiness.

In some embodiments according to the present invention the particulate material is embedded in said dry film layer with substantially no protrusion thereof from the surface of said layer, said surface being the surface distal to the surface of the substrate (i.e., the surface that is not in contact with the substrate and/or the ink dots).

In some embodiments the one or more ink dots form a continues ink film on the substrate.

In another one of its aspects the present invention provides a printed article/pattern produced according to the method of the invention.

In a further one of its aspects the present invention provides an intermediate transfer member (e.g., as herein disclosed and exemplified) comprising a release layer surface, wherein the surface is substantially covered with a substantially dry (treatment) continuous film layer (e.g., as herein disclosed and exemplified).

In some embodiments according to the present invention the substantially dry (treatment) continuous film layer has a thickness of at least about 20 nm and at most about 200 nm.

In some embodiments according to the present invention the thickness of the substantially dry (treatment) continuous film layer is at most 200 nm, at most 120 nm, at most 100 nm, at most 80 nm, at most 70 nm, at most 60 nm, at most 50 nm, at most 45 nm, or at most 40 nm.

In some embodiments according to the present invention the thickness of the substantially dry (treatment) continuous film layer is at least 15 nm or at least 20 nm or at least 25 nm or at least 30 nm.

In some embodiments according to the present invention the substantially dry (treatment) film layer comprises one or more of (i) at least one thermoplastic polymeric particulate material e.g., as disclosed herein; and (ii) at least one thermosetting polymeric particulate material e.g., as disclosed herein.

In some embodiments according to the present invention the substantially dry (treatment) film layer covers at least 50% or at least 75% or at least 90% or at least 95% at least 95% or at least 99% or 100% of the ITM's release layer surface.

In some embodiments according to the present invention the substantially dry (treatment) film layer may further comprise one or more of (i) at least one water soluble polymer; (ii) at least one surfactant; (iii) at least one humectant; (iv) at least one wetting agent; and (v) at least one antibacterial agent.

In some embodiments according to the present invention the substantially dry film layer may further comprise at least one water soluble polymer (optionally being at least one modified polysaccharide as disclosed herein).

In some embodiments according to the present invention the particulate material is embedded in the substantially dry (treatment) film layer with substantially no protrusion thereof from the surface of said layer.

In some embodiments according to the present invention the substantially dry (treatment) film layer is continuous over an entirety of a rectangle of the release surface of the ITM, wherein said rectangle has a width of at least 10 cm and a length of at least 10 meters.

In some embodiments according to the present invention the substantially dry (treatment) film layer for at least 50% or at least 75% or at least 90% or at least 95% at least 95% or at least 99% or 100% of an area of the rectangle, a thickness of the substantially dry (treatment) film layer does not deviate from an average thickness value within the rectangle by more than 50% or more than 40% or more than 30%.

In some embodiments according to the present invention the ITM is an hydrophobic ITM.

In some embodiments according to the present invention the release layer surface is a silicone-based release layer surface that is sufficiently hydrophilic to satisfy at least one of the following properties:

(i) a receding contact angle of a drop of distilled water deposited on the silicone-based release layer surface is at most 60°; and

(ii) a 10-second dynamic contact angle (DCA) of a drop of distilled water deposited on the silicone-based release layer surface is at most 108°.

Provided herein below are some non-limiting embodiments of the system according to the present invention.

As used herein the term “receding contact angle” or “RCA”, refers to a receding contact angle as measured using a Dataphysics OCA15 Pro Contact Angle measuring device, or a comparable Video-Based Optical Contact Angle Measuring System, using the Drop Shape Method. The analogous “advancing contact angle”, or “ACA”, refers to an advancing contact angle measured substantially in the same fashion.

As used herein the term “bulk hydrophobicty” is characterized by a receding contact angle of a droplet of distilled water disposed on an inner surface of the release layer, the inner surface formed by exposing an area of the cured silicone material within the release layer.

As used herein the term “image transfer member” or “intermediate transfer member” or “transfer member” refers to the component of a printing system upon which the ink is initially applied by the printing heads, for instance by inkjet heads, and from which the jetted image is subsequently transferred to another substrate or substrates, typically, the final printing substrates.

As used herein the term “blanket” refers to a flexible transfer member that can be mounted within a printing device to form a belt-like structure on two or more rollers, at least one of which is able to rotate and move the blanket (e.g. by moving the belt thereof) to travel around the rollers.

As used herein, the terms “blanket”, “intermediate transfer member”, ITM are used interchangeably and refer to a flexible member comprising a stack of layers used as an intermediate member configured to receive a wet aqueous treatment formulation which receives an ink image and to transfer the dried ink image film to a target substrate. as described herein.

As used herein, when a portion of an ITM is in motion at a speed of v meters/second, this means that the portion of the blanket ITM moves in a direction parallel to its local surface/plane at a speed of at least v meters/second—e.g. relative to an applicator which is stationary.

As used herein the term ‘Static surface tension’ refers to the static surface tension at 25° C. and atmospheric pressure.

In some embodiments, the term ‘thickness’ of a wet layer is defined as follows.

When a volume of material vol covers a surface area of a surface having an area SA with a wet layer—the thickness of the wet layer is assumed to be vol/SA.

In some embodiments, the term ‘thickness’ of a dry film is defined as follows. When a volume of material vol that is x % liquid, by weight, wets or covers a surface area SA of a surface, and all the liquid is evaporated away to convert the wet layer into a dry film, a thickness of the dry film is assumed to be:

vol/ρ_{wet layer}(100−x)/(SA·ρ_{dry layer})

where ρ_{wet layer} is the specific gravity of the wet layer and ρ_{dry layer} is the specific gravity of the dry layer.

As used herein the term ‘continuous wet layer’ or any lingual variations thereof refers to a continuous wet layer that covers a convex region without any bare sub-regions within a perimeter of the convex region.

As used herein the term ‘continuous thin dried film’ or any lingual variations thereof refers to a continuous dried film that covers a convex region without any discontinuities within a perimeter of the convex region.

As used herein the term ‘cohesive film/tensile strength’ refers to a construct which stays together when peeled away from a surface to which it is adhered—i.e. when peeled away from the surface, the ‘cohesive film’ retains it structural integrity and is peeled as a skin, rather than breaking into little pieces.

In some embodiments the hygroscopic material may be a liquid hygroscopic material. As used herein, the term “liquid hygroscopic agent/material” refers to a hygroscopic agent/material that is liquid at least one temperature within the range of 25° C.-90° C., and has, in a pure state and at 90° C., a vapor pressure of at most 0.05 ata, and more typically, at most 0.02 ata, at most 0.01 ata, or at most 0.003 ata. The term “liquid hygroscopic agent/material” is specifically meant to refer to materials like glycerol.

As used herein the terms “hydrophobicity” and “hydrophilicity” and the like, may be used in a relative sense, and not necessarily in an absolute sense.

As used herein the term ‘(treatment) formulation’ is meant that the formulation is for use with an intermediate transfer member of a printing system i.e., for use in treating a release surface of an ITM with said formulation e.g., as herein described and exemplified.

Unless stated otherwise, physical properties of a liquid (e.g. treatment formulation) such as viscosity and surface tension, refer to the properties at 25° C.

Unless stated otherwise, a ‘concentration’ refers to a w/w—i.e. a weight of a component of formulation per total weight of that formulation.

As used herein, unless stated otherwise, a ‘total percent solids’ of an aqueous composition is calculated by multiplying 100 times the weight of residue, after complete drying at 25° C., divided by the weight of initial aqueous composition.

As used herein, dot gain refers to the increase in dot size over the initial, spherical drop diameter. The dot gain is determined by the ratio of the final dot diameter to the initial drop diameter. It is highly desirable to find a way to increase dot size without having to increase drop volume.

In some embodiments according to the present invention the dot gain may be of at least 1.3, 1.4, or 1.5, and more typically, at least 1.6, 1.7, or at least 1.8, or within a range of 1.5 to 2.1, 1.5 to 2.1, 1.6 to 2.0, or 1.7 to 2.0. At times, using drops having a volume of 6.3 picoliters (D=22.9 micrometers), and using various aqueous treatment formulations of the present invention, the dried ink dots obtained were within a diameter range of 40 to 45 micrometers.

Unless otherwise defined, all technical and scientific terms used herein have the same meaning as commonly understood by one of ordinary skill in the art to which the invention pertains. In case of conflict, the specification, including definitions, will take precedence.

In the description and claims of the present disclosure, each of the verbs, “comprise” “include” and “have”, and conjugates thereof, are used to indicate that the object or objects of the verb are not necessarily a complete listing of members, components, elements, steps or parts of the subject or subjects of the verb. These terms encompass the terms “consisting of” and “consisting essentially of”.

As used herein, the singular form “a”, “an” and “the” include plural references and mean “at least one” or “one or more” unless the context clearly dictates otherwise.

Unless otherwise stated, the use of the expression “and/or” between the last two members of a list of options for selection indicates that a selection of one or more of the listed options is appropriate and may be made.

The term “ratio”, as used herein in the specification and in the claims section that follows, refers to a weight ratio, unless specifically indicated otherwise.

In the disclosure, unless otherwise stated, adjectives such as “substantially” and “about” that modify a condition or relationship characteristic of a feature or features of an embodiment of the present technology, are to be understood to mean that the condition or characteristic is defined to within tolerances that are acceptable for operation of the embodiment for an application for which it is intended. At times, the term “about” indicates ±10% of the value it refers to.

While this disclosure has been described in terms of certain embodiments and generally associated methods, alterations and permutations of the embodiments and methods will be apparent to those skilled in the art. Further, the various embodiments detailed herein in connection with specific aspects may be applicable to all and/or other aspects of the invention.

### DETAILED DESCRIPTION OF EMBODIMENTS

The following examples are not in any way intended to limit the scope of the invention as claimed.

### EXAMPLES

Reference is now made to the following examples, which together with the above descriptions, illustrate the invention in a non-limiting fashion.

A. Exemplary Itm (Banket) Release Layer

List of Materials Used:

| | | CAS | |
|---|---|---|---|
| Ingredient | Supplier | Number | Description |
| DMS-V35 Resin | Gelest | 68083-19-2 | Vinyl terminated polydimethyl |
| | | | siloxane |
| | | | Viscosity 5,000 mPa · s |
| | | | MW ~49.500 |
| | | | Vinyl ~0.018-0.05 mmol/g |
| VQM-146 Resin | Gelest | 68584-83-8 | 20-25% Vinyl resin in DMS V46 |
| | | | Viscosity 50,000-60,000 mPa · s |
| | | | Vinyl ~0.18-0.23 mmol/g |
| Inhibitor 600 | Evonik | 204-070-5 | Mix of |
| Cure Retardant | | | divinylpolydimethylsiloxane and |
| | | | 2-methylbut-3-yn-2-ol |
| | | | Viscosity 900 mPa · s |
| | | | Vinyl 0.11 mmol/g |
| SIP6831.2 Catalyst | Gelest | 68478-92-2 | Platinum |
| | | | divinyltetramethyldisiloxane |
| | | | Platinum 2.1-2.4% |
| Polymer RV 5000 | Evonik | | Vinyl-functional polydimethyl |
| (XPRV 5000) | | | siloxanes |
| Resin | | | Viscosity 3000 mPa · s |
| | | | Vinyl 0.4 mmol/g |
| Crosslinker 100 | Evonik | | Polydimethyl siloxanes including |
| Crosslinker | | | SiH groups in the polymer chain |
| | | | Hydride 7.8 mmol/g |
| HMS-301 | Gelest | 68037-59-2 | Poly(dimethylsiloxane-co- |
| Crosslinker | | | methyl-hydrosiloxane), |
| | | | trimethylsilyl terminated |
| | | | Hydride 4.2 mmol/g |
| Silsurf A010-D-UP | Siltech | 134180-76-0 | polyether siloxane copolymer |
| Additive | | | |
| SilGrip SR 545 | Momentive | 56275-01-5 | Silicone-based resin containing |
| Functional MQ resin | | | “MQ” groups |
| | | | Viscosity 11 mPa · s |
| Aluminized PET | Hanita | NR | Aluminized polyester film |
| | Ltd. | | |
| Skyroll SH 92 | SKC Inc. | NR | Anti-static polyester film |
| Skyroll SH 76 | SKC Inc. | NR | Untreated polyester film |

The carriers used as substrates in the production of the release layer surface include an anti-static polyester film (Examples 1-7).

### Example 1

The ITM release layer of Example 1 had the following composition (wt./wt.):

| Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker HMS-301 | 12 |

The release layer was prepared substantially as described in the present blanket preparation procedure, provided below.

Blanket Preparation Procedure (for Release Layers Cured Against a Carrier Surface)

All components of the release layer formulation were thoroughly mixed together. The desired thickness of the incipient release layer was coated on a PET sheet, using a rod/knife (other coating methods may also be used), followed by curing for 3 minutes at 150° C. Subsequently. Siloprene LSR 2530 was coated on top of the release layer, using a knife, to achieve a desired thickness. Curing was then performed at 150° C. for 3 minutes. An additional layer of Siloprene LSR 2530 was then coated on top of the previous (cured) silicone layer, and fiberglass fabric was incorporated into this wet, fresh layer such that wet silicone penetrated into the fabric structure. Curing was then performed at 150° C. for 3 minutes. A final layer of Siloprene LSR 2530 was then coated onto the fiberglass fabric and, once again, curing was performed at 150° C. for 3 minutes. The integral blanket structure was then cooled to room temperature and the PET was removed.

### Example 2

The ITM release layer of Example 2 has the following composition:

| Component Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker HMS-301 | 12 |
| Silsurf A010-D-UP | 5 |

The blanket was prepared substantially as described in Example 1.

### Example 3

The ITM release layer of Example 3 has the following composition:

| Component Name | Parts |
|---|---|
| DMS-V35 | 70 |
| XPRV-5000 | 30 |
| VQM-146 | 40 |
| Inhibitor 600 | 5 |
| SIP6831.2 | 0.1 |
| Crosslinker 100 | 6.5 |
| Silsurf A010-D-UP | 5 |

The blanket was prepared substantially as described in Example 1.

### Example 4

The ITM release layer of Example 4 has the following composition:

| Component Name | Parts |
|---|---|
| DMS-V35 | 100 |
| VQM-146 | 40 |
| Inhibitor 600 | 3 |
| SIP6831.2 | 0.1 |
| Crosslinker HMS-301 | 5 |

The blanket was prepared substantially as described in Example 1.

### Example 5

The ITM release layer of Example 5 was prepared from Silopren® LSR 2530 (Momentive Performance Materials Inc., Waterford, N.Y.), a two-component liquid silicone rubber, in which the two components are mixed at a 1:1 ratio. The blanket was prepared substantially as described in Example 1.

### Example 6

The ITM release layer of Example 6 has a composition that is substantially identical to that of Example 4, but includes SR545 (Momentive Performance Materials Inc., Waterford, N.Y.), a commercially available silicone-based resin containing polar groups. The polar groups are of the “MQ” type, where “M” represents Me₃SiO and “Q” represents SiO₄. The full composition is provided below:

| Component Name | Parts |
|---|---|
| DMS-V35 | 100 |
| VQM-146 | 40 |
| SR545 | 5 |
| Inhibitor 600 | 3 |
| SIP6831.2 | 0.1 |
| Crosslinker HMS-301 | 5 |

The blanket was prepared substantially as described in Example 1.

### Example 7

The ITM release layer of Example 7 has a composition that is substantially identical to that of Example 6, but includes polymer RV 5000, which includes vinyl-functional polydimethyl siloxanes having a high density of vinyl groups, as described hereinabove. The full composition is provided below:

| Component Name | Parts |
|---|---|
| DMS-V35 | 70 |
| RV 5000 | 30 |
| VQM-146 | 40 |
| Inhibitor 600 | 5 |
| SIP6831.2 | 0.1 |
| Crosslinker HMS-301 | 12 |
| SR545 | 5 |

The blanket was prepared substantially as described in Example 1.

B. Aqueous Treatment Formulation

List of Materials Used for Treatments Below:

| | | | | Chemical |
|---|---|---|---|---|
| | | | | Name/ |
| Ingredient | Supplier | Function | Class | Description |
| Methocel ® K-3 | DOW | Binder | Hydroxymethyl | hydroxypropyl |
| Premium LV | | | propylcellulose | substituted |
| | | | | methyl |
| | | | | cellulose, 19- |
| | | | | 24% methoxyl |
| | | | | substitution, 7-12% |
| | | | | hydroxypropyl |
| | | | | substitution, |
| | | | | 2.4-3.6 cps |
| | | | | viscosity |
| Byk ® Ipx 23289 | BYK ® | Surface energy | Silicone surfactant | Polyether- |
| | | modifier | | modified |
| | | | | polydimethylsil |
| | | | | oxane |
| Loxanol ® PL | BASF | | polyethylenimine | Polypropylene |
| 5060 | Australia | | | glycol alkyl |
| | Ltd. | | | phenyl ether |
| | | | | (CAS Number: |
| | | | | 9064-13-5) |
| sugar | | | Water absorbing | |
| | | | agent | |
| Tego ®280 | Evonik | Substrate | Silicone surfactant | Polyether siloxane |
| | | wetting and anti- | | polymer |
| | | cratering | | |
| | | additive | | |
| Tween ® 20 | Sigma- | Plasticizing | non-ionic | PEG-20 sorbitan |
| | Aldrich | agent | surfactant | monolaurate |
| Mergal ® K12N | Troy | antimicrobial | | 2-bromo-2-nitro- |
| | International | | | 1,3-propanediol |
| water | | | | DI water |
| PVA6-88 | PVA | | | Polyvinyl alcohol |

### Examples 8A-8B—Comparative Examples—Formulations Comprising PVA

The following aqueous treatment formulations were prepared by first preparing a stock solution of PVA 15% and Loxanol P 25%. Next, the other ingredients were mixed for a final formulation with weight % as detailed. Water was added to reach the desired solids content and the mixture was stirred at room temperature for several minutes.

Formulation 8A is a “PVA formulation”, while formulation 8B is a “high concentration PVA” formulation.

| Formulation 8A | Formulation 8B | |
|---|---|---|
| Formulation | Formulation | |
| Concentration in | Concentration in | |
| % wt/wt in final | % wt/wt in final | |
| formulation | formulation | Component Name |
| 4 | 5 | PVA6-88 |
| 0.25 | 0.25 | Loxanol P |
| 6.50 | 6.50 | sugar |
| 6.00 | 6.00 | Tween ®20 |
| 0.20 | 0.20 | Mergal ® K12N |
| Balance | | water |

Formulations 8A and 8B were then applied to an indirect printing apparatus described herein, specifically on the surface of the ITM. The formulation was applied at a thickness of at least 150 μm (e.g. 150-200 μm for example at least 200 μm). The remaining standard indirect printing process steps were then applied including ink jetting of ink image and drying the formulation and ink image to provide a film. However, transfer to plastic using the treatment formulation described in 8A resulted in splitting of the dried treatment formulation during transfer. It is noted that similar formulation using Methocel instead of PVA did not exhibit such splitting.

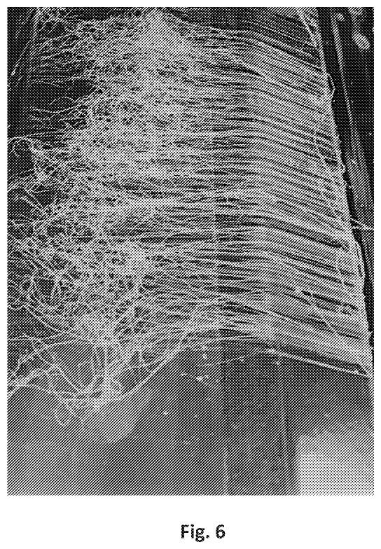

In attempt to resolve this problem, many formulations were formulated and evaluated. Formulation 8B is one example where a higher concentration of PVA was employed. Although formulation 8B consistently provided no splitting while not affecting print quality, it presented a new problem at the extremes of the treatment layer, wherein there was failure to disengage at the extremes, as can be seen in FIG. 6. It is noted that no such failure was observed with similar formulation using Methocel instead of PVA.

Transferring a relatively dry, high quality printing image onto some substrates such as plastics, without loss of mechanical integrity or splitting of the dried treatment film during transfer can be challenging, as has been described in greater detail in Example 8A. The splitting of the dried film also causes presence of remnants which can accumulate on the blanket surface. When the concentration of the polyvinyl alcohol in the formulation was increased, or when the thickness of the polyvinyl alcohol-based film was increased, the separation from the ITM surface did not leave a clean cut at the substrate end and the dried aqueous treatment layer was unable to cleanly disengage at the substrate edge, as is described in Example 8B.

In particular, and as will be discussed below, some embodiments of the invention relate to compositions, methods and apparatus useful for producing a wet treatment layer of uniform thickness over large areas of the ITM and/or at high print speeds which can subsequently be heated to form a dry transfer composition of particular relevance for receiving ink formulations and eventually transfer to a variety of substrate media, and which are particularly useful in the context of plastic media.

Transferring a relatively dry, high quality printing image onto some substrates such as plastics, without loss of mechanical integrity or splitting of the dried treatment film during transfer can be challenging, as has been described in greater detail in Example 8A. The splitting of the dried film also causes presence of remnants which can accumulate on the blanket surface. When the concentration of the polyvinyl alcohol in the formulation was increased, or when the thickness of the polyvinyl alcohol-based film was increased, the separation from the ITM surface did not leave a clean cut at the substrate end and the dried aqueous treatment layer was unable to cleanly disengage at the substrate edge, as is described in Example 8B.

By contrast, the formulations and methods of the present invention may be applied to produce an ink image characterized by any combination of the following features: uniform and controlled dot gain, good and uniform print gloss, and good image quality due to high quality dots having consistent dot convexity and/or well-defined boundaries.

### Example 9—Formulations Comprising Methocel

The aqueous treatment formulation was prepared by first preparing a solution of Methocel®, K3 LV dissolved in water to a concentration of 10% by weight. Next, the other ingredients were mixed for a final formulation with weight % as detailed in the table below. Water was added to reach the desired solids content and the mixture was stirred at room temperature for several minutes.

| | Formulation Concentration in | |
|---|---|---|
| Formulation 9 | % wt/wt in final formulation | Components |
| | 3.38 | Methocel ® K-3 LV |
| | 1.35 | Byk Ipx ® 23289 |
| | 0.23 | Loxanol ® P |
| | 5.85 | sugar |
| | 0.99 | Tego ® 280 |
| | 10.80 | Tween ®20 |
| | 0.20 | Mergal ® K12N |
| | Balance | water |
| Total % solids: | 22.80 | |

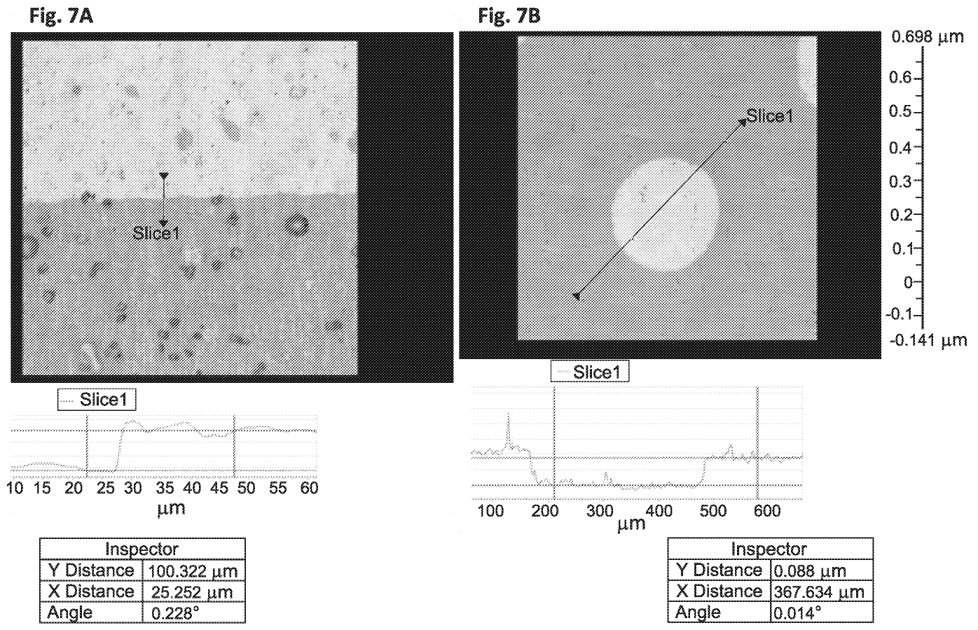

The treatment formulation was applied to a silicone based surface and then dried. A wide stand microscope was then used to magnify and photograph. In FIG. 7A, the dried sample of Formulation 8A provided a more variable consistency, both in the number of holes seen in the field and in the varying thickness of the layer. In FIG. 7B, where Formulation 9 was employed, there is a more homogenous layer as can be seen by the reduced interruptions in layer continuity and by the improved homogeneity in thickness.

The treatment formulation was also tested in the indirect printing for ink image quality and printing on plastics. Identical methods were employed with the exception of the treatment formulation, and the resulting ink images are presented in FIGS. 8A and 9A, in which Formulation 8A was employed, and in FIGS. 8B and 9B, in which Formulation 9 was employed. It is noted that FIGS. 8A and 9A have a reduced print quality in the form of deleted areas compared with FIGS. 8B and 9B.

### Examples 10-12—Formulations Comprising Methocel

The aqueous treatment formulations were prepared by first preparing a solution of Methocel® K3 LV dissolved in water to a concentration of 10% by weight. Next, the other ingredients were mixed for a final formulation with weight % as in the table below. Water was added to reach the desired solids content and the mixture was stirred at room temperature for several minutes.

| Example 10 | | Example 11 | | Example 12 | |
|---|---|---|---|---|---|
| % wt/wt | Components | % wt/wt | Components | % wt/wt | Components |
| 3.38 | Methocel ® | 3.38 | Methocel ® K-3 LV | 3.38 | Methocel ® |
| | K-3 LV | | | | K-3 LV |
| 1.35 | Byk Ipx ® | 0.00 | Byk Ipx ® 23289 | 1.35 | Byk Ipx ® |
| | 23289 | | | | 23289 |
| 0.23 | Loxanol ® P | 0.23 | Loxanol ® P | 0.00 | Loxanol ® P |
| 0.00 | sugar | 5.85 | Sugar | 5.85 | sugar |
| 0.99 | Tego ® 280 | 0.00 | Tego ® 280 | 0.99 | Tego ® 280 |
| 3.00 | Tween ®20 | 0.00 | Tween ®20 | 10.80 | Tween ®20 |
| 0.20 | Mergal ® | 0.20 | Mergal ® K12N | 0.20 | Mergal ® |
| | K12N | | | | K12N |
| balance | water | balance | Water | balance | water |

| | | |
|---|---|---|
| Total % Solids: 9.15% | Total % Solids: 9.66% | Total % Solids: 22.57% |

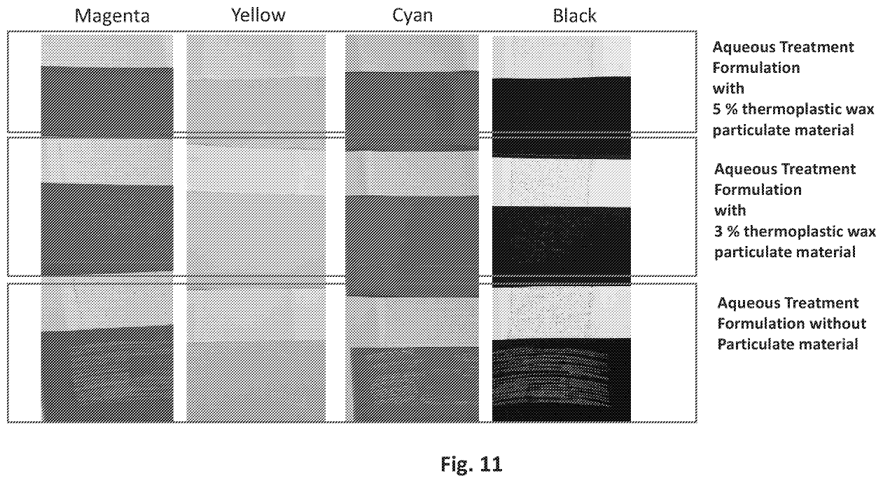

Each of Formulations 10-12 were next applied to the indirect printing apparatus described herein. Printing on plastic resulted in high print quality images without splitting during transfer. A photo of a resulting image using the treatment formulation in Example 11 is presented in FIG. 10. It is noted that although no surfactant was used, the photo has high quality with reduced blemishes.

C. Exemplary Ink Composition

Preparation of Pigments

Pigments used in the examples described below are generally supplied with initial particle size of a few micrometers. Such pigments were ground to submicron range in presence of the dispersing agent, the two materials being fed to the milling device (bead mill) as an aqueous mixture. The progress of milling was controlled on the basis of particle size measurements (for example, a Malvern or Nanosizer instrument). The milling was stopped when the average particle size (dv50) reached 70 to 100 nm.

In the present example, the preparation of an ink composition is described: Heliogen® Blue D7079 was milled with Disperbyk® 190. as described, and the materials were mixed in the following proportion:

| | | |
|---|---|---|
| Heliogen ® Blue D7079 | 30 | g |
| Disperbyk ® 190 (40%) | 30 | g |
| Water | 140 | g |
| Total | 200 | g |

The milled concentrate, now having a Dv50 of less than 100 nm, typically between 70 and 100 nm, and was further diluted with 50 g water and extracted from the milling device at ca. 12 wt. % pigment concentration. The millbase concentrate was further processed as below described for the preparation of an ink composition.

In a first stage. 2.4 g of sodium dodecanoate were added to 200 g of the millbase concentrate to yield a millbase. The mixture was stirred to homogeneity (5′ magnetic stirrer at 50 rpm) and incubated at 60° C. for 1 day. The mixture was then left to cool down to ambient temperature.

In a second stage, ink ingredients were added to the millbase as follows:

| | | |
|---|---|---|
| Millbase Concentrate (from stage 1) | 202.4 | g |
| Joncryl ® 538 (46.5%) | 154.8 | g |
| BYK ® 349 | 5 | g |
| BYK ® 333 | 2 | g |
| Propylene Glycol | 240 | g |
| Water | 595.8 | g |
| Total | 1200 | g |

The mixture was stirred for 30 minutes at ambient temperature, resulting in an ink-jettable ink composition having a viscosity of less than 10 cP.

D. Treatment Formulations with Particulate Materials

### Example 13

### Preparation of Basic Aqueous Treatment Formulations

Exemplary basic compositions of the aqueous treatment formulation used in conjunction with the present invention and referred to herein as V1, V2 and V3 are provided in Table 1. Table 2 and Table 3 respectively.

These basic compositions were used as reference compositions i.e., treatment compositions lacking the particulate material according to the invention.

Basic composition V1 was prepared by mixing the ingredients listed herein below in Table 1:

TABLE 1
Basic Treatment Composition V1

| Ingredient | Concentration (% w/w) | Role of ingredient |
|---|---|---|
| PVA 6-88 | 3.75% | Binder |
| | | (water soluble polymer) |
| BYK LPX 23289 | 1.50% | Surfactant |
| Loxanol P | 0.25% | Wetting agent |
| Sugar | 6.50% | Humectant |
| Tego 280 | 1.10% | Surfactant |
| Tween20 | 12.00% | Surfactant |
| K12N | 0.20% | Antibacterial agent |
| Water | 74.7% | |

Basic composition V2 was prepared by mixing the ingredients listed herein below in Table 2:

TABLE 2
Basic Treatment Composition V2

| Ingredient | Concentration (% w/w) | Role of ingredient |
|---|---|---|
| Metochel K-3 | 3.38% | Binder |
| | | (water soluble polymer) |
| BYK LPX 23289 | 1.35% | Surfactant |
| Loxanol P | 0.23% | Wetting agent |
| Sugar | 5.85% | Humectant |
| Tego 280 | 0.99% | Surfactant |
| Tween20 | 10.80% | Surfactant |
| K12N | 0.20% | Antibacterial agent |
| Water | 77.2% | |

Basic composition V3 was prepared by mixing the ingredients listed herein below in Table 3:

TABLE 3
Basic Treatment Composition V3

| Ingredient | Concentration (% w/w) | Role of ingredient |
|---|---|---|
| Metochel K-3 | 3.38% | Binder |
| | | (water soluble polymer) |
| BYK LPX 23289 | 1.35% | Surfactant |
| Loxanol P | 0.23% | Wetting agent |
| Sugar | 5.85% | Humectant |
| lego 280 | 0.99% | Surfactant |
| Tween20 | 14.80% | Surfactant |
| K12N | 0.20% | Antibacterial agent |
| Water | 73.2% | |

It is noted that the ingredients of the basic treatment compositions according to the invention can be mixed in any suitable manner to form a composition that can be coated onto the intermediate transfer member. The ingredients can be mixed in any suitable amounts. At times the mixed ingredients form a dispersion. To this end, the system of the invention is configures to provide mixing means to provide a homogenous dispersion of the basic treatment compositions. The same applies to the aqueous treatment compositions of the invention (with the particulate material).

Aqueous Treatment Formulations with Particulate Materials Additives

Various particulate materials were added to the basic treatment compositions detailed in Tables 1 to 3 above.

Tables 4-6 below represent the various compositions which were tested with the treatment basic formulation V1. Table 4 further represents various compositions which were tested with the treatment basic formulation V2 (as noted on the left column of Table 4). Tables 7-8 below represent the various compositions which were tested with the treatment basic formulation V2 and V3 (as noted on left column of Table 7-8). The tables detail the printed color tested, the additive with the particulate material, the concentration thereof e.g., the emulsion or dispersion concentration, the observed thickness of the dry treatment film, the detected rub resistance of the image formed, the substrate type used and the measured Coefficient of Friction of the image. In some instances in Table 4 the ink coverage percentage (% coverage) is also provided.

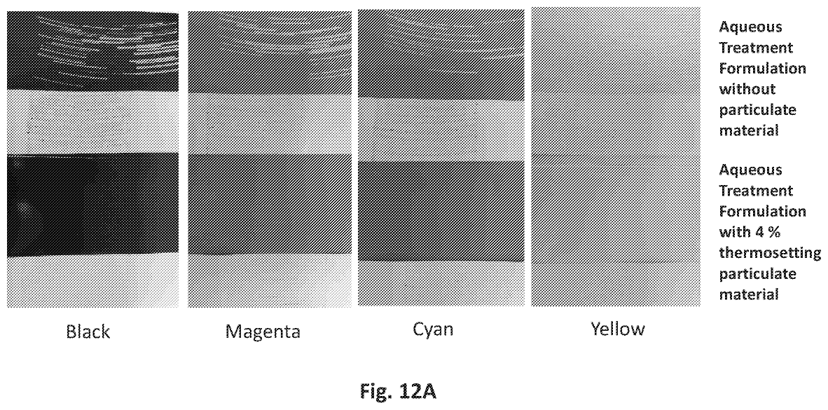

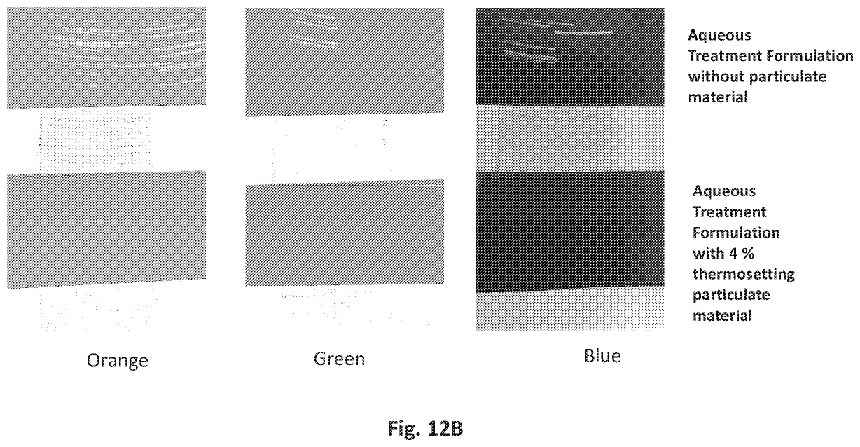

It is noted that in Tables 4-8 the concentration of the additive is provided in % and is considered to be as follows: when for example a 10% concentration is noted, it means that 10 grams of additive were added to 100 grams of the basic composition i.e., resulting with a total weight of 110 grams making the corresponding w/w % being calculated as follows 10*100/110=9.09% w/w. Thus, minor adjustments are needed to convert the concentration detailed in said tables to a w/w %. The same applies to the % values detailed in FIG. 11 and FIGS. 12A-12B.

Table 4 details the various tested samples, using V1 (and V2 when noted in the Table) basic treatment formulation, with or without particulate thermosetting material.

Table 5 details the various tested samples, using V1 basic treatment formulation, with or without particulate thermoplastic material.

Table 6 details the various tested samples, using V1 basic treatment formulation. with or without particulate wax material.

Table 7 details the various tested samples, using V2 or V3 basic treatment formulation, with or without particulate thermoplastic material.

Table 8 details the various tested samples, using V2 or V3 basic treatment formulation. with or without particulate wax material.

TABLE 4
tested samples with or without particulate thermosetting material using V1 and V2 basic treatment formulation.

| | | | Additive | BC | Image | | |
|---|---|---|---|---|---|---|---|
| | Additive | | conc. | thickness | rub | | |
| Color | name | | [%] | [nm] | resistance | Paper type | CoF |
| cyan | — | Reference-basic solution w/o additive | 0 | 100 | (−) | Burgo 170 gsm | 0.72 |
| yellow | — | Reference-basic solution w/o additive | 0 | 100 | (−) | Burgo 170 gsm | 0.91 |
| magenta | — | Reference-basic solution w/o additive | 0 | 100 | (−) | Burgo 170 gsm | 0.85 |
| black | — | Reference-basic solution w/o additive | 0 | 100 | (−) | Burgo 170 gsm | 0.83 |
| cyan | — | Reference-basic solution w/o additive | 0 | 50 | (+) | Uncoated 140 gsm | |
| cyan | — | Reference-basic solution w/o additive | 0 | 50 | (−) | GC1 230 gsm | |
| cyan | — | Reference-basic solution w/o additive | 0 | 50 | (−) | Uncoated 140 gsm | 0.89 |
| cyan | — | Reference-basic solution w/o additive | 0 | 50 | (−) | Silk matt 350 gsm | 0.68 |
| cyan | — | Reference-basic solution w/o additive | 0 | 50 | (−) | Gloss 250 gsm | 0.76 |
| cyan | — | Reference-basic solution w/o additive | 0 | 50 | (+) | Uncoated 140 gsm | |
| cyan | — | Reference-basic solution w/o additive | 0 | 50 | (−) | SBS 400 gsm | |
| cyan | carbon black | carbon black | 0.1 | 50 | (−) | Gloss 130 gsm | |
| cyan | carbon black | carbon black | 0.1 | 50 | (−) | Gloss 250 gsm | |
| cyan | carbon black | carbon black | 0.1 | 50 | (−) | Silk matt 350 gsm | |
| cyan | carbon black | carbon black | 1 | 50 | (−) | Gloss 130 gsm | |
| cyan | carbon black | carbon black | 1 | 50 | (−) | Gloss 250 gsm | |
| cyan | carbon black | carbon black | 1 | 50 | (−) | Silk matt 350 gsm | |
| cyan | DF301 | PTFE Aqueous Dispersion | 4 | 50 | (+) | Gloss 130 gsm | |
| cyan | DF301 | PTFE Aqueous Dispersion | 4 | 50 | (+) | Gloss 250 gsm | |
| cyan | DF301 | PTFE Aqueous Dispersion | 4 | 50 | (+) | Silk matt 350 gsm | |
| cyan | DF301 | PTFE Aqueous Dispersion | 8 | 50 | (+) | Gloss 130 gsm | |
| cyan | DF301 | PTFE Aqueous Dispersion | 8 | 50 | (+) | Gloss 250 gsm | |
| cyan | DF301 | PTFE Aqueous Dispersion | 8 | 50 | (+) | Silk matt 350 gsm | |
| cyan | DF301 | PTFE Aqueous Dispersion | 12 | 50 | (+) | Gloss 130 gsm | |
| cyan | DF301 | PTFE Aqueous Dispersion | 12 | 50 | (+) | Gloss 250 gsm | |
| cyan | DF301 | PTFE Aqueous Dispersion | 12 | 50 | (+) | Silk matt 350 gsm | |
| cyan | DF301 | PTFE Aqueous Dispersion | 4 | 100 | (+) | Gloss 130 gsm | |
| cyan | DF301 | PTFE Aqueous Dispersion | 4 | 100 | (+) | Gloss 250 gsm | |
| cyan | DF301 | PTFE Aqueous Dispersion | 4 | 100 | (+) | Silk matt 350 gsm | |
| cyan | DF301 | PTFE Aqueous Dispersion | 8 | 100 | (+) | Gloss 130 gsm | |
| cyan | DF301 | PTFE Aqueous Dispersion | 8 | 100 | (+) | Gloss 250 gsm | |
| cyan | DF301 | PTFE Aqueous Dispersion | 8 | 100 | (+) | Silk matt 350 gsm | |
| cyan | DF301 | PTFE Aqueous Dispersion | 12 | 100 | (+) | Gloss 130 gsm | |
| cyan | DF301 | PTFE Aqueous Dispersion | 12 | 100 | (+) | Gloss 250 gsm | |
| cyan | DF301 | PTFE Aqueous Dispersion | 12 | 100 | (+) | Silk matt 350 gsm | |
| cyan | microspersion | non-ionic sub-micron PTFE | 3 | 50 | (−) | Gloss 130 gsm | |
| | 1406 | dispersion | | | | | |
| cyan | microspersion | non-ionic sub-micron PTFE | 3 | 50 | (−) | Gloss 250 gsm | |
| | 1406 | dispersion | | | | | |
| cyan | microspersion | non-ionic sub-micron PTFE | 3 | 50 | (−) | Silk matt 350 gsm | |
| | 1406 | dispersion | | | | | |
| cyan | nanoflon | Polytetrafluoroethylene (PTFE) | 7.5 | 50 | (−) | Gloss 250 gsm | |
| | W50C | in water <0.5 micron | | | | | |
| yellow | nanoflon | Polytetrafluoroethylene (PTFE) | 8 | 50 | (+) | GC1 230 gsm | |
| | W50C | in water <0.5 micron | | | | | |
| magenta | nanoflon | Polytetrafluoroethylene (PTFE) | 8 | 50 | (+) | GC1 230 gsm | |
| | W50C | in water <0.5 micron | | | | | |
| cyan | nanoflon | Polytetrafluoroethylene (PTFE) | 8 | 50 | (−) | GC1 230 gsm | |
| | W50C | in water <0.5 micron | | | | | |
| black | nanoflon | Polytetrafluoroethylene (PTFE) | 8 | 50 | (+) | GC1 230 gsm | |
| | W50C | in water <0.5 micron | | | | | |
| cyan | zonyl 1100 | PTFE powder 1100 nm particles | 5 | 50 | (−) | Gloss 250 gsm | |
| | | diameter size | | | | | |
| cyan | zonyl 1100 | PTFE powder 1100 nm particles | 10 | 50 | (−) | Gloss 250 gsm | |
| | | diameter size | | | | | |
| cyan | zonyl 1200 | PTFE powder 1200 nm particles | 5 | 50 | (−) | Gloss 250 gsm | |
| | | diameter size | | | | | |
| cyan | zonyl 1200 | PTFE powder 1200 nm particles | 10 | 50 | (−) | Gloss 250 gsm | |
| | | diameter size | | | | | |
| Magenta | DF301 | PTFE Aqueous Dispersion | 4 | 100 | (+) | Gloss250 | 0.5 |
| Yellow | DF301 | PTFE Aqueous Dispersion | 4 | 100 | (+) | Gloss250 | 0.5 |
| Cyan | DF301 | PTFE Aqueous Dispersion | 4 | 100 | (+) | Gloss250 | 0.6 |
| Black | DF301 | PTFE Aqueous Dispersion | 4 | 100 | (+) | Gloss250 | 0.61 |
| Orange | DF301 | PTFE Aqueous Dispersion | 4 | 100 | (+) | Gloss250 | 0.65 |
| Green | DF301 | PTFE Aqueous Dispersion | 4 | 100 | (+) | Gloss250 | 0.66 |
| Blue | DF301 | PTFE Aqueous Dispersion | 4 | 100 | (+) | Gloss250 | 0.5 |
| Black 100% | DF301 | PTFE Aqueous Dispersion | 3.75 | 100 | (+) | Burgo 170 gsm | 0.76 |
| coverage | | | | | | | |
| Black 75% | DF301 | PTFE Aqueous Dispersion | 3.75 | 100 | (+) | Burgo 170 gsm | 0.73 |
| coverage | | | | | | | |
| Black 50% | DF301 | PTFE Aqueous Dispersion | 3.75 | 100 | (+) | Burgo 170 gsm | 0.66 |
| coverage | | | | | | | |
| cyan | — | Reference-basic solution w/o additive | 0 | 100 | (−) | Gloss250 | 0.86 |
| yellow | — | Reference-basic solution w/o additive | 0 | 100 | (−) | Gloss250 | 0.98 |
| magenta | — | Reference-basic solution w/o additive | 0 | 100 | (−) | Gloss250 | 0.88 |
| black | — | Reference-basic solution w/o additive | 0 | 100 | (−) | Gloss250 | 0.99 |
| Orange | — | Reference-basic solution w/o additive | 0 | 100 | (−) | Gloss250 | 0.92 |
| green | — | Reference-basic solution w/o additive | 0 | 100 | (−) | Gloss250 | 1.05 |
| blue | — | Reference-basic solution w/o additive | 0 | 100 | (−) | Gloss250 | 0.95 |
| Black 100% | — | Reference-basic solution w/o additive | 3.75 | 100 | (−) | Burgo 170 gsm | 1.15 |
| coverage | | | | | | | |
| Black 75% | — | Reference-basic solution w/o additive | 3.75 | 100 | (−) | Burgo 170 gsm | 0.87 |
| coverage | | | | | | | |
| Black 50% | — | Reference-basic solution w/o additive | 3.75 | 100 | (−) | Burgo 170 gsm | 0.83 |
| coverage | | | | | | | |
| Cyan V2 | — | Reference-basic solution w/o additive | 4.0 | 100 | (−) | Silk Matt 350 | |
| Cyan V2 | DF301 | PTFE Aqueous Dispersion | 4.0 | 200 | (+) | Silk Matt 350 | |

TABLE 5
tested samples with or without particulate thermoplastic material, using V1 basic treatment formulation.

| | | | Additive | BC | Image | | |
|---|---|---|---|---|---|---|---|
| | Additive | | conc. | thickness | rub | | |
| Color | name | | [%] | [nm] | resistance | Paper type | CoF |
| cyan | — | Reference-basic solution w/o additive | 0 | 100 | (−) | Burgo 170 gsm | 0.72 |
| yellow | — | Reference-basic solution w/o additive | 0 | 100 | (−) | Burgo 170 gsm | 0.91 |
| magenta | — | Reference-basic solution w/o additive | 0 | 100 | (−) | Burgo 170 gsm | 0.85 |
| black | — | Reference-basic solution w/o additive | 0 | 100 | (−) | Burgo 170 gsm | 0.83 |
| cyan | — | Reference-basic solution w/o additive | 0 | 50 | (+) | Uncoated 140 gsm | |
| cyan | — | Reference-basic solution w/o additive | 0 | 50 | (−) | GC1 230 gsm | |
| cyan | — | Reference-basic solution w/o additive | 0 | 50 | (−) | Uncoated 140 gsm | 0.89 |
| cyan | — | Reference-basic solution w/o additive | 0 | 50 | (−) | Silk matt 350 gsm | 0.68 |
| cyan | — | Reference-basic solution w/o additive | 0 | 50 | (−) | Gloss 250 gsm | 0.76 |
| cyan | — | Reference-basic solution w/o additive | 0 | 50 | (+) | Uncoated 140 gsm | |
| cyan | — | Reference-basic solution w/o additive | 0 | 50 | (−) | SBS 400 gsm | |
| cyan | nanobyk3620 | aqueous dispersion made up of | 10 | 50 | (−) | GC1 230 gsm | |
| | | nanohybrid particles 100 nm | | | | | |
| cyan | nanobyk3620 | aqueous dispersion made up of | 10 | 50 | (−) | SBS 400 gsm | |
| | | nanohybrid particles 100 nm | | | | | |
| cyan | nanobyk3620 | aqueous dispersion made up of | 10 | 50 | (+) | Uncoated 140 gsm | |
| | | nanohybrid particles 100 nm | | | | | |
| cyan | nanobyk3620 | aqueous dispersion made up of | 10 | 50 | (−) | Gloss 250 gsm | |
| | | nanohybrid particles 100 nm | | | | | |
| cyan | nanobyk3620 | aqueous dispersion made up of | 15 | 50 | (+) | Uncoated 140 gsm | |
| | | nanohybrid particles 100 nm | | | | | |
| cyan | nanobyk3620 | aqueous dispersion made up of | 15 | 50 | (+) | Gloss 250 gsm | |
| | | nanohybrid particles 100 nm | | | | | |
| cyan | nanobyk3620 | aqueous dispersion made up of | 15 | 50 | (+) | GC1 230 gsm | |
| | | nanohybrid particles 100 nm | | | | | |
| cyan | nanobyk3620 | aqueous dispersion made up of | 15 | 50 | (+) | SBS 400 gsm | |
| | | nanohybrid particles 100 nm | | | | | |
| cyan | nanobyk3620 | aqueous dispersion made up of | 10 | 100 | (+) | GC1 230 gsm | |
| | | nanohybrid particles 100 nm | | | | | |
| cyan | nanobyk3620 | aqueous dispersion made up of | 10 | 100 | (+) | SBS 400 gsm | |
| | | nanohybrid particles 100 nm | | | | | |
| cyan | nanobyk3620 | aqueous dispersion made up of | 15 | 100 | (+) | Uncoated 140 gsm | 0.73 |
| | | nanohybrid particles 100 nm | | | | | |
| cyan | nanobyk3620 | aqueous dispersion made up of | 15 | 100 | (+) | Gloss 250 gsm | |
| | | nanohybrid particles 100 nm | | | | | |
| cyan | nanobyk3620 | aqueous dispersion made up of | 15 | 100 | (+) | GC1 230 gsm | |
| | | nanohybrid particles 100 nm | | | | | |
| cyan | nanobyk3620 | aqueous dispersion made up of | 15 | 100 | (+) | SBS 400 gsm | |
| | | nanohybrid particles 100 nm | | | | | |
| cyan | nanobyk3620 | aqueous dispersion made up of | 10 | 50 | (+) | Uncoated 140 gsm | |
| | | nanohybrid particles 100 nm | | | | | |
| cyan | nanobyk3620 | aqueous dispersion made up of | 10 | 50 | (−) | Gloss 250 gsm | |
| | | nanohybrid particles 100 nm | | | | | |
| cyan | nanobyk3620 | aqueous dispersion made up of | 10 | 100 | (+) | Uncoated 140 gsm | 0.7 |
| | | nanohybrid particles 100 nm | | | | | |
| cyan | nanobyk3620 | aqueous dispersion made up of | 10 | 100 | (+) | Gloss 250 gsm | |
| | | nanohybrid particles | | | | | |

TABLE 6
details various tested samples with or without wax thermoplastic particulate material, using V1 basic treatment formulation.

| | | | | Additive | BC | Image | | |
|---|---|---|---|---|---|---|---|---|
| | | Additive | | conc. | thickness | rub | | |
| | Color | name | | [%] | [nm] | resistance | Paper type | CoF |
| 1 | cyan | — | Reference-basic solution w/o additive | 0 | 100 | (−) | Burgo 170 gsm | 0.72 |
| 2 | yellow | — | Reference-basic solution w/o additive | 0 | 100 | (−) | Burgo 170 gsm | 0.91 |
| 3 | magenta | — | Reference-basic solution w/o additive | 0 | 100 | (−) | Burgo 170 gsm | 0.85 |
| 4 | black | — | Reference-basic solution w/o additive | 0 | 100 | (−) | Burgo 170 gsm | 0.83 |
| 5 | cyan | — | Reference-basic solution w/o additive | 0 | 50 | (+) | Uncoated 140 gsm | |
| 6 | cyan | — | Reference-basic solution w/o additive | 0 | 50 | (−) | GC1 230 gsm | |
| 7 | cyan | — | Reference-basic solution w/o additive | 0 | 50 | (−) | Uncoated 140 gsm | 0.89 |
| 8 | cyan | — | Reference-basic solution w/o additive | 0 | 50 | (−) | Silk matt 350 gsm | 0.68 |
| 9 | cyan | — | Reference-basic solution w/o additive | 0 | 50 | (−) | Gloss 250 gsm | 0.76 |
| 10 | cyan | — | Reference-basic solution w/o additive | 0 | 50 | (+) | Uncoated 140 gsm | |
| 11 | cyan | — | Reference-basic solution w/o additive | 0 | 50 | (−) | SBS 400 gsm | |
| 12 | cyan | Aquacer 497 | Paraffin-based wax emulsion | 3 | 100 | (−) | Gloss 250 gsm | |
| 13 | cyan | Aquacer 497 | Paraffin-based wax emulsion | 3 | 100 | (−) | Silk matt 350 gsm | |
| 14 | cyan | Aquacer 497 | Paraffin-based wax emulsion | 5 | 100 | (−) | Gloss 130 gsm | |
| 15 | cyan | Aquacer 497 | Paraffin-based wax emulsion | 5 | 100 | (−) | Gloss 250 gsm | |
| 16 | cyan | Aquacer 497 | Paraffin-based wax emulsion | 5 | 100 | (−) | Silk matt 350 gsm | |
| 17 | cyan | aquacer530 | Non-ionic emulsion based on an | 5 | 50 | (−) | Gloss 250 gsm | |
| | | | oxidized HDPE wax | | | | | |
| 18 | cyan | aquacer530 | Non-ionic emulsion based on an | 3 | 50 | (−) | Gloss 250 gsm | |
| | | | oxidized HDPE wax | | | | | |
| 19 | cyan | aquacer530 | Non-ionic emulsion based on an | 5 | 50 | (−) | Gloss 250 gsm | |
| | | | oxidized HDPE wax | | | | | |
| 20 | cyan | aquacer530 | Non-ionic emulsion based on an | 3 | 50 | (−) | Gloss 250 gsm | |
| | | | oxidized HDPE wax | | | | | |
| 21 | cyan | C37 lakewax | aqueous cationic emulsion of an | 1.5 | 50 | (−) | Gloss 130 gsm | |
| | | | oxidized polyethylene wax ≤500 nm | | | | | |
| 22 | cyan | C37 lakewax | aqueous cationic emulsion of an | 1.5 | 50 | (−) | Gloss 250 gsm | |
| | | | oxidized polyethylene wax ≤500 nm | | | | | |
| 23 | cyan | C37 lakewax | aqueous cationic emulsion of an | 1.5 | 50 | (−) | Silk matt 350 gsm | |
| | | | oxidized polyethylene wax ≤500 nm | | | | | |
| 24 | cyan | C37 lakewax | aqueous cationic emulsion of an | 3 | 50 | (+) | Gloss 130 gsm | |
| | | | oxidized polyethylene wax ≤500 nm | | | | | |
| 25 | cyan | C37 lakewax | aqueous cationic emulsion of an | 3 | 50 | (+) | Gloss 250 gsm | 0.59 |
| | | | oxidized polyethylene wax ≤500 nm | | | | | |
| 26 | cyan | C37 lakewax | aqueous cationic emulsion of an | 3 | 50 | (+) | Silk matt 350 gsm | 0.45 |
| | | | oxidized polyethylene wax ≤500 nm | | | | | |
| 27 | cyan | C37 lakewax | aqueous cationic emulsion of an | 5 | 50 | (+) | Gloss 250 gsm | 0.52 |
| | | | oxidized polyethylene wax ≤500 nm | | | | | |
| 28 | cyan | C37 lakewax | aqueous cationic emulsion of an | 5 | 50 | (+) | Silk matt 350 gsm | 0.35 |
| | | | oxidized polyethylene wax ≤500 nm | | | | | |
| 29 | cyan | C37 lakewax | aqueous cationic emulsion of an | 3 | 100 | (+) | Burgo 170 gsm | 0.48 |
| | | | oxidized polyethylene wax ≤500 nm | | | | | |
| 30 | yellow | C37 lakewax | aqueous cationic emulsion of an | 3 | 100 | (+) | Burgo 170 gsm | 0.5 |
| | | | oxidized polyethylene wax ≤500 nm | | | | | |
| 31 | magenta | C37 lakewax | aqueous cationic emulsion of an | 3 | 100 | (+) | Burgo 170 gsm | 0.5 |
| | | | oxidized polyethylene wax ≤500 nm | | | | | |
| 32 | black | C37 lakewax | aqueous cationic emulsion of an | 3 | 100 | (+) | Burgo 170 gsm | 0.53 |
| | | | oxidized polyethylene wax ≤500 nm | | | | | |
| 33 | cyan | FluoroSLIP | PTFE/Polyethylene Wax Blend 9 | 8 | 50 | (−) | Gloss 130 gsm | 0.85 |
| | | 533 | micron diameter | | | | | |
| 34 | cyan | FluoroSLIP | PTFE/Polyethylene Wax Blend 9 | 8 | 50 | (−) | Gloss 250 gsm | 0.56 |
| | | 533 | micron diameter | | | | | |
| 35 | cyan | FluoroSLIP | PTFE/Polyethylene Wax Blend 9 | 8 | 50 | (−) | Silk matt 350 gsm | 0.59 |
| | | 533 | micron diameter | | | | | |
| 36 | cyan | NEPTUNE | Oxidized polyethylene Wax | 8 | 50 | (−) | Gloss 130 gsm | 0.72 |
| | | 5223 | | | | | | |
| 37 | cyan | NEPTUNE | Oxidized polyethylene Wax | 8 | 50 | (−) | Gloss 250 gsm | 0.57 |
| | | 5223 | | | | | | |
| 38 | cyan | NEPTUNE | Oxidized polyethylene Wax | 8 | 50 | (−) | Silk matt 350 gsm | 0.62 |
| | | 5223 | | | | | | |
| 39 | cyan | S-379-H | Polyethylene wax | 8 | 50 | (−) | Gloss 130 gsm | 0.97 |
| 40 | cyan | S-379-H | Polyethylene wax | 8 | 50 | (−) | Gloss 250 gsm | 0.72 |
| 41 | cyan | S-379-H | Polyethylene wax | 8 | 50 | (−) | Silk matt 350 gsm | |
| 42 | cyan | S-381-N5 | Micronized Wax Alloy | 8 | 50 | (−) | Gloss 130 gsm | 0.72 |
| 43 | cyan | S-381-N5 | Micronized Wax Alloy | 8 | 50 | (−) | Gloss 250 gsm | 0.72 |
| 44 | cyan | S-381-N5 | Micronized Wax Alloy | 8 | 50 | (−) | Silk matt 350 gsm | 0.63 |
| 45 | magenta | Tego 482 | emulsion of a high molecular weight | 5 | 50 | (−) | Gloss 250 gsm | |
| | | | polydimethylsiloxane | | | | | |
| 46 | magenta | Tego 482 | emulsion of a high molecular weight | 5 | 50 | (−) | Gloss 250 gsm | |
| | | | polydimethylsiloxane | | | | | |
| 47 | magenta | Tego 482 | emulsion of a high molecular weight | 5 | 50 | (−) | Gloss 250 gsm | |
| | | | polydimethylsiloxane | | | | | |
| 48 | magenta | Tego 482 | emulsion of a high molecular weight | 5 | 50 | (−) | Gloss 250 gsm | |
| | | | polydimethylsiloxane | | | | | |

TABLE 7
tested samples with or without particulate thermoplastic material, using V2 or V3 basic treatment formulation.

| | | | Additive | BC | Image | | |
|---|---|---|---|---|---|---|---|
| | Additive | | conc. | thickness | rub | | |
| Color | name | | [%] | [nm] | resistance | Paper type | CoF |
| Cyan (V2) | — | Reference-basic solution w/o additive | 0 | 50 | (−) | Gloss 250 gsm | 0.72 |
| Cyan (V2) | — | Reference-basic solution w/o additive | 0 | 50 | (−) | Silk matt 350 gsm | 0.69 |
| Cyan (V2) | — | Reference-basic solution w/o additive | 0 | 100 | (−) | Silk matt 350 gsm | |
| Cyan (V3) | — | Reference-basic solution w/o additive | 0 | 100 | (−) | Silk matt 350 gsm | |
| Cyan (V3) | — | Reference-basic solution w/o additive | 0 | 100 | (−) | Burgo 130 | 0.94 |
| Cyan (V3) | — | Reference-basic solution w/o additive | 0 | 100 | (−) | Gloss 250 | |
| Black (V3) | — | Reference-basic solution w/o additive | 0 | 100 | (−) | Silk matt 350 gsm | |
| Black (V3) | — | Reference-basic solution w/o additive | 0 | 100 | (−) | Burgo 130 | 1.06 |
| Black (V3) | — | Reference-basic solution w/o additive | 0 | 100 | (−) | Gloss 250 | |
| Magenta (V3) | — | Reference-basic solution w/o additive | 0 | 100 | (−) | Silk matt 350 gsm | |
| Magenta (V3) | — | Reference-basic solution w/o additive | 0 | 100 | (−) | Burgo 130 | 0.95 |
| Magenta (V3) | — | Reference-basic solution w/o additive | 0 | 100 | (−) | Gloss 250 | |
| Yellow (V3) | — | Reference-basic solution w/o additive | 0 | 100 | (−) | Silk matt 350 gsm | |
| Yellow (V3) | — | Reference-basic solution w/o additive | 0 | 100 | (−) | Burgo 130 | 1.07 |
| Yellow (V3) | — | Reference-basic solution w/o additive | 0 | 100 | (−) | Gloss 250 | |
| Green (V3) | — | Reference-basic solution w/o additive | 0 | 100 | (−) | Silk matt 350 gsm | |
| Green (V3) | — | Reference-basic solution w/o additive | 0 | 100 | (−) | Burgo 130 | |
| Green (V3) | — | Reference-basic solution w/o additive | 0 | 100 | (−) | Gloss 250 | |
| Orange (V3) | — | Reference-basic solution w/o additive | 0 | 100 | (−) | Silk matt 350 gsm | |
| Orange (V3) | — | Reference-basic solution w/o additive | 0 | 100 | (−) | Burgo 130 | |
| Orange (V3) | — | Reference-basic solution w/o additive | 0 | 100 | (−) | Gloss 250 | |
| Blue (V3) | — | Reference-basic solution w/o additive | 0 | 100 | (−) | Silk matt 350 gsm | |
| Blue (V3) | — | Reference-basic solution w/o additive | 0 | 100 | (−) | Burgo 130 | |
| Blue (V3) | — | Reference-basic solution w/o additive | 0 | 100 | (−) | Gloss 250 | |
| Black (V3) | — | Reference-basic solution w/o additive | 0 | 100 | (−) | Gloss 250 gsm | |
| Cyan (V2) | DF301 | Polytetrafluoroethylene (PTFE) | 8 | 100 | (+) | Silk matt 350 gsm | |
| | | Aqueous Dispersion | | | | | |
| Cyan (V2) | DF301 | Polytetrafluoroethylene (PTFE) | 12 | 100 | (+) | Silk matt 350 gsm | |
| | | Aqueous Dispersion | | | | | |
| Black (V3) | DF301 | Polytetrafluoroethylene (PTFE) | 4 | 100 | (+) | Gloss 250 gsm | |
| | | Aqueous Dispersion | | | | | |
| Black (V3) | DF301 | Polytetrafluoroethylene (PTFE) | 6 | 100 | (+) | Gloss 250 gsm | |
| | | Aqueous Dispersion | | | | | |
| Black (V3) | DF301 | Polytetrafluoroethylene (PTFE) | 8 | 100 | (+) | Gloss 250 gsm | |
| | | Aqueous Dispersion | | | | | |
| Black (V3) | DF301 | Polytetrafluoroethylene (PTFE) | 3 | 100 | (+) | Gloss 250 gsm | |
| | | Aqueous Dispersion | | | | | |
| Cyan (V3) | DF301 | Polytetrafluoroethylene (PTFE) | 3 | 100 | (+) | Silk matt 350 gsm | |
| | | Aqueous Dispersion | | | | | |
| Cyan (V3) | DF301 | Polytetrafluoroethylene (PTFE) | 3 | 100 | (+) | Burgo 130 | 0.63 |
| | | Aqueous Dispersion | | | | | |
| Cyan (V3) | DF301 | Polytetrafluoroethylene (PTFE) | 3 | 100 | (+) | Gloss 250 | |
| | | Aqueous Dispersion | | | | | |
| Black (V3) | DF301 | Polytetrafluoroethylene (PTFE) | 3 | 100 | (+) | Silk matt 350 gsm | |
| | | Aqueous Dispersion | | | | | |
| Black (V3) | DF301 | Polytetrafluoroethylene (PTFE) | 3 | 100 | (+) | Burgo 130 | 0.68 |
| | | Aqueous Dispersion | | | | | |
| Black (V3) | DF301 | Polytetrafluoroethylene (PTFE) | 3 | 100 | (+) | Gloss 250 | |
| | | Aqueous Dispersion | | | | | |
| Magenta (V3) | DF301 | Polytetrafluoroethylene (PTFE) | 3 | 100 | (+) | Silk matt 350 gsm | |
| | | Aqueous Dispersion | | | | | |
| Magenta (V3) | DF301 | Polytetrafluoroethylene (PTFE) | 3 | 100 | (+) | Burgo 130 | 0.65 |
| | | Aqueous Dispersion | | | | | |
| Magenta (V3) | DF301 | Polytetrafluoroethylene (PTFE) | 3 | 100 | (+) | Gloss 250 | |
| | | Aqueous Dispersion | | | | | |
| Yellow (V3) | DF301 | Polytetrafluoroethylene (PTFE) | 3 | 100 | (+) | Silk matt 350 gsm | |
| | | Aqueous Dispersion | | | | | |
| Yellow (V3) | DF301 | Polytetrafluoroethylene (PTFE) | 3 | 100 | (+) | Burgo 130 | 0.71 |
| | | Aqueous Dispersion | | | | | |
| Yellow (V3) | DF301 | Polytetrafluoroethylene (PTFE) | 3 | 100 | (+) | Gloss 250 | |
| | | Aqueous Dispersion | | | | | |
| Green (V3) | DF301 | Polytetrafluoroethylene (PTFE) | 3 | 100 | (+) | Silk matt 350 gsm | |
| | | Aqueous Dispersion | | | | | |
| Green (V3) | DF301 | Polytetrafluoroethylene (PTFE) | 3 | 100 | (+) | Burgo 130 | |
| | | Aqueous Dispersion | | | | | |
| Green (V3) | DF301 | Polytetrafluoroethylene (PTFE) | 3 | 100 | (+) | Gloss 250 | |
| | | Aqueous Dispersion | | | | | |
| Orange (V3) | DF301 | Polytetrafluoroethylene (PTFE) | 3 | 100 | (+) | Silk matt 350 gsm | |
| | | Aqueous Dispersion | | | | | |
| Orange (V3) | DF301 | Polytetrafluoroethylene (PTFE) | 3 | 100 | (+) | Burgo 130 | |
| | | Aqueous Dispersion | | | | | |
| Orange (V3) | DF301 | Polytetrafluoroethylene (PTFE) | 3 | 100 | (+) | Gloss 250 | |
| | | Aqueous Dispersion | | | | | |
| Blue (V3) | DF301 | Polytetrafluoroethylene (PTFE) | 3 | 100 | (+) | Silk matt 350 gsm | |
| | | Aqueous Dispersion | | | | | |
| Blue (V3) | DF301 | Polytetrafluoroethylene (PTFE) | 3 | 100 | (+) | Burgo 130 | |
| | | Aqueous Dispersion | | | | | |
| Blue (V3) | DF301 | Polytetrafluoroethylene (PTFE) | 3 | 100 | (+) | Gloss 250 | |
| | | Aqueous Dispersion | | | | | |

TABLE 8
tested samples with or without wax thermoplastic particulate material, using V2 or V3 basic treatment formulation.

| | | | Additive | BC | Image | | |
|---|---|---|---|---|---|---|---|
| | Additive | | conc. | thickness | rub | | |
| Color | name | | [%] | [nm] | resistance | Paper type | CoF |
| Cyan | — | Reference-basic solution w/o additive | 0 | 50 | (−) | Gloss 250 gsm | 0.72 |
| (V2) | | | | | | | |
| Cyan | — | Reference-basic solution w/o additive | 0 | 50 | (−) | Silk matt 350 gsm | 0.69 |
| (V2) | | | | | | | |
| Cyan | C37 lakewax | aqueous cationic emulsion of an oxidized | 3 | 50 | (−) | Gloss 250 gsm | 0.59 |
| (V2) | | polyethylene wax | | | | | |
| Cyan | C37 lakewax | aqueous cationic emulsion of an oxidized | 3 | 50 | (−) | Silk matt 350 gsm | 0.58 |
| (V2) | | polyethylene wax | | | | | |
| Cyan | C37 lakewax | aqueous cationic emulsion of an oxidized | 5 | 50 | (−) | Gloss 250 gsm | 0.61 |
| (V2) | | polyethylene wax | | | | | |
| Cyan | C37 lakewax | aqueous cationic emulsion of an oxidized | 5 | 50 | (−) | Silk matt 350 gsm | 0.54 |
| (V2) | | polyethylene wax | | | | | |
| Cyan | C37 lakewax | aqueous cationic emulsion of an oxidized | 4 | 100 | (+) | Silk matt 350 gsm | |
| (V2) | | polyethylene wax | | | | | |
| Cyan | C37 lakewax | aqueous cationic emulsion of an oxidized | 8 | 100 | (+) | Silk matt 350 gsm | |
| (V2) | | polyethylene wax | | | | | |
| Cyan | C37 lakewax | aqueous cationic emulsion of an oxidized | 12 | 100 | (+) | Silk matt 350 gsm | |
| (V2) | | polyethylene wax | | | | | |

The data detailed in Tables 4 to 8 illustrate that no image nub resistance [designated in the tables as (−)] for basic solution without (w/o) the additive particulate material was observed for all colors and all substrates both in 50 nm and 100 nm dry treatment layer thickness, except for an uncoated 140 gsm substrate. Good rub resistance [designated in the tables as (+)] with several additives was observed at specific concentrations, particles size and concentration.

### Rub Resistance Measurements

The rub resistance test was performed utilizing a TMI Rub Tester Model No. 10-18-01-0001 (Testing Machines, Inc., New Castle, Del.). The improvement was determined based on scores which were determined based on visual inspection of the rubbing results.

FIG. 11 illustrates the rub resistance of a printed image (printed at 8 bar on silk matt 350 gsm) observed with 3% and 5% of a cationic emulsion of the thermoplastic particulate oxidized polyethylene wax material. In the absence of said material, rub marks are clearly detected with the colors tested. The marks are also detected in the mirror image of the rub marks on a white paper. FIG. 11 illustrates the improvement of the rub resistance as a function of the additive amount.

FIGS. 12A-12B illustrate the rub resistance of a printed image (printed at 8 bar on gloss 250) observed with 4% of the thermosetting material PTFE aqueous dispersion. In the absence of said material, rub marks are clearly detected with the colors tested. The marks are also detected in the mirror image of the rub marks on a white paper.

### Coefficient of Friction Measurements

The CoF of the tested images is detailed in Tables 4 to 8.

The CoF of ink free regions of the printed substrates were also tested. Several papers were tested. For smooth substrates, such as gloss papers, no differences in coefficient of friction was observed with or without the aqueous treatment formulations of the invention. For rough papers, a significant difference in coefficient of friction of paper with and without the aqueous treatment formulations of the invention was observed (data not shown).

Fingerprints of Printed Image Using a Treatment Formulation with Particulate Material According to the Present Invention

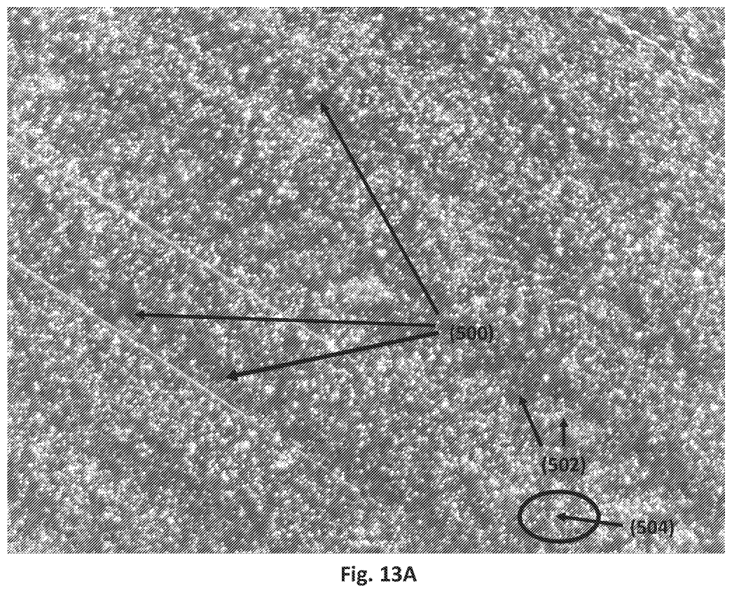

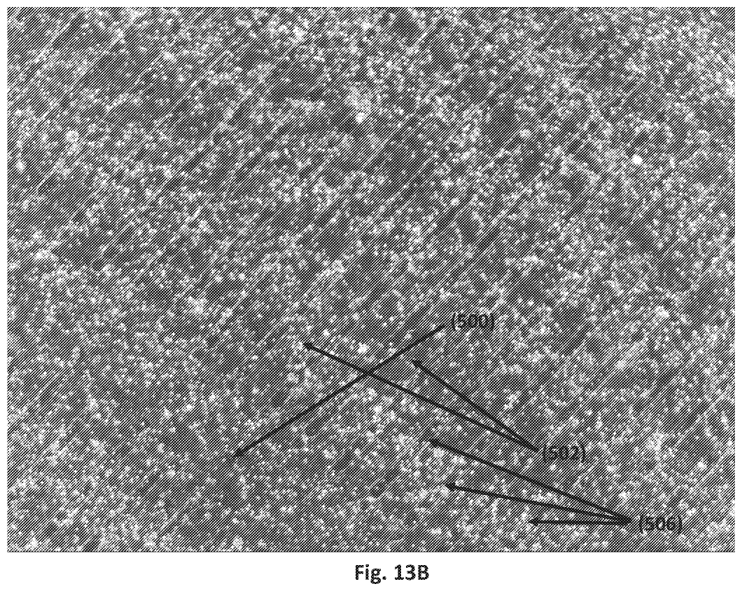

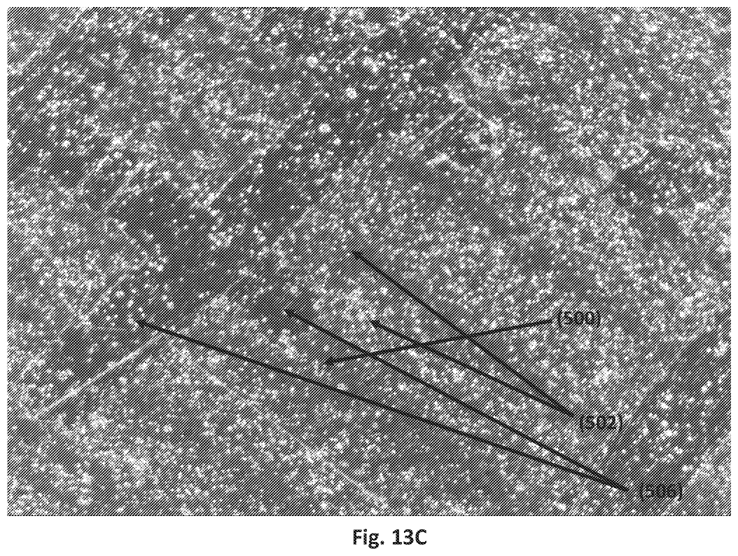

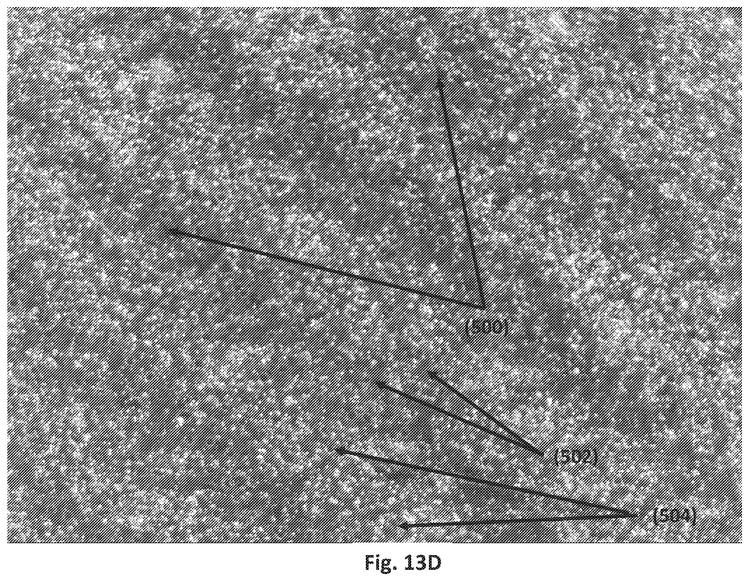

FIGS. 13A-13D illustrate a printed surface of paper printed according to some embodiments of the invention. The patterns were imaged utilizing Bodelin, 5 MP Digital microscope (magnification: 10× to 300×). The arrows in FIGS. 13A-13D indicate some areas which are not coated by the treatment formulations of the invention, i.e., indicating paper surface only with no treatment formulation (500) (shown black in the figure due to the use of a black paper). The arrows further indicate some coating layer dots (502) of areas coated with a treatment layer (shown as white dots). The arrows further indicate some ink printed areas, shown as cyan dots (504) or cyan image (506).

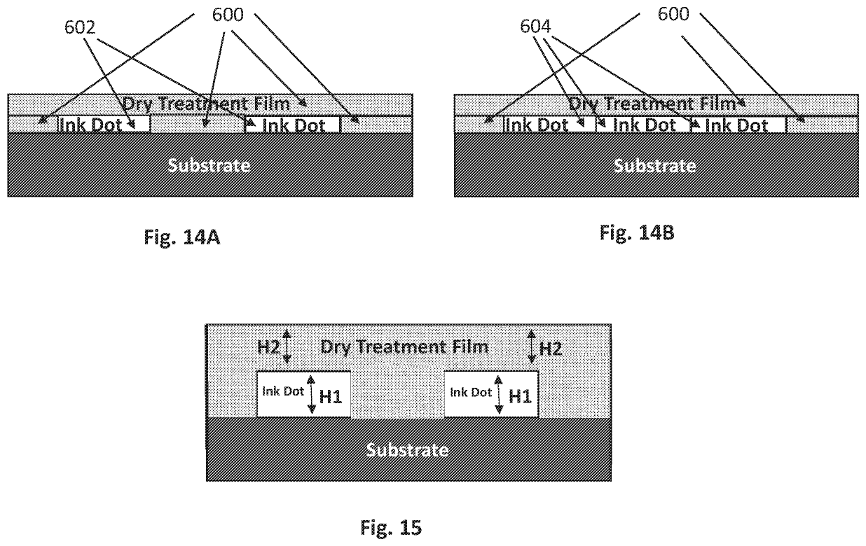

FIGS. 14A-14B illustrate printed patterns on a surface of a substrate according to some embodiments of the invention. FIG. 14A illustrate a pattern in which the ink dots are spaced apart (602) each of which is in close contact with and surrounded by the dry treatment film (600). The dry treatment film (600) is in close contact with the surface of the substrate in non-printed ink free areas. FIG. 14B illustrate a pattern in which the ink dots are continuous (604) and are in close contact with the dry treatment film (600). The dry treatment film (600) is in close contact with the surface of the substrate in non-printed ink free areas. It is noted that FIGS. 14A-14B are only illustrative and the relative dimensions and shapes of the components detailed therein are for illustration purposes only.

FIG. 15 illustrate relative thickness of ink dots and dry treatment film according to some embodiments of the invention. It is noted that the dry treatment layer according to the present invention is very thin. The thickness thereof above the ink dot is designated in FIG. 15 as H2. The thickness of the ink dot is designated in FIG. 15 as H1. At times, in the printed patterns/articles according to the present invention the ratio between H2 to H2 is 1 i.e., the thickness of the coating film is substantially the same as the thickness of the ink dot. At times the ratio between H2 to H1 is below 1 i.e., the thickness of the coating film is lower than the thickness of the ink dot. It is noted that FIG. 15 is only illustrative and the relative dimensions and shapes of the components detailed therein for illustration purposes only.

### ILLUSTRATIVE EMBODIMENTS

The following embodiments are illustrative and not intended to limit the claimed subject matter.

EMBODIMENT 1 An aqueous formulation for use with an intermediate transfer member of a printing system, the aqueous formulation comprising:

at least one modified polysaccharide;

at least one carrier liquid containing water;

at least one particulate material selected from (i) at least one thermoplastic polymeric particulate material; (ii) at least one thermosetting polymeric particulate material; or (iii) a combination thereof; and

optionally, one or more of (a) at least one humectant; (b) at least one surfactant; and (c) at least one wetting agent.

EMBODIMENT 2 The aqueous formulation according to Embodiment 1, wherein said modified polysaccharide is a cellulose derivative.
EMBODIMENT 3 The aqueous formulation according to Embodiment 2 wherein said cellulose derivative is methylcellulose.
EMBODIMENT 4 The aqueous formulation according to Embodiment 3, wherein said methylcellulose is hydroxypropyl methylcellulose.
EMBODIMENT 5 The aqueous formulation according to any one of Embodiments 1 to 4, wherein said modified polysaccharide is a non-thermoplastic polymer.
EMBODIMENT 6 The aqueous formulation according to any one of Embodiments 1 to 5, wherein said modified polysaccharide includes a charged polysaccharide.
EMBODIMENT 7 The aqueous formulation according to Embodiment 6, wherein said charged polysaccharide is or includes an acidic polysaccharide optionally containing carboxyl groups and/or sulfuric ester groups.
EMBODIMENT 8 The aqueous formulation according to Embodiment 6, wherein said charged polysaccharide is or includes a positively charged polysaccharide.
EMBODIMENT 9 The aqueous treatment formulation of any one of Embodiments 1 to 8 wherein said modified polysaccharide has a structure:

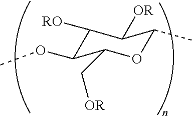

wherein n is an integer being of 3 or more; and
wherein R is selected from the group consisting of: H, CH₃, CH₂COOH, CH₂CH(OH)CH₃, CH₂CH(OH)CH₃, and wherein the various R groups may be the same or different.
EMBODIMENT 10 The aqueous treatment formulation of any one of Embodiments 1 to 9, wherein said modified polysaccharide is methylcellulose and wherein at least 2% of R is a methyl (CH₃) group.
EMBODIMENT 11 The aqueous treatment formulation of any one of Embodiments 1 to 10, wherein said modified polysaccharide has at least one of the following characteristics:

i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C., or at most 105° C. or between 60-120° C., or 60-110° C., or 60-100° C., or 65-110° C., or 65-105° C., or 65-100° C., or 70-110° C., or 70-100° C., or 75-110° C., or 75-100° C., or 80-100° C.;

ii. a viscosity in mPa·s, as measured in 2% concentration by weight in water at 25° C., of at most 11, at most 10, at most 9, at most 8, at most 7, at most 6, at most 5, at most 4, and optionally, at least 0.5 or at least 1, or at least 2 or a viscosity within a range of 0.5-10, 1-8, 2-8, 2-5, or 2-4;

iii. a hydroxypropyl substitution of at least 1%, 2%, 4%, 6%, 7% or between 1-30%, 5-25%, 5-20%, 5-10%, 7-9% or 7.3-8.3% or a hydroxypropyl substitution, on a molar basis, of at least 0.1, or at least 0.15 or at least 0.2 or between 0.1-1.0, 0.1-0.9, 0.1-0.7 or 0.1-0.3;

iv. a number average molecular weight, in Daltons, of at most 13,000 or at most 12000, or at most 11000, or at most 10,000, or at most 9000, or at most 8000.

EMBODIMENT 12 The aqueous treatment formulation of Embodiment 11, wherein said modified polysaccharide is a cellulose derivative.
EMBODIMENT 13 The aqueous treatment formulation of Embodiment 12, wherein said cellulose derivative is methyl cellulose.
EMBODIMENT 14 The aqueous treatment formulation of Embodiment 13, wherein said methyl cellulose is HPMC.
EMBODIMENT 15 The aqueous treatment formulation of any one of Embodiments 1 to 14, wherein said modified polysaccharide is, or includes, a methylcellulose.
EMBODIMENT 16 The aqueous treatment formulation of Embodiment 15, wherein said methylcellulose has at least one of the following structural characteristics:

i. a hydroxypropyl substitution of at least 2%, or at least 4%, or at least 6%, or at least 7% or at most 20%, or at most 15%, or at most 14%, or at most 12% or between 4-15% or 7-12%;

ii. a hydroxypropyl molar substitution of more than 0.1 or more than 0.15 or more than 0.2; and

iii. a number average molecular weight, as measured in Daltons, of at most 13,000 or at most 12,000, or at most 11,000, or at most 10,000, or at most 9,000, or at most 8,000.

EMBODIMENT 17 The aqueous treatment formulation of any one of Embodiments 1 to 16, wherein the modified polysaccharide is methylcellulose having a methoxyl substitution of less than 25%, or within a range of 15 to 25%.
EMBODIMENT 18 The aqueous treatment formulation of any one of Embodiments 1 to 17, wherein said modified polysaccharide is methylcellulose having a hydroxypropyl substitution within a range of 7 to 12%.
EMBODIMENT 19 The aqueous treatment formulation of any one of Embodiments 1 to 18, wherein said modified polysaccharide has a solubility in water, or within the aqueous treatment formulation, of at least 1.5%, or at least 2%, or at least 3%, or at least 4%, or at least 5%, or at least 7%, or at least 8%, or at least 10%, by weight, at 25° C.
EMBODIMENT 20 The aqueous treatment formulation of any one of Embodiments 11 to 19, wherein the temperature of gelation as measured at 2% concentration by weight in water is at least 50° C.
EMBODIMENT 21 The aqueous treatment formulation of any one of Embodiments 11 to 19, wherein the viscosity, in mPa·s, as measured in 2% concentration by weight in water at 25° C., is at most 11.
EMBODIMENT 22 The aqueous treatment formulation of any one of Embodiments 1 to 21, wherein said formulation further comprises at least one wetting agent.
EMBODIMENT 23 The aqueous treatment formulation of Embodiment 22, wherein said wetting agent is polyethyleneimine.
EMBODIMENT 24 The aqueous treatment formulation of Embodiment 23, wherein a ratio of said modified polysaccharide to polyethyleneimine is within a range of 4:1-200:1, by weight.
EMBODIMENT 25 The aqueous treatment formulation of Embodiment 24, wherein said ratio is within a range of 4:1-100:1.
EMBODIMENT 26 The aqueous treatment formulation of Embodiment 25, wherein said ratio is within a range of 4:1-60:1.
EMBODIMENT 27 The aqueous treatment formulation of Embodiment 26, wherein said ratio is within a range of 4:1-35:1.
EMBODIMENT 28 The aqueous treatment formulation of Embodiment 27, wherein said ratio is within a range of 4:1-25:1.
EMBODIMENT 29 The aqueous treatment formulation of Embodiment 24, wherein said ratio is within a range of 5:1-100:1.
EMBODIMENT 30 The aqueous treatment formulation of Embodiment 29, wherein said ratio is within a range of 5:1-50:1.
EMBODIMENT 31 The aqueous treatment formulation of Embodiment 30 wherein said ratio is within a range of 5:1-35:1.
EMBODIMENT 32 The aqueous treatment formulation of Embodiment 24, wherein said ratio is within a range of 6:1-50:1.
EMBODIMENT 33 The aqueous treatment formulation of Embodiment 32, wherein said ratio is within a range of 6:1-35:1.
EMBODIMENT 34 The aqueous treatment formulation of Embodiment 24, wherein said ratio is within a range of 8:1-35:1.
EMBODIMENT 35 The aqueous treatment formulation of Embodiment 34, wherein said ratio is within a range of 8:1-25:1.
EMBODIMENT 36 The aqueous treatment formulation of any one of Embodiments 23 to 35, wherein the formulation comprises a concentration of polyethyleneimine, by weight, of at least 0.05%, at least 0.1% or at least 0.2/a, and optionally, at most 1% or at most 0.8%, at most 0.7% or at most 0.6%, at most 0.5% or within a range of 0.1 to 1%, 0.1 to 0.8%, 0.1 to 0.7%, 0.1 to 0.6%, 0.1 to 0.5%, 0.2 to 0.7%, 0.2 to 0.6%, or 0.2 to 0.5%.
EMBODIMENT 37 The aqueous treatment formulation of any one of Embodiments 23 to 36, wherein the polyethyleneimine has an average molecular weight of at least 200,000, at least 350,000, at least 500,000, at least 700,000, and optionally, at most 3,000,000, at most 2,500,000, or at most 2,000,000.
EMBODIMENT 38 The aqueous treatment formulation of any one of Embodiments 23 to 37, wherein the ratio by weight of the modified polysaccharide to the polyethyleneimine is 5-200:1, or 5-50:1, or 7-35:1, or 10-20:1.
EMBODIMENT 39 The aqueous treatment formulation of any one of Embodiments 1 to 38, wherein said formulation comprises at least one carrier liquid containing water, said water making up at least 50% or at least 55% or at least 60% or at least 65% of the aqueous treatment formulation, on a weight-weight basis.
EMBODIMENT 40 The aqueous treatment formulation of Embodiment 39, wherein said water making up at least 55% of the aqueous treatment formulation, on a weight-weight basis.
EMBODIMENT 41 The aqueous treatment formulation of any one of Embodiments 1 to 40, wherein said formulation further comprises at least one surfactant.
EMBODIMENT 42 The aqueous treatment formulation of Embodiment 41, wherein said surfactant is one or more of a non-ionic surfactant and a silicone surfactant.
EMBODIMENT 43 The aqueous treatment formulation of any one of Embodiments 1 to 42, wherein the formulation further comprises a first non-ionic surfactant having a solubility in water of at least 5% or at least 7% by weight, at 25° C., a silicone surfactant, or both.
EMBODIMENT 44 The aqueous treatment formulation of Embodiment 43, wherein the formulation contains at least 5%, at least 6%, at least 7%, at least 8%, at least 9%, or at least 10%, by weight, of said first non-ionic surfactant.
EMBODIMENT 45 The aqueous treatment formulation of Embodiment 43 or 44, wherein the formulation contains at most 18%, at most 16%, at most 15%, at most 14%, or at most 13%, by weight, of said first non-ionic surfactant.
EMBODIMENT 46 The aqueous treatment formulation of any one of Embodiments 42 to 45, wherein the solubility in water of said first non-ionic surfactant, at 25° C., is at least 8%, at least 10%, at least 12%, at least 15%, at least 20%, at least 25%, or at least 30%, and optionally, at most 80% or at most 60%.
EMBODIMENT 47 The aqueous treatment formulation of Embodiment 42, wherein the non-ionic surfactant within said aqueous treatment formulation, by weight, is within a range of 5.5-18%, 5.5-16%, 6.5-18%, 6.5-16%, 7.5-18%, 7.5-16%, 8.5-18%, 8.5-16%, 9.5-18%, 9.5-16%, 10.5-18%, or 10.5-16%.
EMBODIMENT 48 The aqueous treatment formulation of any one of Embodiments 42 to 47, wherein a cloud point temperature of said first non-ionic surfactant is at least 60° C., at least 70° C., at least 80° C., at least 90° C., at least 100° C., at least 105° C., at least 110° C., at least 115° C., at least 120° C., or at least 130° C., optionally as determined by the ASTM D7689-11 test method.
EMBODIMENT 49 The aqueous treatment formulation of any one of Embodiments 1 to 48, wherein the formulation further comprises a second, or said, non-ionic silicone-containing surfactant.
EMBODIMENT 50 The aqueous treatment formulation of Embodiment 49, wherein said non-ionic silicone-containing surfactant has a solubility in water of at least 1%, at 25° C.
EMBODIMENT 51 The aqueous treatment formulation of Embodiment 49 or 50, wherein said non-ionic silicone-containing surfactant is a polysiloxane-polyoxyalkylene copolymer, and wherein optionally, a concentration of said polysiloxane-polyoxyalkylene copolymer is at least 0.3%, at least 0.5%, at least 0.75%, or at least 1.0%, by weight, and yet further optionally, at most 5%, at most 4%, at most 3%, at most 2.5%, at most 2%, or at most 1.75%, by weight.
EMBODIMENT 52 The aqueous treatment formulation of any one of Embodiment 41 to 51, wherein said formulation comprises at least 5%, by weight, of a first non-ionic surfactant having a solubility in water of at least 7%, at 25° C. and a second non-ionic, silicone-containing surfactant having a solubility in water of at least 1%, at 25° C.
EMBODIMENT 53 The aqueous treatment formulation of any one of Embodiments 41 to 52, wherein the aqueous formulation has a total surfactant concentration of at least 0.3%, at least 0.5%, at least 0.75%, at least 1%, at least 2%, at least 3%, at least 4%, at least 5%, at least 6%, at least 7%, at least 8%, at least 9%, at least 10%, at least 11%, at least 12% and optionally, within a range of 6 to 40%, 6 to 30%, 6 to 20%, 7 to 30%, 7 to 20%, 7 to 15%, 8 to 25%, 8 to 20%, 8 to 15%, 8 to 13%, 9 to 25%, 9 to 20%, 9 to 15%, 9 to 13%, 10 to 25%, 10 to 20%, 10 to 15%, or 10 to 13%.
EMBODIMENT 54 The aqueous treatment formulation of any one of Embodiments 1 to 53, wherein said aqueous formulation having the following properties:

i. a static surface tension within a range of 20 and 40 mN/m at 25° C.;

ii. a 25° C. dynamic viscosity that is at least 10 cP; and

iii. a 60° C. evaporation load of at most 7.5:1, by weight.

EMBODIMENT 55 The aqueous treatment formulation of any one of Embodiments 1 to 54, wherein said formulation further comprises at least one humectant optionally being a sugar.
EMBODIMENT 56 The aqueous treatment formulation of any one of Embodiments 1 to 55, wherein said formulation comprises a modified polysaccharide in an amount of at least 1.5% or 2.0% or 2.5% or 3.0%, by weight.
EMBODIMENT 57 The aqueous treatment formulation of any one of Embodiments 1 to 56, wherein said formulation has a static surface tension within a range of 25 and 40 mN/m at 25° C.
EMBODIMENT 58 The aqueous treatment formulation of any one of Embodiments 1 to 56, wherein said formulation has a 25° C. dynamic viscosity that is at least 10 mPa·s, or at least 12 mPa·s, or at least 14 mPa·s or within a range of 10 mPa·s to 100 mPa·s, 12 to 100 mPa·s, 14 to 100 mPa·s, 10 to 60 mPa·s, or 12 to 40 mPa·s.
EMBODIMENT 59 The aqueous treatment formulation of any one of Embodiments 1 to 58, further comprising at least one antibacterial agent.
EMBODIMENT 60 The aqueous treatment formulation of any one of Embodiments 1 to 59, wherein said particulate material is provided in a form of an emulsion and/or a dispersion and wherein a concentration of said emulsion and/or dispersion within the aqueous treatment formulation is at least about 0.5% and at most about 15%, by weight relative to the total weight of the formulation.
EMBODIMENT 61 The aqueous treatment formulation of any one of Embodiments 1 to 60, wherein said particulate material have a particle size (diameter or longest axis) of between about 1 nm to about 500 nm.
EMBODIMENT 62 The aqueous treatment formulation of any one of Embodiments 1 to 61, wherein said particulate material is homogeneously dispersed in the aqueous formulation.
EMBODIMENT 63 The aqueous treatment formulation of any one of Embodiments 1 to 62, wherein said thermosetting polymeric particulate material is a hydrophobic particulate material.
EMBODIMENT 64 The aqueous treatment formulation of Embodiment 63, wherein said hydrophobic particulate material is a polymer selected from polytetrafluoroethylene (PTFE), perfluoroalkoxy alkane (PFA) or fluorinated ethylene propylene (FEP).
EMBODIMENT 65 The aqueous treatment formulation of Embodiment 64, wherein said hydrophobic particulate material is PTFE (i.e., Teflon).
EMBODIMENT 66 The aqueous treatment formulation of Embodiment 65, wherein the PTFE particulate material is of a size (diameter or longest axis) of between about 1 to about 500 nm.
EMBODIMENT 67 The aqueous treatment formulation of Embodiment 66, wherein the PTFE particulate material is of a size of between about 50 nm to about 200 nm.
EMBODIMENT 68 The aqueous treatment formulation of any one of Embodiments 64 to 67, wherein the PTFE particulate material is of a size of about 200 nm and is provided in a form of a dispersion, wherein the concentration of the dispersion thereof within the aqueous treatment formulation is between about 4% to about 12%, by weight relative to the total weight of the formulation.
EMBODIMENT 69 The aqueous treatment formulation of any one of Embodiments 64 to 67, wherein the PTFE particulate material is of a size of about 300 nm to about 400 nm and is provided in a form of a dispersion, wherein the concentration of the dispersion thereof within the aqueous formulation is about 8%, by weight relative to the total weight of the formulation.
EMBODIMENT 70 The aqueous treatment formulation of Embodiment 68 or 69, wherein the PTFE dispersion is an aqueous dispersion having the following properties:

i. Viscosity—about 13 cP

ii. Surface tension—about 31.4 mN/m

iii. pH—about 9.95

iv. Solid content—about 60%

v. Particle size—about 200 nm.

EMBODIMENT 71 The aqueous treatment formulation of any one of Embodiments 1 to 70, wherein said thermoplastic polymeric particulate material is a wax particulate material.
EMBODIMENT 72 The aqueous treatment formulation of Embodiment 71, wherein said wax particulate material is an oxidized polyethylene wax particulate material.
EMBODIMENT 73 The aqueous treatment formulation of Embodiment 72, wherein said particulate oxidized polyethylene wax is of a size of between about 1 nm to about 500 nm, said size being of the diameter or the longest axis thereof.
EMBODIMENT 74 The aqueous treatment formulation of Embodiment 73, wherein said particulate oxidized polyethylene wax is of a size of about 1 to about 500 nm and is provided in the form of an emulsion, wherein the concentration of the emulsion thereof within the aqueous formulation is between about 1.5% to about 5%, by weight relative to the total weight of the formulation.
EMBODIMENT 75 The aqueous treatment formulation of any one of Embodiments 72 to 74, wherein said particulate oxidized polyethylene wax has a glass transition temperature (Tg) value of about 130° C.
EMBODIMENT 76 The aqueous treatment formulation of any one of Embodiments 1 to 75, wherein said at least one thermoplastic polymeric particulate material is provided in a form of an emulsion, optionally wherein said emulsion being a cationic emulsion.
EMBODIMENT 77 The aqueous treatment formulation of Embodiment 76, wherein said cationic emulsion is an emulsion of a particulate oxidized polyethylene wax.
EMBODIMENT 78 The aqueous treatment formulation of Embodiment 76 or 77, wherein said cationic emulsion of a particulate oxidized polyethylene wax has the following properties:

i. Viscosity—about 80 cP at 20° C.

ii. Density—about 1 g/cm³

iii. pH—about 9.5 at about 1% concentration

iv. Solid content—about 25-29%

v. Particle size—below about 500 nm.

EMBODIMENT 79 The aqueous treatment formulation of any one of Embodiments 1 to 75, wherein said thermoplastic polymeric particulate material is a coated wax particulate material.
EMBODIMENT 80 The aqueous treatment formulation of Embodiment 79, wherein said coated wax particulate material is a particulate wax material coated with silicon dioxide.
EMBODIMENT 81 The aqueous treatment formulation of Embodiment 79 or 80, wherein said coated wax particulate material is of a size of about 100 nm, said size being of the diameter or the longest axis thereof, and is provided in a form of a dispersion, wherein the concentration of the dispersion thereof within the aqueous formulation is at least about 10%, by weight relative to the total weight of the formulation.
EMBODIMENT 82 The aqueous treatment formulation of any one of Embodiments 79 to 81, wherein said coated wax particulate material has a glass transition temperature (Tg) value of about 125° C.
EMBODIMENT 83 The aqueous treatment formulation of any one of Embodiments 1 to 82, wherein said particulate material is capable of improving at least one mechanical property of a printed product and/or pattern produced by utilizing the aqueous treatment formulation with the intermediate transfer member of the printing system, wherein the improvement in the mechanical property is in comparison with a printed product and/or pattern produced by utilizing an aqueous treatment formulation identical to the aqueous treatment formulation of any one of Embodiments 1 to 82 but lacking said particulate material.
EMBODIMENT 84 The aqueous treatment formulation of Embodiment 83, wherein said mechanical property is rub resistance.
EMBODIMENT 85 A method of indirect printing comprising:
a. providing an intermediate transfer member comprising a release layer surface;
b. providing the aqueous treatment formulation of any one of Embodiments 1 to 84;
c. applying the aqueous treatment formulation onto the ITM release layer surface to form thereon a wet layer having a thickness of at most about 1.0 μm;
d. subjecting the wet layer to a drying process to form a dried film layer, from the wet layer, on the ITM release layer surface, said dried film layer optionally having a thickness of at least about 20 nm and at most about 200 nm;
c. depositing droplets of an aqueous ink onto the dried film to form an ink image on the release layer surface of the ITM release layer surface;
f, optionally drying the ink image to leave an ink-image residue on the ITM release layer surface; and
g. transferring the ink-image residue onto a printing substrate by pressured contact between the ITM and the printing substrate.
EMBODIMENT 86 The method of Embodiment 85, wherein the particulate material has a particle size (diameter or longest axis) of between about 1 nm to about 500 nm.
EMBODIMENT 87 The method of Embodiment 86, wherein said particulate material has substantially two dimensional disc-like shape (i.e., with a diameter constituting the longest access of the particulate material).
EMBODIMENT 88 The method of any one of Embodiments 85 to 87, wherein in said dried film on the ITM release layer surface the diameter or longest axis of said particulate material is substantially parallel to the ITM.
EMBODIMENT 89 The method of any one of Embodiments 85 to 88, wherein a thickness of the dried film onto which the aqueous ink droplets are deposited is at most 200 nm, at most 120 nm, at most 100 nm, at most 80 nm, at most 70 nm, at most 60 nm, at most 50 nm, at most 45 nm, or at most 40 nm.
EMBODIMENT 90 The method of any one of Embodiments 85 to 89, wherein a thickness of the dried treatment film onto which the aqueous ink droplets are deposited is at least 15 nm or at least 20 nm or at least 25 nm or at least 30 nm.
EMBODIMENT 91 The method of any one of Embodiments 85 to 90, wherein a thickness of the dried treatment film onto which the aqueous ink droplets are deposited is at most about 50 nm.
EMBODIMENT 92 The method of any one of Embodiments 85 to 90, wherein a thickness of the dried treatment film onto which the aqueous ink droplets are deposited is at most about 100 nm.
EMBODIMENT 93 The method of any one of Embodiments 85 to 90, wherein a thickness of the dried treatment film onto which the aqueous ink droplets are deposited is at most about 120 nm.
EMBODIMENT 94 The method of any one of Embodiments 85 to 90, wherein a thickness of the dried treatment film onto which the aqueous ink droplets are deposited is at most about 150 nm.
EMBODIMENT 95 The method of any one of Embodiments 85 to 94, wherein the dried treatment film is continuous over an entirety of a rectangle of the release surface of the ITM, wherein said rectangle has a width of at least 10 cm and a length of at least 10 meters.
EMBODIMENT 96 The method of Embodiment 95, wherein the dried treatment film for at least 50% or at least 75% or at least 90% or at least 95% at least 95% or at least 99% or 100% of an area of the rectangle, a thickness of the dried treatment film does not deviate from an average thickness value within the rectangle by more than 50% or more than 40% or more than 30%.
EMBODIMENT 97 The method of any one of Embodiments 85 to 96, wherein the ink-image residue is transferred together with non-printed areas of the dried treatment film onto the printing substrate.
EMBODIMENT 98 The method of any one of Embodiments 85 to 97, wherein the dried treatment film is sufficiently cohesive such that during transfer of the ink-image residue, the dried treatment film completely separates from the ITM and transfers to the printing substrate with the dried ink image, both in printed and non-printed areas.
EMBODIMENT 99 The method of any one of Embodiments 85 to 98, wherein said ITM is an hydrophobic ITM.
EMBODIMENT 100 The method of any one of Embodiments 85 to 99, wherein said ITM comprises a silicone-based release layer surface that is sufficiently hydrophilic to satisfy at least one of the following properties:

(i) a receding contact angle of a drop of distilled water deposited on the silicone-based release layer surface is at most 60°; and

(ii) a 10-second dynamic contact angle (DCA) of a drop of distilled water deposited on the silicone-based release layer surface is at most 108°.

EMBODIMENT 101 The method of any one of Embodiments 85 to 100, wherein said dried film layer has a thickness of at least about 20 nm and at most about 200 nm.
EMBODIMENT 102 The method of any one of Embodiments 85 to 101, wherein said method provides a printed product and/or pattern with improved one or more mechanical property, wherein the improvement in the one or more mechanical property is in comparison with a printed product produced by utilizing said method but in the absence of said particulate material.
EMBODIMENT 103 The method of Embodiment 102, wherein said mechanical property is rub resistance.
EMBODIMENT 104 A system for printing, the system comprising:
a. an intermediate transfer member comprising a release layer surface;
b. a quantity of the aqueous treatment formulation according to any one of Embodiments 1 to 82;
c. a treatment station for applying the aqueous formulation to the ITM surface to form thereon a wet layer having a thickness of at most about 1.0 μm;
d. an image forming station for forming ink images on the ITM by depositing droplets of an aqueous ink upon the ITM surface after the wet layer has dried into a dried film so that the droplets are applied to the dried film, said dried film layer optionally having a thickness of at least about 20 nm and at most about 200 nm; and
e. a transfer station for transferring the ink images from the ITM to a substrate.
EMBODIMENT 105 The system according to Embodiments 104, wherein said dried film layer has a thickness of at least about 20 nm and at most about 200 nm.
EMBODIMENT 106 A printing system comprising:
a. an intermediate transfer member comprising a flexible endless belt mounted over a plurality of guide rollers;
b. an image forming station configured to form ink images upon a surface of the ITM, first and second of the guide rollers being arranged upstream and downstream of the image forming station to define an upper run passing through the image forming station and a lower run;
c. an impression station through which the lower run of the ITM passes, the impression station being disposed downstream of the image forming station and configured to transfer the ink images from the ITM surface to substrate; and
d. a treatment station disposed downstream of the impression station and upstream of the image forming station for forming a uniform thin layer of a liquid formulation onto the ITM surface at the lower run thereof, the treatment station comprising:
e. a coater for coating the ITM with the aqueous treatment formulation according to any one of Embodiments 1 to 82; and
f. a coating thickness-regulation assembly for removing excess liquid so as to leave only a desired uniform wet thin layer of the formulation, said layer having a thickness of at most about 1.0 μm, the coating thickness-regulation assembly comprising a rounded tip facing the ITM surface at the lower run.
EMBODIMENT 107 The system of any one of Embodiments 104 to 106, wherein said ITM is an hydrophobic ITM.
EMBODIMENT 108 The system of any one of Embodiments 104 to 107, wherein said ITM comprises a silicone-based release layer surface that is sufficiently hydrophilic to satisfy at least one of the following properties:

(i) a receding contact angle of a drop of distilled water deposited on the silicone-based release layer surface is at most 60°; and

(ii) a 10-second dynamic contact angle (DCA) of a drop of distilled water deposited on the silicone-based release layer surface is at most 108°.

EMBODIMENT 109 A method of improving at least one mechanical property of a printed ink image (on a substrate) comprising:
a. providing an intermediate transfer member comprising a release layer surface;
b. providing an aqueous treatment formulation according to any one of Embodiments 1 to 82;
c. applying the aqueous treatment formulation onto the ITM release layer surface to form thereon a wet (treatment) layer having a thickness of at most about 1.0 μm:
d, optionally subjecting the wet (treatment) layer of (c) to a drying process to form a dried (treatment) film layer, from the wet (treatment) layer, on the ITM release layer surface, said dried film layer optionally having a thickness of at least about 20 nm and at most 200 nm;
e. depositing droplets of an aqueous ink onto the optionally dried (treatment) film to form an ink image on the release layer surface of the ITM release layer surface;
f. drying the ink image to leave an ink-image residue on the ITM release layer surface; and
g. transferring the ink-image residue onto a printing substrate by pressured contact between the ITM and the printing substrate;
to thereby produce a printed ink image on a substrate, wherein said printed ink image has at least one mechanical property improved compared to an ink image produced with said aqueous formulation but without the particulate material.
EMBODIMENT 110 The method according to Embodiment 109, wherein said dried film layer has a thickness of at least about 20 nm and at most about 200 nm.
EMBODIMENT 111 The method of Embodiment or 110, wherein said mechanical property is rub resistance.
EMBODIMENT 112 A kit for printing with an indirect printing system, the kit comprising:
a. an intermediate transfer member comprising a release layer surface; and
b. a quantity of an aqueous treatment formulation according to any one of Embodiments 1 to 82.
EMBODIMENT 113 A printed article comprising:

(i) a substrate;

(ii) one or more ink dots fixedly adhered to at least a region of a surface of said substrate, said ink dot may be continuous thereby forming an ink film on said substrate or may be spaced apart from each other;

wherein said one or more ink dots and said at least a region of said surface of said substrate are covered with a substantially dry film layer optionally having a thickness of at least about 20 nm and at most about 200 nm and wherein said substantially dry film layer comprises one or more of (i) at least one thermoplastic polymeric particulate material; and (ii) at least one thermosetting polymeric particulate material.

EMBODIMENT 114 The printed article of Embodiment 113, wherein said substrate is selected from the group consisting of an uncoated fibrous printing substrate, a commodity coated fibrous printing substrate, plastic, polyethylene terephthalate (PET), polyethylene (PE), biaxially oriented polypropylene (BOPP), aluminum and any combinations thereof.
EMBODIMENT 115 The printed article of Embodiment 114, wherein said substrate is a paper, optionally selected from the group of papers consisting of bond paper, uncoated offset paper, coated offset paper, copy paper, ground wood paper, coated ground wood paper, freesheet paper, coated freesheet paper and laser paper.
EMBODIMENT 116 The printed article of any one of Embodiments 113 to 115, wherein said particulate material have a particle size (diameter or longest axis) of between about 1 nm to about 500 nm.
EMBODIMENT 117 The printed article of any one of Embodiments 113 to 116, wherein said particulate material have substantially two dimensional disc-like shape (i.e., with a diameter constituting the longest access of the particulate material).
EMBODIMENT 118 The printed article of any one of Embodiments 113 to 117, wherein the diameter or longest axis of said particulate material is substantially parallel to said surface of the substrate.
EMBODIMENT 119 The printed article of any one of Embodiments 113 to 118, wherein said substantially dry film layer has a thickness of at least about 20 nm and at most about 200 nm.
EMBODIMENT 120 The printed article of Embodiment 119, wherein the thickness of said dry film layer is at most 200 nm, at most 120 nm, at most 100 nm, at most 80 nm, at most 70 nm, at most 60 nm, at most 50 nm, at most 45 nm, or at most 40 nm.
EMBODIMENT 121 The printed article of any one of Embodiments 113 to 120, wherein the thickness of said dry film layer at least 15 nm or at least 20 nm or at least 25 nm or at least 30 nm.
EMBODIMENT 122 The printed article of any one of Embodiments 113 to 121, wherein the thickness of said dry film is at most about 50 nm.
EMBODIMENT 123 The printed article of any one of Embodiments 113 to 121, wherein the thickness of said dry film is at most about 100 nm.
EMBODIMENT 124 The printed article of any one of Embodiments 113 to 121, wherein the thickness of said dry film is at most about 120 nm.
EMBODIMENT 125 The printed article of any one of Embodiments 113 to 121, wherein the thickness of said dry film is at most about 150 nm.
EMBODIMENT 126 The printed article of any one of Embodiments 113 to 125, wherein said dry film is continuous over an entirety of said surface of said substrate (e.g., covering region with or without ink dots).
EMBODIMENT 127 The printed article of any one of Embodiments 113 to 126, wherein said dry film layer covers at least 50% or at least 75% or at least 90% or at least 95% at least 95% or at least 99% or 100% of said surface.
EMBODIMENT 128 The printed article of any one of Embodiments 113 to 127, wherein said thermosetting polymeric particulate material is a hydrophobic particulate material.
EMBODIMENT 129 The printed article of Embodiment 128, wherein said hydrophobic particulate material is a polymer selected from polytetrafluoroethylene (PTFE), perfluoroalkoxy alkane (PFA) or fluorinated ethylene propylene (FEP).
EMBODIMENT 130 the printed article of Embodiment 129, wherein said hydrophobic particulate material is PTFE (i.e., Teflon).
EMBODIMENT 131 The printed article of Embodiment 130, wherein the PTFE particulate material is of a size (diameter or longest axis) of between about 1 to about 500 nm.
EMBODIMENT 132 The printed article of Embodiment 131, wherein the PTFE particulate material is of a size of between about 50 nm to about 200 nm.
EMBODIMENT 133 The printed article of any one of Embodiments 113 to 132, wherein said thermoplastic polymeric particulate material is a wax particulate material.
EMBODIMENT 134 The printed article of Embodiment 133, wherein said wax particulate material is an oxidized polyethylene wax particulate material.
EMBODIMENT 135 The printed article of Embodiment 134, wherein said particulate oxidized polyethylene wax is of a size (diameter or longest axis) of between about 1 nm to about 500 nm.
EMBODIMENT 136 The printed article of Embodiment 134 or 135, wherein said particulate oxidized polyethylene wax has a glass transition temperature (Tg) value of about 130° C.
EMBODIMENT 137 The printed article of any one of Embodiments 113 to 136, wherein said thermoplastic polymeric particulate material is a coated wax particulate material.
EMBODIMENT 138 The printed article of Embodiment 137, wherein said coated wax particulate material is a wax particulate material coated with silicon dioxide.
EMBODIMENT 139 The printed article of Embodiment 138, wherein said coated wax particulate material is of a size (diameter or longest axis) of about 100 nm.
EMBODIMENT 140 The printed article of Embodiment 138 or 139, wherein said coated wax particulate material has a glass transition temperature (Tg) value of about 125° C.
EMBODIMENT 141 The printed article of any one of Embodiments 113 to 140, wherein said film layer further comprises one or more of (i) at least one modified polysaccharide (substantially as disclosed herein); (ii) at least one surfactant (substantially as disclosed herein); (iii) at least one humectant (substantially as disclosed herein); (iv) at least one wetting agent (substantially as disclosed herein); and (v) at least one antibacterial agent (substantially as disclosed herein).
EMBODIMENT 142 The printed article of any one of Embodiments 113 to 141, wherein said article has improved one or more mechanical property in comparison with a printed article lacking said particulate material.
EMBODIMENT 143 The printed article of Embodiment 142, wherein said improved mechanical property is manifested in ink containing regions on said substrate.
EMBODIMENT 144 The printed article of Embodiment 142 or 143, wherein said improved mechanical property is manifested in regions of the surface of said substrate which are coated with said substantially dry film layer and are free of ink (ink fire).
EMBODIMENT 145 The printed article of any one of Embodiment 142 to 144, wherein said mechanical property is selected from one or more of rub resistance, coefficient of friction, scratch resistance and surface tack.
EMBODIMENT 146 The printed article of Embodiment 145, wherein said mechanical property is rub resistance.
EMBODIMENT 147 The printed article of Embodiment 145, wherein said mechanical property is coefficient of friction.
EMBODIMENT 148 The printed article of any one of Embodiments 113 to 147, wherein the particulate material is embedded in said dry film layer with substantially no protrusion thereof from the surface of said layer, said surface being the surface distal to the surface of the substrate.
EMBODIMENT 149 The printed article of any one of Embodiments 113 to 148, wherein said one or more ink dots form a continues ink film on said substrate.
EMBODIMENT 150 The printed article of any one of Embodiments 113 to 149, produced according to the method of any one of Embodiments 85 to 103.
EMBODIMENT 151 The printed article of any one of Embodiments 113 to 145, wherein said film layer further comprises at least one modified polysaccharide (substantially as disclosed herein).
EMBODIMENT 152 An intermediate transfer member comprising a release layer surface, wherein said surface is substantially covered with a substantially dry continuous film layer comprising one or more of (i) at least one thermoplastic polymeric particulate material (substantially as disclosed herein) and (ii) at least one thermosetting polymeric particulate material (substantially as disclosed herein), and wherein the thickness of said substantially dry continuous film layer being of at least about 20 nm and at most about 200 nm.
EMBODIMENT 153 The intermediate transfer member of Embodiment 152, wherein the substantially dry film layer covers at least 50% or at least 75% or at least 90% or at least 95% at least 95% or at least 99% or 100% of the intermediate transfer member release layer surface.
EMBODIMENT 154 The intermediate transfer member of Embodiment 152 or 153, wherein said substantially dry film layer further comprises one or more of (i) at least one modified polysaccharide (substantially as disclosed herein); (ii) at least one surfactant (substantially as disclosed herein), (iii) at least one humectant (substantially as disclosed herein); (iv) at least one wetting agent (substantially as disclosed herein); and (v) at least one antibacterial agent (substantially as disclosed herein).
EMBODIMENT 155 The intermediate transfer member of any one of Embodiments 152 to 154 wherein said substantially dry film layer further comprises at least one modified polysaccharide.
EMBODIMENT 156 The intermediate transfer member of any one of Embodiments 152 to 155 wherein the particulate material is embedded in the substantially dry film layer with substantially no protrusion thereof from the surface of said layer.
EMBODIMENT 157 The intermediate transfer member of any one of Embodiments 152 to 156, wherein said intermediate transfer member is an hydrophobic intermediate transfer member.
EMBODIMENT 158 The intermediate transfer member of any one of Embodiments 152 to 157, wherein said release layer surface is a silicone-based release layer surface that is sufficiently hydrophilic to satisfy at least one of the following properties:

(i) a receding contact angle of a drop of distilled water deposited on the silicone-based release layer surface is at most 60°; and

(ii) a 10-second dynamic contact angle (DCA) of a drop of distilled water deposited on the silicone-based release layer surface is at most 108°.

EMBODIMENT 1A. An aqueous treatment formulation for an image transfer member in an aqueous ink imaging system, the formulation comprising:

a. a modified polysaccharide or cellulose ether having a solubility in water, or within the aqueous treatment formulation, of at least 1.5%, or at least 2%, or at least 3%, or at least 4%, or at least 5%, or at least 7%, or at least 8%, or at least 10%, by weight, at 25° C., and at least one or more of the following characteristics:

i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C., at most 105° C., or between 60-120° C., or between 60-110° C., or between 60-100° C., or between 65-110° C., or between 65-105° C., or between 65-100° C., or between 70-110° C., or between 70-100° C., or between 75-110° C., or between 75-100° C., or between 80-100° C.:

ii. a viscosity, in mPa·s, as measured in 2% concentration by weight in water at 25° C., is at most 11, at most 10, at most 9, at most 8, at most 7, at most 6, at most 5, at most 4, and optionally, at least 0.5 or at least 1, or at least 2, or within a range of 0.5-10, 1-8, 2-8, 2-5, or 2-4;

b. water; and

c, optionally including at least one of, or two of or all three of: a water absorbing agent, a surfactant, and a polyethyleneimine (PEI).

EMBODIMENT 2A. The aqueous treatment formulation of embodiment 1A, wherein the modified polysaccharide is, or includes, a methylcellulose.
EMBODIMENT 3A. The aqueous treatment formulation of any one of embodiments 1A-2A, wherein the formulation includes said polyethyleneimine.
EMBODIMENT 4A. The aqueous treatment formulation of any one of embodiments 1A-3A, wherein the temperature of gelation as measured at 2% concentration by weight in water is at least 50° C.
EMBODIMENT 5A. The aqueous treatment formulation of any one of embodiments 1A-4A, wherein the viscosity, in mPa·s, as measured in 2% concentration by weight in water at 25° C., is at most 11.
EMBODIMENT 6A. An aqueous treatment formulation for an image transfer member in an aqueous ink imaging system, the formulation comprising:
(a) a modified polysaccharide or cellulose ether having a solubility in water, or within the aqueous treatment formulation, of at least 1.5% or at least 2%, or at least 3% or at least 4%, or at least 5%, or at least 7%, or at least 8%, or at least 10%, by weight, at 25° C.;
(b) a polyethyleneimine (PEI); and
(c) a carrier liquid containing water, said water making up at least 50% or at least 55% or at least 60% or at least 65% of the aqueous treatment formulation, on a weight-weight basis:

said aqueous treatment formulation optionally including at least one of, at least two of, or all of: a water absorbing agent; a non-ionic surfactant; and a silicone surfactant.

EMBODIMENT 7A. The aqueous treatment formulation of embodiment 3A or 6A, wherein a ratio of said modified polysaccharide or cellulose ether to polyethyleneimine is within a range of 4:1-200:1, by weight.
EMBODIMENT 8A. The aqueous treatment formulation of embodiment 7A, wherein said ratio is within a range of 4:1-100:1.
EMBODIMENT 9A. The aqueous treatment formulation of embodiment 8A, wherein said ratio is within a range of 4:1-60:1.
EMBODIMENT 10A. The aqueous treatment formulation of embodiment 9A, wherein said ratio is within a range of 4:1-35:1.
EMBODIMENT 11A. The aqueous treatment formulation of embodiment 10A, wherein said ratio is within a range of 4:1-25:1.
EMBODIMENT 12A. The aqueous treatment formulation of embodiment 8A, wherein said ratio is within a range of 5:1-100:1.
EMBODIMENT 13A. The aqueous treatment formulation of embodiment 12A, wherein said ratio is within a range of 5:1-50:1.
EMBODIMENT 14A. The aqueous treatment formulation of embodiment 13A, wherein said ratio is within a range of 5:1-35:1.
EMBODIMENT 15A. The aqueous treatment formulation of embodiment 13A, wherein said ratio is within a range of 6:1-50:1.
EMBODIMENT 16A. The aqueous treatment formulation of embodiment 15A, wherein said ratio is within a range of 6:1-35:1.
EMBODIMENT 17A. The aqueous treatment formulation of embodiment 16A, wherein said ratio is within a range of 8:1-35:1.
EMBODIMENT 18A. The aqueous treatment formulation of embodiment 17A, wherein said ratio is within a range of 8:1-25:1.
EMBODIMENT 19A. The aqueous treatment formulation of any one of embodiments 1A to 18A, wherein the treatment formulation includes said water absorbing agent.
EMBODIMENT 20A. The aqueous treatment formulation of any one of embodiments 1A to 19A, wherein the treatment formulation includes said surfactant.
EMBODIMENT 21A. The aqueous treatment formulation of any one of embodiments 1A to 20A, wherein said modified polysaccharide is a methylcellulose.
EMBODIMENT 22A. The aqueous treatment formulation of any one of embodiments 1A to 21A, wherein said modified polysaccharide is a non-thermoplastic polymer.
EMBODIMENT 23A. The aqueous treatment formulation of any one of embodiments 1A to 22A, wherein said modified polysaccharide includes a charged polysaccharide.
EMBODIMENT 24A. The aqueous treatment formulation of embodiment 23A, wherein said charged polysaccharide is or includes an acidic polysaccharide optionally containing carboxyl groups and/or sulfuric ester groups.
EMBODIMENT 25A. The aqueous treatment formulation of embodiment 23A, wherein said charged polysaccharide is or includes a positively charged polysaccharide.
EMBODIMENT 26A. The aqueous treatment formulation of any one of embodiments 1A to 25A wherein said modified polysaccharide has a structure:

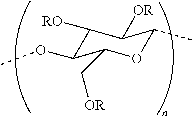

wherein
n is an integer being of 3 or more; and
R is selected from the group consisting of: H, CH₃, CH₂COOH, CH₂CH(OH)CH₃, CH₂CH(OH)CH₃, wherein the various R groups may be the same or different.
EMBODIMENT 27A. The aqueous treatment formulation of any one of embodiments 1A to 26A, wherein said modified polysaccharide is a cellulose derivative.
EMBODIMENT 28A. The aqueous treatment formulation of embodiment 27A, wherein said cellulose derivative is a methylcellulose and wherein at least a 2% of R is a methyl (CH₃) group.
EMBODIMENT 29A. The aqueous treatment formulation of embodiment 28A, wherein said methylcellulose is a hydroxypropyl methylcellulose (HPMC).
EMBODIMENT 30A. The aqueous treatment formulation of embodiments 6A-29A, wherein the modified polysaccharide, cellulose derivative, methyl cellulose or HPMC has at least one of the following characteristics:

i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C., or at most 105° C., or between 60-120° C., or 60-110° C., or 60-100° C., or 65-110° C., or 65-105° C., or 65-100° C., or 70-110° C., or 70-100° C., or 75-110° C., or 75-100° C., or 80-100° C.;

ii. a viscosity in mPa·s, as measured in 2% concentration by weight in water at 25° C., of at most 11, at most 10, at most 9, at most 8, at most 7, at most 6, at most 5, at most 4, and optionally, at least 0.5 or at least 1, or at least 2 or a viscosity within a range of 0.5-10, 1-8, 2-8, 2-5, or 2-4;

iii. a hydroxypropyl substitution of at least 1%, 2%, 4%, 6%, 7% or between 1-30%, 5-25%, 5-20%, 5-10%, 7-9% or 7.3-8.3% or a hydroxypropyl substitution, on a molar basis, of at least 0.1, or at least 0.15 or at least 0.2 or between 0.1-1.0, 0.1-0.9, 0.1-0.7 or 0.1-0.3;

iv. a number average molecular weight, in Daltons, of at most 13,000 or at most 12000, or at most 11000, or at most 10,000, or at most 9000, or at most 8000.

EMBODIMENT 31A. An aqueous treatment formulation for an image transfer member in an aqueous ink imaging system, the formulation comprising: a methylcellulose, a polyethyleneimine, a water absorbing agent, a surfactant, and a carrier liquid containing water.
EMBODIMENT 32A. The aqueous treatment formulation of embodiment 31A, wherein the methylcellulose is a hydroxypropyl methylcellulose.
EMBODIMENT 33A. The aqueous treatment formulation any one of embodiments 1A-32A, wherein the methylcellulose or hydroxypropyl methylcellulose has a temperature of gelation, as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C. and optionally, at most 120° C. at most 110° C., or at most 105° C. or between 60-120° C., or 60-110° C., or 60-100° C., or 65-110° C., or 65-105° C., or 65-100° C., or 70-110° C., or 70-100° C., or 75-110° C., or 75-100° C., or 80-100° C.
EMBODIMENT 34A. The aqueous treatment formulation of any one of embodiments 1A-33A, wherein the viscosity of the formulation is 15-30 or 20-25 or 20-25 mPa·s, as measured at 25° C.
EMBODIMENT 35A. The aqueous treatment formulation of any one of embodiments 28A or 31A-34A, wherein said methylcellulose has at least one of the following structural characteristics:

i. a hydroxypropyl substitution of at least 2%, or at least 4%, or at least 6%, or at least 7% or at most 20%, or at most 15%, or at most 14%, or at most 12% or between 4-15% or 7-12%:

ii. a hydroxypropyl molar substitution of more than 0.1 or more than 0.15 or more than 0.2; and

iii. a number average molecular weight, as measured in Daltons, of at most 13,000 or at most 12,000, or at most 11,000, or at most 10,000, or at most 9,000, or at most 8,000.

EMBODIMENT 36A. The aqueous treatment formulation of embodiment 31A-35A, wherein the formulation comprises a methylcellulose having a methoxyl substitution of less than 25%, or within a range of 15 to 25%.
EMBODIMENT 37A. The aqueous treatment formulation of any one of embodiments 1A-35A, wherein the formulation comprises a methylcellulose having a hydroxypropyl substitution within a range of 7 to 12%.
EMBODIMENT 38A. The aqueous treatment formulation of any one of embodiments 1A-37A, wherein the formulation comprises a concentration of polyethyleneimine, by weight, of at least 0.05%, at least 0.1% or at least 0.2%, and optionally, at most 1% or at most 0.8%, at most 0.7% or at most 0.6%, at most 0.5% or within a range of 0.1 to 1%, 0.1 to 0.8%, 0.1 to 0.7%, 0.1 to 0.6%, 0.1 to 0.50%0, 0.2 to 0.7%, 0.2 to 0.6%, or 0.2 to 0.5%.
EMBODIMENT 39A. The aqueous treatment formulation of any one of embodiments 1A-38A, wherein the polyethyleneimine has an average molecular weight of at least 200,000, at least 350,000, at least 500,000, at least 700,000, and optionally, at most 3,000,000, at most 2,500,000, or at most 2,000,000.
EMBODIMENT 40A. The aqueous treatment formulation of any one of embodiments 1A-39A, wherein the ratio by weight of the modified polysaccharide, cellulose derivative, or hydroxypropyl methylcellulose to the polyethyleneimine is 5-200:1, or 5-50:1, or 7-35:1, or 10-20:1.
EMBODIMENT 41A. The aqueous treatment formulation of any one of embodiments 1A-40A, wherein the formulation further comprises a first non-ionic surfactant having a solubility in water of at least 5% or at least 7% by weight, at 25° C., a silicone surfactant, or both.
EMBODIMENT 42A. The aqueous treatment formulation of embodiment 41A, wherein the formulation contains at least 6%, at least 7%, at least 8%, at least 9%, or at least 10%, by weight, of said first non-ionic surfactant.
EMBODIMENT 43A. The aqueous treatment formulation of embodiment 41A or 42A, wherein the formulation contains at most 18%, at most 16%, at most 15%, at most 14%, or at most 13%, by weight, of said first non-ionic surfactant.
EMBODIMENT 44A. The aqueous treatment formulation of embodiment 41A, wherein the non-ionic surfactant within said aqueous treatment formulation, by weight, is within a range of 5.5-18%, 5.5-16%, 6.5-18%, 6.5-16%, 7.5-18%, 7.5-16%, 8.5-18%, 8.5-16%, 9.5-18%, 9.5-16%, 10.5-18%, or 10.5-16%.
EMBODIMENT 45A. The aqueous treatment formulation of any one of embodiments 41A-44A, wherein a cloud point temperature of said first non-ionic surfactant is at least 60° C., at least 70° C., at least 80° C., at least 90° C., at least 100° C., at least 105° C., at least 110° C., at least 115° C., at least 120° C., or at least 130° C., optionally as determined by the ASTM D7689-11 test method.
EMBODIMENT 46A. The aqueous treatment formulation of any one of embodiments 1A-45A, wherein the formulation further comprises a second, or said, non-ionic silicone-containing surfactant, optionally a polysiloxane-polyoxyalkylene copolymer, and wherein further optionally, a concentration of said polysiloxane-polyoxyalkylene copolymer is at least 0.3%, at least 0.5%, at least 0.75%, or at least 1.0%, by weight, and yet further optionally, at most 5%, at most 4%, at most 3%, at most 2.5%, at most 2%, or at most 1.75%, by weight.
EMBODIMENT 47A. The aqueous treatment formulation of any one of embodiments 1A-46A, wherein the formulation further comprises a water absorbing agent which is optionally a sugar.
EMBODIMENT 48A. The aqueous treatment formulation of any one of embodiments 1A-47A, wherein the formulation comprises at most 0.3%, at most 0.1%, or is substantially devoid of any one or more of the following: a starch or specifically a waxy starch, a hygroscopic plasticizer, a non-ionic surfactant, a non-ionic silicone surfactant and a thermoplastic polymer and more specifically, PVA.
EMBODIMENT 49A. The aqueous treatment formulation of any one of embodiments 1A-48A, wherein the formulation contains a total percent solids, by weight of the formulation, of at least 8%, or at least 9%, or at least 10%, or at least 12% or at least 14%, or at least 16%, or at least 18%, or at least 20% or at most 30%, or at most 28%, or at most 26% or between 12-30% or between 14-30% or between 16-30% or between or between 12-28% or between 14-28% or between 16-28% or between 18-28%.
EMBODIMENT 50A. The aqueous treatment formulation of any one of embodiments 1A-49A, wherein the formulation comprises a cellulose derivative, or hydroxypropyl methylcellulose, in an amount of at least 1.5% or 2.0% or 2.5% or 3.0%, by weight.
EMBODIMENT 51A. The aqueous treatment formulation of any one of embodiments 1A-50A, wherein the formulation has a static surface tension within a range of 25 and 40 mN/m at 25° C.
EMBODIMENT 52A. The aqueous treatment formulation of any one of embodiments 1-51, wherein the formulation has a 25° C. dynamic viscosity that is at least 10 mPa·s, or at least 12 mPa·s, or at least 14 mPa·s or within a range of 10 mPa·s to 100 mPa·s, 12 to 100 mPa·s, 14 to 100 mPa·s, 10 to 60 mPa·s, or 12 to 40 mPa·s.
EMBODIMENT 53A. The formulation of any one of embodiments 1A-52A, wherein all components of said aqueous treatment formulation are completely dissolved at 25° C.
EMBODIMENT 54A. The formulation of any one of embodiments 1A-53A, wherein a total concentration of organic solvents within the provided aqueous treatment formulation is at most 3%, at most 2%, at most 1%, or at most 0.5%, by weight, or wherein the formulation is organic-solvent-free.
EMBODIMENT 55A. An aqueous treatment formulation for an image transfer member in an aqueous ink imaging system, the formulation comprising:

a. a modified polysaccharide or cellulose ether having a solubility in water, or within the aqueous treatment formulation, of at least 1.5%, or at least 2%, or at least 3%, or at least 4%, or at least 5%, or at least 7/o, or at least 8%, or at least 10%, by weight, at 25° C., and at least one or more of the following characteristics:

i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C. at most 105° C., or between 60-120° C., or between 60-110° C., or between 60-100° C., or between 65-110° C., or between 65-105° C., or between 65-100° C., or between 70-110° C., or between 70-100° C., or between 75-110° C., or between 75-100° C., or between 80-100° C.;

ii. a viscosity, in mPa·s, as measured in 2% concentration by weight in water at 25° C., is at most 11, at most 10, at most 9, at most 8, at most 7, at most 6, at most 5, at most 4, and optionally, at least 0.5 or at least 1, or at least 2, or within a range of 0.5-10, 1-8, 2-8, 2-5, or 2-4:

b. water; and

c, optionally including at least one of, or two of or all three of: a water absorbing agent, a nonionic surfactant, a silicone surfactant, and a polyethyleneimine (PEI).

EMBODIMENT 56A. The formulation of any one of embodiments 1A-55A, wherein the formulation comprises at most 0.3%, or at most 0.1% quaternary ammonium salts.
EMBODIMENT 57A. The formulation of embodiment 56A, wherein the formulation is substantially devoid of quaternary ammonium salts.
EMBODIMENT 58A. The formulation of any one of embodiments 1A-57 A, wherein the formulation comprises at most 0.3%, or at most 0.1% thermoplastic polymers.
EMBODIMENT 59A. The formulation of embodiment 58A, wherein the formulation is substantially devoid of thermoplastic polymers.
EMBODIMENT 60A. The formulation of any one of embodiments 1A-59A, wherein the formulation comprises at most 0.3%. polyvinyl alcohols (PVA).
EMBODIMENT 61A. The formulation of any one of embodiments 1A-59A, wherein the formulation comprises at most 0.1% polyvinyl alcohols (PVA).
EMBODIMENT 62A. The formulation of any one of embodiments 1A-59A, wherein the formulation comprises at most 0.3%, or at most 0.1% polyvinyl alcohols (PVA).
EMBODIMENT 63A. The formulation of embodiment 60, wherein the formulation is substantially devoid of polyvinyl alcohols (PVA).
EMBODIMENT 64A. The formulation of any one of embodiments 1A-51A, wherein the formulation comprises a total of at most 1%, at most 0.5%, at most 0.3%, or at most 0.1%, or is substantially devoid of all of the following: quaternary ammonium salts, starches, or specifically a waxy starch, thermoplastic polymers, and more specifically, PVA.
EMBODIMENT 65A. The formulation of any one of embodiments 1A-54A, wherein the formulation comprises at most 0.3%, at most 0.1%, or is substantially devoid of any methylcellulose without hydroxypropyl substitution.
EMBODIMENT 66A. The formulation of any one of embodiments 1A-54A, wherein the formulation comprises at most 0.3%, at most 0.1%, or is substantially devoid of, hygroscopic plasticizers.
EMBODIMENT 67A. The formulation of any one of embodiments 1A-54A, wherein the formulation comprises said PEI.
EMBODIMENT 68A. The formulation of any one of embodiments 1A-54A, wherein the formulation comprises said water absorbing agent.
EMBODIMENT 69A. The formulation of any one of embodiments 1A-54A, wherein the formulation comprises said nonionic surfactant.
EMBODIMENT 70A. The formulation of any one of embodiments 1A-54A, wherein the formulation comprises a silicone surfactant.
EMBODIMENT 71A. A method of indirect printing on a substrate, the method comprising: providing an intermediate transfer member (ITM); providing an aqueous treatment formulation of any one of embodiments 1A-55A or an aqueous treatment formulation substantially as disclosed herein; applying the aqueous treatment formulation to an image receiving surface of the ITM to form a wet treatment layer; partially drying the wet treatment layer to form an at least partially dry treatment layer; jetting aqueous ink droplets onto the partially dried treatment layer to form a wet ink image; partially drying the wet ink image on the aqueous treatment layer to form a partially dried ink image film; and transferring a partially dried ink image film to a printing substrate by pressured contact between said surface of the ITM and the printing substrate.
EMBODIMENT 72A. The method of indirect printing of embodiment 71A, the method further comprising: removing an ink-image residue from said image receiving surface, said ink-image residue including a treatment formulation residue from said aqueous treatment formulation.
EMBODIMENT 73A. The method of indirect printing of embodiment 72A, wherein at least 70%, at least 80%, at least 90/a, or substantially all of said treatment formulation residue is removed by redissolution.
EMBODIMENT 74A. The method of indirect printing of embodiment 72A or embodiment 73A, wherein at least 70%, at least 80%, at least 90%, or substantially all of said ink-image residue is removed by redissolution.
EMBODIMENT 75A. The method of indirect printing of any one of embodiments 71A to 74A, wherein the method is devoid of any mechanical cleaning or mechanical residue removal operations.
EMBODIMENT 76A. The method of indirect printing of any one of embodiments 71A to 75A, wherein said aqueous treatment formulation is selected such that said wet treatment layer is in a form of an aqueous gel layer on said image receiving surface.
EMBODIMENT 77A. The method of indirect printing of embodiment 76A, wherein a temperature of said aqueous gel layer on said image receiving surface is within a range of 50 to 100° C. 55 to 100° C. 57 to 100° C. 60 to 100° C. 62 to 100° C. 65 to 100° C. 67 to 100° C., 70 to 100° C., 75 to 100° C., or 80 to 100° C.
EMBODIMENT 78A. The method of indirect printing of any one of embodiments 71A to 77A, wherein a gelation temperature of said aqueous treatment formulation is within a range of 50 to 100° C., 55 to 100° C., 57 to 100° C., 60 to 100° C., 62 to 100° C., 65 to 100° C., 67 to 100° C., 70 to 100° C., 75 to 100° C., or 80 to 100° C.
EMBODIMENT 79A. The method for indirect printing of any one of embodiments 71A to 78A, wherein the substrate is a printing substrate selected from the group consisting of plastic, polyethylene terephthalate (PET), polyethylene (PE). biaxially oriented polypropylene (BOPP), aluminum, and combinations thereof.
EMBODIMENT 80A. The method for indirect printing of any one of embodiments 71A to 79A, wherein the wet treatment layer has a thickness of at most 0.8, at most 0.5 μm, at most 0.4 μm, at most 0.3 μm, at most 0.2 μm, or at most 0.15 μm, and optionally, at least 0.05 μm or at least 0.10 μm, and further optionally, within a range of 0.05 to 0.8 μm, 0.10 to 0.5 μm, or 0.10 to 0.25 μm.
EMBODIMENT 81A. A system for indirect printing, the system comprising:

i. an intermediate transfer member (ITM) comprising a silicone-based release layer surface:

ii. a container containing an aqueous treatment formulation of any one of embodiments 1A-55A, or containing an aqueous treatment formulation substantially as disclosed herein;

iii. a treatment station for applying the aqueous treatment formulation to the silicone-based release layer surface of the ITM to form thereon a wet treatment layer;

iv. an optional drying station for drying the aqueous treatment formulation;

v, at least one ink jet nozzle positioned proximate to the intermediate transfer member and configured for jetting ink droplets onto the aqueous treatment formulation formed on the intermediate transfer member;

vi. an ink processing station configured to at least partially dry the ink on the aqueous treatment formulation formed on the intermediate transfer member to produce an ink-image residue, and

vii. an ink-image residue transfer mechanism for transferring the ink-image residue onto a printing substrate by pressured contact between the ITM and the printing substrate.

EMBODIMENT 82A. The system of embodiment 81A, wherein the system is devoid of any mechanical residue removal mechanism adapted to mechanically remove ink image residue or treatment formulation residue from the release layer surface.
EMBODIMENT 83A. The system of embodiment 81A, wherein the system is devoid of any scraping blade mechanism adapted to mechanically remove ink image residue or treatment formulation residue from the release layer surface.
EMBODIMENT 84A. The system of any one of embodiments 81A to 83A, wherein the system further comprises a washing station for removing ink image residue or treatment formulation residue from the release layer surface.
EMBODIMENT 1B. An aqueous formulation for use with an intermediate transfer member of a printing system, the aqueous formulation comprising:
at least one water soluble polymer;
one or more of (i) a cationic emulsion of at least one oxidized polyethylene wax particulate material, (ii) a dispersion and/or an emulsion of at least one coated wax particulate material; and (iii) a dispersion and/or an emulsion of at least one thermosetting polymeric particulate material;
a carrier liquid containing water; and
optionally, one or more of (a) at least one surfactant; (b) at least one humectant; and (c) at least one wetting agent.
   EMBODIMENT 2B. An aqueous formulation for use with an intermediate transfer member of a printing system, the aqueous formulation comprising:

at least 1.5%, by weight, of at least one water soluble polymer having a solubility in water of at least 5% at 25° C.;

at least 5%, by weight, of a first non-ionic surfactant having a solubility in water of at least 7%, at 25° C.;

a second non-ionic, silicone-containing surfactant having a solubility in water of at least 1%, at 25° C.:
at least one particulate material selected from (i) at least one thermoplastic polymeric particulate material, optionally in the form of an emulsion and/or a dispersion, (ii) at least one thermosetting polymeric particulate material, optionally in the form of a dispersion and/or an emulsion; or (iii) a combination thereof;

a carrier liquid containing water, said water making up at least about 55%, by weight of the aqueous formulation; and

optionally, one or more of (a) at least one humectant; and (b) at least one wetting agent.

EMBODIMENT 3B. The aqueous formulation of embodiment 1B or 2B, wherein said particulate material is provided in a form of an emulsion or a dispersion and wherein a concentration of said emulsion or dispersion within the aqueous formulation is at least about 0.5% and at most about 15%, by weight relative to the total weight of the formulation.
EMBODIMENT 4B. The aqueous formulation of any one of embodiments 1B to 3B, wherein said particulate material have a particle size (diameter or longest axis) of between about 1 nm to about 500 nm.
EMBODIMENT 5B. The aqueous formulation of any one of embodiments 1B to 4B, wherein said particulate material is homogeneously dispersed in the aqueous formulation.
EMBODIMENT 6B. The aqueous formulation of any one of embodiments 1B to 5B, wherein said thermosetting polymeric particulate material is a hydrophobic particulate material.
EMBODIMENT 7B. The aqueous formulation of embodiment 6B, wherein said hydrophobic particulate material is a polymer selected from polytetrafluoroethylene (PTFE), perfluoroalkoxy alkane (PFA) or fluorinated ethylene propylene (FEP).
EMBODIMENT 8B. The aqueous formulation of embodiments 7B, wherein said hydrophobic particulate material is PTFE (i.e., Teflon).
EMBODIMENT 9B. The aqueous formulation of embodiments 8B, wherein the PTFE particulate material is of a size (diameter or longest axis) of between about 1 to about 500 nm.
EMBODIMENT 10B. The aqueous formulation of embodiments 9B, wherein the PFFE particulate material is of a size of between about 50 nm to about 200 nm.
EMBODIMENT 11B. The aqueous formulation of any one of embodiments 7B to 10B, wherein the PTFE particulate material is of a size of about 200 nm and is provided in a form of a dispersion, wherein the concentration of the dispersion thereof within the aqueous formulation is between about 4% to about 12%, by weight relative to the total weight of the formulation.
EMBODIMENT 12B. The aqueous formulation of any one of embodiments 7B to 11B, wherein the PTFE particulate material is of a size of about 300 nm to about 400 nm and is provided in a form of a dispersion, wherein the concentration of the dispersion thereof within the aqueous formulation is about 8%, by weight relative to the total weight of the formulation.
EMBODIMENT 13B. The aqueous formulation of embodiment 11B or embodiments 12B, wherein the PTFE dispersion is an aqueous dispersion having the following properties:
i. Viscosity—about 13 cP
ii. Surface tension—about 31.4 mN/m
iii. pH—about 9.95
iv. Solid content—about 60%
v. Particle size—about 200 nm.
   EMBODIMENT 14B. The aqueous formulation any one of embodiments 2B to 13B, wherein said thermoplastic polymeric particulate material is a wax particulate material.
   EMBODIMENT 15B. The aqueous formulation of embodiment 14B, wherein said wax particulate material is an oxidized polyethylene wax particulate material.
   EMBODIMENT 16B. The aqueous formulation of any one of embodiments 1B to 15B, wherein said particulate oxidized polyethylene wax is of a size (diameter or longest axis) of between about 1 nm to about 500 nm.
   EMBODIMENT 17B. The aqueous formulation of embodiment 16B, wherein said particulate oxidized polyethylene wax is of a size of about 1 to about 500 nm and is provided in the form of an emulsion, wherein the concentration of the emulsion thereof within the aqueous formulation is between about 1.5% to about 5%, by weight relative to the total weight of the formulation.
   EMBODIMENT 18B. The aqueous formulation of any one of embodiments 1B to 17B, wherein said particulate oxidized polyethylene wax has a glass transition temperature (Tg) value of about 130° C.
   EMBODIMENT 19B. The aqueous formulation of any one of embodiments 2B to 17B, wherein said at least one thermoplastic polymeric particulate material is provided in a form of an emulsion, optionally wherein said emulsion being a cationic emulsion.
   EMBODIMENT 20B. The aqueous formulation of embodiment 19B, wherein said cationic emulsion is an emulsion of a particulate oxidized polyethylene wax.
   EMBODIMENT 21B. The aqueous formulation of embodiment 1B or embodiment 20B, wherein said cationic emulsion of a particulate oxidized polyethylene wax has the following properties:
i. Viscosity—about 80 cP at 20° C.
ii. Density—about 1 g/cm³
iii. pH—about 9.5 at about 1% concentration
iv. Solid content—about 25-29%
v. Particle size—below about 500 nm.
   EMBODIMENT 22B. The aqueous formulation of any one of embodiments 2B to 21B, wherein said thermoplastic polymeric particulate material is a coated wax particulate material.
   EMBODIMENT 23B. The aqueous formulation of embodiment 22B, wherein said coated wax particulate material is a particulate wax material coated with silicon dioxide.
   EMBODIMENT 24B. The aqueous formulation of embodiment 23B, wherein said coated wax particulate material is of a size (diameter or longest axis) of about 100 nm and is provided in a form of a dispersion, wherein the concentration of the dispersion thereof within the aqueous formulation is at least about 10%, by weight relative to the total weight of the formulation.
   EMBODIMENT 25B. The aqueous formulation of any one of embodiment 22B to 24B, wherein said coated wax particulate material has a glass transition temperature (Tg) value of about 125° C.
   EMBODIMENT 26B. The aqueous formulation of any one of embodiments 1B to 25B, wherein said formulation is free of aggregates.
   EMBODIMENT 27B. The aqueous formulation of any one of embodiments 1B to 26B, further comprising at least one antibacterial agent.
   EMBODIMENT 28B. The aqueous formulation of any one of embodiments 1B to 27B, wherein said aqueous formulation having the following properties:
i. a static surface tension within a range of 20 and 40 mN/m at 25° C.;
ii. a 25° C. dynamic viscosity that is at least 10 cP; and
iii. a 60° C. evaporation load of at most 7.5:1, by weight.
   EMBODIMENT 29B. The aqueous formulation of any one of embodiments 1B to 28B, wherein said water soluble polymer is selected from the group consisting of polyvinyl alcohol, water-soluble cellulose, polyvinylpyrrolidone (PVP), polyethylene oxide, and water-soluble acrylates.
   EMBODIMENT 30B. The aqueous formulation of any one of embodiments 1B to 29B, wherein a concentration of said water soluble polymer is within a range of 2.0 to 8%, 2.5 to 6.5%, 2.5 to 6%, 2.5 to 5.5%, or 2.5 to 5%, optionally being of at most 10% or at most 8% or at most 6% or at most 5%.
   EMBODIMENT 31B. The aqueous formulation of any one of embodiments 1B to 30B, wherein the solubility in water of said at least one water soluble polymer, at 25° C. is at least 7%, at least 10%, at least 12%, at least 15%, at least 20%, or at least 25%, and optionally, at most 80% or at most 60%.
   EMBODIMENT 32B. The aqueous formulation of any one of embodiments 1B to 31B, wherein the aqueous formulation has a total surfactant concentration of at least 0.3%, at least 0.5%, at least 0.75%, at least 10%, at least 20%, at least 3%, at least 4%, at least 5%, at least 6%, at least 7%, at least 8%, at least 9%, at least 10%, at least 11%, at least 12% and optionally, within a range of 6 to 40%, 6 to 30%, 6 to 20%, 7 to 30%, 7 to 20%, 7 to 15%, 8 to 25%, 8 to 20%, 8 to 15%, 8 to 13%, 9 to 25%, 9 to 20%, 9 to 15%, 9 to 13%, 10 to 25%, 10 to 20%, 10 to 15%, or 10 to 13%.
   EMBODIMENT 33B. The aqueous formulation of any one of embodiments 2B to 32B, wherein said aqueous formulation contains at least 6%, at least 7%, at least 8%, at least 9%, or at least 10%, by weight, of said first non-ionic surfactant.
   EMBODIMENT 34B. The aqueous formulation of any one of embodiments 2B to 33B, wherein said aqueous formulation contains at most 18%, at most 16%, at most 15%, at most 14%, or at most 13%, by weight, of said first non-ionic surfactant.
   EMBODIMENT 35B. The aqueous formulation of any one of embodiments 2B to 34B, wherein a concentration of said first non-ionic surfactant within said aqueous treatment formulation, by weight, is within a range of 5.5-18%, 5.5-16%, 6.5-18%, 6.5-16%, 7.5-18%, 7.5-16%, 8.5-18%, 8.5-16%, 9.5-18%, 9.5-16%, 10.5-18%, or 10.5-16%.
   EMBODIMENT 36B. The aqueous formulation of any one of embodiments 2B to 35B, wherein said solubility in water of said first non-ionic surfactant, at 25° C., is at least 8%, at least 10%, at least 12%, at least 15%, at least 20%, at least 25%, or at least 30%, and optionally, at most 80% or at most 60%.
   EMBODIMENT 37B. The aqueous formulation of any one of embodiments 2B to 36B, wherein said second, non-ionic silicone-containing surfactant includes a polysiloxane-polyoxyalkylene copolymer, and wherein optionally, a concentration of said polysiloxane-polyoxyalkylene copolymer is at least 0.3%, at least 0.5%, at least 0.75%, or at least 1.0%, by weight, and further optionally, at most 5%, at most 4%, at most 3%, at most 2.5%, at most 2%, or at most 1.75%, by weight.
   EMBODIMENT 38B. The aqueous formulation of any one of embodiments 2B to 37B, wherein said aqueous formulation contains at least 0.3%, at least 0.5%, at least 0.75%, or at least 1.0%, by weight and optionally, at most 5%, at most 4%, at most 3%, at most 2.5%, at most 2%, or at most 1.75%, by weight, of said second, non-ionic silicone-containing surfactant.
   EMBODIMENT 39B. The aqueous formulation of any one of embodiments 1B to 38B, wherein said wetting agent is PEI.
   EMBODIMENT 40B. The aqueous formulation of any one of embodiments 1B to 39B, wherein a concentration of PEI within said aqueous formulation, by weight, is within a range of 0.1 to 1%, 0.1 to 0.8%, 0.1 to 0.7%, 0.1 to 0.6%, 0.1 to 0.5%, 0.2 to 0.7%, 0.2 to 0.6%, or 0.2 to 0.5%.
   EMBODIMENT 41B. The aqueous formulation of embodiment 39B or 40B, wherein the PEI has an average molecular weight of at least 200,000, at least 350,000, at least 500,000, at least 700,000, and optionally, at most 3,000,000, at most 2,500,000, or at most 2,000,000.
   EMBODIMENT 42B. The aqueous formulation of any one of embodiments 1B to 41B, wherein said formulation contains at least 55%, by weight of water.
   EMBODIMENT 43B. The aqueous formulation of any one of embodiments 1B to 42B, wherein said particulate material is capable of improving at least one mechanical property of a printed product produced by utilizing the aqueous formulation with the intermediate transfer member of the printing system, wherein the improvement in the mechanical property is in comparison with a printed product produced by utilizing an aqueous formulation identical to the aqueous formulation of any one of embodiments 1B to 42B but lacking said particulate material.
   EMBODIMENT 44B. The aqueous formulation of embodiment 43B, wherein said mechanical property is rub resistance.
   EMBODIMENT 45B. A method of indirect printing comprising:
   a. providing an intermediate transfer member comprising a release layer surface.
   b. providing the aqueous formulation of any one of embodiments 1B to 44B;
   c. applying the aqueous formulation onto the ITM release layer surface to form thereon a wet layer having a thickness of at most about 1.0 μm;
   d. subjecting the wet layer to a drying process to form a dried film layer, from the wet layer, on the ITM release layer surface, said dried film layer having a thickness of at least about 20 nm and at most about 200 nm;
   e. depositing droplets of an aqueous ink onto the dried film to form an ink image on the release layer surface of the ITM release layer surface:
   f. drying the ink image to leave an ink-image residue on the ITM release layer surface; and
   g. transferring the ink-image residue onto a printing substrate by pressured contact between the ITM and the printing substrate.
   EMBODIMENT 46B. A method of indirect printing comprising:
   a. providing an intermediate transfer member (ITM) comprising a release layer surface;
   b. providing an aqueous formulation comprising:
at least one water soluble polymer;
at least one particulate material selected from (i) least one thermoplastic polymeric particulate material, optionally in the form of an emulsion and/or a dispersion; (ii) at least one thermosetting polymeric particulate material, optionally in the form of a dispersion and/or an emulsion; or (iii) a combination thereof;
a carrier liquid containing water; and optionally, one or more of (iv) at least one surfactant; (v) at least one humectant; and (vi) at least one wetting agent;
   c. applying the aqueous formulation onto the ITM release layer surface to form thereon a wet layer having a thickness of at most about 1.0 μm;
   d. subjecting the wet layer to a drying process to form a dried film layer, from the wet layer, on the ITM release layer surface, said dried film layer having a thickness of at least about 20 nm and at most about 200 nm;
   e. depositing droplets of an aqueous ink onto the dried film to form an ink image on the release layer surface of the ITM release layer surface;
   f. drying the ink image to leave an ink-image residue on the ITM release layer surface; and
   g. transferring the ink-image residue onto a printing substrate by pressured contact between the ITM and the printing substrate.
   EMBODIMENT 47B. The method of embodiment 45B or 46B, wherein said particulate material has a particle size (diameter or longest axis) of between about 1 nm to about 500 nm.
   EMBODIMENT 48B. The method of embodiment 47B, wherein said particulate material have substantially two dimensional disc-like shape (i.e., with a diameter constituting the longest access of the particulate material).
   EMBODIMENT 49B. The method of any one of embodiments 45B to 48B, wherein in said dried film on the ITM release layer surface the diameter or longest axis of said particulate material is substantially parallel to the ITM.
   EMBODIMENT 50B. The method of any one of embodiments 45B to 49B, wherein a thickness of the dried film to which the aqueous ink droplets are deposited is at most 200 nm, at most 120 nm, at most 100 nm, at most 80 nm, at most 70 nm, at most 60 nm, at most 50 nm, at most 45 nm, or at most 40 nm.
   EMBODIMENT 51B. The method of any one of embodiments 45B to 50B, wherein a thickness of the dried treatment film to which the aqueous ink droplets are deposited is at least 15 nm or at least 20 nm or at least 25 nm or at least 30 nm.
   EMBODIMENT 52B. The method of any one of embodiments 45B to 51B, wherein a thickness of the dried treatment film to which the aqueous ink droplets are deposited is at most about 50 nm.
   EMBODIMENT 53B. The method of any one of embodiments 45B to 51B, wherein a thickness of the dried treatment film to which the aqueous ink droplets are deposited is at most about 100 nm.
   EMBODIMENT 54B. The method of any one of embodiments 45B to 51B, wherein a thickness of the dried treatment film to which the aqueous ink droplets are deposited is at most about 120 nm.
   EMBODIMENT 55B. The method of any one of embodiments 45B to 51B, wherein a thickness of the dried treatment film to which the aqueous ink droplets are deposited is at most about 150 nm.
   EMBODIMENT 56B. The method of any one of embodiments 45B to 55B, wherein the dried treatment film is continuous over an entirety of a rectangle of the release surface of the ITM, wherein said rectangle has a width of at least 10 cm and a length of at least 10 meters.
   EMBODIMENT 57B. The method of embodiments 56B, wherein the dried treatment film for at least 50% or at least 75% or at least 90% or at least 95% at least 95% or at least 99% or 100% of an area of the rectangle, a thickness of the dried treatment film does not deviate from an average thickness value within the rectangle by more than 50% or more than 40% or more than 30%.
   EMBODIMENT 58B. The method of any one of embodiments 45B to 57B, wherein the ink-image residue is transferred together with non-printed areas of the dried treatment film onto the printing substrate.
   EMBODIMENT 59B. The method of any one of embodiments 45B to 58B, wherein the dried treatment film is sufficiently cohesive such that during transfer of the ink-image residue, the dried treatment film completely separates from the ITM and transfers to the printing substrate with the dried ink image, both in printed and non-printed areas.
   EMBODIMENT 60B. The method of any one of embodiments 45B to 59B, wherein said particulate material is provided in the form of an emulsion or a dispersion and wherein a concentration of said emulsion or dispersion within the aqueous formulation is at least about 0.5% and at most about 15%, by weight relative to the total weight of the formulation.
   EMBODIMENT 61B. The method of any one of embodiments 45B to 60B, wherein said particulate material is homogeneously dispersed in the aqueous formulation.
   EMBODIMENT 62B. The method of any one of embodiments 45B to 61B, wherein said thermosetting polymeric particulate material is a hydrophobic particulate material.
   EMBODIMENT 63B. The method of embodiment 62B, wherein said hydrophobic particulate material is a polymer selected from polytetrafluoroethylene (PTFE), perfluoroalkoxy alkane (PFA) or fluorinated ethylene propylene (FEP).
   EMBODIMENT 64B. The method of embodiment 63B, wherein said hydrophobic particulate material is PTFE (i.e., Teflon).
   EMBODIMENT 65B. The method of embodiment 64B, wherein the PTFE particulate material is of a size (diameter or longest axis) of between about 1 to about 500 nm.
   EMBODIMENT 66B. The method of embodiment 65B, wherein the PTFE particulate material is of a size of between about 50 nm to about 200 nm.
   EMBODIMENT 67B. The method of any one of embodiments 63B to 66B, wherein the PTFE particulate material is of a size of about 200 nm and is provided in a form of a dispersion, wherein the concentration of the dispersion thereof within the aqueous formulation is between about 4% to about 12%, by weight relative to the total weight of the formulation.
   EMBODIMENT 68B. The method of any one of embodiments 63B to 67B, wherein the PTFE particulate material is of a size of about 300 nm to about 400 nm and is provided in a form of a dispersion, wherein the concentration of the dispersion thereof within the aqueous formulation is about 8%, by weight relative to the total weight of the formulation.
   EMBODIMENT 69B. The method of embodiment 67B, wherein the PTFE dispersion is an aqueous dispersion having the following properties:
i. Viscosity—about 13 cP
ii. Surface tension—about 31.4 mN/m
iii. pH—about 9.95
iv. Solid content—about 60%
v. Particle size—about 200 nm.
   EMBODIMENT 70B. The method of any one of embodiments 45B to 69B, wherein said thermoplastic polymeric particulate material is a wax particulate material.
   EMBODIMENT 71B. The method of embodiment 70B, wherein said wax particulate material is an oxidized polyethylene wax particulate material.
   EMBODIMENT 72B. The method of embodiment 71B, wherein said particulate oxidized polyethylene wax is of a size (diameter or longest axis) of between about 1 nm to about 500 nm.
   EMBODIMENT 73B. The method of embodiment 72B, wherein said particulate oxidized polyethylene wax is of a size of about 1 to about 500 nm and is provided in the form of an emulsion, wherein the concentration of the emulsion thereof within the aqueous formulation is between about 1.5% to about 5%, by weight relative to the total weight of the formulation.
   EMBODIMENT 74B. The method of any one of embodiments 71B to 73B, wherein said particulate oxidized polyethylene wax has a glass transition temperature (Tg) value of about 130° C.
   EMBODIMENT 75B. The method of any one of embodiments 45B to 74B, wherein said thermoplastic polymeric particulate material is provided in the form of an emulsion and wherein said emulsion is a cationic emulsion.
   EMBODIMENT 76B. The method of embodiment 75B, wherein said cationic emulsion is an emulsion of a particulate oxidized polyethylene wax.
   EMBODIMENT 77B. The method of embodiment 76B, wherein said cationic emulsion of a particulate oxidized polyethylene wax has the following properties:
i. Viscosity—about 80 cP at 20° C.
ii. Density—about 1 g/cm³
iii. pH—about 9.5 at about 1% concentration
iv. Solid content—about 25-29%
v. Particle size—below about 500 nm.
   EMBODIMENT 78B. The method of any one of embodiments 45B to 77B, wherein said thermoplastic polymeric particulate material is a coated wax particulate material.
   EMBODIMENT 79B. The method of embodiment 78B, wherein said coated wax particulate material is a wax particulate material coated with silicon dioxide.
   EMBODIMENT 80B. The method of embodiment 79B, wherein said coated wax particulate material is of a size (diameter or longest axis) of about 100 nm and is provided in a form of a dispersion, wherein the concentration of the dispersion thereof within the aqueous formulation is at least about 10%, by weight relative to the total weight of the formulation.
   EMBODIMENT 81B. The method of any one of embodiment 78B to 80B, wherein said coated wax particulate material has a glass transition temperature value of about 125° C.
   EMBODIMENT 82B. The method of any one of embodiments 45B to 81B, wherein said formulation is free of aggregates.
   EMBODIMENT 83B. The method of any one of embodiments 45B to 82B, wherein said aqueous formulation further comprises at least one antibacterial agent.
   EMBODIMENT 84B. The method of any one of embodiments 45B to 83B, wherein said aqueous formulation having the following properties:

i. a static surface tension within a range of 20 and 40 mN/m at 25° C.;

ii. a 25° C. dynamic viscosity that is at least 10 cP; and

iii. a 60° C. evaporation load of at most 7.5:1, by weight.

EMBODIMENT 85B. The method of any one of embodiments 45B to 84B, wherein said water soluble polymer is selected from the group consisting of polyvinyl alcohol, water-soluble cellulose. polyvinylpyrrolidone (PVP), polyethylene oxide, and water-soluble acrylates.
EMBODIMENT 86B. The method of any one of embodiments 45B to 85B, wherein a concentration of said water soluble polymer is within a range of 2.0 to 8%, 2.5 to 6.5%, 2.5 to 6%, 2.5 to 5.5%, or 2.5 to 5%.
EMBODIMENT 87B. The method of any one of embodiments 45B to 86B, wherein the solubility in water of said at least one water soluble polymer, at 25° C., is at least 7%, at least 10%, at least 12%, at least 15%, at least 20%, or at least 25%, and optionally, at most 80% or at most 60%.
EMBODIMENT 88B. The method of any one of embodiments 45B to 87B, wherein the aqueous formulation has a total surfactant concentration of at least 0.3%, at least 0.5%, at least 0.75%, at least 1%, at least 2%, at least 3%, at least 4%, at least 5%, at least 6%, at least 7%, at least 8%, at least 9%, at least 10%, at least 11%, at least 12% and optionally, within a range of 6 to 40%, 6 to 30%, 6 to 20%, 7 to 30%, 7 to 20%, 7 to 15%, 8 to 25%, 8 to 20%, 8 to 15%, 8 to 13%, 9 to 25%, 9 to 20%, 9 to 15%, 9 to 13%, 10 to 25%, 10 to 20%, 10 to 15%, or 10 to 13%.
EMBODIMENT 89B. The method of any one of embodiments 45B to 88B, wherein said wetting agent is PEI.
EMBODIMENT 90B. The method of embodiment 89B, wherein a concentration of PEI within said aqueous formulation, by weight, is within a range of 0.1 to 1%, 0.1 to 0.8%, 0.1 to 0.7%, 0.1 to 0.6%, 0.1 to 0.5%, 0.2 to 0.7%, 0.2 to 0.6%, or 0.2 to 0.5%.
EMBODIMENT 91B. The method of embodiment 89B or 90B, wherein the PEI has an average molecular weight of at least 200,000, at least 350,000, at least 500,000, at least 700,000, and optionally, at most 3,000,000, at most 2,500.000, or at most 2,000,000.
EMBODIMENT 92B. The method of any one of embodiments 45B to 91B, wherein said formulation contains at least 55%, by weight of water.
EMBODIMENT 93B. The method of any one of embodiments 45B to 92B, wherein said particulate material is capable of improving at least one mechanical property of the produced printed product, wherein the improvement in the mechanical property is in comparison with a printed product produced by utilizing an aqueous formulation identical to the aqueous formulation of any one of embodiments 1B to 42B but lacking said particulate material.
EMBODIMENT 94B. The method of embodiment 93B, wherein said mechanical property is rub resistance.
EMBODIMENT 95B. The method of any one of embodiments 45B to 94B, wherein said ITM is an hydrophobic ITM.
EMBODIMENT 96B. The method of any one of embodiments 45B to 94B, wherein said ITM comprises a silicone-based release layer surface that is sufficiently hydrophilic to satisfy at least one of the following properties:

(i) a receding contact angle of a drop of distilled water deposited on the silicone-based release layer surface is at most 60°; and

(ii) a 10-second dynamic contact angle (DCA) of a drop of distilled water deposited on the silicone-based release layer surface is at most 108°.

EMBODIMENT 97B. The method of any one of embodiments 45B to % B, wherein said method provides a printed product with improved one or more mechanical property, wherein the improvement in the one or more mechanical property is in comparison with a printed product produced by utilizing said method but in the absence of said particulate material.
EMBODIMENT 98B. The method of embodiment 97B, wherein said mechanical property is rub resistance.
EMBODIMENT 99B. A system for printing, the system comprising:
a. an intermediate transfer member comprising a release layer surface;
b. a quantity of the aqueous formulation according to any one of embodiments 1B to 44B;
c. a treatment station for applying the aqueous formulation to the ITM surface to form thereon a wet layer having a thickness of at most about 1.0 μm;
d. an image forming station for forming ink images on the ITM by depositing droplets of an aqueous ink upon the ITM surface after the wet layer has dried into a dried film so that the droplets are applied to the dried film, said dried film layer having a thickness of at least about 20 nm and at most about 200 nm; and
e. a transfer station for transferring the ink images from the ITM to a substrate.
EMBODIMENT 100B. A printing system comprising:
a. an intermediate transfer member comprising a flexible endless belt mounted over a plurality of guide rollers;
b. an image forming station configured to form ink images upon a surface of the ITM, first and second of the guide rollers being arranged upstream and downstream of the image forming station to define an upper run passing through the image forming station and a lower run;
c. an impression station through which the lower run of the ITM passes, the impression station being disposed downstream of the image forming station and configured to transfer the ink images from the ITM surface to substrate; and
d. a treatment station disposed downstream of the impression station and upstream of the image forming station for forming a uniform thin layer of a liquid formulation onto the ITM surface at the lower run thereof, the treatment station comprising:
e. a coater for coating the ITM with the aqueous formulation according to any one of embodiments 1B to 44B; and
f. a coating thickness-regulation assembly for removing excess liquid so as to leave only a desired uniform wet thin layer of the formulation, said layer having a thickness of at most about 1.0 μm, the coating thickness-regulation assembly comprising a rounded tip facing the ITM surface at the lower run.
EMBODIMENT 101B. A system for printing, the system comprising:
a. an intermediate transfer member comprising a release layer surface;
b. a quantity of an aqueous formulation comprising:
at least one water soluble polymer;
at least one particulate material selected from (i) at least one thermoplastic polymeric particulate material, optionally in the form of an emulsion and/or a dispersion (ii) at least one thermosetting polymeric particulate material, optionally in the form of a dispersion and/or an emulsion; or (iii) a combination thereof: a carrier liquid containing water; and
optionally, one or more of (iv) at least one surfactant; (v) at least one humectant; and (vi) at least one wetting agent:
   c. a treatment station for applying the aqueous formulation to the ITM surface to form thereon a wet layer having a thickness of at most about 1.0 μm;
   d. an image forming station for forming ink images on the ITM by depositing droplets of an aqueous ink upon the ITM surface after the wet layer has dried into a dried film so that the droplets are applied to the dried film, said dried film layer having a thickness of at least about 20 nm and at most about 200 nm; and
   e. a transfer station for transferring the ink images from the ITM to a substrate.
   EMBODIMENT 102B. A printing system comprising:
   a. an intermediate transfer member comprising a flexible endless belt mounted over a plurality of guide rollers:
   b. an image forming station configured to form ink images upon a surface of the ITM, first and second of the guide rollers being arranged upstream and downstream of the image forming station to define an upper run passing through the image forming station and a lower run;
   c. an impression station through which the lower run of the ITM passes, the impression station being disposed downstream of the image forming station and configured to transfer the ink images from the ITM surface to substrate; and
   d. a treatment station disposed downstream of the impression station and upstream of the image forming station for forming a uniform thin layer of a liquid formulation onto the ITM surface at the lower run thereof, the treatment station comprising:
   e. a coater for coating the ITM with a quantity of an aqueous formulation comprising:
at least one water soluble polymer;
at least one particulate material selected from (i) at least one thermoplastic polymeric particulate material, optionally in the form of an emulsion and/or a dispersion; (ii) at least one thermosetting polymeric particulate material optionally in the form of a dispersion and/or an emulsion; or (iii) a combination thereof; a carrier liquid containing water; and
optionally, one or more of (iv) at least one surfactant; (v) at least one humectant; and (vi) at least one wetting agent; and
   f. a coating thickness-regulation assembly for removing excess liquid so as to leave only a desired uniform wet thin layer of the formulation, said layer having a thickness of at most about 1.0 μm, the coating thickness-regulation assembly comprising a rounded tip facing the ITM surface at the lower run.
   EMBODIMENT 103B. The system of any one of embodiments 99B to 102B, wherein said ITM is an hydrophobic ITM.
   EMBODIMENT 104B The system of any one of embodiments 99B to 102B, wherein said ITM comprises a silicone-based release layer surface that is sufficiently hydrophilic to satisfy at least one of the following properties:

(i) a receding contact angle of a drop of distilled water deposited on the silicone-based release layer surface is at most 60°; and

(ii) a 10-second dynamic contact angle (DCA) of a drop of distilled water deposited on the silicone-based release layer surface is at most 108°.

EMBODIMENT 105B A method of improving at least one mechanical property of a printed ink image (on a substrate) comprising:
a. providing an intermediate transfer member comprising a release layer surface;
b. providing an aqueous formulation according to any one of embodiments 1B to 42B;
c. applying the aqueous formulation onto the ITM release layer surface to form thereon a wet (treatment) layer having a thickness of at most about 1.0 μm:
d. subjecting the wet (treatment) layer of (d) to a drying process to form a dried (treatment) film layer, from the wet (treatment) layer, on the ITM release layer surface, said dried film layer having a thickness of at least about 20 nm and at most 200 nm;
e. depositing droplets of an aqueous ink onto the dried (treatment) film to form an ink image on the release layer surface of the ITM release layer surface;
f. drying the ink image to leave an ink-image residue on the ITM release layer surface; and
g. transferring the ink-image residue onto a printing substrate by pressured contact between the ITM and the printing substrate;
to thereby produce a printed ink image on a substrate, wherein said printed ink image has at least one mechanical property improved compared to an ink image produced with said aqueous formulation but without said particulate material.
EMBODIMENT 106B A method of improving at least one mechanical property of a printed ink image (on a substrate) comprising:
a. providing an intermediate transfer member comprising a release layer surface;
b. providing an aqueous formulation comprising:
at least one water soluble polymer;
a carrier liquid containing water; and
optionally, one or more of (i) at least one surfactant; (ii) at least one humectant; and (iii) at least one wetting agent;
   c. adding to the aqueous formulation of (b) one or more of (i) a cationic emulsion of at least one oxidized polyethylene wax particulate material; (ii) a dispersion and/or an emulsion of at least one coated wax particulate material, and (iii) a dispersion and/or an emulsion of at least one thermosetting polymeric particulate material;
   d. applying the formulation produced in (c) onto the ITM release layer surface to form thereon a wet (treatment) laver having a thickness of at most about 1.0 μm:
   e. subjecting the wet (treatment) layer of (d) to a drying process to form a dried (treatment) film layer, from the wet (treatment) layer, on the ITM release layer surface, said dried film layer having a thickness of at least about 20 nm and at most 200 nm;
   f. depositing droplets of an aqueous ink onto the dried (treatment) film to form an ink image on the release layer surface of the ITM release layer surface;
   g. drying the ink image to leave an ink-image residue on the ITM release layer surface; and
   h. transferring the ink-image residue onto a printing substrate by pressured contact between the ITM and the printing substrate;
   to thereby produce a printed ink image on a substrate, wherein said printed ink image has at least one mechanical property improved compared to an ink image produced without addition of said emulsion or dispersion of (c) to the aqueous formulation of (b).
   EMBODIMENT 107B A method of improving at least one mechanical property of a printed ink image (on a substrate) comprising:
   a. providing an intermediate transfer member comprising a release layer surface;
   b. providing an aqueous formulation comprising:
at least one water soluble polymer;
a carrier liquid containing water; and
optionally, one or more of (i) at least one surfactant; (ii) at least one humectant; and (iii) at least one wetting agent;
   c. adding to the aqueous formulation of (b) at least one particulate material selected from (i) at least one oxidized polyethylene wax particulate material; (ii) at least one coated wax particulate material; (iii) at least one thermosetting polymeric particulate material; (iv) or any combination thereof:
   d. applying the formulation produced in (c) onto the ITM release layer surface to form thereon a wet (treatment) layer having a thickness of at most about 1.0 μm;
   e. subjecting the wet (treatment) layer of (d) to a drying process to form a dried (treatment) film layer, from the wet (treatment) layer, on the ITM release layer surface, said dried film layer having a thickness of at least about 20 nm and at most 200 nm;
   f. depositing droplets of an aqueous ink onto the dried (treatment) film to form an ink image on the release layer surface of the ITM release layer surface;
   g. drying the ink image to leave an ink-image residue on the ITM release layer surface; and
   h. transferring the ink-image residue onto a printing substrate by pressured contact between the ITM and the printing substrate;
   to thereby produce a printed ink image on a substrate, wherein said printed ink image has at least one mechanical property improved compared to an ink image produced without addition of said particulate material of (c) to the aqueous formulation of (b).
   EMBODIMENT 108B A method of improving at least one mechanical property of a printed ink image (on a substrate) comprising:
   a. providing an intermediate transfer member comprising a release layer surface;
   b. providing an aqueous formulation comprising:

at least 1.5%, by weight, of at least one water soluble polymer having a solubility in water of at least 5% at 25° C.;

at least 5%, by weight, of a first non-ionic surfactant having a solubility in water of at least 7%, at 25° C.;

a second non-ionic, silicone-containing surfactant having a solubility in water of at least 1%, at 25° C.;

a carrier liquid containing water, said water making up at least about 55%, by weight of the aqueous formulation; and

optionally, one or more of (i) at least one humectant; and (ii) at least one wetting agent;

c. adding to the aqueous formulation of (b) at least one particulate material selected from (i) at least one thermoplastic polymeric particulate material; (ii) at least one thermosetting polymeric particulate material; or (iii) a combination thereof;
d. applying the formulation produced in (c) onto the ITM release layer surface to form thereon a wet (treatment) layer having a thickness of at most about 1.0 μm:
e. subjecting the wet (treatment) layer of (d) to a drying process to form a dried (treatment) film layer, from the wet (treatment) layer, on the ITM release layer surface, said dried film layer having a thickness of at least about 20 nm and at most 200 nm:
f. depositing droplets of an aqueous ink onto the dried (treatment) film to form an ink image on the release layer surface of the ITM release layer surface;
g. drying the ink image to leave an ink-image residue on the ITM release layer surface; and
h. transferring the ink-image residue onto a printing substrate by pressured contact between the ITM and the printing substrate:
to thereby produce a printed ink image on a substrate, wherein said printed ink image has at least one mechanical property improved compared to an ink image produced without addition of said particulate material of (c) to the aqueous formulation of (b).
EMBODIMENT 109B The method of any one of embodiments 105B to 108B, wherein said mechanical property is rub resistance.
EMBODIMENT 110B The method of any one of embodiments 105B to 109B, wherein said particulate material is provided in the form of an emulsion or a dispersion and wherein a final concentration of said emulsion or dispersion within the aqueous formulation after the addition of said emulsion or dispersion to said formulation is at least about 0.5% and at most about 15%, by weight relative to the total weight of the formulation and wherein said particulate material have a particle size (diameter or longest axis) of between about 1 nm to about 500 nm.
EMBODIMENT 111B A kit for printing with an indirect printing system, the kit comprising:
a. an intermediate transfer member comprising a release layer surface; and
b. a quantity of an aqueous treatment formulation according to any one of embodiments 1B to 44B.
EMBODIMENT 112B A kit for printing with an indirect printing system, the kit comprising:
a. an intermediate transfer member comprising a release layer surface;
b. a quantity of an aqueous formulation comprising:
at least one water soluble polymer;
one or more of (i) a cationic emulsion of at least one oxidized polyethylene wax particulate material; (ii) a dispersion and/or an emulsion of at least one coated wax particulate material; and (iii) a dispersion and/or an emulsion of at least one thermosetting polymeric particulate material;
a carrier liquid containing water; and
optionally, one or more of (iv) at least one surfactant; (v) at least one humectant; and (vi) at least one wetting agent.
   EMBODIMENT 113B A kit for printing with an indirect printing system, the kit comprising:
   a. an intermediate transfer member comprising a release layer surface:
   b. a quantity of an aqueous formulation comprising:
at least one water soluble polymer;
a carrier liquid containing water; and
optionally, one or more of (i) at least one surfactant; (ii) at least one humectant; and (iii) at least one wetting agent; and
   c, one or more of (i) a cationic emulsion of at least one oxidized polyethylene wax particulate material; (ii) a dispersion and/or an emulsion of at least one coated wax particulate material; and (iii) a dispersion and/or an emulsion of at least one thermosetting polymeric particulate material.
   EMBODIMENT 114B A kit for printing with an indirect printing system, the kit comprising:
   a. an intermediate transfer member comprising a release layer surface:
   b. a quantity of an aqueous formulation comprising:
at least 1.5%, by weight, of at least one water soluble polymer having a solubility in water of at least 5% at 25° C.;
at least 5%, by weight, of a first non-ionic surfactant having a solubility in water of at least 7%, at 25° C.;
a second non-ionic, silicone-containing surfactant having a solubility in water of at least 1%, at 25° C.;
one or more of (i) a dispersion and/or an emulsion of at least one thermoplastic polymeric particulate material, and (ii) a dispersion and/or an emulsion of at least one thermosetting polymeric particulate material;
a carrier liquid containing water, said water making up at least about 55%, by weight of the aqueous formulation; and
optionally, one or more of (iii) at least one humectant; and (iv) at least one wetting agent.
   EMBODIMENT 115B A kit for printing with an indirect printing system, the kit comprising:
   a. an intermediate transfer member comprising a release layer surface;
   b. a quantity of an aqueous formulation comprising:
at least 1.5%, by weight, of at least one water soluble polymer having a solubility in water of at least 5% at 25° C.;
at least 5%, by weight, of a first non-ionic surfactant having a solubility in water of at least 7%, at 25° C.;
a second non-ionic, silicone-containing surfactant having a solubility in water of at least 1%, at 25° C.;
a carrier liquid containing water, said water making up at least about 55%, by weight of the aqueous formulation; and
optionally, one or more of (i) at least one humectant; and (ii) at least one wetting agent; and
   c, one or more of (i) a dispersion and/or an emulsion of at least one thermoplastic polymeric particulate material; and (ii) a dispersion and/or an emulsion of at least one thermosetting polymeric particulate material.
   EMBODIMENT 116B A kit for printing with an indirect printing system, the kit comprising:
   a. an intermediate transfer member comprising a release layer surface;
   b. a quantity of an aqueous formulation comprising:

at least one water soluble polymer;

one or more of (i) a dispersion and/or an emulsion of at least one thermoplastic polymeric particulate material; and (ii) a dispersion and/or an emulsion of at least one thermosetting polymeric particulate material:

a carrier liquid containing water; and

optionally, one or more of (iii) at least one water absorbing agent; (iv) at least one humectant; and (v) at least one wetting agent.

EMBODIMENT 117B A kit for printing with an indirect printing system, the kit comprising:
a. an intermediate transfer member comprising a release layer surface;
b. a quantity of an aqueous formulation comprising:
at least one water soluble polymer;
a carrier liquid containing water; and
optionally, one or more of (i) at least one surfactant; (ii) at least one humectant; and (iii) at least one wetting agent; and
   c. a quantity of one or more of (i) a dispersion and/or an emulsion of at least one thermoplastic polymeric particulate material; and (ii) a dispersion and/or an emulsion of at least one thermosetting polymeric particulate material.
   EMBODIMENT 118B A printed article comprising:

(i) a substrate;

(ii) one or more ink dots fixedly adhered to at least a region of a surface of said substrate:

wherein said one or more ink dots and said at least a region of said surface of said substrate are covered with a substantially dry film layer having a thickness of at least about 20 nm and at most about 200 nm and wherein said substantially dry film layer comprises one or more of (i) at least one thermoplastic polymeric particulate material; and (ii) at least one thermosetting polymeric particulate material.

EMBODIMENT 119B The printed article of embodiments 118B, wherein said substrate is selected from the group consisting of an uncoated fibrous printing substrate, a commodity coated fibrous printing substrate, and a plastic printing substrate.
EMBODIMENT 120B The printed article of embodiments 118B, wherein said substrate is a paper, optionally selected from the group of papers consisting of bond paper, uncoated offset paper, coated offset paper, copy paper, ground wood paper, coated ground wood paper, freesheet paper, coated freesheet paper, and laser paper.
EMBODIMENT 121B The printed article of any one of embodiments 118B to 120B, wherein said particulate material have a particle size (diameter or longest axis) of between about 1 nm to about 500 nm.
EMBODIMENT 122B The printed article of any one of embodiments 118B to 121B, wherein said particulate material has substantially two dimensional disc-like shape (i.e., with a diameter constituting the longest access of the particulate material).
EMBODIMENT 123B The printed article of any one of embodiments 118B to 122B, wherein the diameter or longest axis of said particulate material is substantially parallel to said surface of the substrate.
EMBODIMENT 124B The printed article of any one of embodiments 118B to 123B, wherein the thickness of said dry film layer is at most 200 nm, at most 120 nm, at most 100 nm, at most 80 nm, at most 70 nm, at most 60 nm, at most 50 nm, at most 45 nm, or at most 40 nm.
EMBODIMENT 125B The printed article of any one of embodiments 118B to 124B, wherein the thickness of said dry film layer at least 15 nm or at least 20 nm or at least 25 nm or at least 30 nm.
EMBODIMENT 126B The printed article of any one of embodiments 118B to 125B, wherein the thickness of said dry film is at most about 50 nm.
EMBODIMENT 127B The printed article of any one of embodiments 118B to 125B, wherein the thickness of said dry film is at most about 100 nm.
EMBODIMENT 128B The printed article of any one of embodiments 118B to 125B, wherein the thickness of said dry film is at most about 120 nm.
EMBODIMENT 129B The printed article of any one of embodiments 118B to 125B, wherein the thickness of said dry film is at most about 150 nm.
EMBODIMENT 130B The printed article of any one of embodiments 118B to 129B, wherein said dry film is continuous over an entirety of said surface of said substrate (e.g., covering region with or without ink dots).
EMBODIMENT 131B The printed article of any one of embodiments 118B to 130B, wherein said dry film layer covers at least 50% or at least 75% or at least 90% or at least 95% at least 95% or at least 99% or 100% of said surface.
EMBODIMENT 132B The printed article of any one of embodiments 118B to 131B, wherein said thermosetting polymeric particulate material is a hydrophobic particulate material.
EMBODIMENT 133B The printed article of embodiment 132B, wherein said hydrophobic particulate material is a polymer selected from polytetrafluoroethylene (PTFE), perfluoroalkoxy alkane (PFA) or fluorinated ethylene propylene (FEP).
EMBODIMENT 134B The printed article of embodiment 132B, wherein said hydrophobic particulate material is PTFE (i.e., Teflon).
EMBODIMENT 135B The printed article of embodiment 134B, wherein the PTFE particulate material is of a size (diameter or longest axis) of between about 1 to about 500 nm.
EMBODIMENT 136B The printed article of embodiment 135B, wherein the PTFE particulate material is of a size of between about 50 nm to about 200 nm.
EMBODIMENT 137B The printed article of any one of embodiments 118B to 136B, wherein said thermoplastic polymeric particulate material is a wax particulate material.
EMBODIMENT 138B The printed article of embodiment 137B, wherein said wax particulate material is an oxidized polyethylene wax particulate material.
EMBODIMENT 139B The printed article of embodiment 138B, wherein said particulate oxidized polyethylene wax is of a size (diameter or longest axis) of between about 1 nm to about 500 nm.
EMBODIMENT 140B The printed article of embodiment 138B or 139B, wherein said particulate oxidized polyethylene wax has a glass transition temperature (Tg) value of about 130° C.
EMBODIMENT 141B The printed article of any one of embodiment 118B to 140B, wherein said thermoplastic polymeric particulate material is a coated wax particulate material.
EMBODIMENT 142B The printed article of embodiment 141B, wherein said coated wax particulate material is a wax particulate material coated with silicon dioxide.
EMBODIMENT 143B The printed article of embodiment 142B, wherein said coated wax particulate material is of a size (diameter or longest axis) of about 100 nm.
EMBODIMENT 144B The printed article of any one of embodiment 141B to 143B, wherein said coated wax particulate material has a glass transition temperature (Tg) value of about 125° C.
EMBODIMENT 145B The printed article of any one of embodiment 118B to 144B, wherein said film layer optionally further comprises one or more of (i) at least one water soluble polymer; (ii) at least one surfactant; (iii) at least one humectant; (iv) at least one wetting agent; and (v) at least one antibacterial agent.
EMBODIMENT 146B The printed article of any one of embodiment 118B to 145B, wherein said article has improved one or more mechanical property in comparison with a printed article lacking said particulate material.
EMBODIMENT 147B The printed article of embodiment 146B, wherein said improved mechanical property is manifested in ink containing regions on said substrate.
EMBODIMENT 148B The printed article of embodiment 146B or 147B, wherein said improved mechanical property is manifested in regions of the surface of said substrate which are coated with said substantially dry film layer and are free of ink (ink free).
EMBODIMENT 149B The printed article of any one of embodiments 146B to embodiment 148B, wherein said mechanical property is selected from one or more of rub resistance, coefficient of friction, scratch resistance and surface tack.
EMBODIMENT 150B The printed article of embodiment 149B, wherein said mechanical property is rub resistance.
EMBODIMENT 151B The printed article of embodiment 149B, wherein said mechanical property is coefficient of friction.
EMBODIMENT 152B The printed article of any one of embodiments 118B to 151B, wherein the particulate material is embedded in said dry film layer with substantially no protrusion thereof from the surface of said layer, said surface being the surface distal to the surface of the substrate.
EMBODIMENT 153B The printed article of any one of embodiments 118B to 152B, wherein said one or more ink dots form a continues ink film on said substrate.
EMBODIMENT 154B The printed article of any one of embodiments 118B to 153B, produced according to the method of any one of embodiments 45B to 98B.

1. An aqueous formulation for use with an intermediate transfer member of a printing system, the aqueous formulation comprising:
at least one modified polysaccharide;
at least one carrier liquid containing water;
at least one particulate material selected from (i) at least one thermoplastic polymeric particulate material; (ii) at least one thermosetting polymeric particulate material; or (iii) a combination thereof; and
optionally, one or more of (a) at least one humectant; (b) at least one surfactant; and (c) at least one wetting agent.

2. The aqueous formulation according to claim 1, wherein said modified polysaccharide is a cellulose derivative.

3. The aqueous formulation according to claim 2 wherein said cellulose derivative is methylcellulose.

4. The aqueous formulation according to claim 3, wherein said methylcellulose is hydroxypropyl methylcellulose.

5-8. (canceled)

9. The aqueous formulation of claim 1, wherein said modified polysaccharide has a structure: 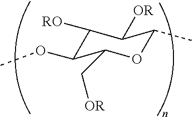
wherein n is an integer being of 3 or more; and
wherein R is selected from the group consisting of: H, CH₃, CH₂COOH, CH₂CH(OH)CH₃, CH₂CH(OH)CH₃, and wherein the various R groups may be the same or different.

10. (canceled)

11. The aqueous formulation of claim 1, wherein said modified polysaccharide has at least one of the following characteristics:
i. a temperature of gelation as measured at 2% concentration by weight in water, or in the aqueous treatment formulation, of at least 50° C., or at least 55° C., or at least 57° C., or at least 60° C., or at least 62° C., or at least 65° C., or at least 68° C., or at least 70° C., or at least 75° C., and optionally, at most 120° C., at most 110° C., or at most 105° C., or between 60-120° C., or 60-110° C., or 60-100° C., or 65-110° C., or 65-105° C., or 65-100° C., or 70-110° C., or 70-100° C., or 75-110° C., or 75-100° C., or 80-100° C.;
ii. a viscosity in mPa·s, as measured in 2% concentration by weight in water at 25° C., of at most 11, at most 10, at most 9, at most 8, at most 7, at most 6, at most 5, at most 4, and optionally, at least 0.5 or at least 1, or at least 2 or a viscosity within a range of 0.5-10, 1-8, 2-8, 2-5, or 2-4;
iii. a hydroxypropyl substitution of at least 1%, 2%, 4%, 6%, 7% or between 1-30%, 5-25%, 5-20%, 5-10%, 7-9% or 7.3-8.3% or a hydroxypropyl substitution, on a molar basis, of at least 0.1, or at least 0.15 or at least 0.2 or between 0.1-1.0, 0.1-0.9, 0.1-0.7 or 0.1-0.3;
iv. a number average molecular weight, in Daltons, of at most 13,000 or at most 12000, or at most 11000, or at most 10,000, or at most 9000, or at most 8000.

12-59. (canceled)

60. The aqueous formulation of claim 1, wherein said particulate material is provided in a form of an emulsion and/or a dispersion and wherein a concentration of said emulsion and/or dispersion within the aqueous treatment formulation is at least about 0.5% and at most about 15%, by weight relative to the total weight of the formulation.

61. The aqueous formulation of claim 1, wherein said particulate material has a particle size of between about 1 nm to about 500 nm.

62. (canceled)

63. The aqueous formulation of claim 1, wherein said thermosetting polymeric particulate material is a hydrophobic particulate material.

64. The aqueous formulation of claim 63, wherein said hydrophobic particulate material is a polymer selected from polytetrafluoroethylene (PTFE), perfluoroalkoxy alkane (PFA) or fluorinated ethylene propylene (FEP).

65. The aqueous formulation of claim 64, wherein said hydrophobic particulate material is PTFE.

66-70. (canceled)

71. The aqueous formulation of claim 1, wherein said thermoplastic polymeric particulate material is a wax particulate material.

72. The aqueous formulation of claim 71, wherein said wax particulate material is an oxidized polyethylene wax particulate material.

73-75. (canceled)

76. The aqueous formulation of claim 1, wherein said at least one thermoplastic polymeric particulate material is provided in a form of an emulsion, optionally wherein said emulsion being a cationic emulsion.

77. The aqueous formulation of claim 76, wherein said cationic emulsion is an emulsion of a particulate oxidized polyethylene wax.

78. (canceled)

79. The aqueous formulation of claim 1, wherein said thermoplastic polymeric particulate material is a coated wax particulate material.

80. The aqueous formulation of claim 79, wherein said coated wax particulate material is a particulate wax material coated with silicon dioxide.

81-84. (canceled)

85. A method of indirect printing comprising:
a. providing an intermediate transfer member (ITM) comprising a release layer surface;
b. providing the aqueous formulation of claim 1;
c. applying the aqueous formulation onto the ITM release layer surface to form thereon a wet layer having a thickness of at most about 1.0 μm;
d. subjecting the wet layer to a drying process to form a dried film layer, from the wet layer, on the ITM release layer surface, said dried film layer optionally having a thickness of at least about 20 nm and at most about 200 nm;
e. depositing droplets of an aqueous ink onto the dried film to form an ink image on the release layer surface of the ITM release layer surface;
f. optionally drying the ink image to leave an ink-image residue on the ITM release layer surface; and
g. transferring the ink-image residue onto a printing substrate by pressured contact between the ITM and the printing substrate.

86-87. (canceled)

88. The method of claim 85, wherein in said dried film on the ITM release layer surface the diameter or longest axis of said particulate material is substantially parallel to the ITM, and optionally wherein said particulate material substantially two dimensional disc-like shape with a diameter constituting the longest assess of the particulate material.

89-103. (canceled)

104. A system for printing, the system comprising:
a. an intermediate transfer member (ITM) comprising a release layer surface;
b. a quantity of the aqueous formulation according to claim 1;
c. a treatment station for applying the aqueous formulation to the ITM surface to form thereon a wet layer having a thickness of at most about 1.0 μm;
d. an image forming station for forming ink images on the ITM by depositing droplets of an aqueous ink upon the ITM surface after the wet layer has dried into a dried film so that the droplets are applied to the dried film, said dried film layer optionally having a thickness of at least about 20 nm and at most about 200 nm; and
e. a transfer station for transferring the ink images from the ITM to a substrate.

105. (canceled)

106. A printing system comprising:
a. an intermediate transfer member comprising a flexible endless belt mounted over a plurality of guide rollers;
b. an image forming station configured to form ink images upon a surface of the ITM, first and second of the guide rollers being arranged upstream and downstream of the image forming station to define an upper run passing through the image forming station and a lower run;
c. an impression station through which the lower run of the ITM passes, the impression station being disposed downstream of the image forming station and configured to transfer the ink images from the ITM surface to substrate; and
d. a treatment station disposed downstream of the impression station and upstream of the image forming station for forming a uniform thin layer of a liquid formulation onto the ITM surface at the lower run thereof, the treatment station comprising:
e. a coater for coating the ITM with the aqueous formulation according to claim 1; and
f. a coating thickness-regulation assembly for removing excess liquid so as to leave only a desired uniform wet thin layer of the formulation, said layer having a thickness of at most about 1.0 μm, the coating thickness-regulation assembly comprising a rounded tip facing the ITM surface at the lower run.

107-108. (canceled)

109. A method of improving at least one mechanical property of a printed ink image (on a substrate) comprising:
a. providing an intermediate transfer member (ITM) comprising a release layer surface;
b. providing an aqueous formulation according to claim 1;
c. applying the aqueous formulation onto the ITM release layer surface to form thereon a wet (treatment) layer having a thickness of at most about 1.0 μm;
d. optionally subjecting the wet (treatment) layer of (c) to a drying process to form a dried (treatment) film layer, from the wet (treatment) layer, on the ITM release layer surface, said dried film layer optionally having a thickness of at least about 20 nm and at most 200 nm;
e. depositing droplets of an aqueous ink onto the optionally dried (treatment) film to form an ink image on the release layer surface of the ITM release layer surface;
f. drying the ink image to leave an ink-image residue on the ITM release layer surface; and
g. transferring the ink-image residue onto a printing substrate by pressured contact between the ITM and the printing substrate;
to thereby produce a printed ink image on a substrate, wherein said printed ink image has at least one mechanical property improved compared to an ink image produced with said aqueous formulation but without the particulate material.

110. (canceled)

111. The method of claim 109, wherein said mechanical property is rub resistance.

112. (canceled)

113. A printed article comprising:
(i) a substrate;
(ii) one or more ink dots fixedly adhered to at least a region of a surface of said substrate, said ink dot may be continuous thereby forming an ink film on said substrate or may be spaced apart from each other;
wherein said one or more ink dots and said at least a region of said surface of said substrate are covered with a substantially dry film layer optionally having a thickness of at least about 20 nm and at most about 200 nm and wherein said substantially dry film layer comprises one or more of (i) at least one thermoplastic polymeric particulate material; and (ii) at least one thermosetting polymeric particulate material.

114-140. (canceled)

141. The printed article of claim 113, wherein said film layer further comprises one or more of (i) at least one modified polysaccharide; (ii) at least one surfactant; (iii) at least one humectant; (iv) at least one wetting agent; and (v) at least one antibacterial agent.

142. (canceled)

143. The printed article of claim 113, wherein said article has improved one or more mechanical property in comparison with a printed article lacking said particulate material.

144. The printed article of claim 143, wherein said improved mechanical property is manifested in ink containing regions on said substrate.

145. The printed article of claim 144, wherein said improved mechanical property is manifested in regions of the surface of said substrate which are coated with said substantially dry film layer and are free of ink.

146. (canceled)

147. The printed article of claim 141, wherein said mechanical property is rub resistance.

148-151. (canceled)

152. An intermediate transfer member comprising a release layer surface, wherein said surface is substantially covered with a substantially dry continuous film layer comprising one or more of (i) at least one thermoplastic polymeric particulate material and (ii) at least one thermosetting polymeric particulate material, and wherein the thickness of said substantially dry continuous film layer being of at least about 20 nm and at most about 200 nm, wherein said substantially dry film layer further comprises one or more of (i) at least one modified polysaccharide; (ii) at least one surfactant; (iii) at least one humectant; (iv) at least one wetting agent; and (v) at least one antibacterial agent.

153-155. (canceled)

156. The intermediate transfer member of claim 152 wherein the particulate material is embedded in the substantially dry film layer with substantially no protrusion thereof from the surface of said layer.

157-158. (canceled)

159. The article of claim 145 wherein the particulate material is embedded in said dry film layer with substantially no protrusion thereof from the surface of said layer, said surface being the surface distal to the surface of the substrate.
